(19) United States
(12) Patent Application Publication
(10) Pub. No.: US 2016/0063415 A1
(43) Pub. Date: Mar. 3, 2016

(54) CROP PRODUCTION SYSTEM

(71) Applicant: North Central Cooperative, Clarion, IA (US)

(72) Inventor: Gary Olson, Clarion, IA (US)

(21) Appl. No.: 14/743,431

(22) Filed: Jun. 18, 2015

Related U.S. Application Data
(60) Provisional application No. 62/013,537, filed on Jun. 18, 2014.

(51) Int. Cl. G06Q 10/06; G06Q 10/08; G06Q 50/02; G06Q 30/02

(52) U.S. Cl. CPC G06Q 10/06313; G06Q 30/0283; G06Q 10/0875; G06Q 50/02

(57) ABSTRACT

A system for crop production management includes instructions executing on a computing device for collecting and displaying field specific agricultural data and business data sufficient for a crop producer to make determinations regarding agricultural inputs including seed, fertilizer, and chemicals; an ordering system associated with a back-end computing system for providing pricing for the agricultural inputs on a per unit basis and on a field-by-field basis; and an inventory system associated with the back-end computing system and operatively connected to the ordering system for updating inventory for the agricultural inputs associated with an agricultural service business providing the agricultural inputs to the crop producer; wherein the back-end computing system is in operative communication with the computing device.

### CROSS-REFERENCE TO RELATED APPLICATIONS

This application claims priority to U.S. Provisional Patent Application No. 62/013,537, filed Jun. 18, 2014, hereby incorporated by reference in its entirety.

### FIELD OF THE INVENTION

The present invention relates to agricultural technologies. More particularly, but not exclusively, the present invention relates to computer-implemented systems to perform planning and analysis association with crop production operations.

### BACKGROUND OF THE ART

In recent times, it has generally been recognized that agricultural operations can be improved through the collection or use of agriculture related data. Various entities have developed and released computer-based tools which attempt to do so. However, there have been a number of issues associated with such attempts.

First, often times such attempts at improving certain measures of crop performance do not take into account the financial side of agricultural operations. Second, such attempts are not holistic in their approach and do not take into account sufficient information so that a crop producer receives the information they need to make informed business decisions. Third, such attempts are limited in focus such as being overly focused on plant genetics or overly focused on data acquired from farm equipment. Fourth, such attempts may be tied to a particular manufacturer and so not of utility to a farming operation using inputs from multiple chemical or seed manufacturers. Therefore problems remain. What are needed are improved methods and systems for agricultural planning and analysis.

Another significant problem facing crop producers is government compliance. It is likely that crop producers will be faced with an increasing number of rules, regulations, and requirements from various governmental bodies. Therefore, improved methods and systems for compliance will be needed.

### SUMMARY OF THE INVENTION

Therefore, it is a primary object, feature, or advantage of the present invention to improve over the state of the art.

It is a further object, feature, or advantage of the present invention to provide a comprehensive system for performing planning and analysis of crop production operations.

A further object, feature, or advantage of the present invention is to provide a cooperative management tool which performs functions such as, but not limited to, split billing, tracking profit and loss, efficient entries, product inventory, and successful grain marketing.

A still further object, feature, or advantage of the present invention is to provide a crop producer management which performs functions such as, but not limited to, soil and seed management, technology management, environmental management, product placement, and site specific management.

Another object, feature, or advantage of the present invention is to provide a compliance management tool to assist in tracking and ensuring compliance with government regulations such as, but not limited, to spraying and application logs, tracking, environmental regulations, government program details, and seed traits.

A still further object, feature, or advantage of the present invention is to improve the relationship between and communications between crop producers and agricultural service providers.

One or more of these and/or other objects, features, or advantages of the present invention will become apparent from the specification and claims that follow. No single embodiment need meet or include each object, feature, or advantage as different embodiments may have different objects, features, or advantages.

According to one aspect, a system for crop management is provided. The system includes instructions executing on a computing device for collecting and displaying field specific agricultural data and business data sufficient for a crop producer to make determinations regarding agricultural inputs comprising seed, fertilizer, and chemicals. The system further includes an ordering system associated with a back-end computing system for providing pricing for the agricultural inputs on a per unit basis and on a field-by-field basis, and an inventory system associated with the back-end computing system and operatively connected to the ordering system for updating inventory for the agricultural inputs associated with an agricultural service business providing the agricultural inputs to the crop producer. The back-end computing system may be in operative communication with the computing device.

According to another aspect, a method includes providing through a software system executing on a computer to a crop producer field specific agricultural data and business data sufficient for a crop producer to make determinations regarding agricultural inputs including seed, fertilizer, and chemicals. The method further includes recording ordering information for crop-producer ordered seed, fertilizer, and chemicals, and tracking pickup, delivery, and returns of the crop-producer ordered seed, fertilizer, and chemicals.

### BRIEF DESCRIPTION OF THE DRAWINGS

FIG. 1A illustrates interaction between three of the components of the system, namely a decision making tool for producers, a strategic business tool for retail businesses, and a compliance tool for government regulations.

FIG. 1B illustrates representative types of field information.

FIG. 1C illustrates an example of all operations of an enterprise, the separate business entities associated with the enterprise with different billing splits, and the separate fields associated with the different business entities.

FIG. 1D illustrates one example of a field order process.

FIG. 2A illustrates data which may be used in the various tools described.

FIG. 2B illustrates various components of the system.

FIG. 2C illustrates a system.

FIG. 3 illustrates a worksheet associated with a field.

FIG. 4 illustrates another example of a worksheet.

FIG. 5 illustrates another example of a worksheet.

FIGS. 6A, 6B, 6C, 6D, 6E, 6F, 6G, 6H, 6I, and 6J illustrate one example of a field fertilizer needs worksheet.

FIGS. 7A, 7B, 7C, 7D, 7E, 7F, 7G, 7H, and 7I illustrate a worksheet for fertilizer cost.

FIGS. 8A,8B, 8C, 8D, 8E, 8F, 8G, 8H, 8I, 8J, 8K, 8L, 8M, 8N, 8O, and 8P illustrate an example of a worksheet for corn chemistry.

FIGS. 9A, 9B, 9C, 9D, 9E, 9F, 9G, 9H, 9I, 9J, 9K, 9L, 9M, 9N, 9O, 9P, and 9Q illustrate an example of a worksheet for soybean chemistry.

FIGS. 10A, 10B, 10C, 10D, 10E, 10F, 10G, and 10H illustrate an example of a worksheet for corn hybrids.

FIGS. 11A, 11B, 11C, 11D, 11E, and 11F illustrate an example of worksheet for soybean varieties.

FIGS. 12A, 12B, 12C, 12D, 12E, and 12F illustrate an example of a worksheet for other crop chemistry.

FIGS. 13A and 13B illustrate an example of a worksheet for corn cash flow.

FIG. 14 illustrates an example of a worksheet for soybean cash flow.

FIGS. 15A and 15B illustrates an example of a worksheet associated with field steps.

FIGS. 16A, 16B, 16C, 16D, 16E, 16F, 16G, and 16H illustrate one example of a field fertilizer needs worksheet.

FIG. 17 illustrate an example of a worksheet for corn chemistry.

FIG. 18 is an example of a worksheet for soybean chemistry.

FIG. 19 illustrate an example of a worksheet for other crop chemistry.

FIG. 20 illustrate an example of a worksheet for corn hybrids.

FIG. 21 illustrate an example of worksheet for soybean varieties.

FIG. 22 illustrate a worksheet for other seed cost.

FIG. 23 illustrates a worksheet associated with a field map.

FIG. 24 illustrates a worksheet associated with a soil map.

FIGS. 25A, 25B, 25C, 25D, 25E, 25F, 25G, 25H, and 25I illustrate a worksheet for fertilizer cost.

FIG. 26 illustrates another example of a worksheet.

FIG. 27 illustrates another example of a worksheet.

FIGS. 28A and 28B illustrates an example of a worksheet associated with field steps.

FIG. 29 illustrate one example of a field fertilizer needs worksheet.

FIG. 30 illustrate an example of a worksheet for corn chemistry.

FIG. 31 an example of a worksheet for soybean chemistry.

FIG. 32 illustrate an example of a worksheet for other crop chemistry.

FIG. 33 illustrate an example of a worksheet for corn hybrids.

FIG. 34 illustrate an example of worksheet for soybean varieties.

FIG. 35 illustrate a worksheet for other seed cost.

FIG. 36 illustrates a worksheet associated with a field map.

FIG. 37 illustrates a worksheet associated with a soil map.

FIGS. 38A, 38B, 38C, 38D, 38E, 38F, 38G, 38H, and 38I illustrate a worksheet for fertilizer cost.

FIG. 39 illustrates another example of a worksheet.

FIG. 40 illustrates another example of a worksheet.

FIGS. 41A and 41B illustrates an example of a worksheet associated with field steps.

FIGS. 42A and 42B illustrate one example of a field fertilizer needs worksheet.

FIGS. 43A, 43B, and 43C illustrate an example of a worksheet for corn chemistry.

FIGS. 44A, 44B, and 44C an example of a worksheet for soybean chemistry.

FIGS. 45A, 45B, and 45C illustrate an example of a worksheet for other crop chemistry.

FIGS. 46A and 46B illustrate an example of a worksheet for corn hybrids.

FIGS. 47A and 47B illustrate an example of worksheet for soybean varieties.

FIGS. 48A and 48B illustrate a worksheet for other seed cost.

FIG. 49 illustrates a worksheet associated with a field map.

FIG. 50 illustrates a worksheet associated with a soil map.

FIGS. 51A, 51B, 51C, 51D, 51E, 51F, 51G, 51H, and 51I illustrate a worksheet for fertilizer cost.

FIG. 52 illustrates another example of a worksheet.

FIG. 53 illustrates another example of a worksheet.

FIGS. 54A and 54B illustrate an example of a worksheet associated with field steps.

FIG. 55 illustrate one example of a field fertilizer needs worksheet.

FIG. 56 illustrate an example of a worksheet for corn chemistry.

FIG. 57 an example of a worksheet for soybean chemistry.

FIG. 58 illustrate an example of a worksheet for other crop chemistry.

FIG. 59 illustrate an example of a worksheet for corn hybrids.

FIG. 60 illustrate an example of worksheet for soybean varieties.

FIG. 61 illustrate a worksheet for other seed cost.

FIG. 62 illustrates a worksheet associated with a field map.

FIG. 63 illustrates a worksheet associated with a soil map.

FIGS. 64A, 64B, 64C, 64D, 64E, 64F, 64G, 64H, and 64I illustrate a worksheet for fertilizer cost.

FIG. 65 illustrates another example of a worksheet.

FIG. 66 illustrates another example of a worksheet.

FIGS. 67A and 67B illustrate an example of a worksheet associated with field steps.

FIG. 68 illustrate one example of a field fertilizer needs worksheet.

FIG. 69 illustrate an example of a worksheet for corn chemistry.

FIG. 70 an example of a worksheet for soybean chemistry.

FIG. 71 illustrate an example of a worksheet for other crop chemistry.

FIG. 72 illustrate an example of a worksheet for corn hybrids.

FIG. 73 illustrate an example of worksheet for soybean varieties.

FIG. 74 illustrates a worksheet associated with a field map.

FIG. 75 illustrates a worksheet associated with a soil map.

FIGS. 76A, 76B, 76C, 76D, 76E, 76F, 76G, 76H, and 76I illustrate a worksheet for fertilizer cost.

FIG. 77 illustrates another example of a worksheet.

FIG. 78 illustrates another example of a worksheet.

FIGS. 79A, 79B, 79C, 79D, 79E, 79F, and 79G illustrate server data associated with a backend system.

FIG. 80 is a screen display illustrating an account fields map view.

FIG. 81 is a screen display illustrating an account fields table.

FIG. 82 is a screen display illustrating an account home screen.

FIG. 83 is a screen display illustrating an actions list.

FIG. 84 is a screen display illustrating an add existing account page.

FIG. 85 is a screen display illustrating an add split group page.

FIG. 86 is a screen display illustrating a create new account page.

FIG. 87 is a screen display illustrating a create new enterprise page.

FIG. 88 is a screen display illustrating a dashboard page.

FIG. 89 is a screen display illustrating a dashboard ownerless fields page.

FIG. 90 is a screen display illustrating an edit field info page.

FIG. 91 is a screen display illustrating an edit field info page.

FIG. 92 is a screen display illustrating an enterprise edit page.

FIG. 93 is a screen display illustrating an enterprise home screen page.

FIG. 94 is a screen display illustrating an enterprise map view page.

FIG. 95 is a screen display illustrating an enterprise table view page.

FIG. 96 is a screen display illustrating a field creator page.

FIG. 97 is a screen display illustrating a field creator full screen.

FIG. 98 is a screen display illustrating a field overview page.

FIG. 99 is a screen display illustrating a field summary table edit page

FIG. 100 is a screen display illustrating a field yearly and historical data page.

FIG. 101 is a screen display illustrating a field summary table page.

FIG. 102 is a screen display illustrating a home screen page.

FIG. 103 is a screen display illustrating a location home screen page.

FIG. 104 is a screen display illustrating a chemical new order page.

FIG. 105 is a screen display illustrating a chemical new order page with price override.

FIG. 106 is a screen display illustrating a chemical new order calculate page.

FIG. 107 is a screen display illustrating a fertilizer new order page.

FIG. 108 is a screen display illustrating a fertilizer new order calculation page.

FIG. 109 is a screen display illustrating a new order proposal overall page.

FIG. 110 is a screen display illustrating a new order proposal overall page.

FIG. 111 is a screen display illustrating an orders page.

FIG. 112 is a screen display illustrating a print field map page.

FIG. 113 is a screen display illustrating a print fields summary page.

FIG. 114 is a screen display illustrating a search page.

FIG. 115 is a screen display illustrating a search bar being used.

FIG. 116 is a screen display illustrating a split group home screen page.

FIG. 117 is a screen display illustrating a SSURGO field map page.

### DETAILED DESCRIPTION

A comprehensive system for crop production planning is provided. The comprehensive system recognizes the interactions between crop producers, agricultural service businesses such as agricultural cooperatives, and governments. Moreover, the comprehensive system which may be implemented by an agricultural service business provides significant benefits to the agricultural service business, producers who transact business with the agricultural service business, and the government who has as an interest in the producers and agricultural service businesses complying with applicable recommendations, rules and regulations. Although a comprehensive system is provided it is contemplated that only portions of the comprehensive system described may be used in a particular application or implementation.

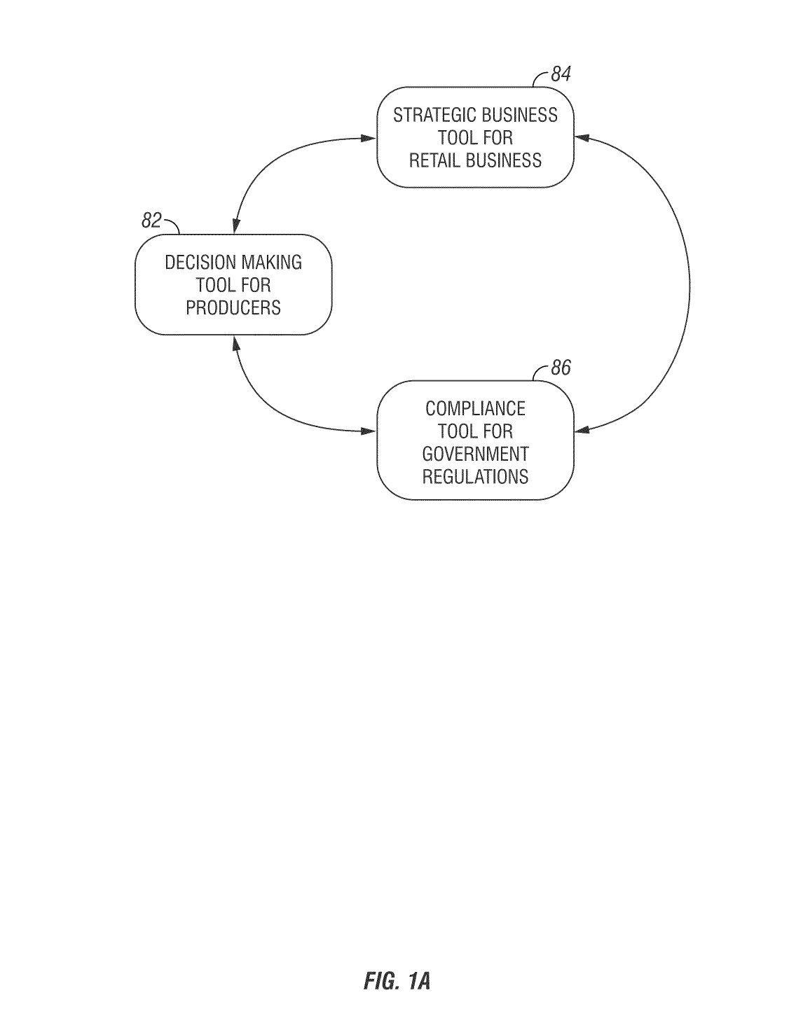

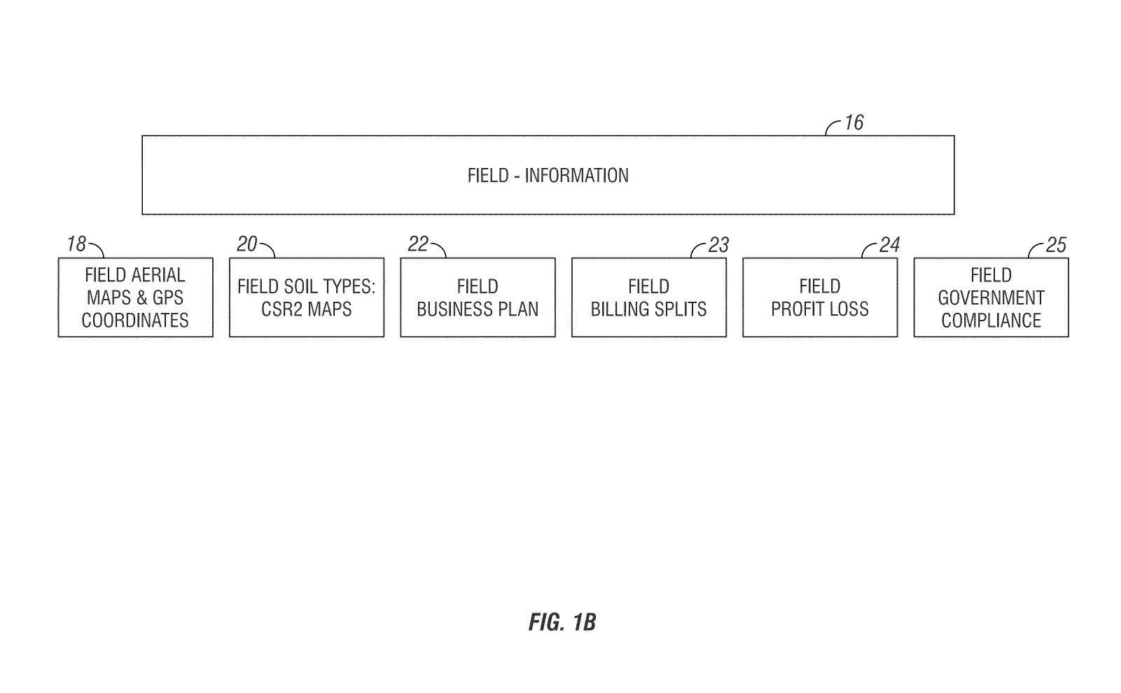

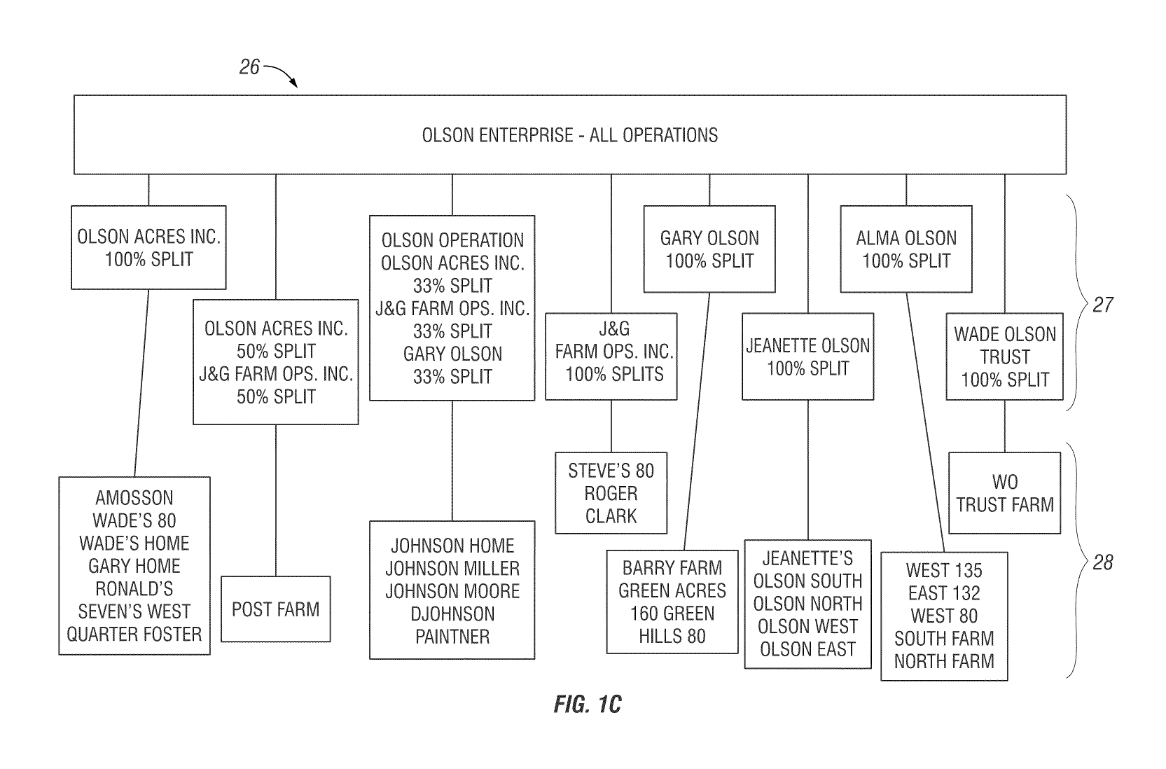

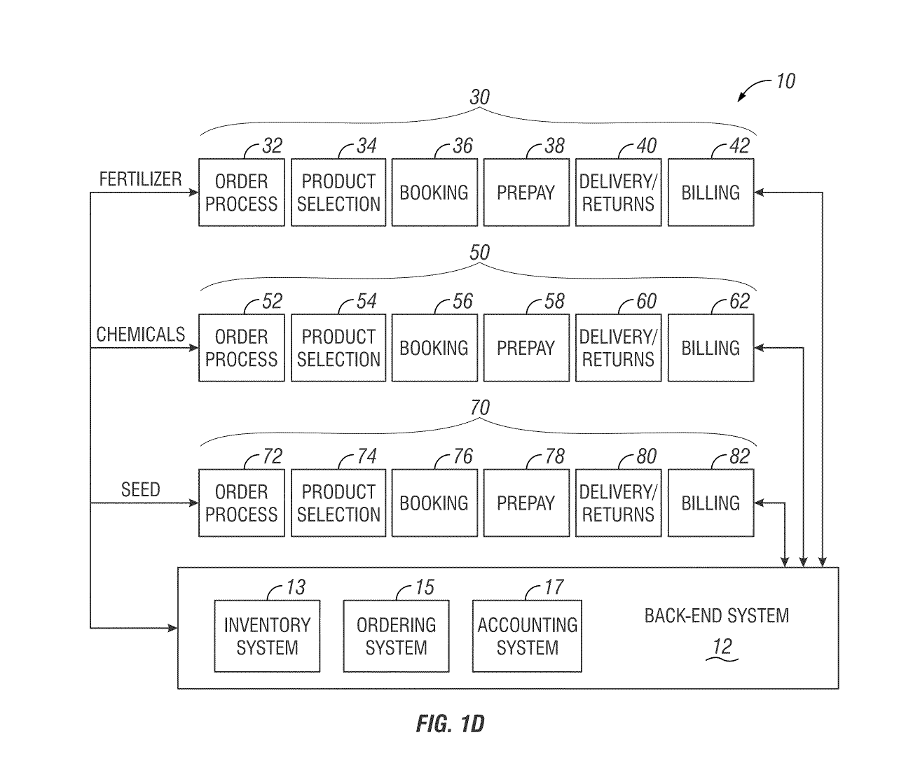

FIG. 1A illustrates interaction between three of the components of the system, namely a decision making tool for producers, a strategic business tool for retail businesses, and a compliance tool for government regulations. The components include a decision making tool for producers 82, a strategic business tool for retail businesses 84, and a compliance tool for government regulations 86. Each of these tools may make use of one or more components of the system and described herein.

FIG. 1B illustrates representative types of field information that may be using a system to assist in planning which may be provided by a field information planning component 16 which may include components for field aerial maps and GPS coordinates 18, field soil types such as CSR2 maps 20, a field business plan 22, field billing splits 23, field profit or loss 24 and field government compliance 25.

FIG. 1C illustrates an example of all operations of an enterprise 26, the separate business entities 27 associated with the enterprise with different billing splits, and the separate fields 28 associated with the different business entities. It is to be understood that a given enterprise may involve multiple different entities and that for some fields there may be a split or sharing of income and expenses. Knowledge of such information is important to be able to provide split billing.

FIG. 1D illustrates one example of a system 10. The system 10 includes a back-end system 12 which may include an AS/400 computer system running operations software for an agricultural cooperative. The back end system 12 may include an inventory system 13, an ordering system 15, and an accounting system 17. The back end system 12 may be used for general business operations.

Also shown, in FIG. 1D is a component 30 associated with fertilizer, a component 50 associated with chemicals, and a component 70 associated with seed. Other components associated with agricultural inputs may also be present. Each of these components may be implemented using one or more worksheets from a spreadsheet program such as Microsoft Excel. Each of these components may be operatively connected to the back-end system 12. In operation, each of these components may communicate with the back-end system to convey information such as inventory availability for different products, the costs of different products, account information, etc. Each of these components may operate as a series of instructions of a software application stored on a non-transitory computer readable medium which executes on a computing device and an associated user interface may be provided to prompt users for information, display results of an analysis and for other purposes.

With respect to the fertilizer component 30, different sub-components may be present. This may include components for an order process 32, product selection 34, booking 36, pre-pay 38, and delivery/returns 40, and billing 42. Similarly, for the chemicals component 50, different sub-components may be present. This may include components for the order process 52, product selection 54, booking 56, prepay 58, delivery/returns 60, and billing 62. Similarly, for the seed component 70, different sub-components may be present. This may include components for the order process 72, the product selection 74, booking 76, prepay 78, delivery/returns 80, and billing 82.

As previously explained, the various components within the system may be stored on non-transitory computer or machine readable storage medium as a series of instructions. The various components can be implemented programmatically in various ways using any number of computer platforms, computer applications, and/or software development tools.

One of the benefits of the various methods and systems described herein is that it provides farmers or crop producers with data needed to make crop production decisions. Moreover, these decisions can be made on a field-by-field basis and include decisions such as the specific type of seed to plant, fertilizer to be applied, chemicals to be used and how those decisions can effect profit or loss. Moreover, decisions such as the amount of the crop inputs and timing of payments can also be taken into account and factored into the analysis.

Another benefit relates to the benefits provided to an agricultural services business such as an agricultural cooperative. By providing agricultural producers with the information needed to make decisions, agricultural producers can make decisions regarding agricultural inputs which are obtained from the agricultural services business. Moreover, the tool can be used for providing up-front pricing and to enhance inventory controls. By assisting crop producers in making decisions regarding product ordering, crop producers are more likely to order an appropriate amount of products reducing total returns. Thus, the system provides various advantages to agricultural service businesses as well as the producer.

It is to be understood that another benefit of the system relates to government compliance. Note that each field may be tracked individually including the agricultural inputs which are applied to the field such as seed, chemicals, fertilizer, herbicide, insecticide, fungicide, etc. Further note that within each plan not just an amount of each agricultural input recommended, planned, or sold for the field is provided, but rather the actual amount used within the field is tracked. Thus, accurate information is generated and maintained. This can be useful in compliance with existing regulations or recommendations as well as future government regulations. For example, if environmental regulations are enacted limiting the application of fertilizer applied, then this can be planned for in the appropriate worksheet or program component and can be tracked to provide a record of compliance. Thus, worksheets or components described herein may be used as a compliance tool to assist with government regulations.

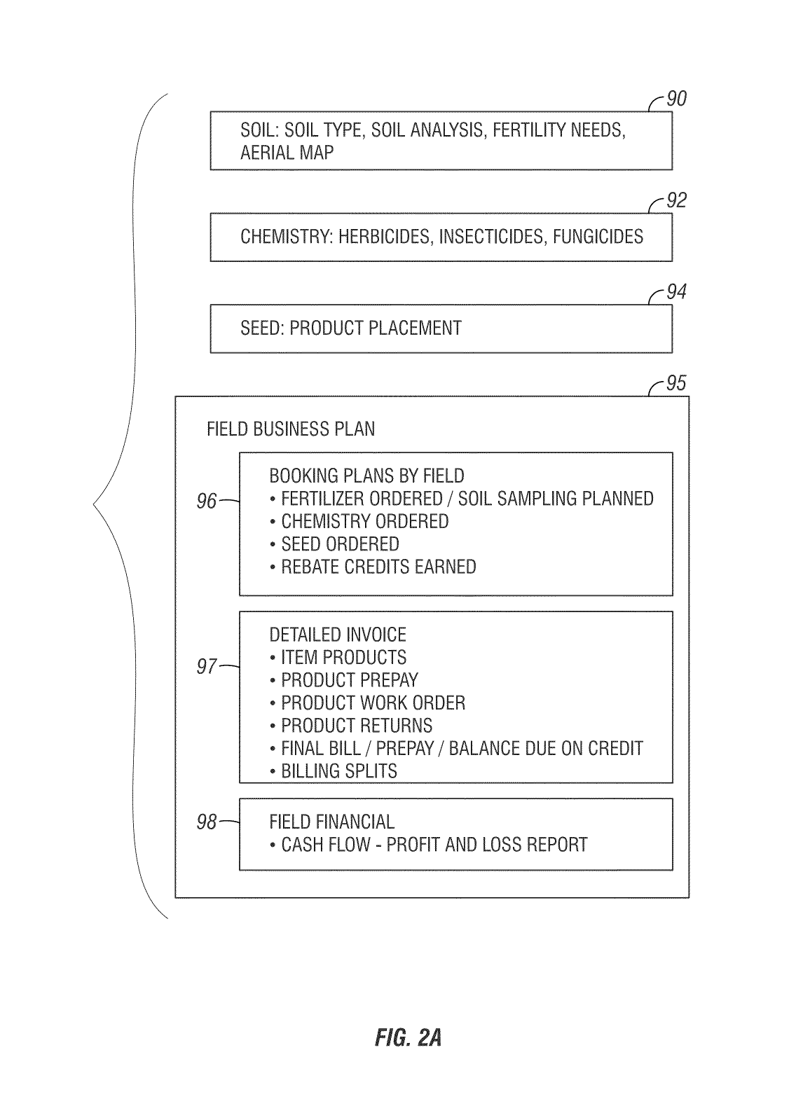

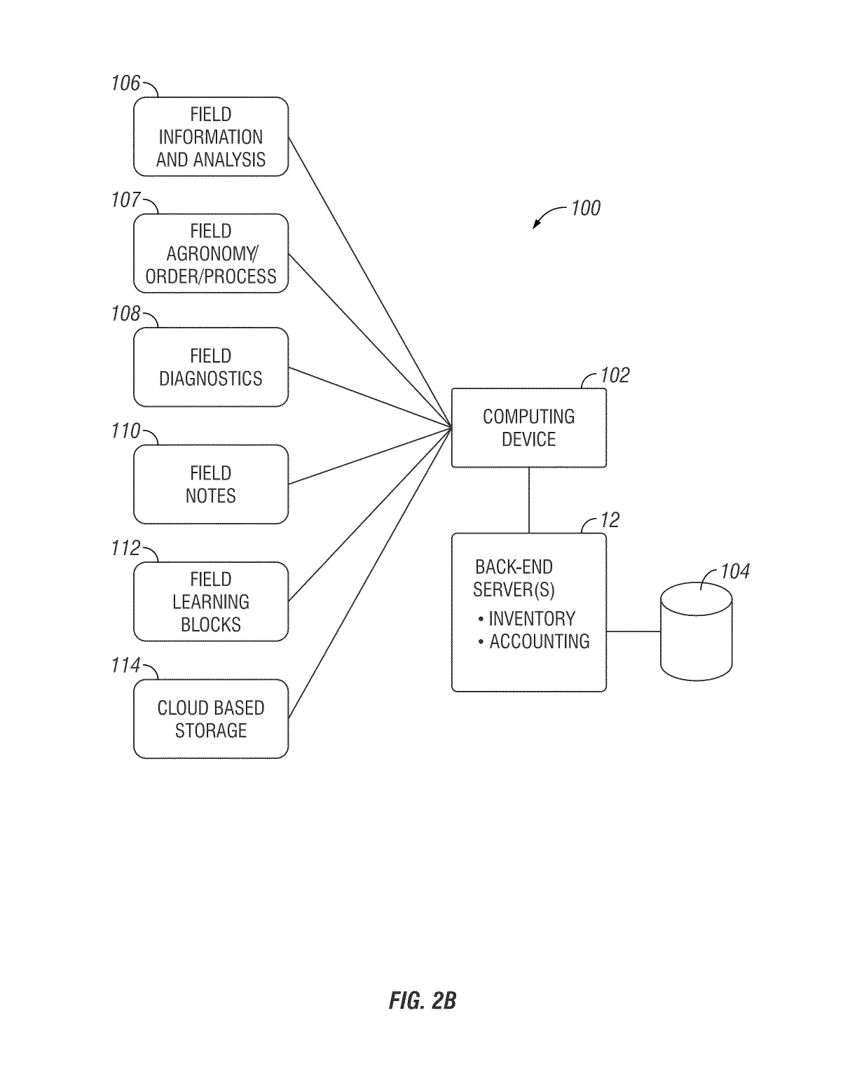

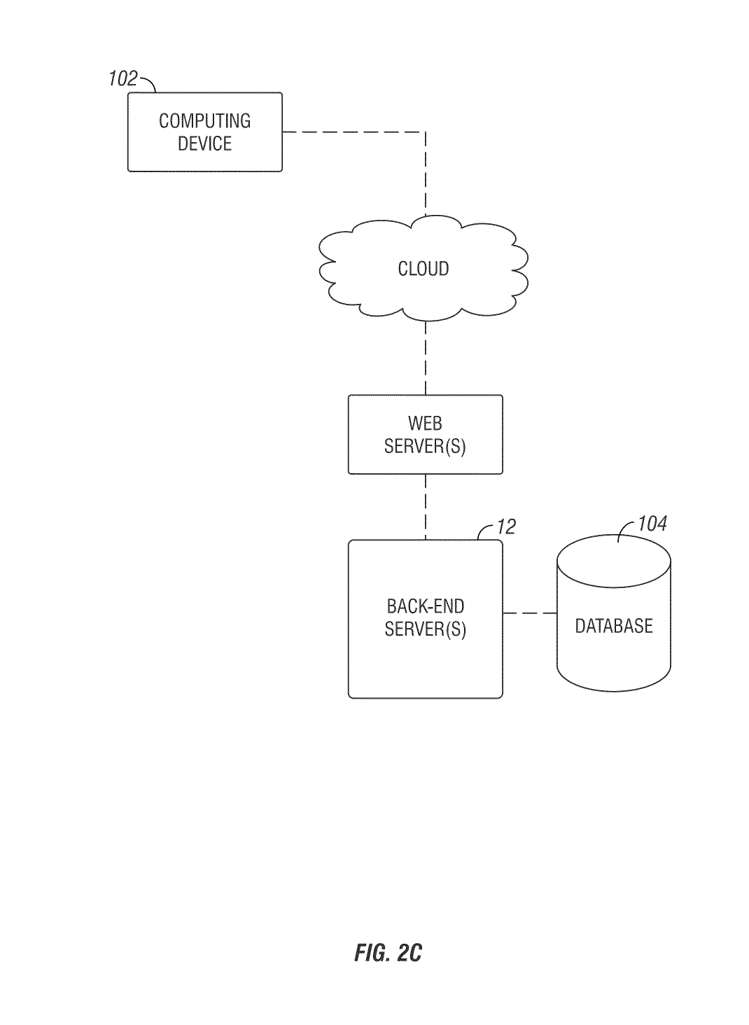

FIG. 2A illustrates data which may be used in in the various tools described. The data may include soil data 90. Soil data may include soil type data, soil analysis data, fertility needs, and aerial maps.

The data may further include chemistry data 92. The chemistry data may include data associated with herbicides, insecticides, and fungicides.

The data may further include seed data 94.

The data may further include data supporting a field business plan 95. This may include booking plans by field 96. This may include fertilizer ordered or soil sampling planned, chemistry ordered, seed ordered, rebate credits earned, and other data associated with booking plans.

The data may further include detailed invoices 97. This may include items or products ordered, product prepays, product work orders, product returns, and final bills, prepays, balance due on credit, as well as billing splits.

The data may further include field financial data 98 including cash flow and profit and loss reports. Although various types of data are shown and described, it is contemplated that additional data may also be used including marketing data such as future prices, weather data, historical field data, as-planted data, as-applied data for chemical applications, harvest data, genetic analysis data, and other types of data.

FIG. 2B illustrates various components which may be implemented as instructions executing on a computing device 102 or backend servers 12 in operative communication with the computing device 102 as a part of a system 100. Data created by or used by the various components may also be stored in a database 104 associated with the backend system although some data may be stored locally or in cloud storage. The various components include a field information and analysis component 106, a field agronomy/order process 107, a diagnostics component 108, a field notes component 110, field learning blocks 112, and cloud-based storage 114.

The field information and analysis component 160 may provide for collecting, storing, and displaying various information about fields in order to provide total field information. Information may include a field name and a field location which may be specified in various ways such as by county, section or other manner associated with land records, and/or also by GPS information such as latitude and longitude of a central point on the field. Field information may also include billing information for a field to take into account splits. Splits occur where costs and revenues are split between multiple parties. Other information may include maps for the field including aerial maps and soil type maps, yield estimate maps, or other types of maps. Other information may further include historical information for the field including dry year and wet year information. Other information may include field rain fall and hail maps, field historical yield records, FSA reporting and insurance, the number of acres planted, the number of acres harvested, and yield results. Although various examples of field information are discussed it is to be understood that other types of field information may also be included as may be appropriate for a particular crop, a particular type of field, or otherwise.

The field information and analysis component 160 may also provide for a total field analysis program for crops which are grown by the producer. This may include a field fertility removal analysis to show the effects of crop removal, a field fertility analysis plan including a field fertility cost analysis which permits prepayment and determines cost per acre for implementation of the plan. This may further include a field fertilizer applied map, a field fertilizer actual cost analysis, a field fertilizer pre-pay option, a field fertilizer actual costs, a field fertilizer cost analysis showing balance due, and a field fertilizer cost analysis showing billing splits. Field fertilizer inventory may also be tracked and field fertility analysis such as in the form of soil test results may also be provided.

The field information and analysis component 160 may also provide for field chemistry selection for the crops being grown. The field chemistry which is ordered and/or prepaid may be tracked; the field chemistry picked-up and the field chemistry used may also be tracked. Field chemistry applied maps may be generated or imported and a field chemistry actual cost analysis may be performed. This analysis may include tracking the field chemistry prepaid, the field chemistry picked up (or delivered), the field chemistry returned (so that actual use can be determined), the balance due, billing splits, and rebates may also all be analyzed as a part of the actual cost analysis.

Another aspect of the field information and analysis component relates to field seed selection. This may include a data genetic analysis for a field, the number of field seed bags ordered (or other units in which seed is sold) and/or prepaid, the hybrid lot number, the selected traits, the seed size, and the seed treatment. Information may also include the number of field seed bags picked up, the field seed bags used, and a field seed back actual cost analysis. The cost analysis may take into account the number of field seed bags prepaid, pick-up, returned (so that the number actually used can be determined), the balance due, and billing splits. A field hybrid or variety planted acres maps may also be generated.

Another aspect of the field information and analysis component relates to crop profit or loss. This can be used on historical yield per acre data which may be used to determine insurance protection and coverage. Other data an analyses may include an all field input expenses analysis, a projected harvested bushels, an actual harvested bushels, insurance coverage and guarantee per acre and field, projected profit or loss per acre and per field, an actual profit or loss per acre and per field, gross income splits, and grain marketing plan and actual grain marketing.

Another aspect of the field information and analysis component relates to the total of all of a farmer's fields and related analysis. This may include inventory control, pricing adjustments, accounts pre-pay, accounts receivable, accounts payable, account billing splits, grain marketing monitoring, and chemistry rebates.

The field diagnostics component can provide for linking external data to a particular field. This may include field weather, field fertility, field weeds and chemistry, field insects, field diseases, and field seed-genetics. This data may include data from external web sites of data feeds. For example, weather data may be sourced from NOAA. Data may be made available from any number of information services.

The field notes component allows for collecting information regarding what is happening in a field. This may include notes related to field diagnostics or field issues, other field notes, photos, recordings, and a field complaint protocol. This information may come from the producer or may come from an agronomist, crop scout, or other individual associated with the agricultural services business.

The field learning blocks component provides for generating data which may be used to assist crop producers in selection of various agricultural inputs. This data may be collected in various ways including through field trials, field research trials, field harvest data which is dissected by genetics and may be a single year or over multiple fields and this information may all be stored in a database system and used to assist crop producers in product selection.

Cloud-based storage may be used to contain all information related to a field. Then a computing device such as a computer or mobile device may be used to access the data.

FIG. 2B illustrates various components which may be implemented as instructions executing on a computing device 102 or backend servers 12 in operative communication with the computing device 102 as a part of a system 100. Data created by or used by the various components may also be stored in a database 104 associated with the backend system although some data may be stored locally or in cloud storage. The various components include a field information and analysis component 106, a field agronomy/order process 107, a diagnostics component 108, a field notes component 110, field learning blocks 112, and cloud-based storage 114.

FIG. 2C illustrates one example. As shown in FIG. 2C, illustrates another example of a computing device 102 which is in operative communication with one or more web-based servers through the cloud. One or more back-end servers 12 are in operatively communication with the one or more web servers. A database 104 is in operative communication with the one or more back-end servers 12.

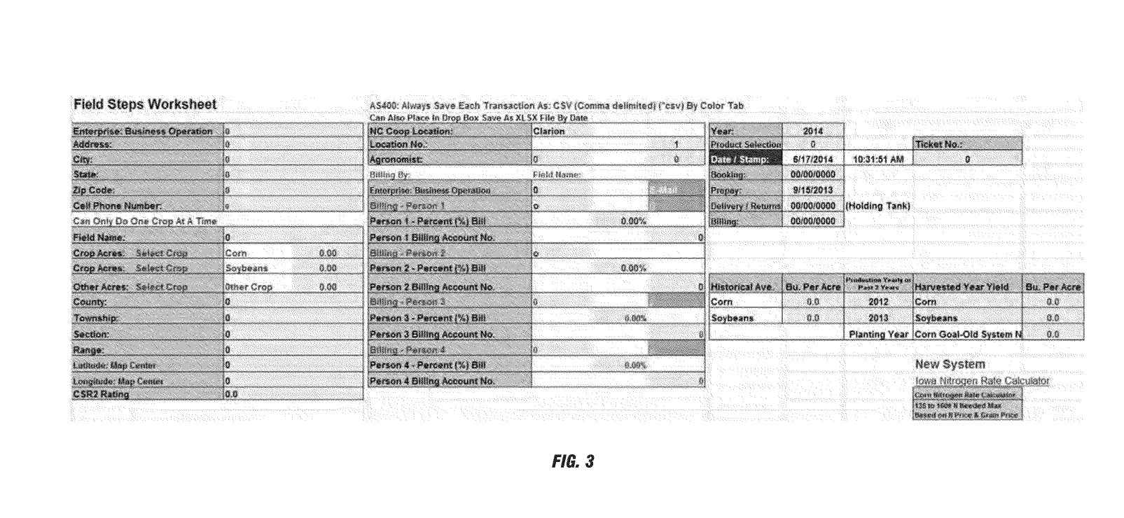

FIG. 3 illustrates a worksheet associated with a field. Information present includes name and contact information for a farmer or producer as well as information for a field or an enterprise (such as a corporation or partnership), the number of crop acres and the number of acres for each type of crop (such as crop, soybeans, wheat, canola, sunflower, etc.) as well as the location of a field which may be specified by county, township, section, range as well as latitude and longitude for a map center. A CSR2 rating may also be included which is a type of soil rating which rates soil types for their potential row-crop productivity.

Information regarding an agricultural services business such as a coop may also be provided. This can include a location of the co-op, and the name of an agronomist. Contact information for the producer and billing information may also be provided. Also shown on FIG. 3 are dates for when a ticket is created, a date when a business plan is created, a booking date, a pick up date, and a return date. Also shown in FIG. 3 are historical yields for different crops planted in the field.

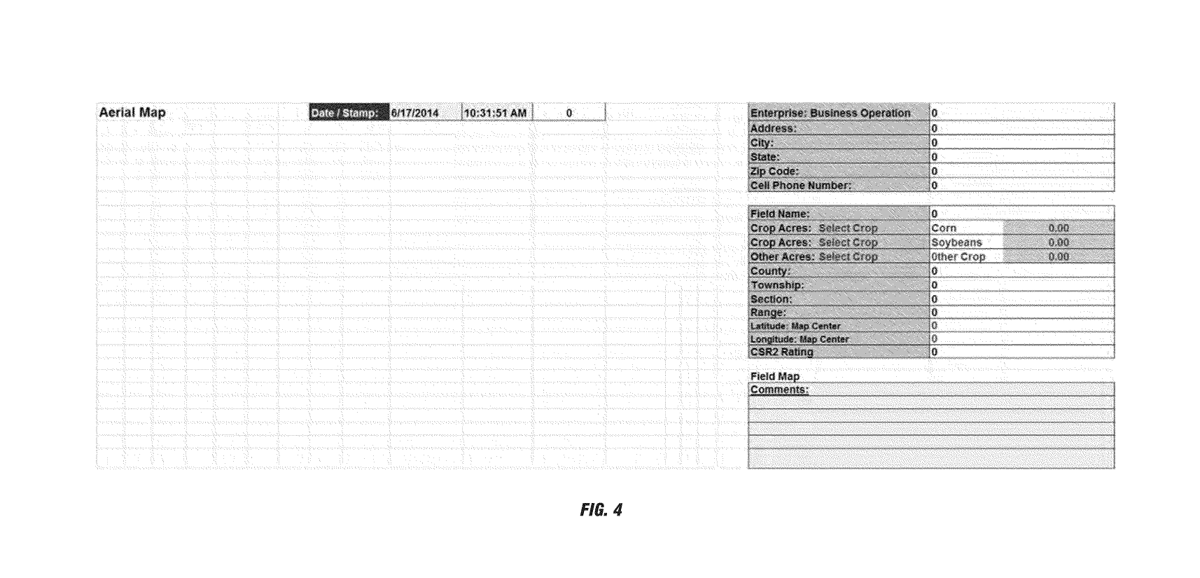

FIG. 4 illustrates another example of a worksheet. The worksheet includes an aerial map of the field. Additional information about the field may be displayed including the name of the farmer or crop producer and associated contact information such as address and phone number. Information about the field is also shown including the name of the field, the number of crop acres for different types of crops, the location of the field such as county, township, section, range, latitude and longitude, and a CSR2 rating. Comments about the field may also be collected.

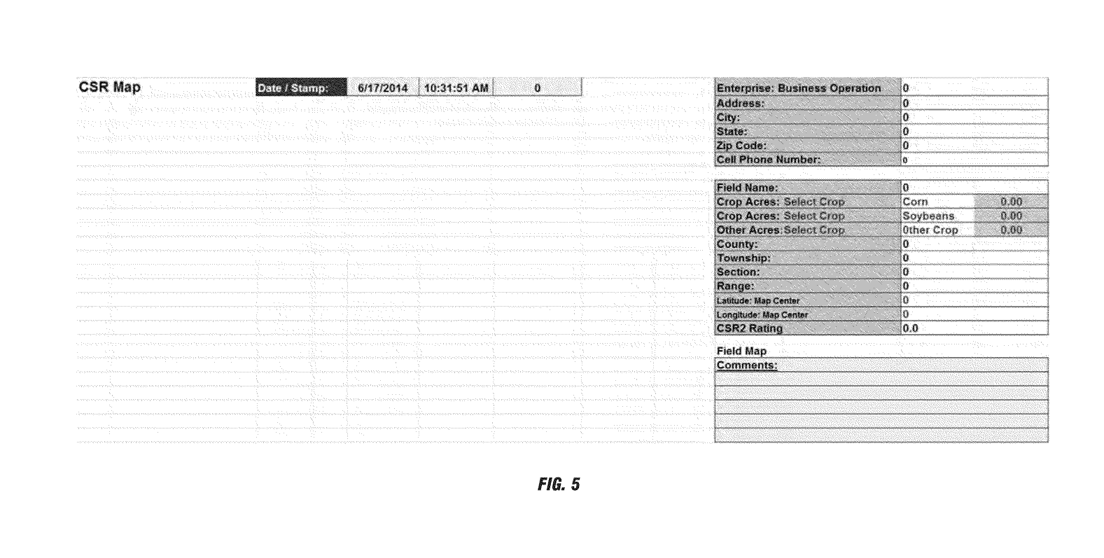

FIG. 5 illustrates another example of a worksheet. The worksheet includes a soil map or CSR map showing different CSR values within the field. Additional information about the field including crop producer contact information, basic field information, field location, and comments may also be provided.

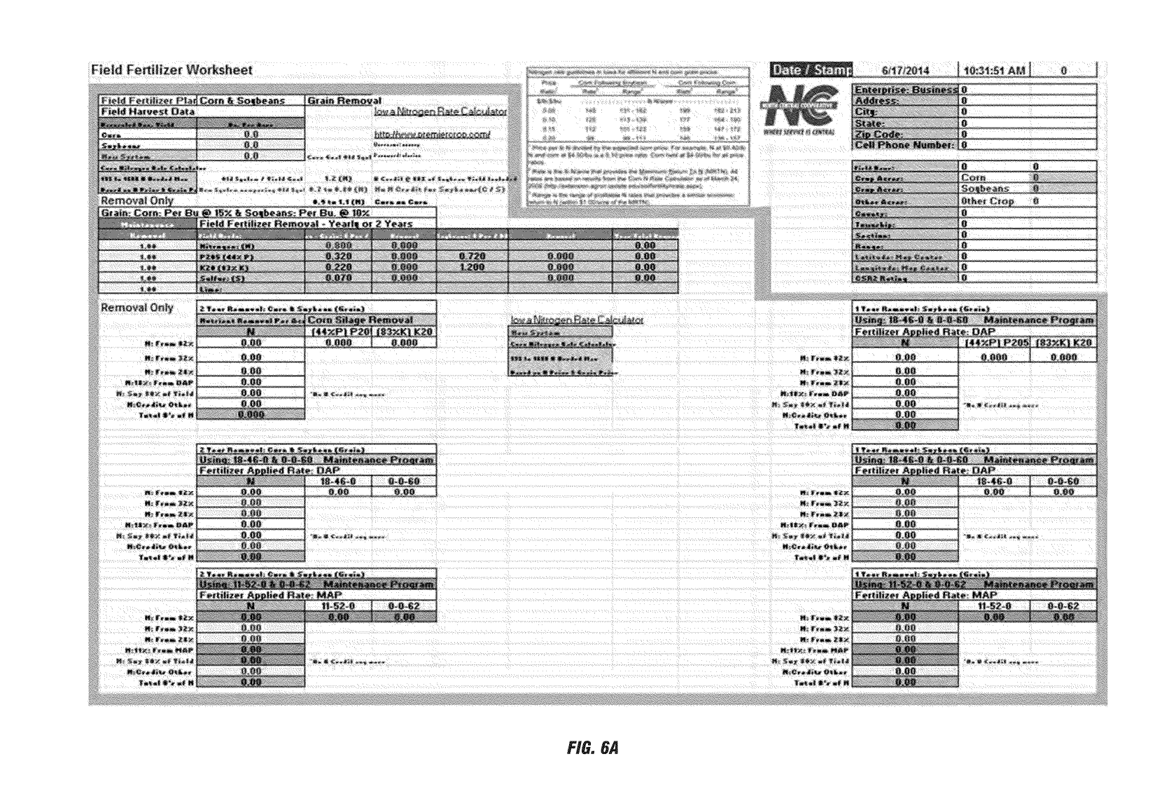

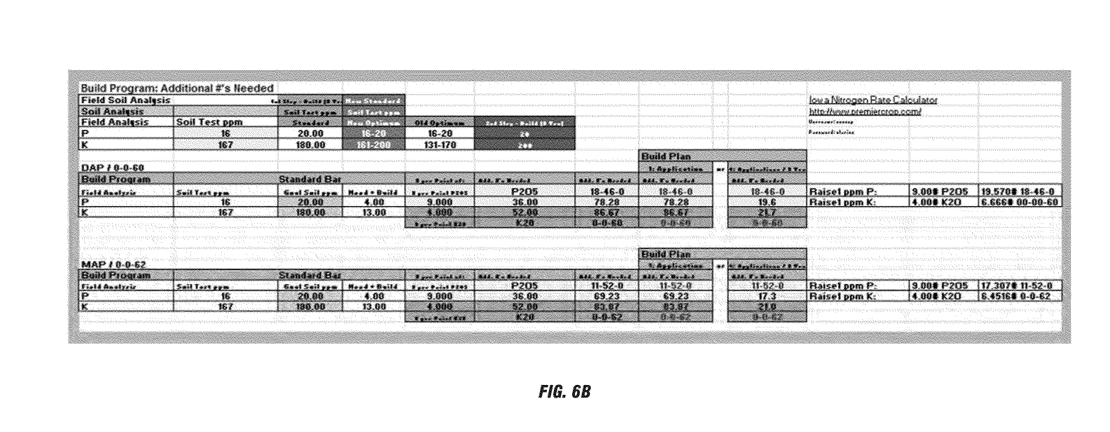

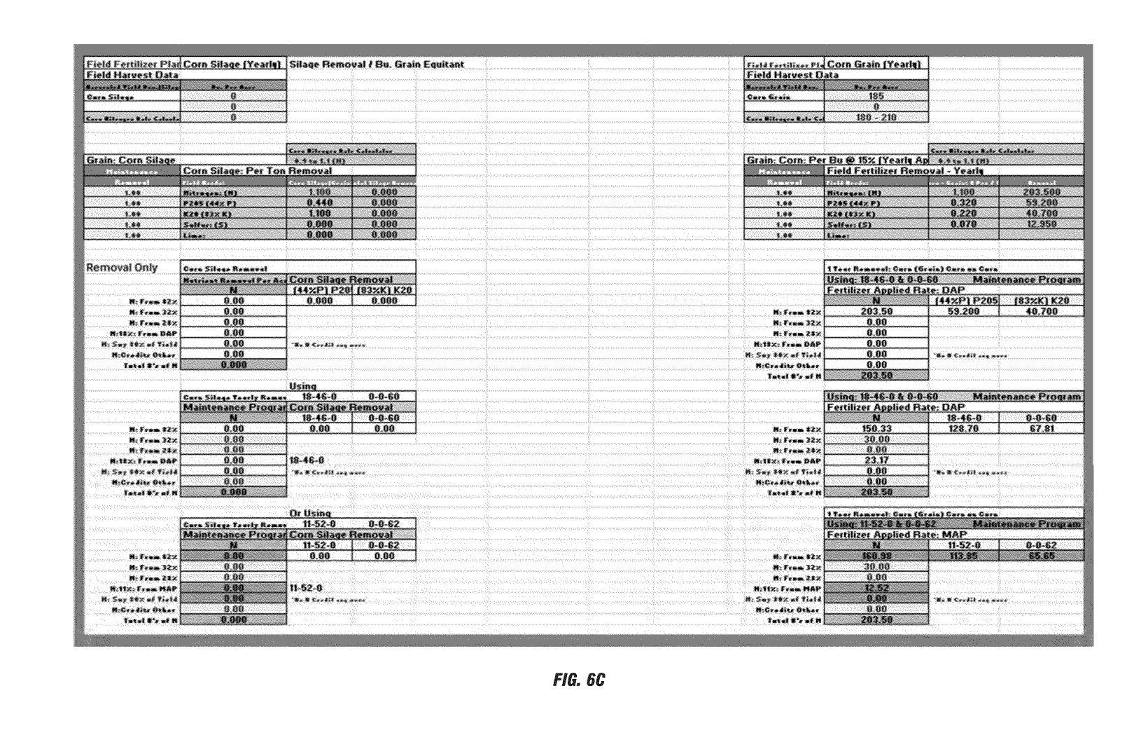

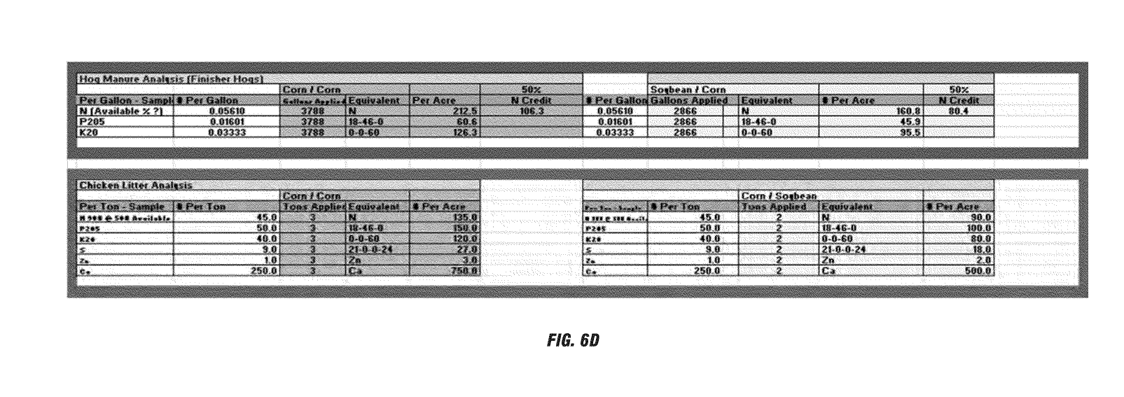

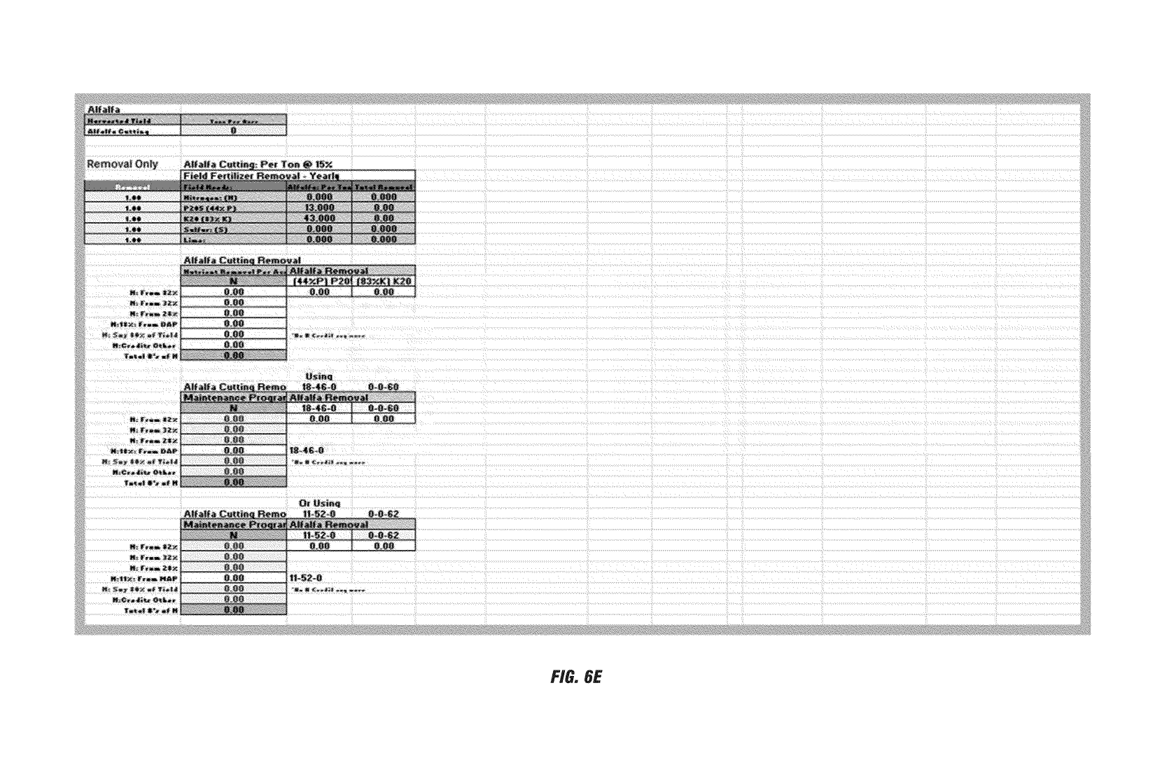

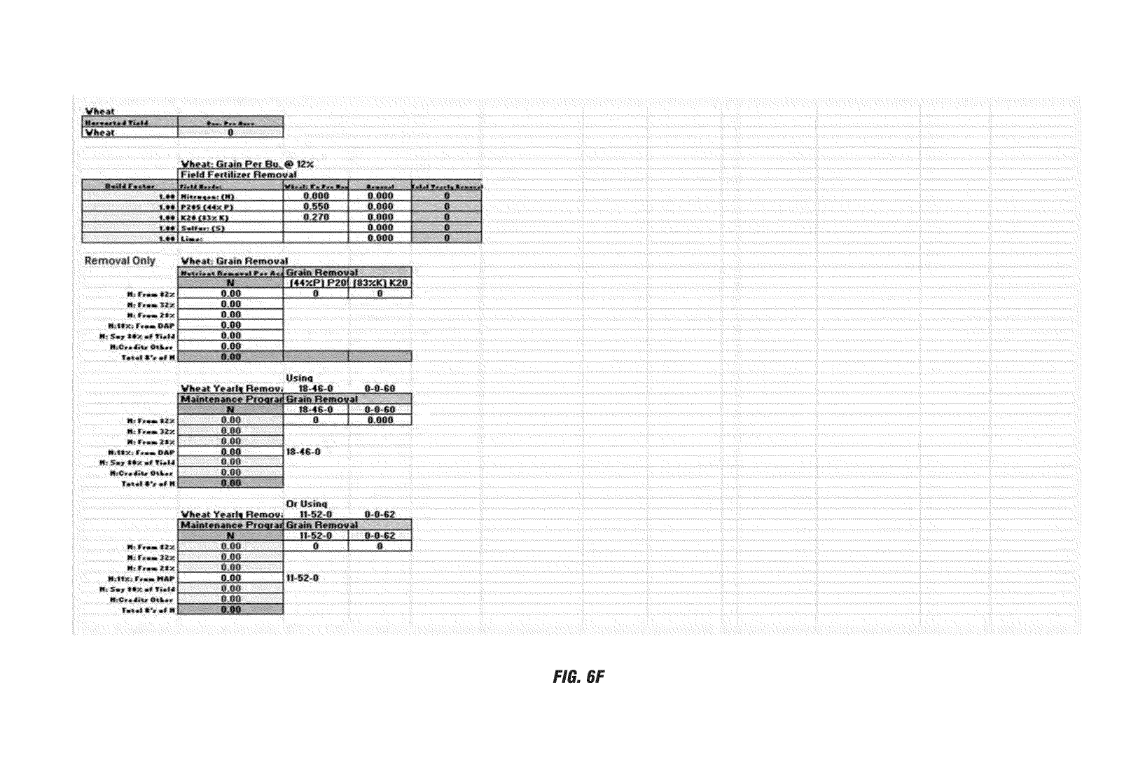

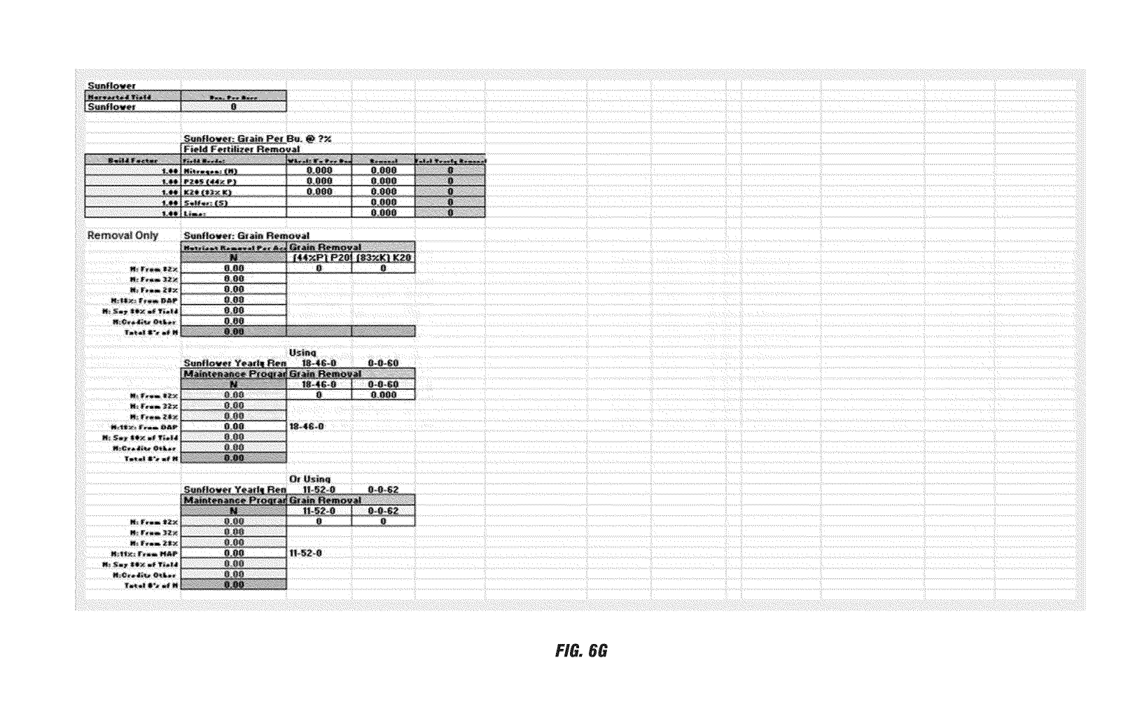

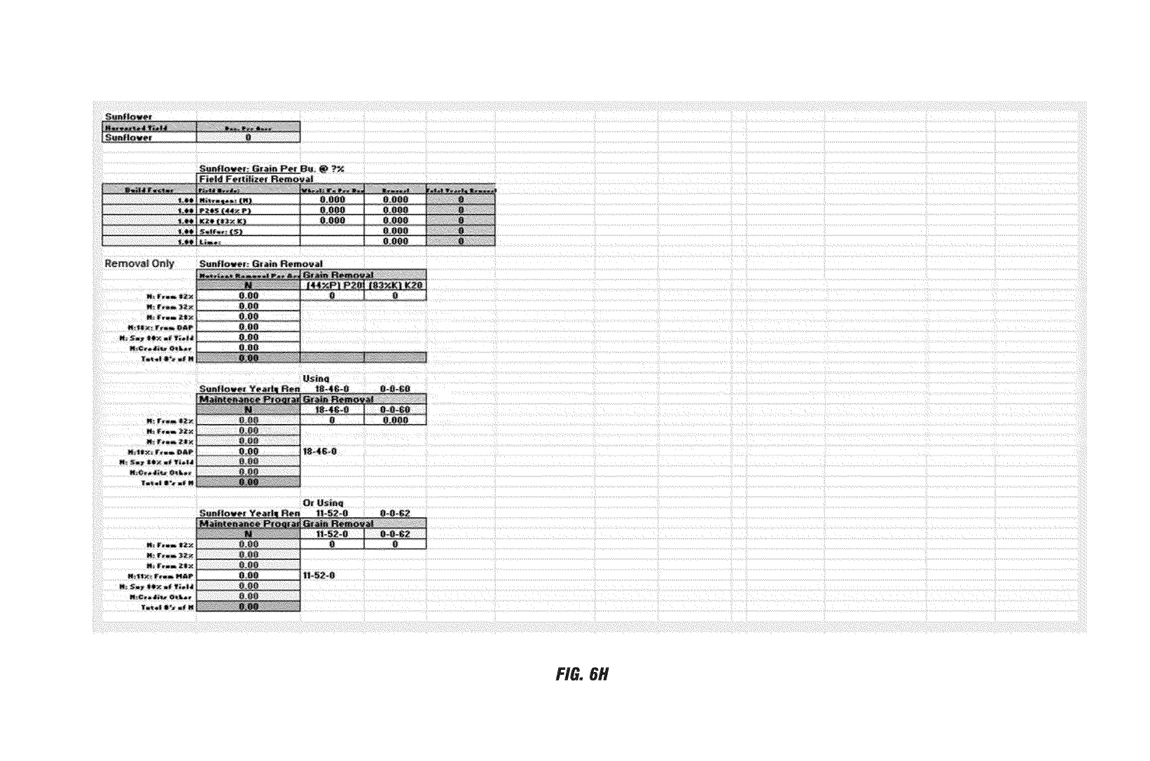

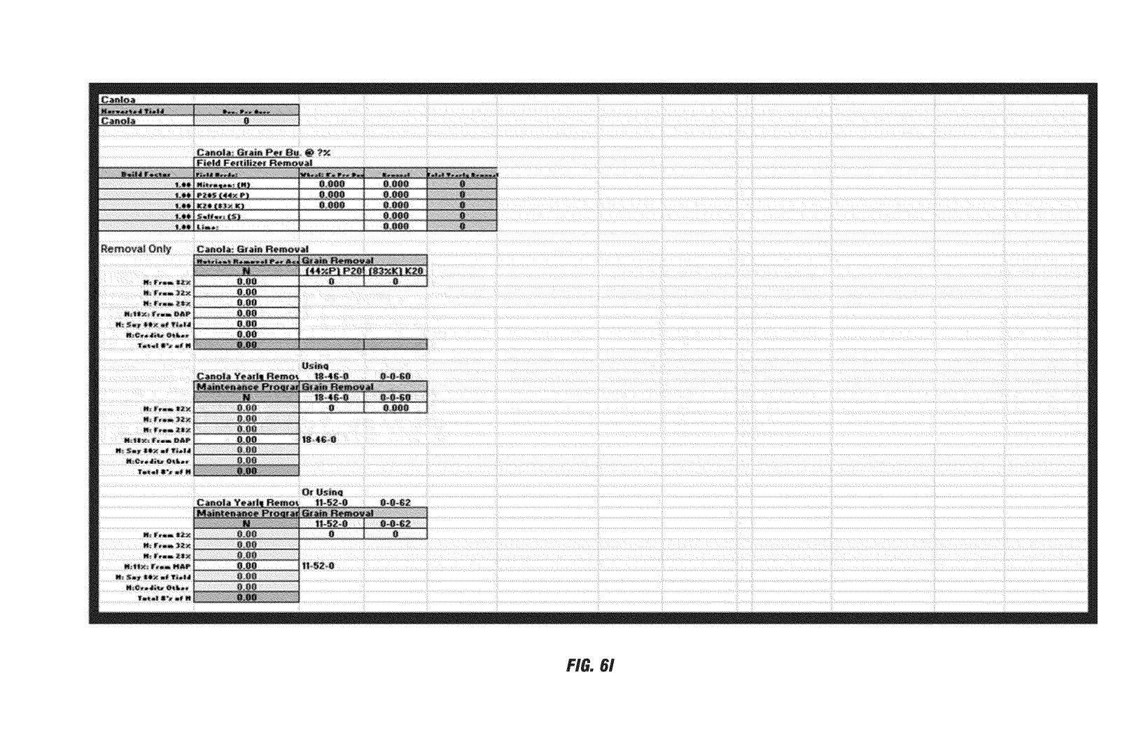

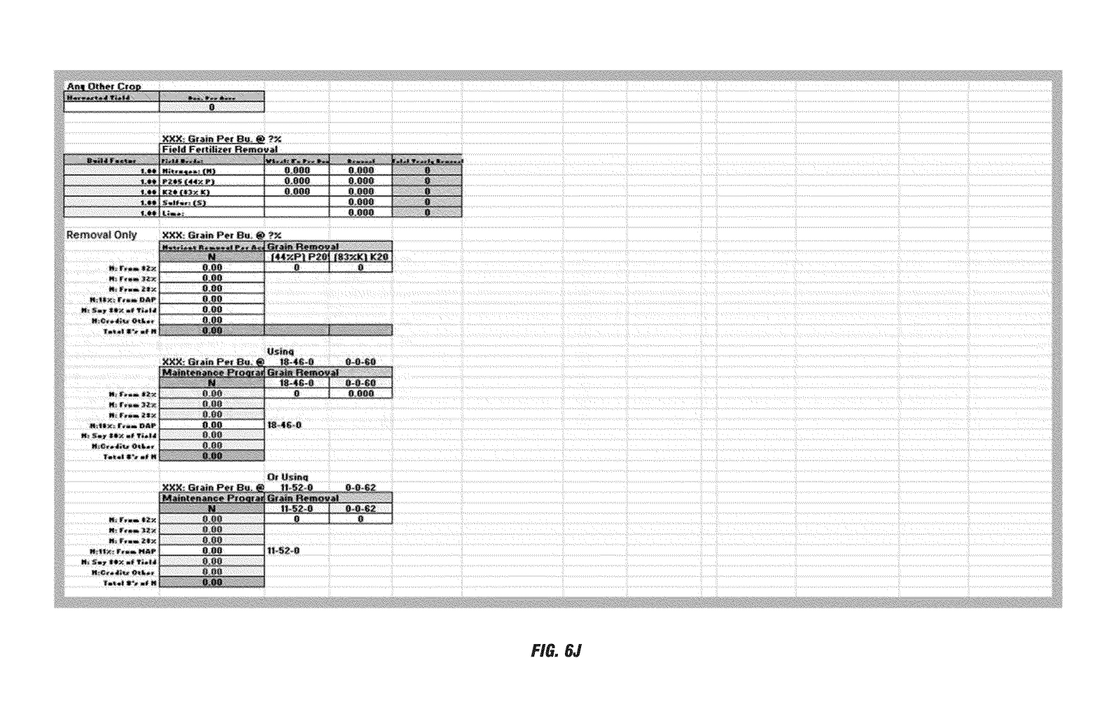

FIGS. 6A-6J illustrate one example of a field fertilizer needs worksheet. The field fertilizer worksheet provides for planning fertilizer needs. The field fertilizer worksheet takes into account removal of nutrients associated with growing a crop as shown in FIG. 6A. The field fertilizer worksheet also takes into account where fertilizer is applied as a part of a build process. The field fertilizer process also may take into account application of alternative sources of fertilizer such as hog manure application and chicken litter as shown in FIG. 6D. Any number of different crops may be present including corn, soybeans, corn silage (FIG. 6C), alfalfa (FIG. 6E), wheat (FIG. 6F), sunflower (FIG. 6G, 6H), canola (FIG. 6I) and any other crops (FIG. 6J.

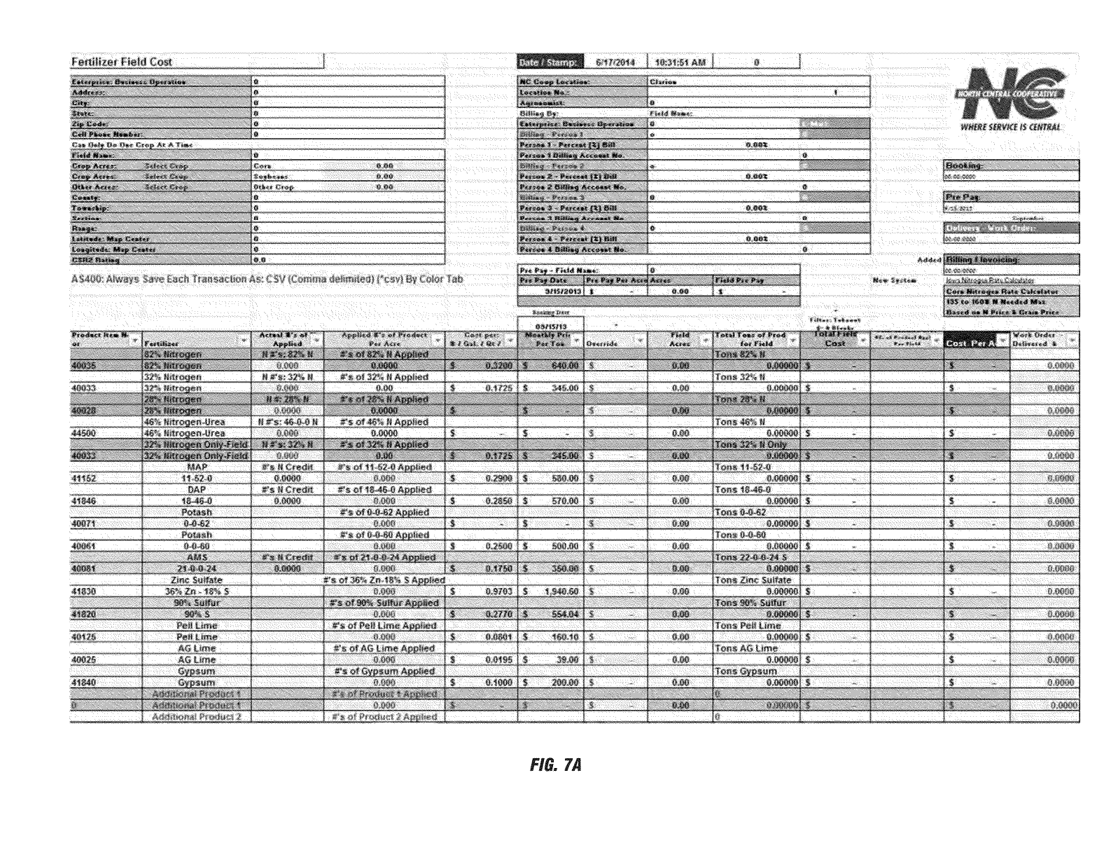

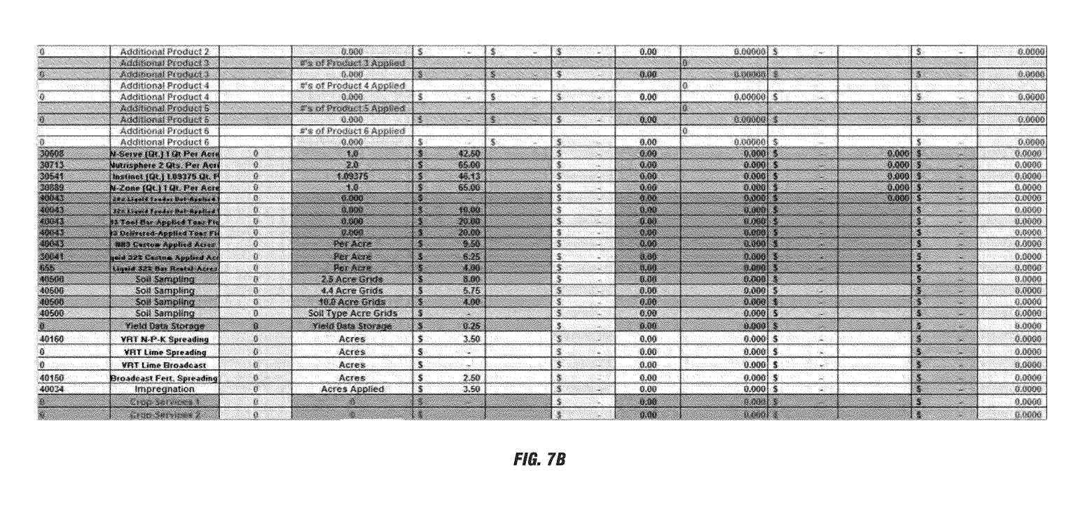

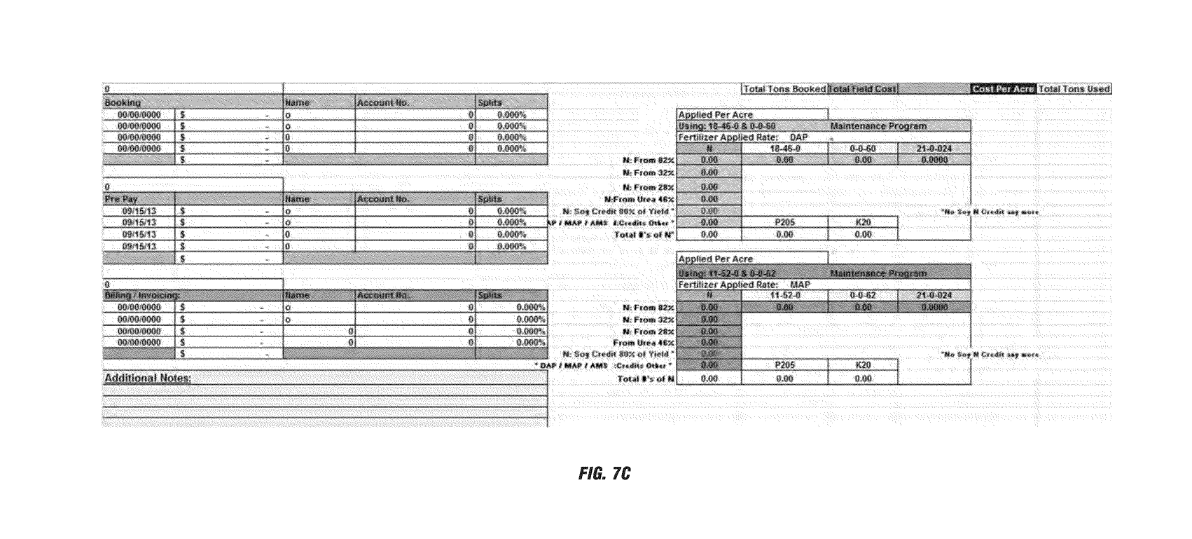

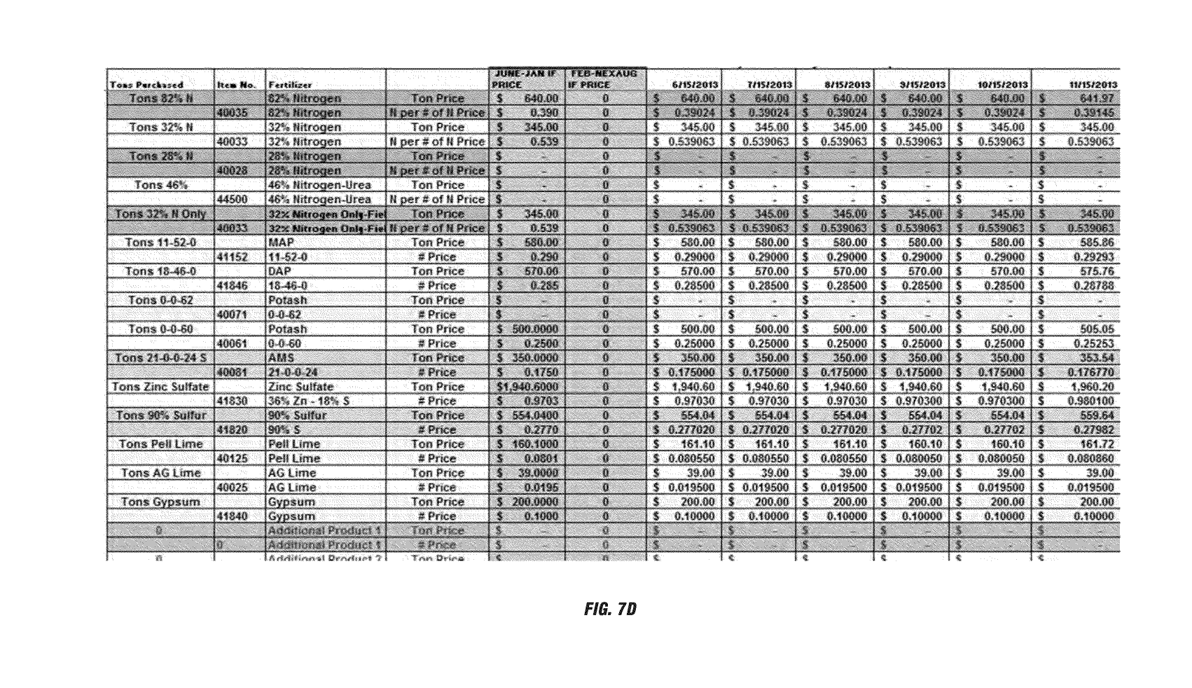

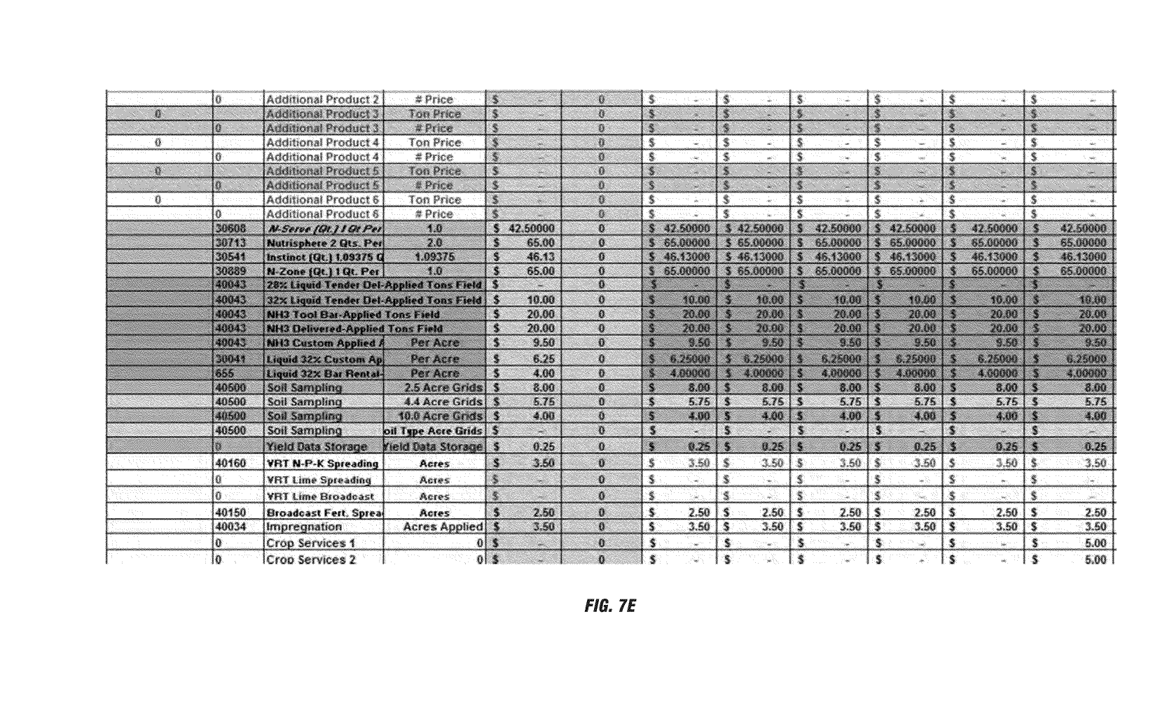

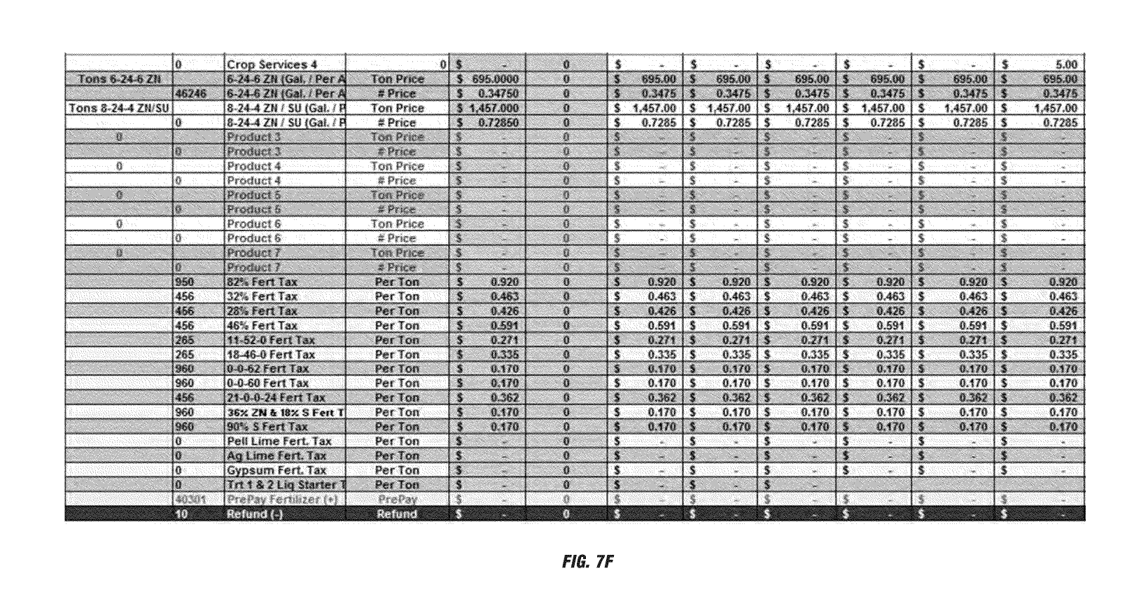

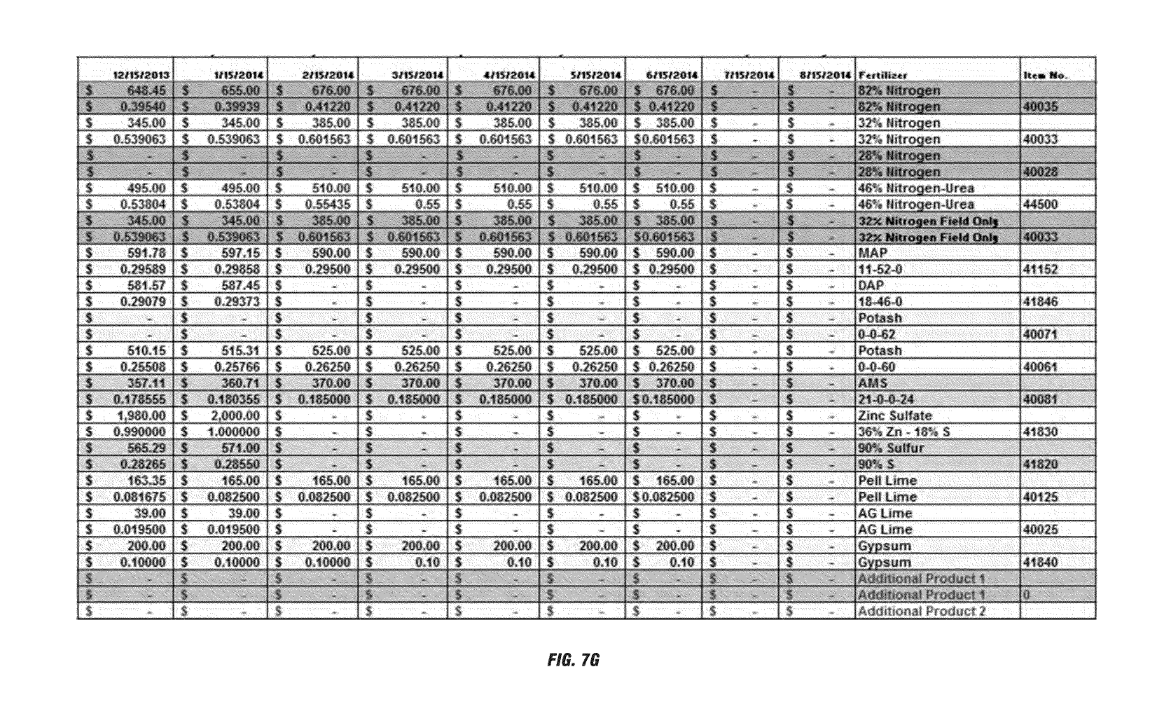

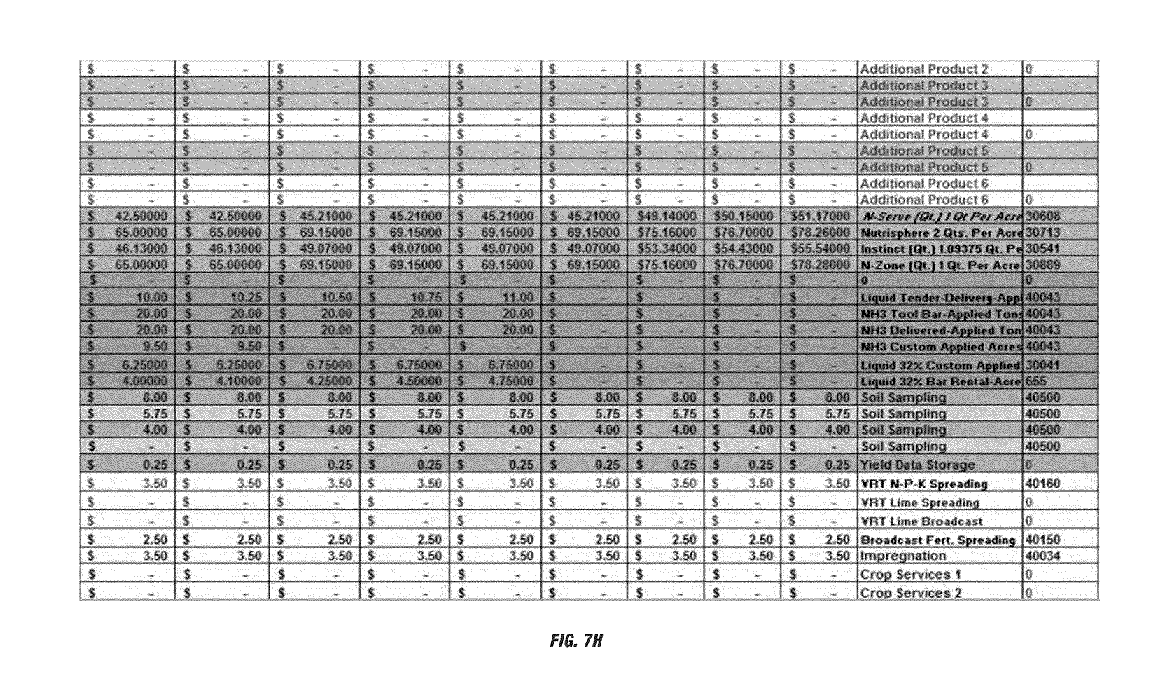

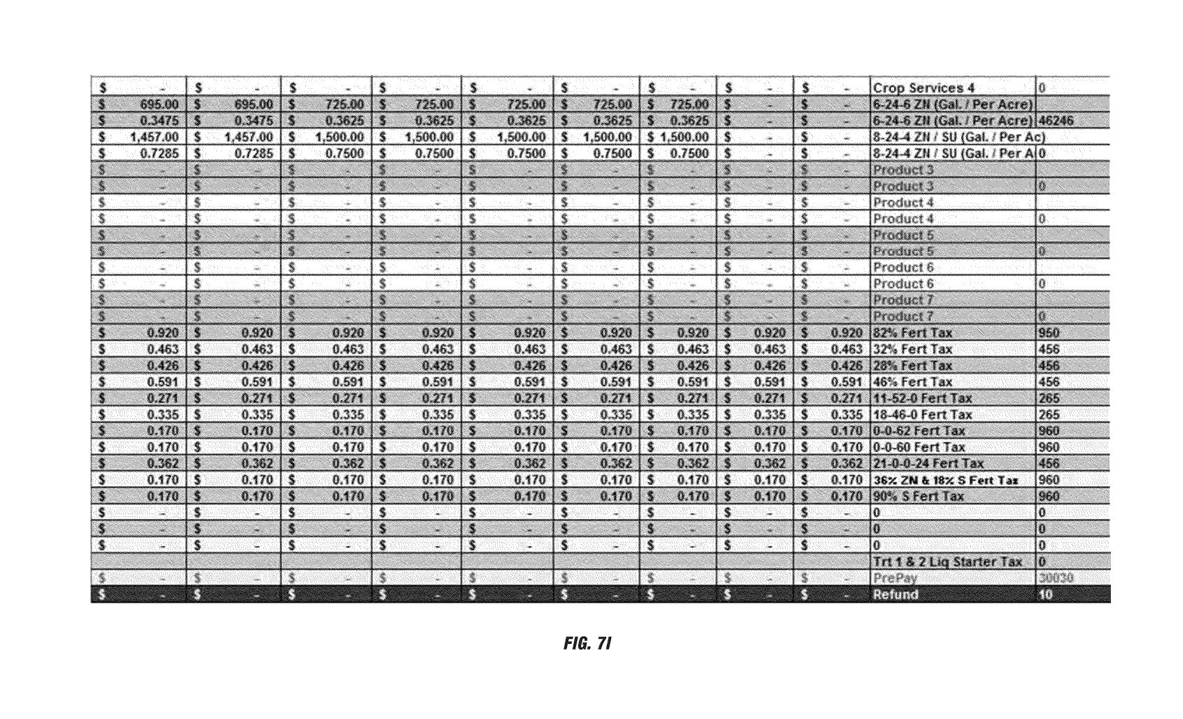

FIGS. 7A-7I illustrate a worksheet for fertilizer cost. Various different fertilizer products are shown in FIG. 7A and FIG. 7B as well as the actual pounds of nitrogen per acre, the applied pounds of product per acre, the cost per unit of the products and the monthly price. Based on the price and the field acres a total field cost can be calculated and the cost per acre can be calculated. The amount of product delivered and applied can be tracked. As shown in FIG. 7C, a total cost can be calculated and prepayment can be taken into consideration as well as any balance due or refund.

FIGS. 7D-7I illustrate that an upfront monthly cost can be attributed to fertilizer inputs. Note that this type of monthly pricing may be different from industry norms.

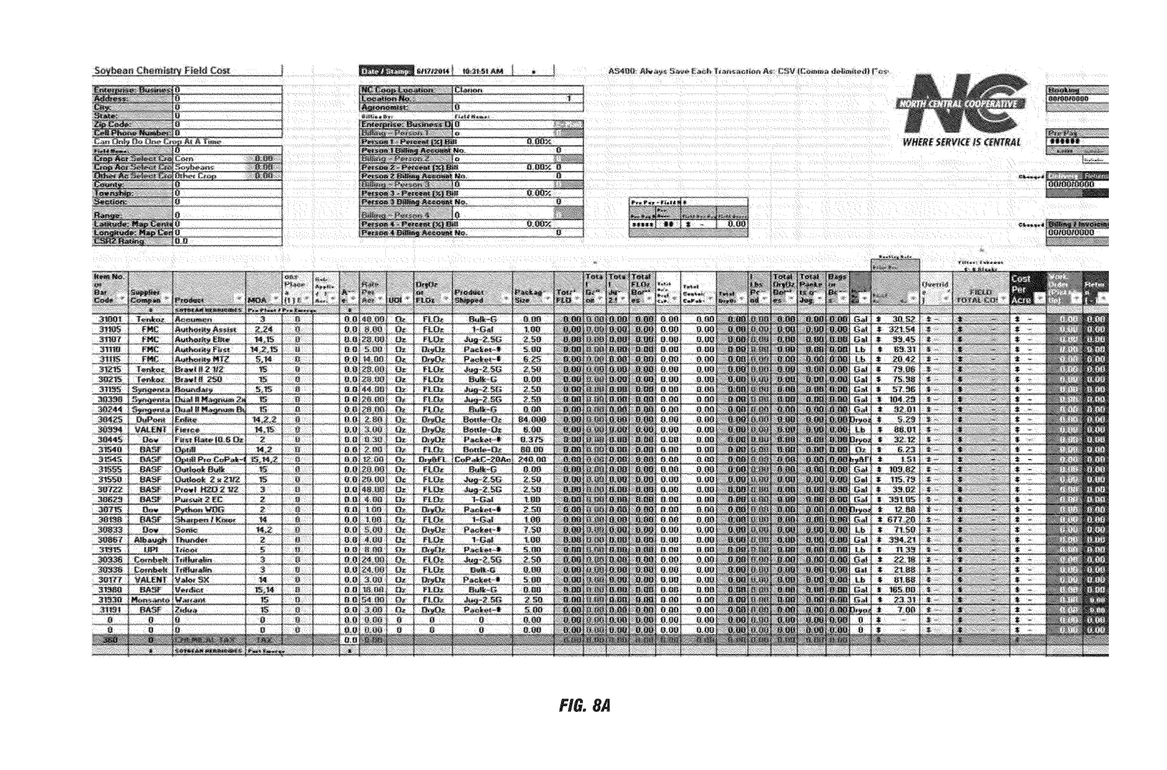

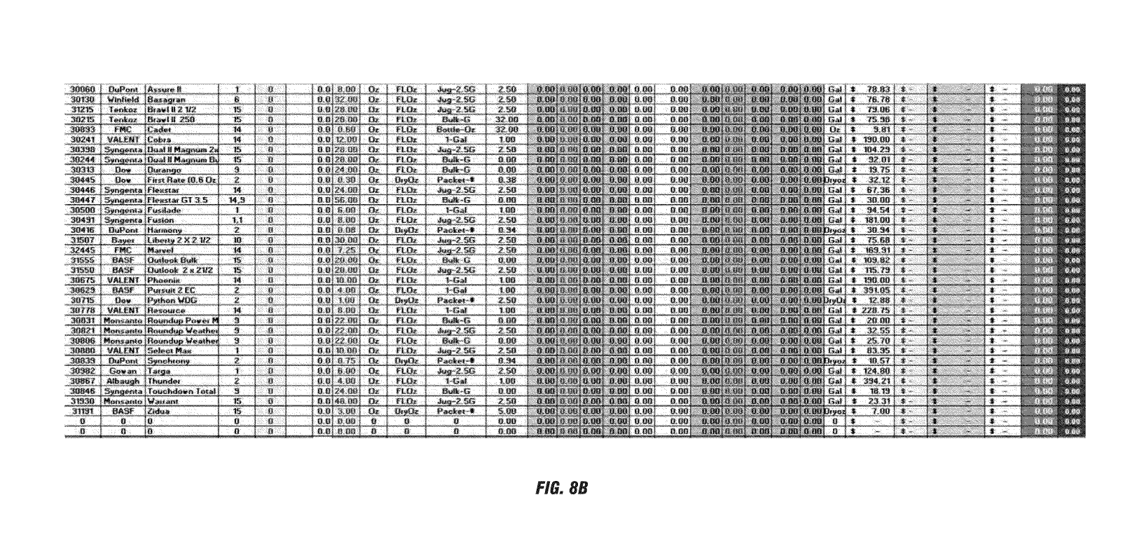

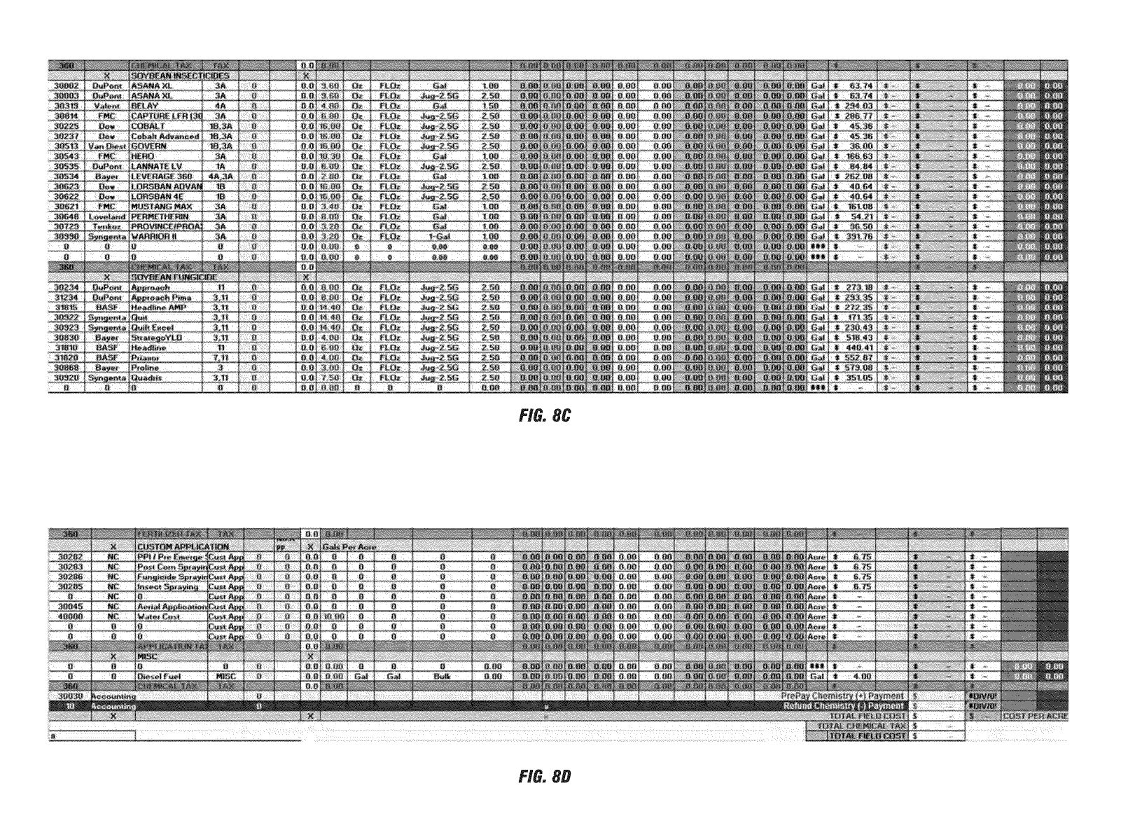

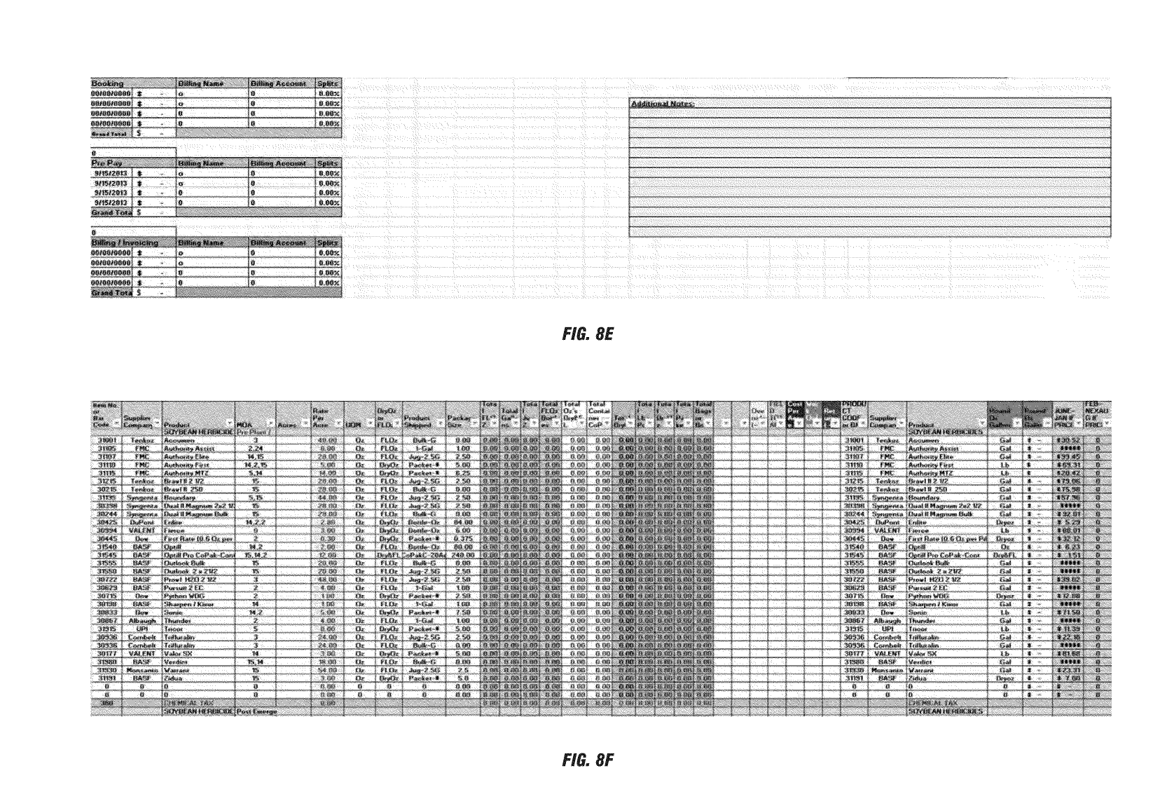

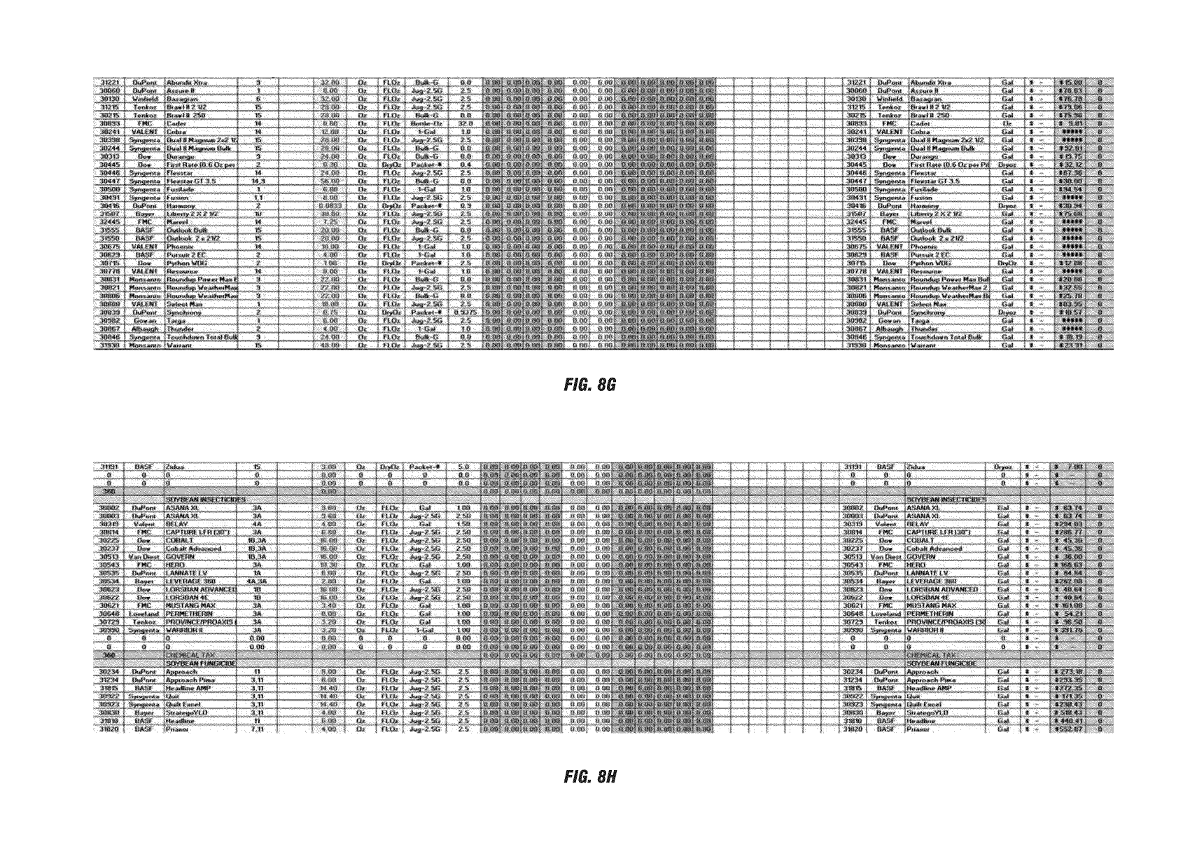

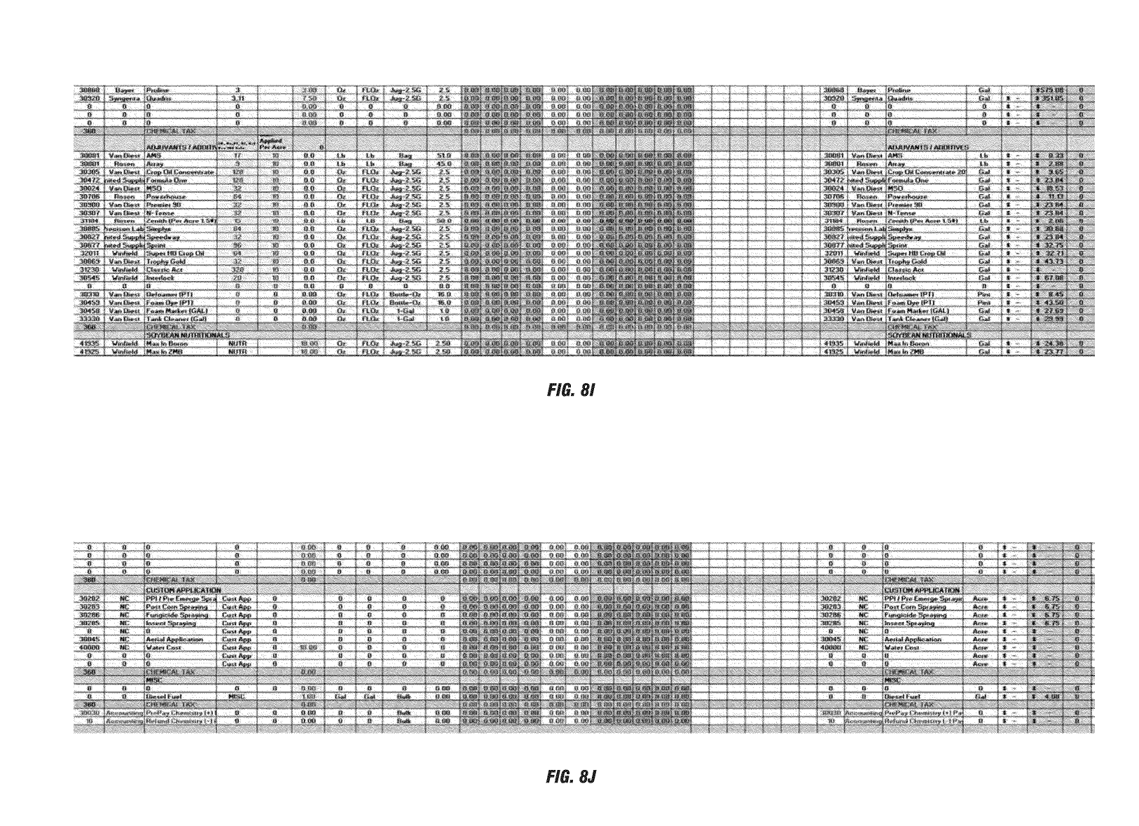

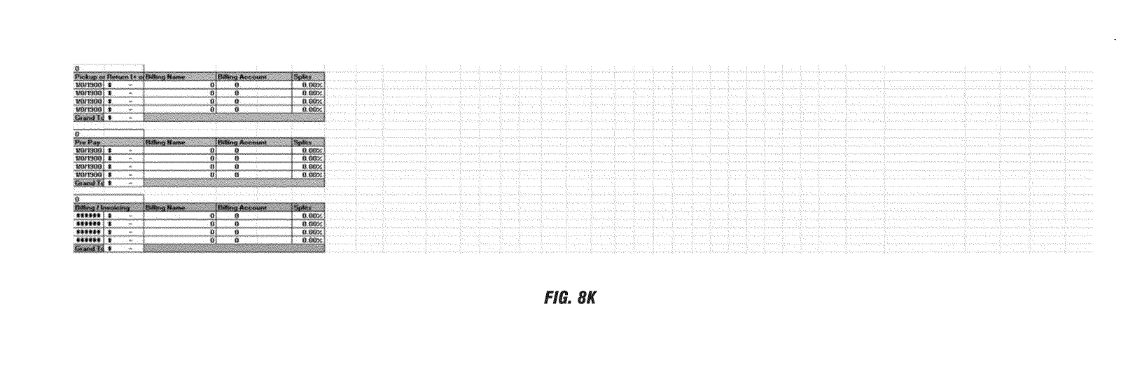

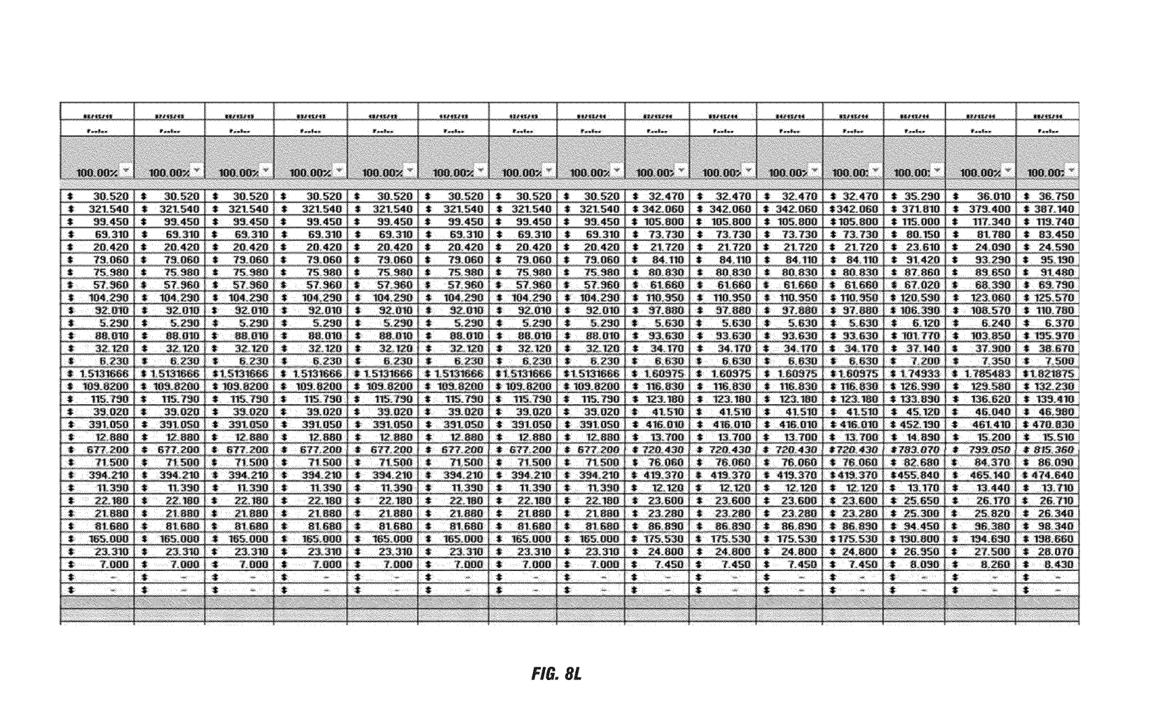

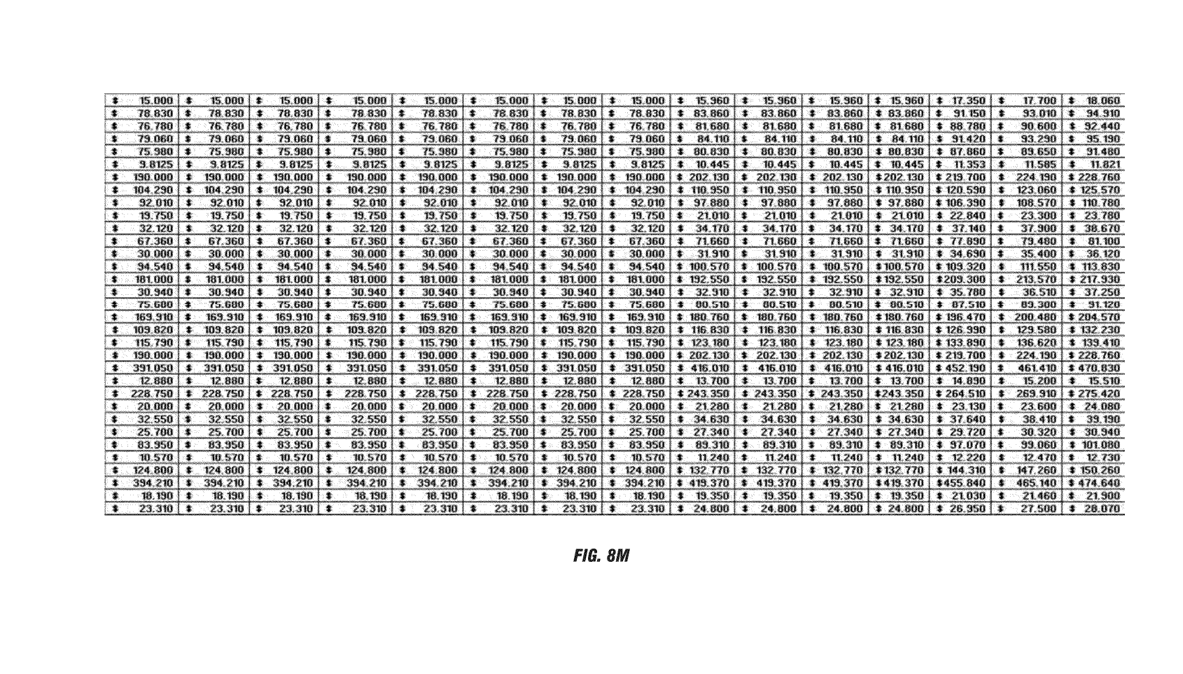

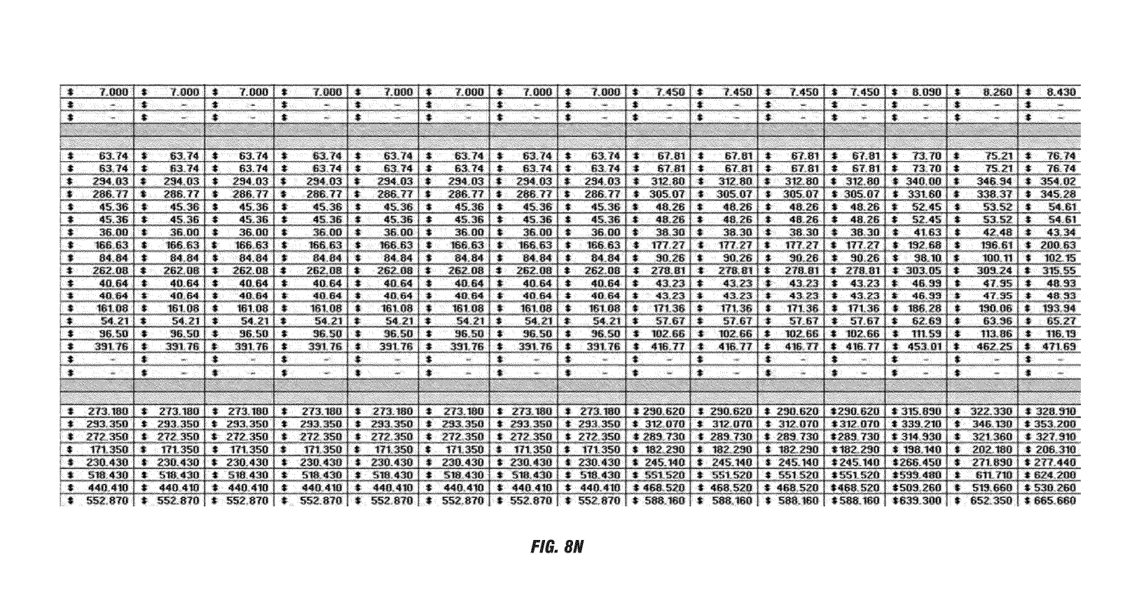

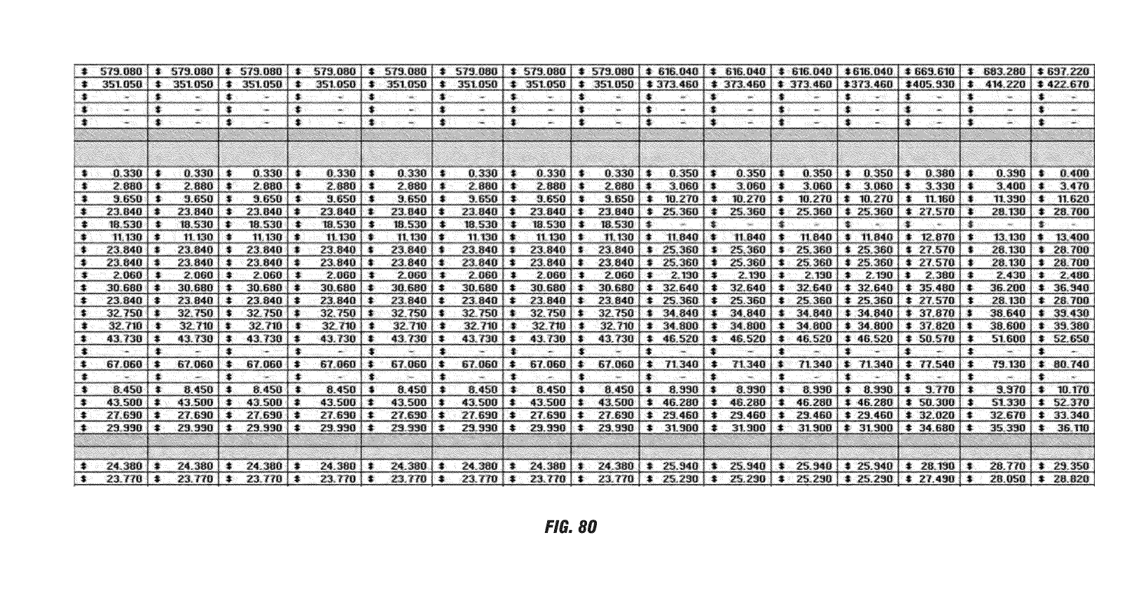

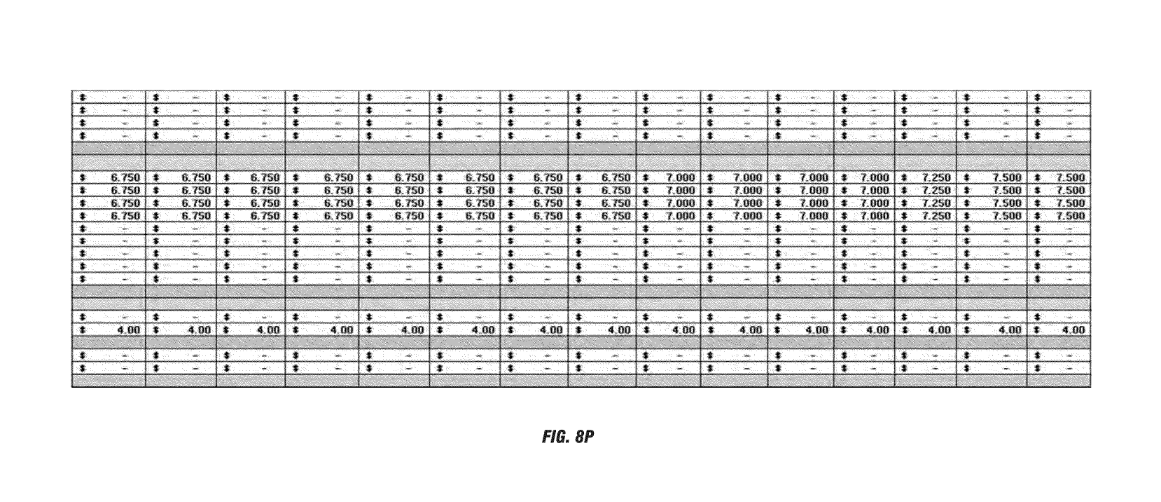

FIGS. 8A-8B illustrate an example of a worksheet for corn chemistry. The worksheet may be used to select corn herbicides, corn insecticides, corn fungicides, adjuvants and additives, nutritionals, custom application, and other miscellaneous products. Pricing for different months may also be provided.

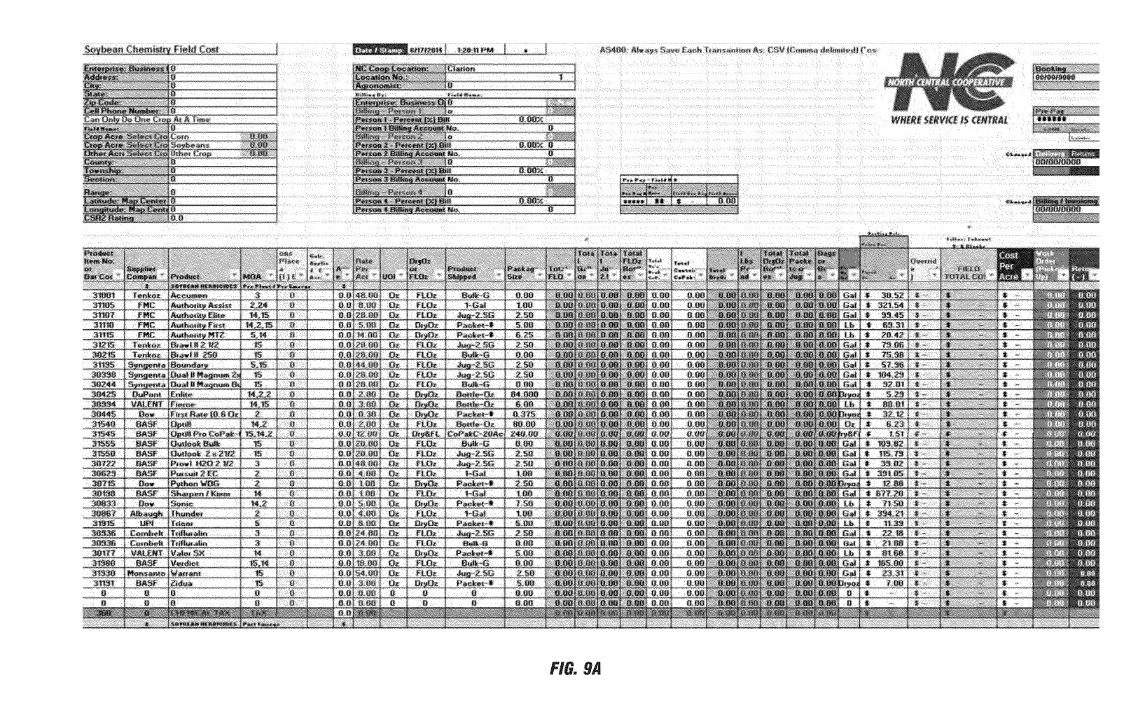

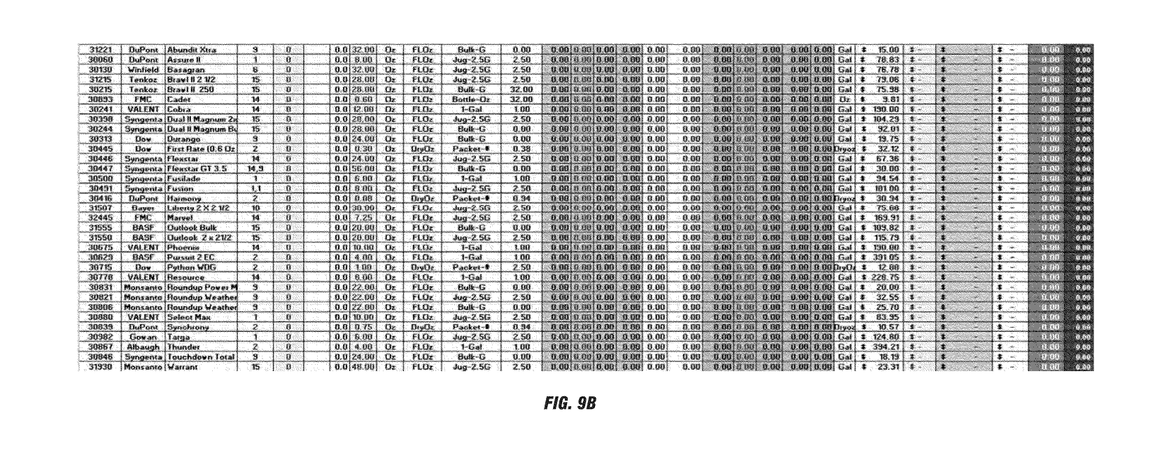

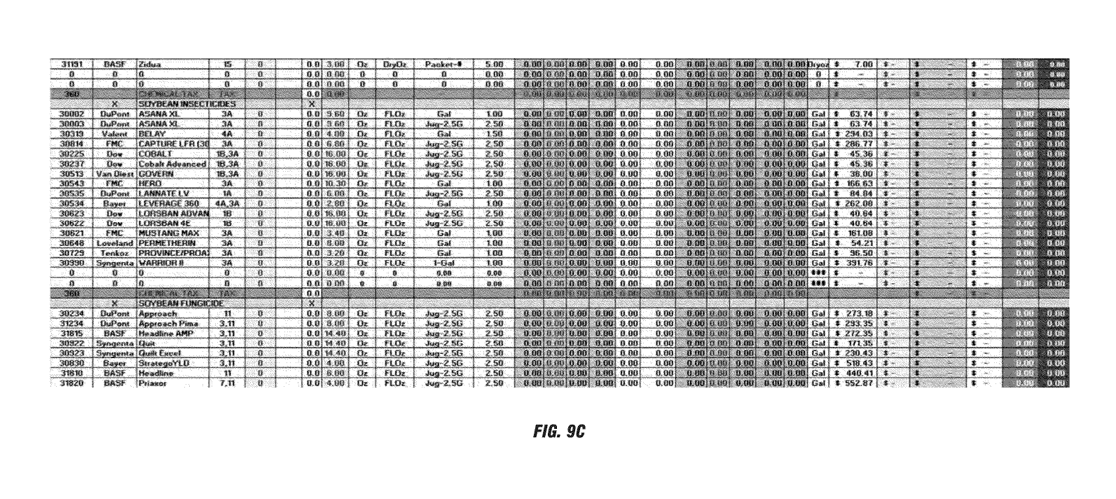

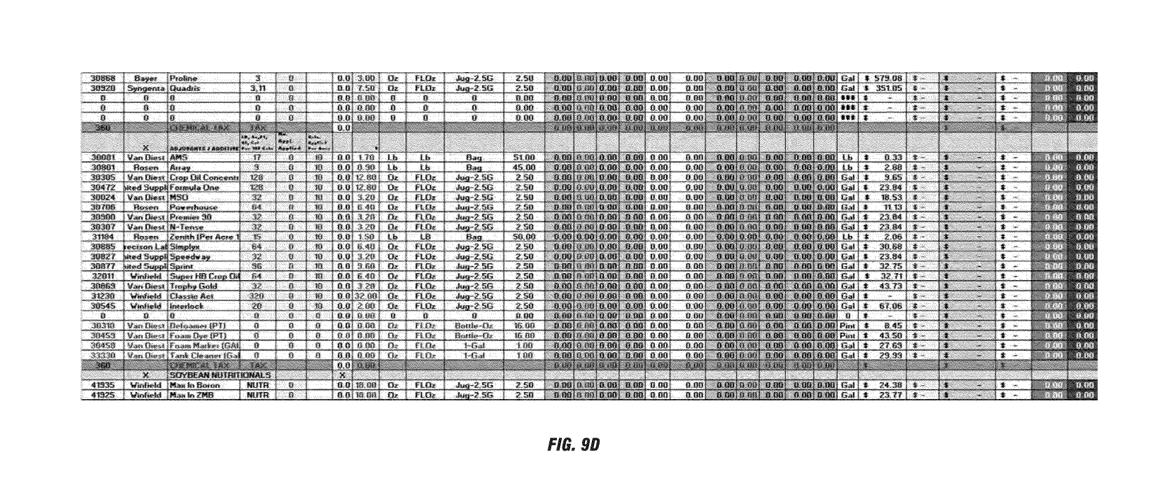

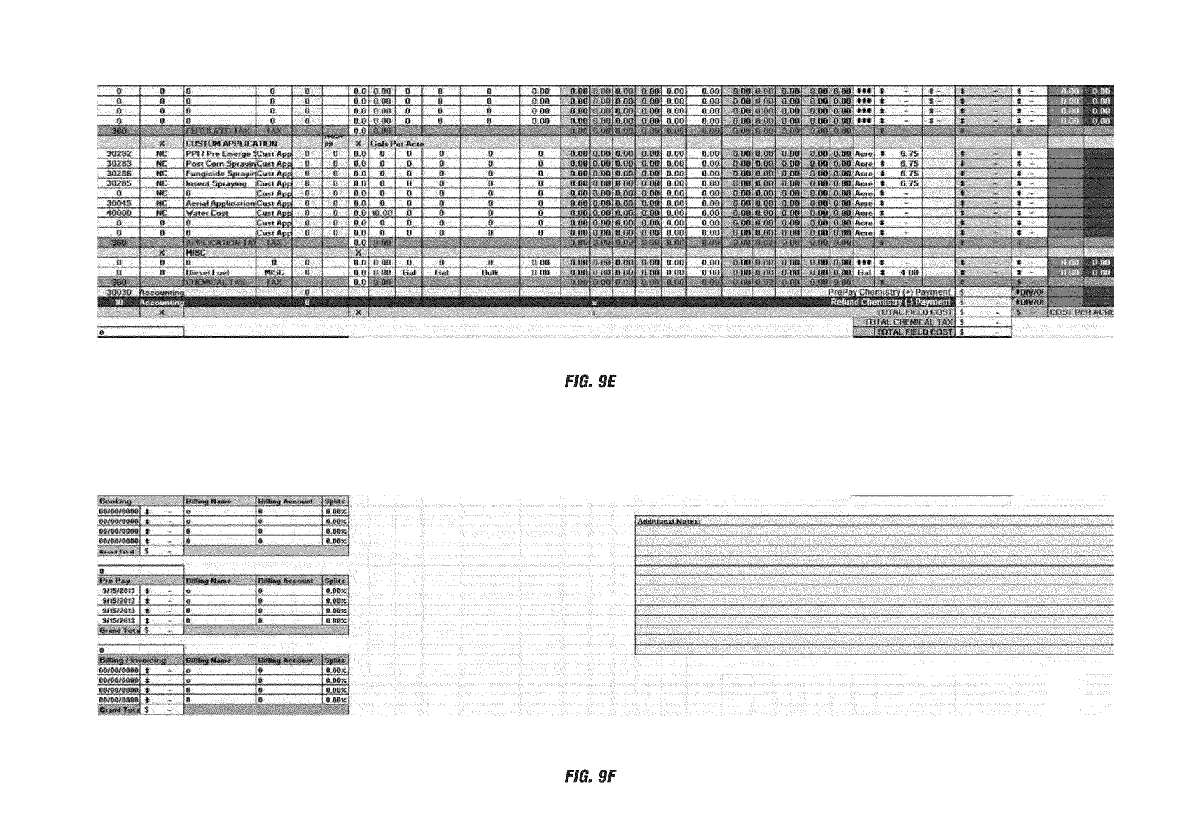

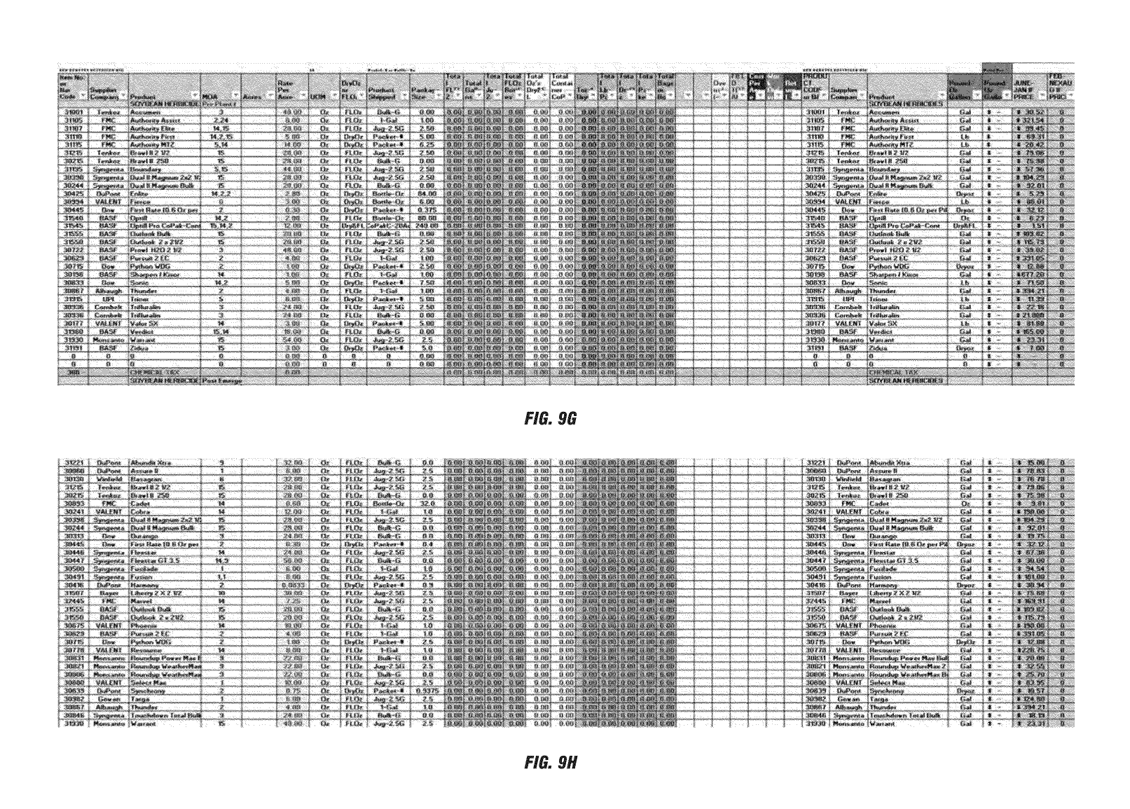

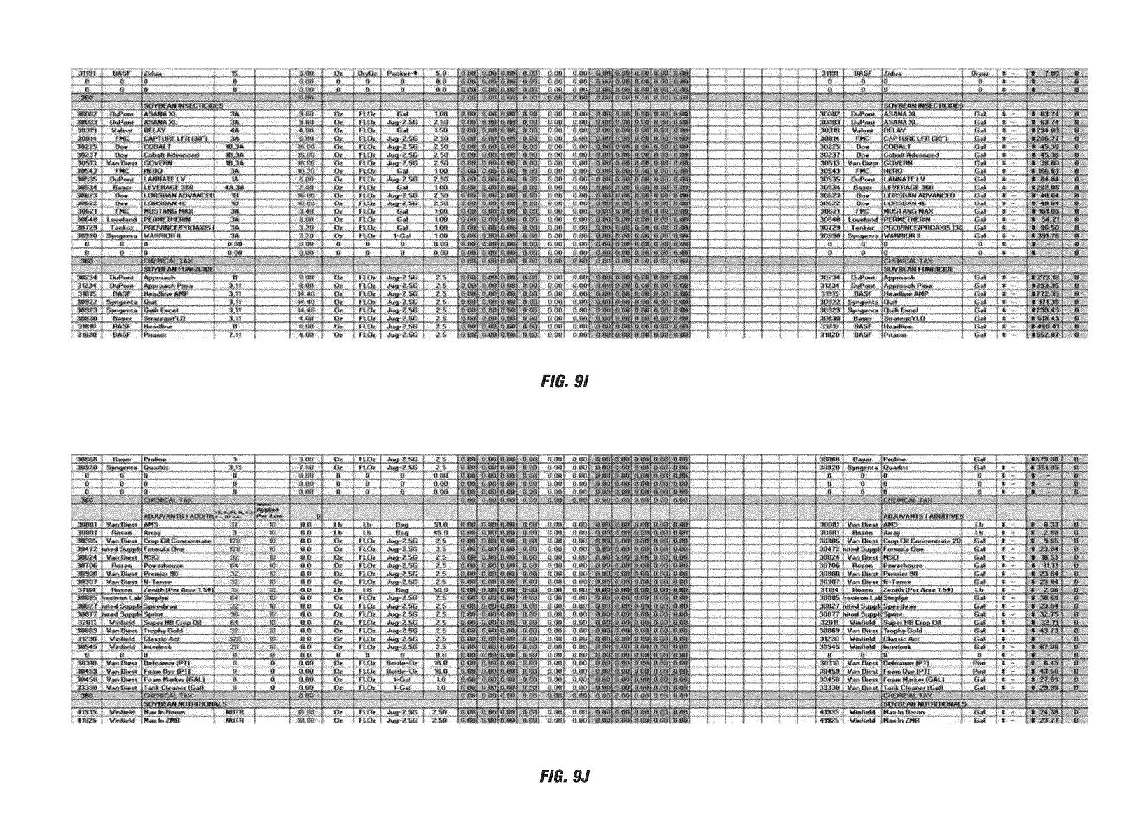

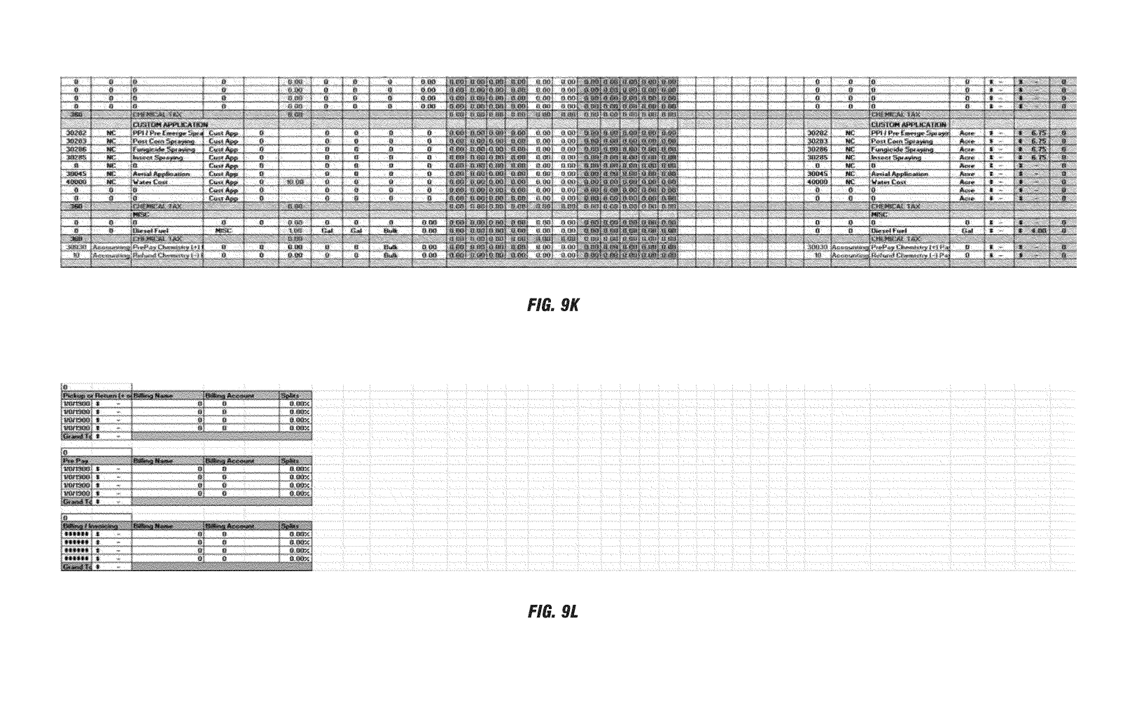

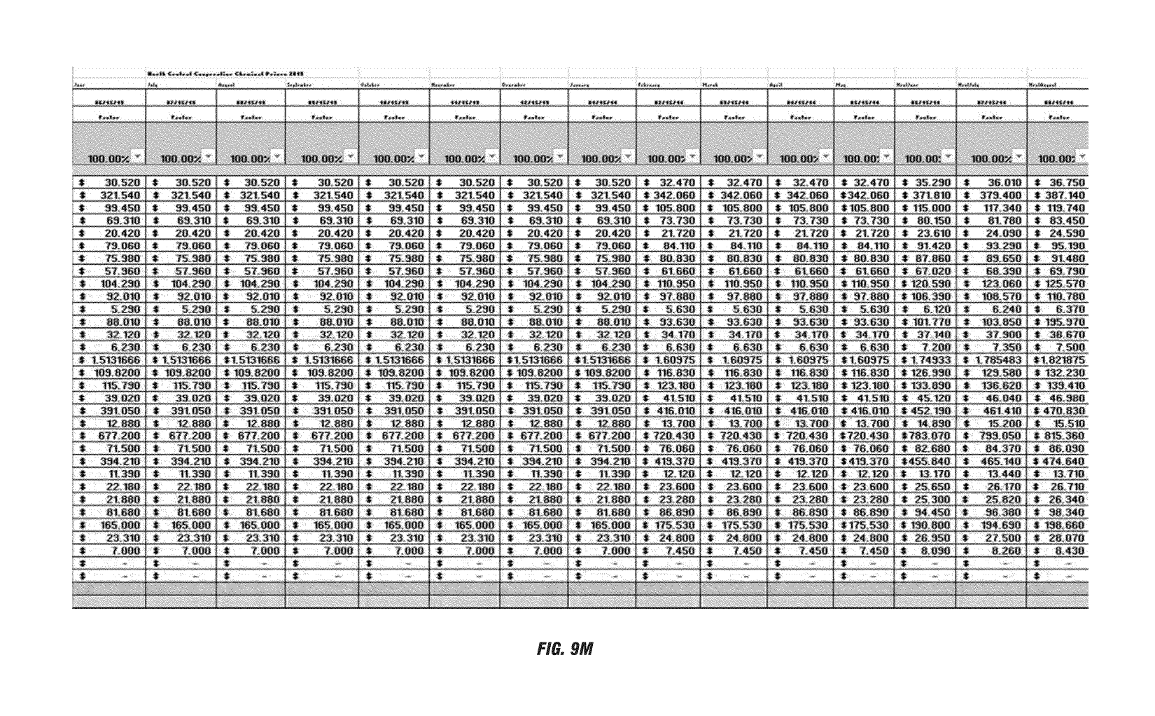

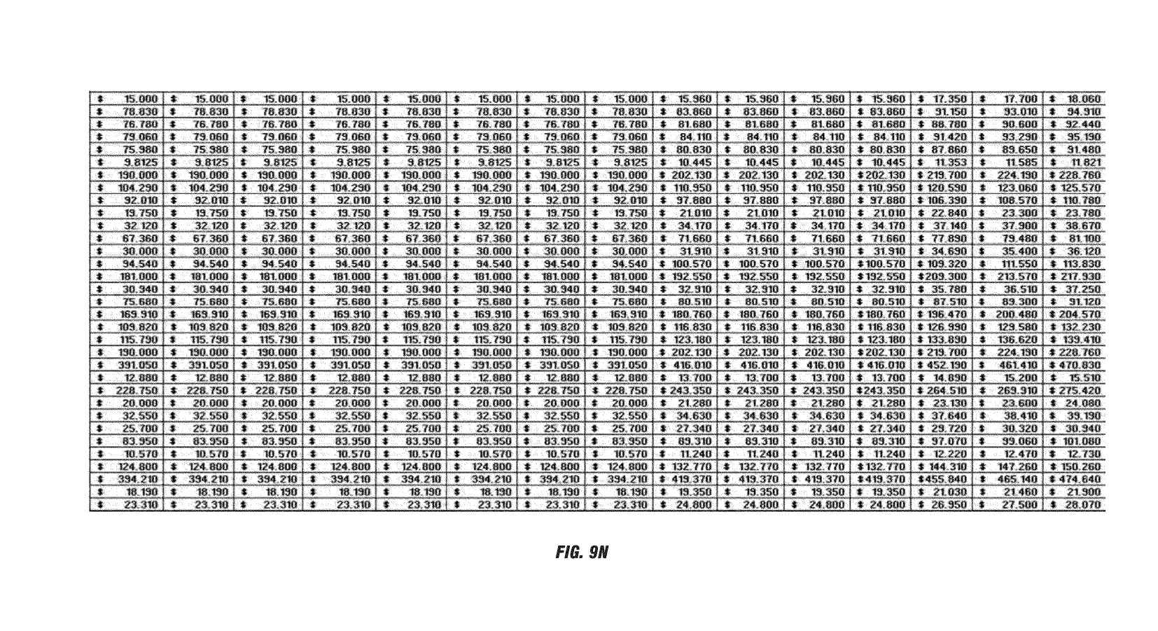

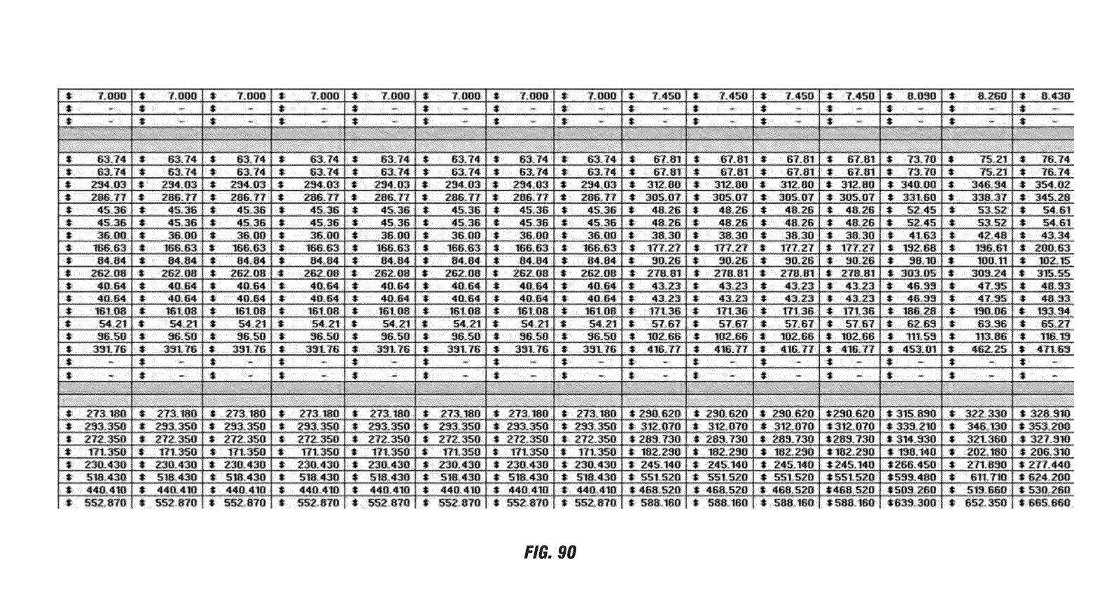

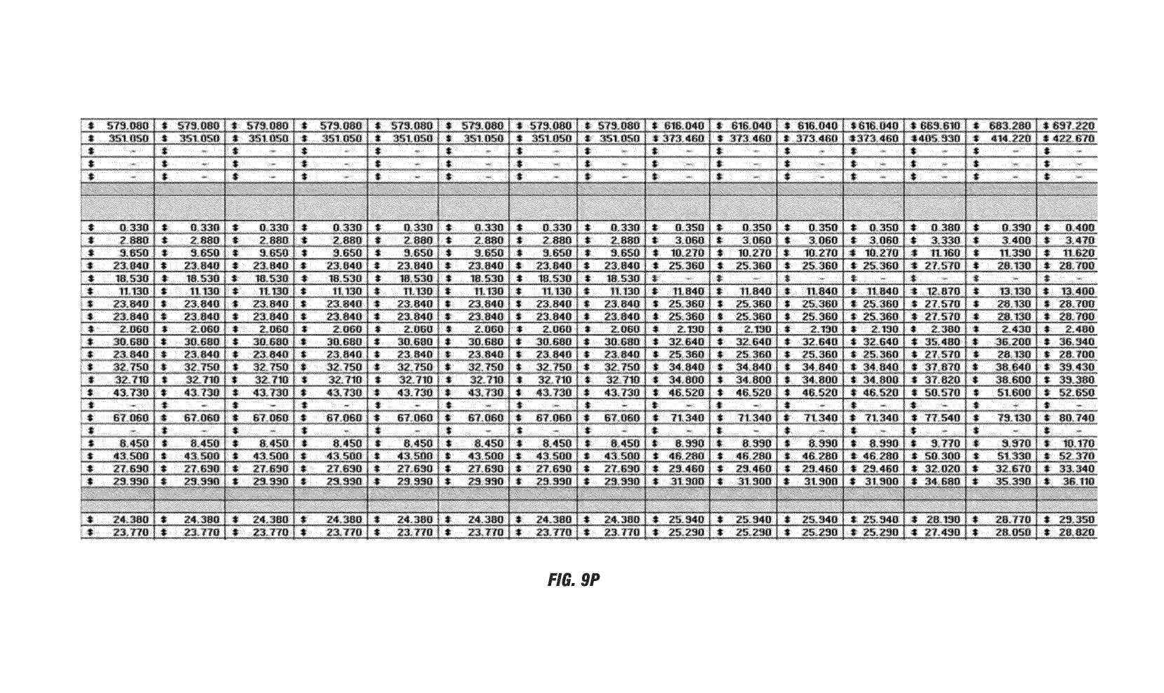

FIGS. 9A-9Q illustrate an example of a worksheet for soybean chemistry. The worksheet may be used to select soybean herbicides (FIGS. 9A, 9B, 9C), soybean insecticides (FIG. 9C), soybean fungicides (FIGS. 9C, 9D), adjuvants and additives (FIG. 9D), nutritionals (FIGS. 9D, 9E), custom application (FIG. 9E), and miscellaneous products or fees (FIG. 9E). Addition portions of the example are shown in FIG. 9F-9Q.

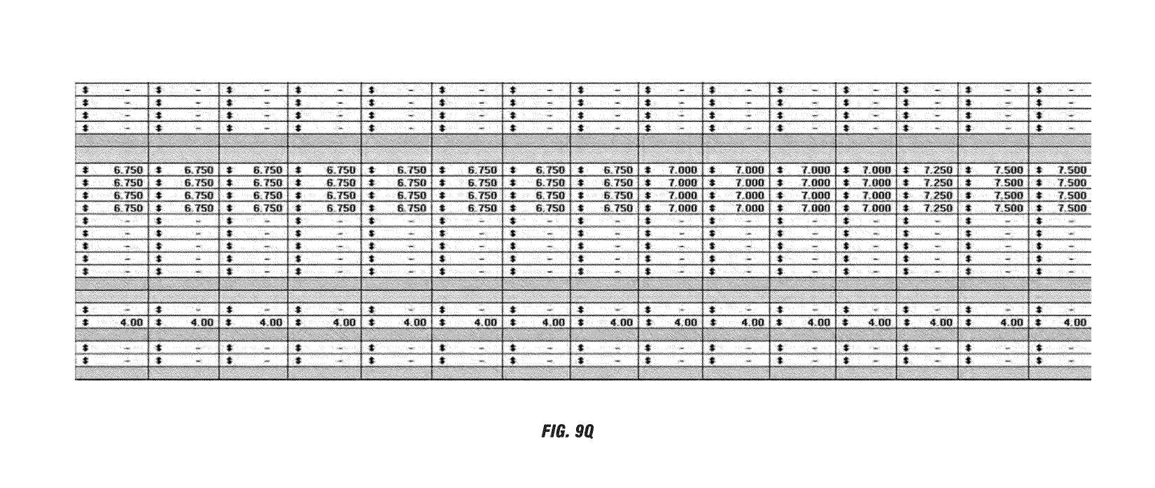

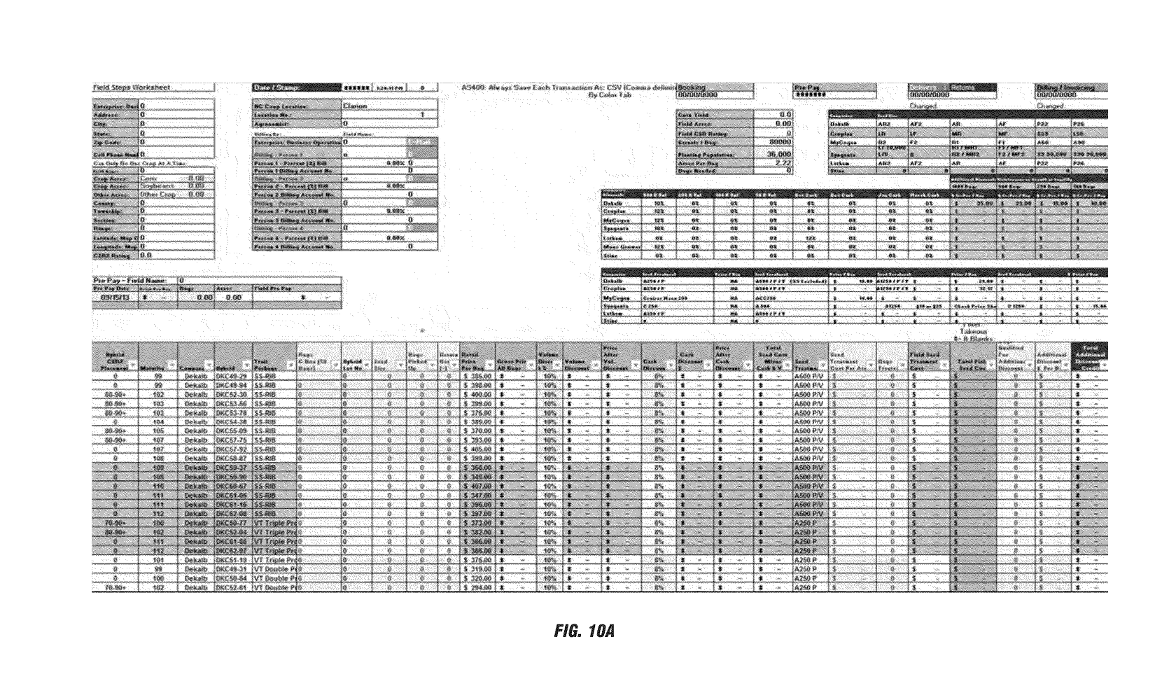

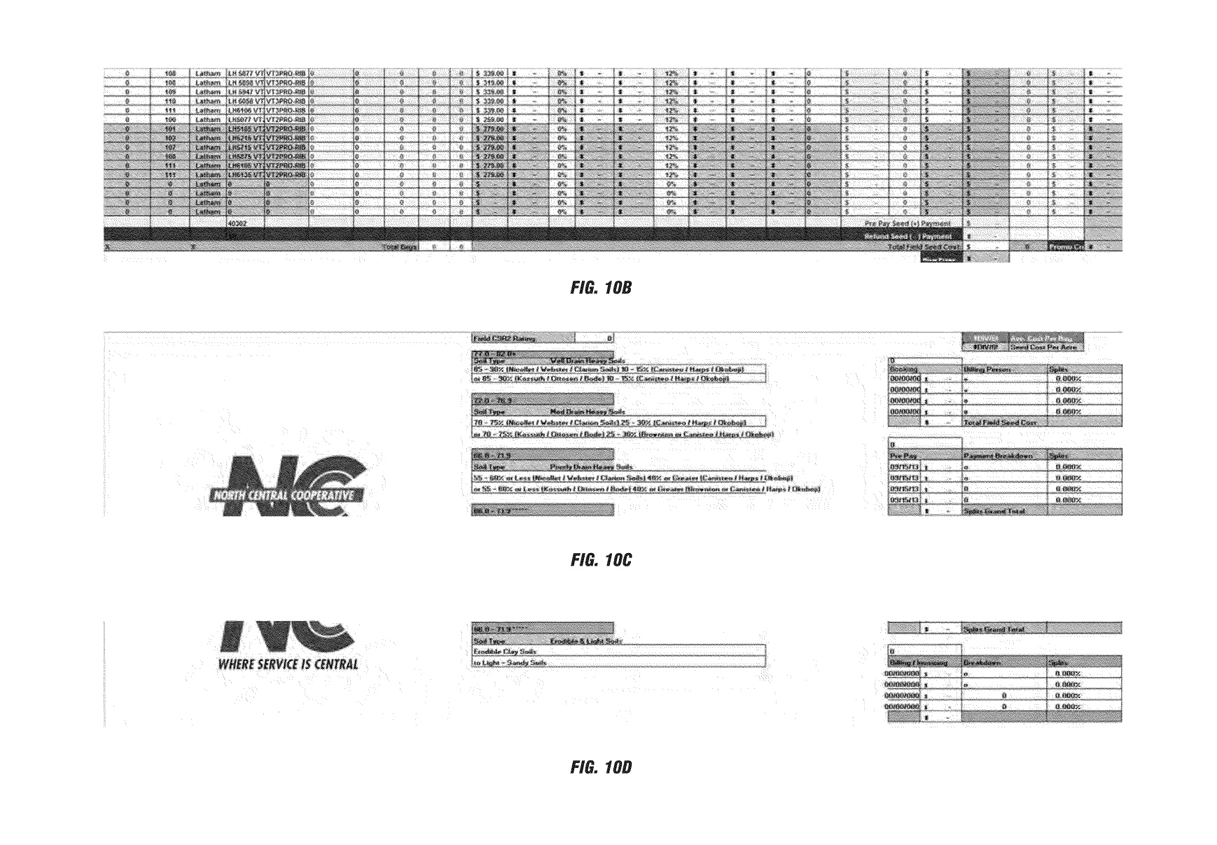

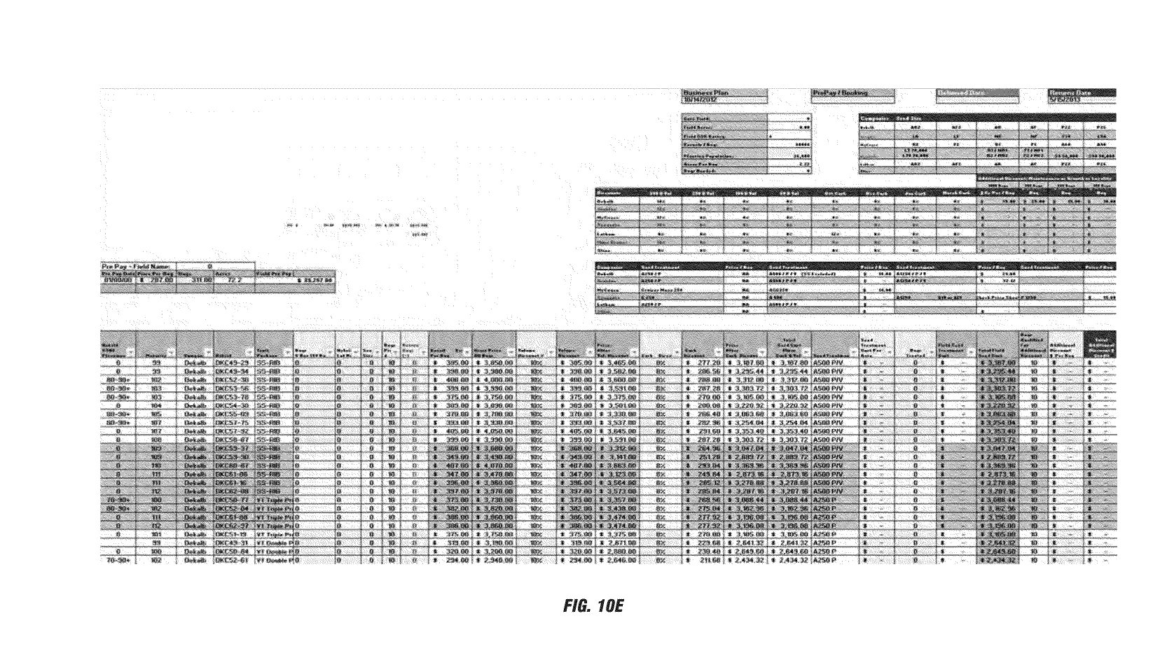

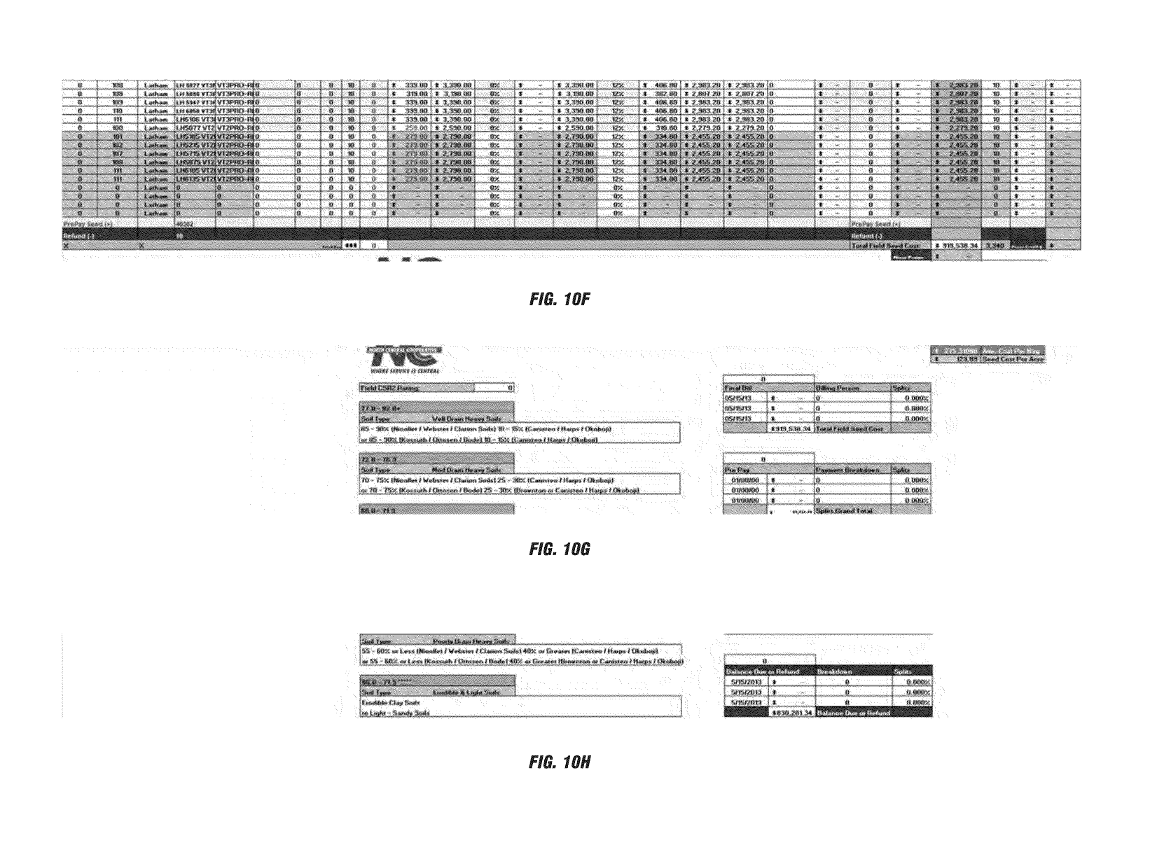

FIGS. 10A-10H illustrate an example of a worksheet for corn hybrids. The worksheet may be used to select a type of hybrid for a particular field. Information regarding CSR2 information, maturity, and traits for the hybrid may be displayed for a plurality of different hybrids. Information regarding the number of bags, the lot number associated with the bags and the seed size may be shown. The number of bags picked up and bags returned may be tracked as well as pricing information including any discounts if applicable.

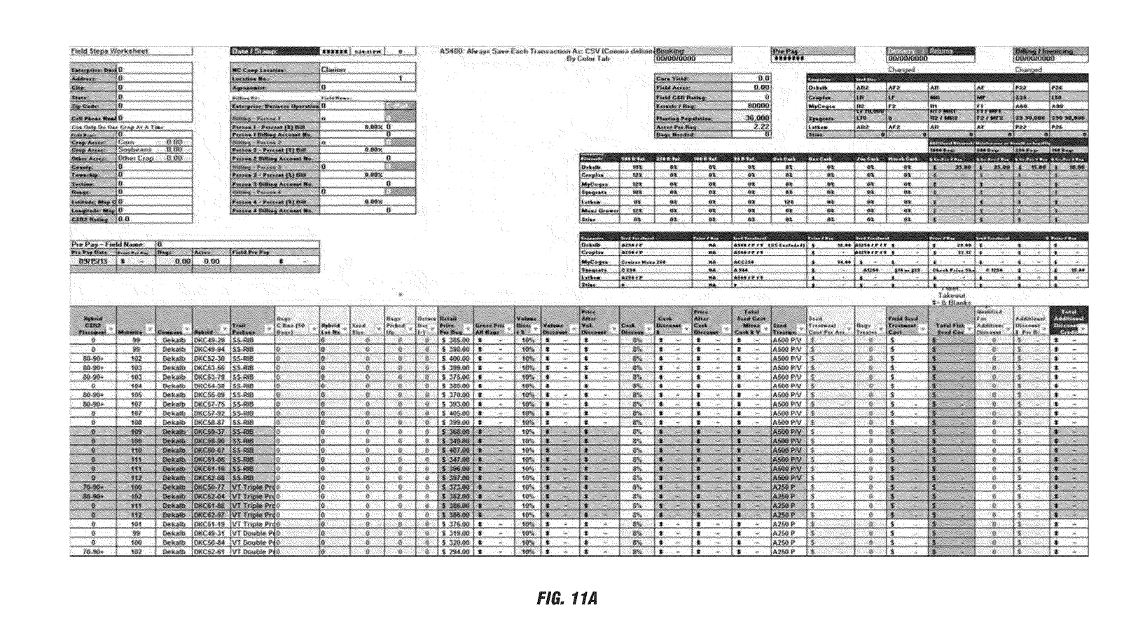

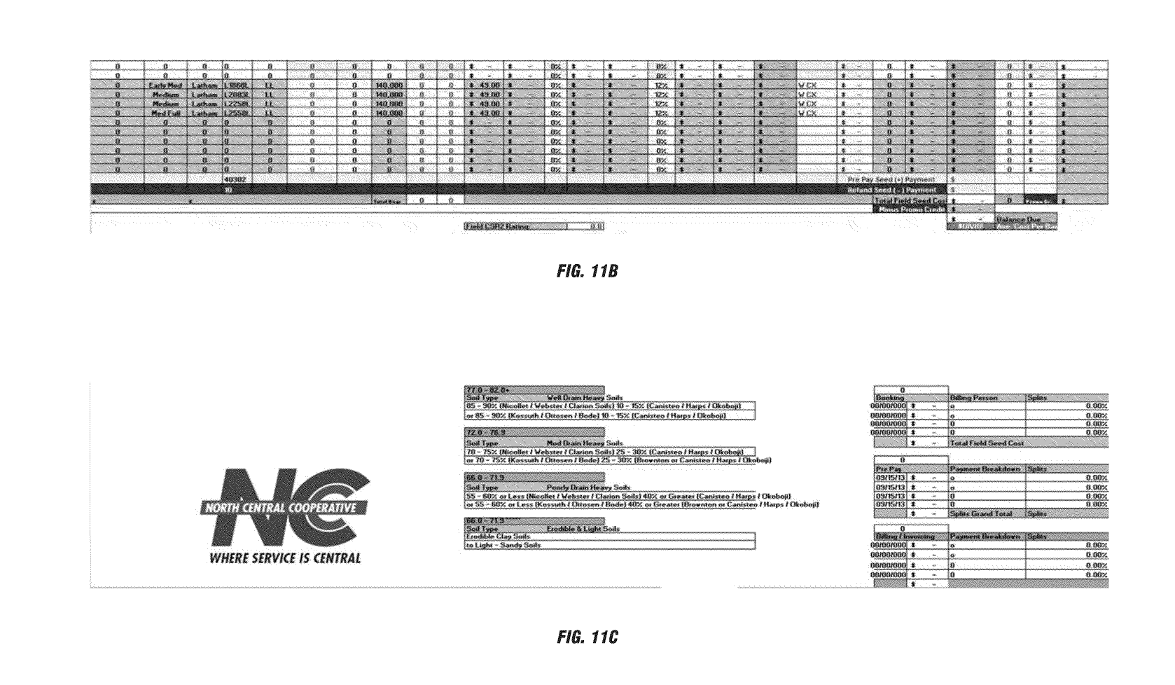

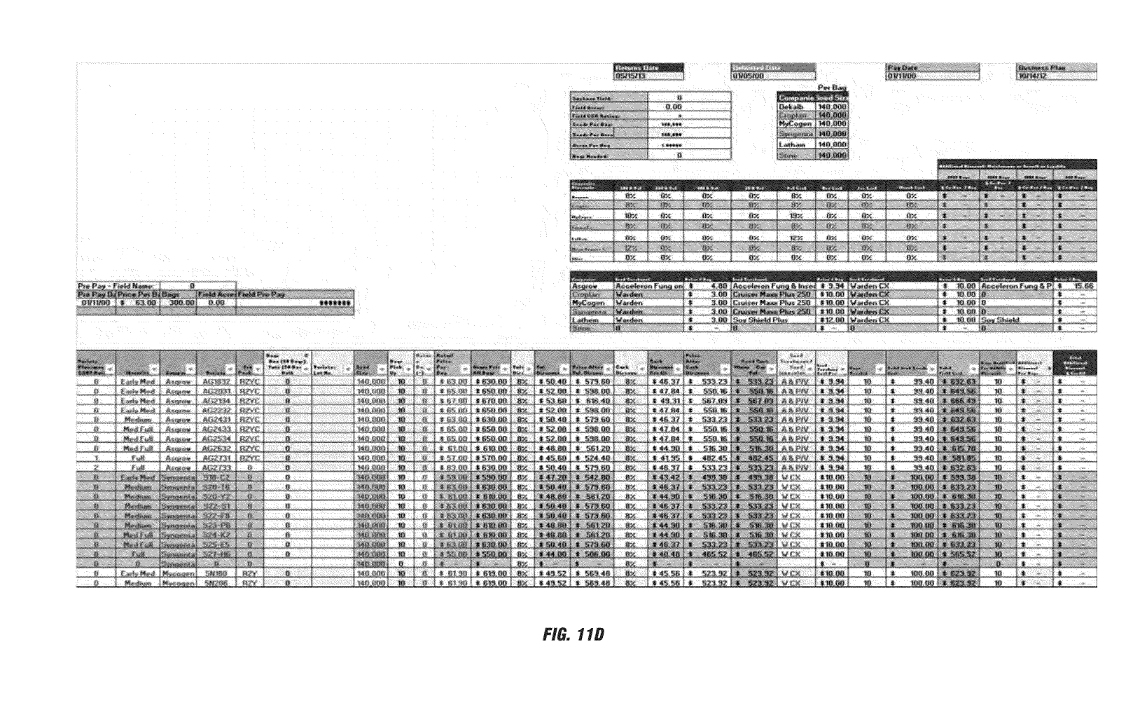

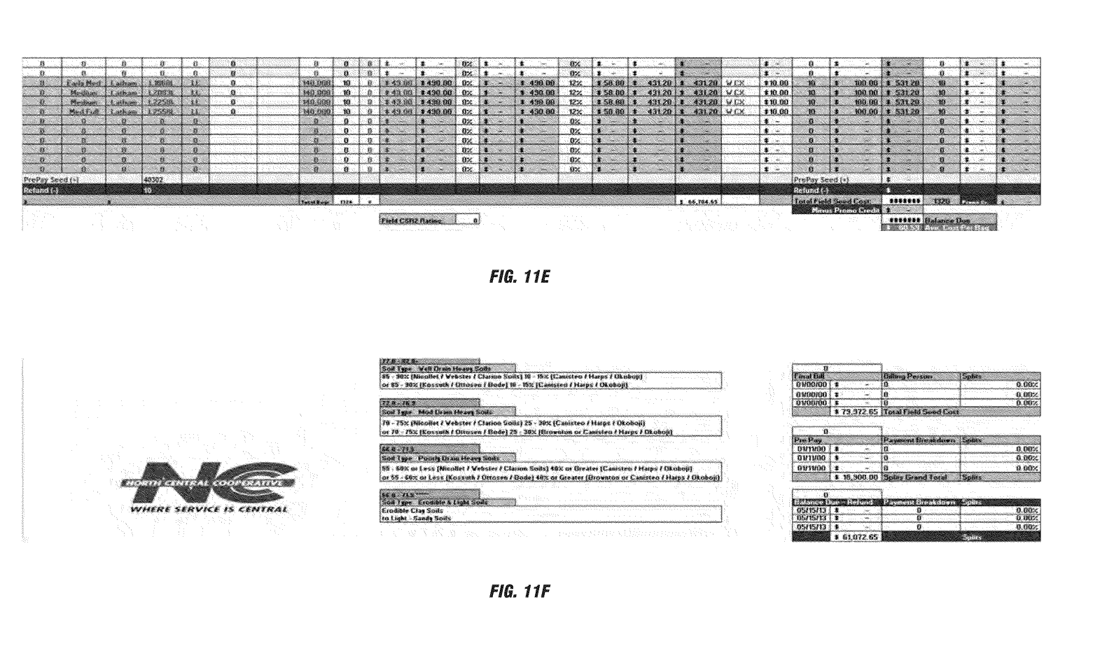

FIGS. 11A-11F illustrate an example of worksheet for soybean varieties. The worksheet may be used to select a variety of soybean for a given field based on soil, maturity, company, variety, and trait packages. In addition, the number of units of seed (e.g. bags or boxes, totes, etc.) may be specified. The lot number may be specified as well as seed size, pricing information, discount information, and the number of units picked up or returned may also be specified. Seed treatment or seed inoculation may also be specified along with related costs.

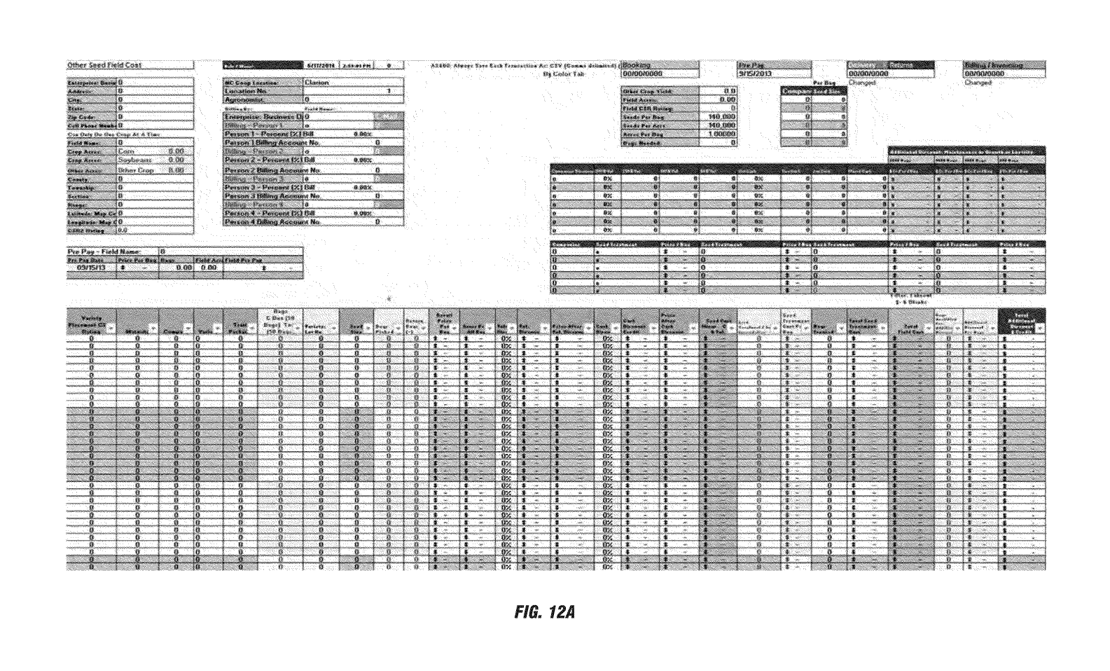

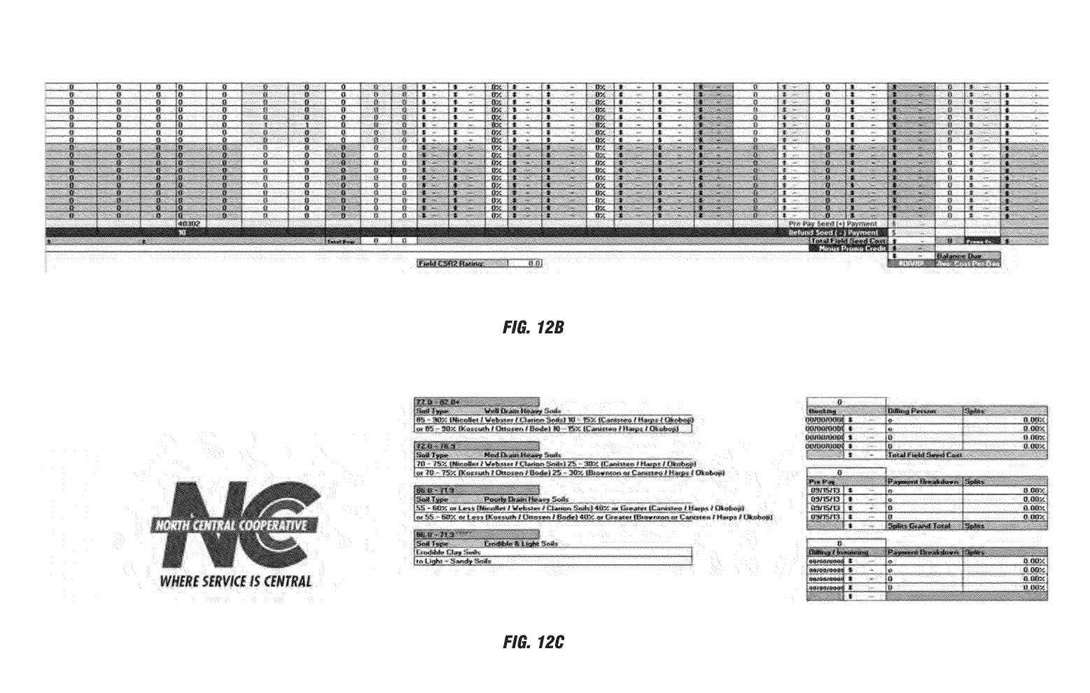

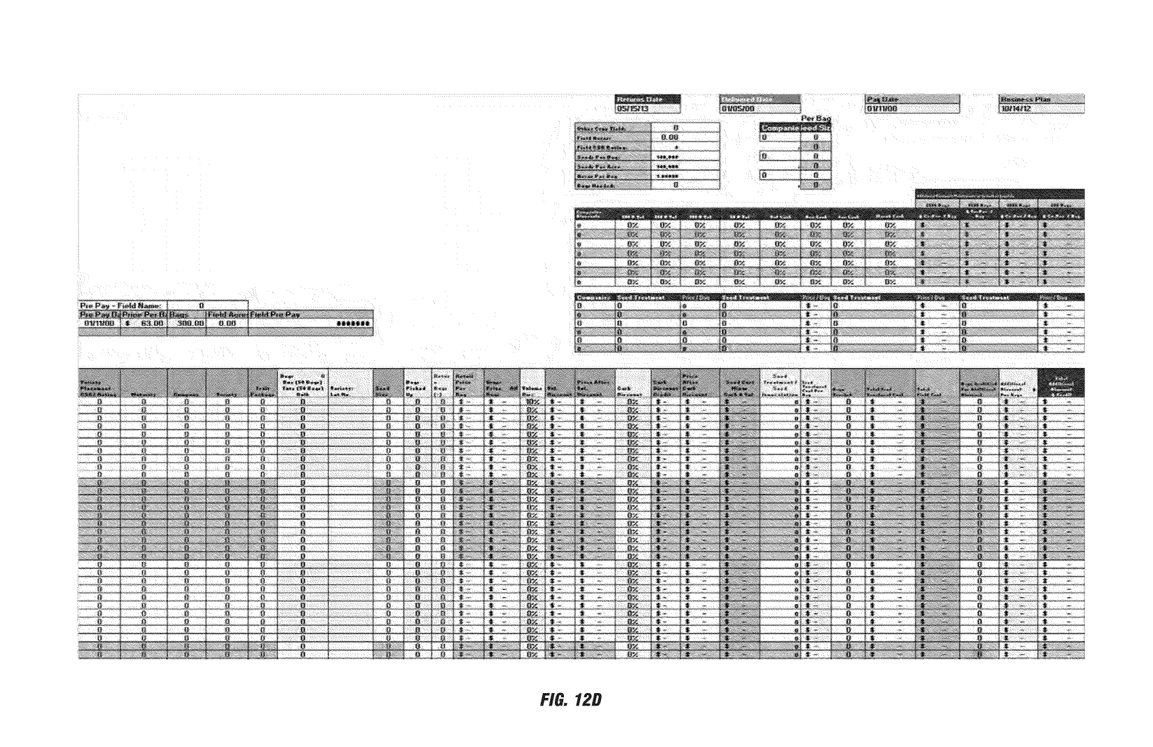

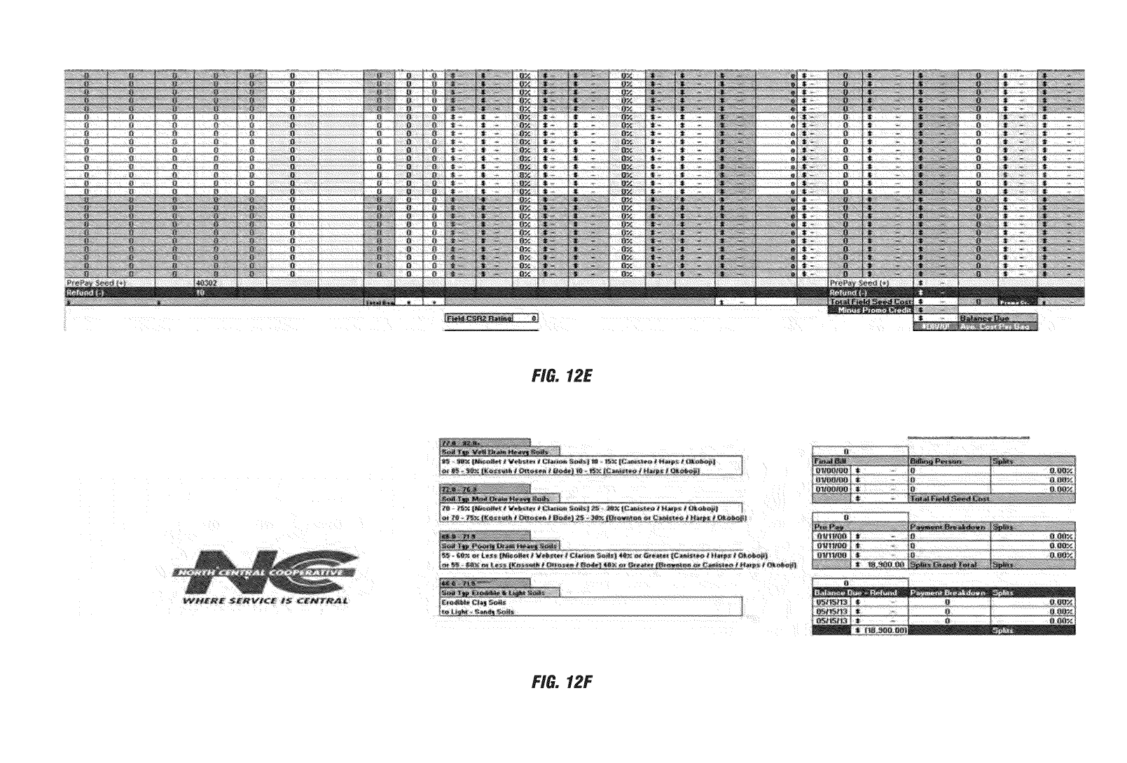

FIGS. 12A-12FB illustrate an example of a worksheet for corn cash flow. The corn cash flow statement takes into account factors affecting profit or loss for a field or enterprise. This can include field expenses such as cash rent or land payments, fertilizer costs, machinery costs, seed and traits costs, herbicide costs, nutritional costs, fungicide costs, insecticide costs, fuel costs, drying and electricity costs, insurance costs, repair costs, interest, miscellaneous costs and grain hauling costs, and property taxes. Thus the total crop expenses per acre can be determined as shown in FIG. 12A. FIG. 12B illustrates that the worksheet takes into account income based on the amount of corn pre-sold through contracts or based on future prices as well as income associated with crop insurance, and government farm payments. A component is also shown for listing grain contracts with a cooperative and a link is provided to allow for making an offer through a grain offer system. Thus, the worksheet provides for tracking information used in calculating income, expenses, profits, and loss. Information from FIGS. 12A-12B may also be provided by a crop producer to a bank to assist with obtaining financing.

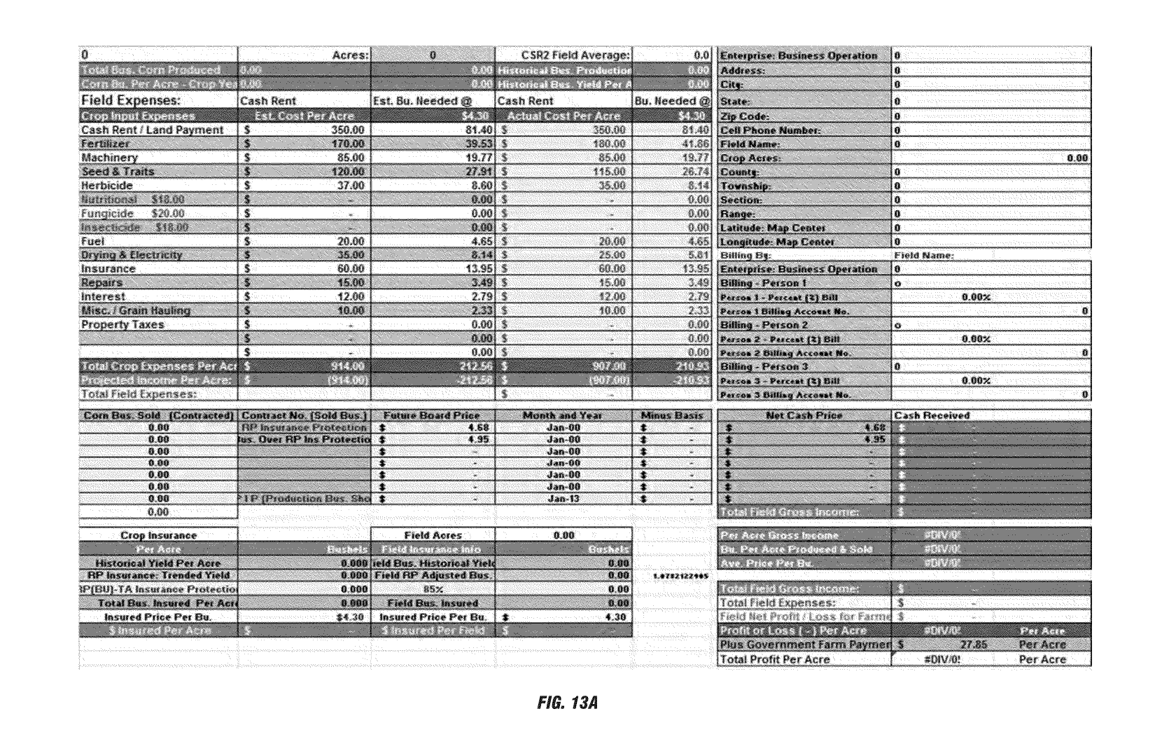

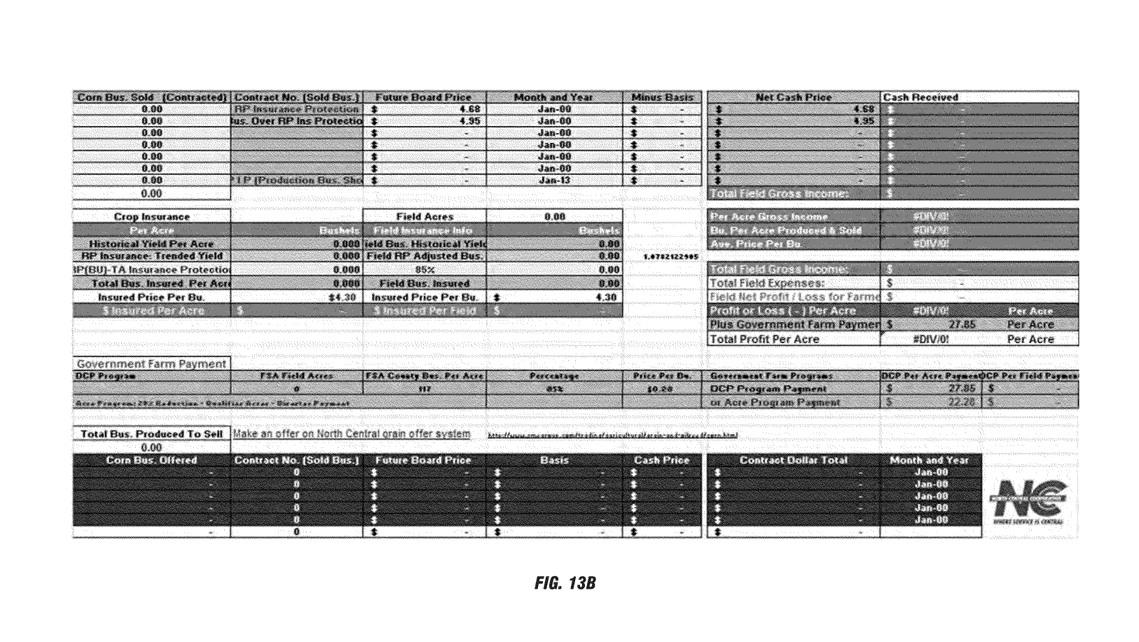

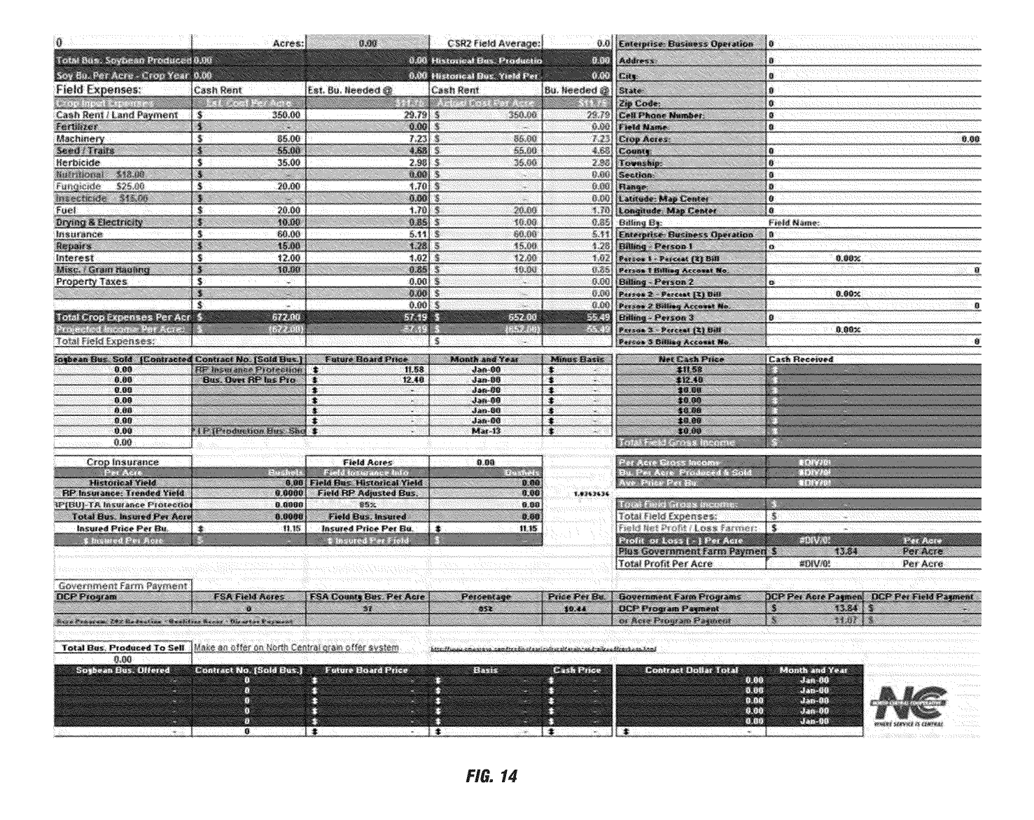

FIGS. 13A-13F illustrate an example of a worksheet for corn cash flow. FIG. 14 illustrates an example of a worksheet for soybean cash flow. The soybean cash flow statement takes into account factors affecting profit or loss for a field or enterprise. This can include field expenses, crop input expenses, and all other expenses that may affect profit or loss. The soybean cash flow worksheet considers factors such as those found in the corn cash flow worksheet.

FIG. 14 illustrates an example of a worksheet showing a summary for a producer for seed plans. The summary shows all fields of the producer.

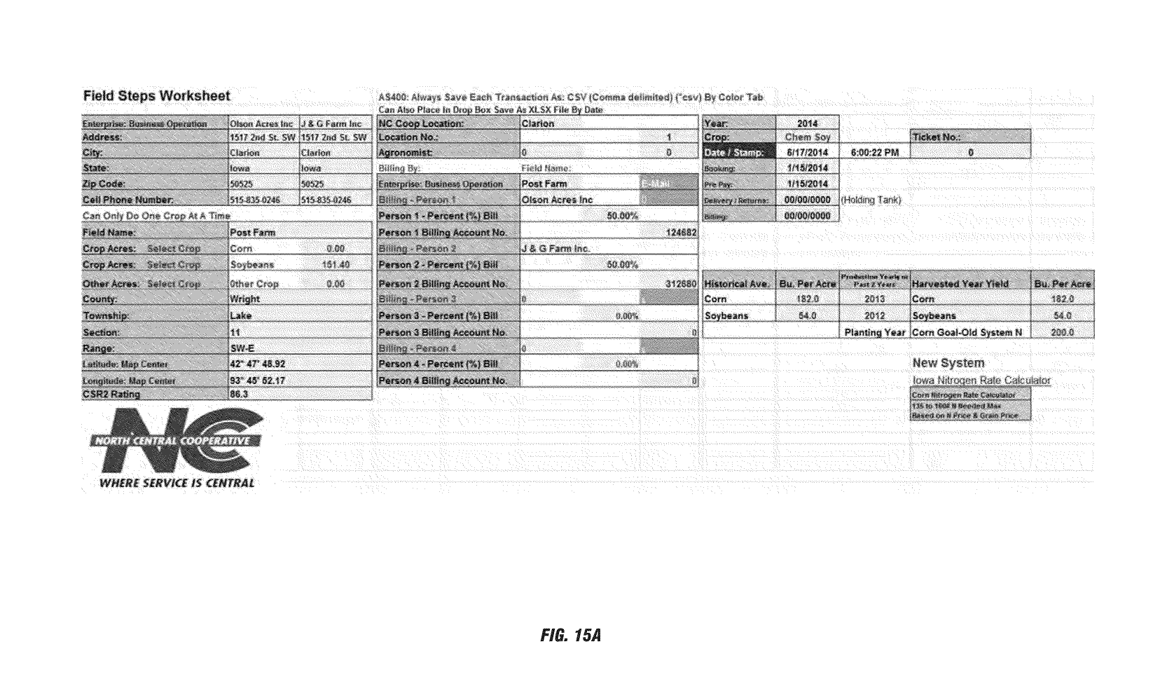

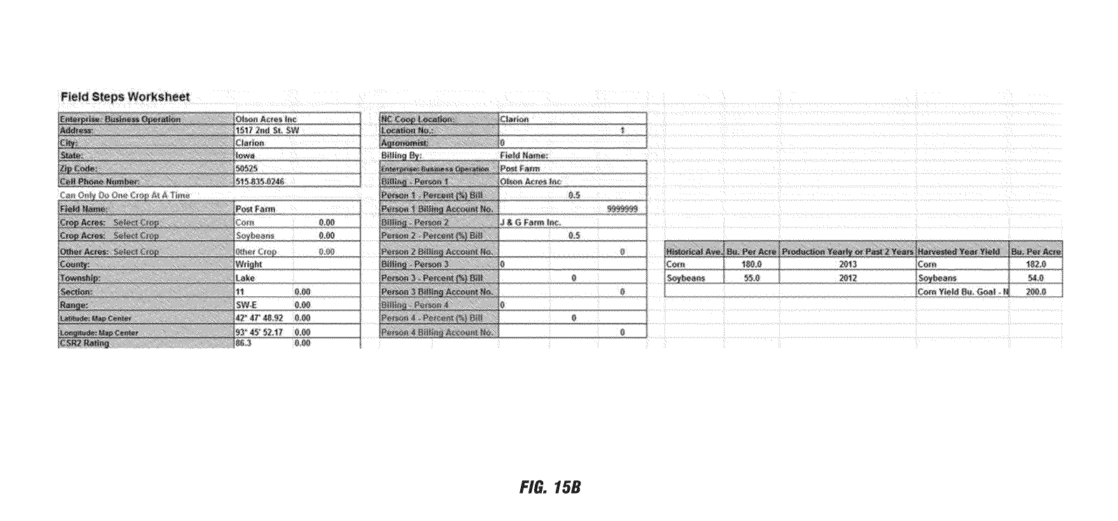

FIGS. 15A-15B illustrates an example of a worksheet associated with field steps.

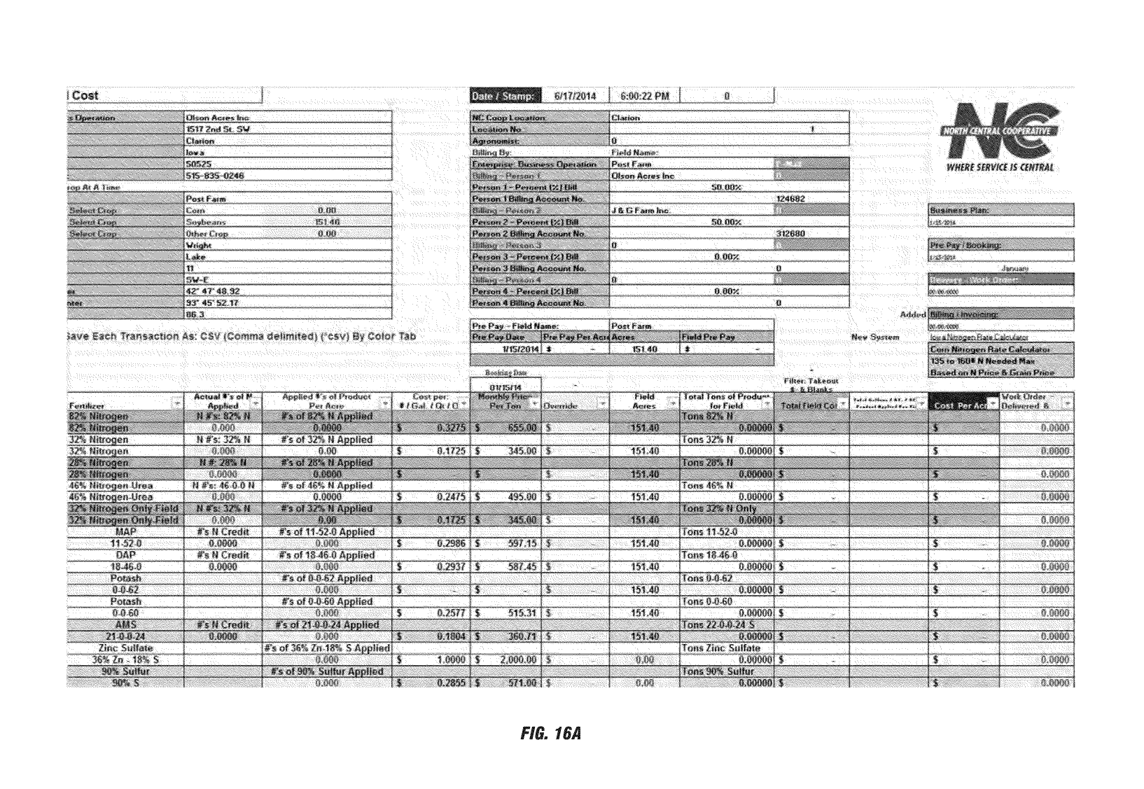

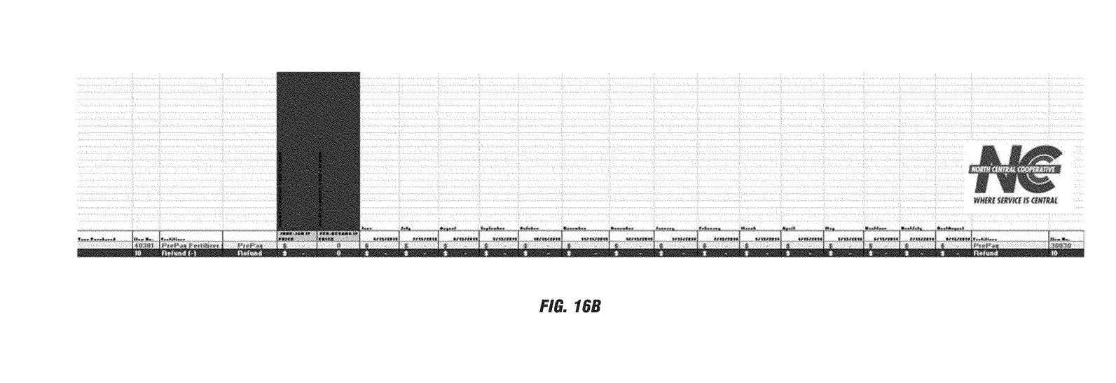

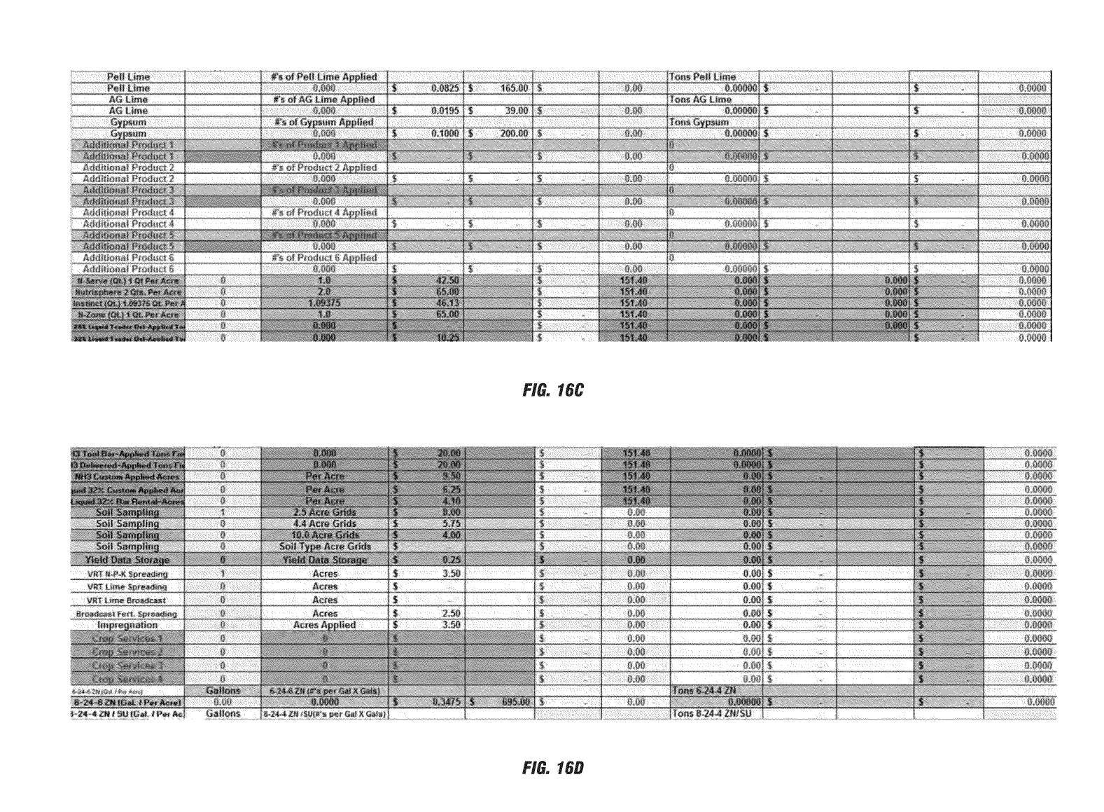

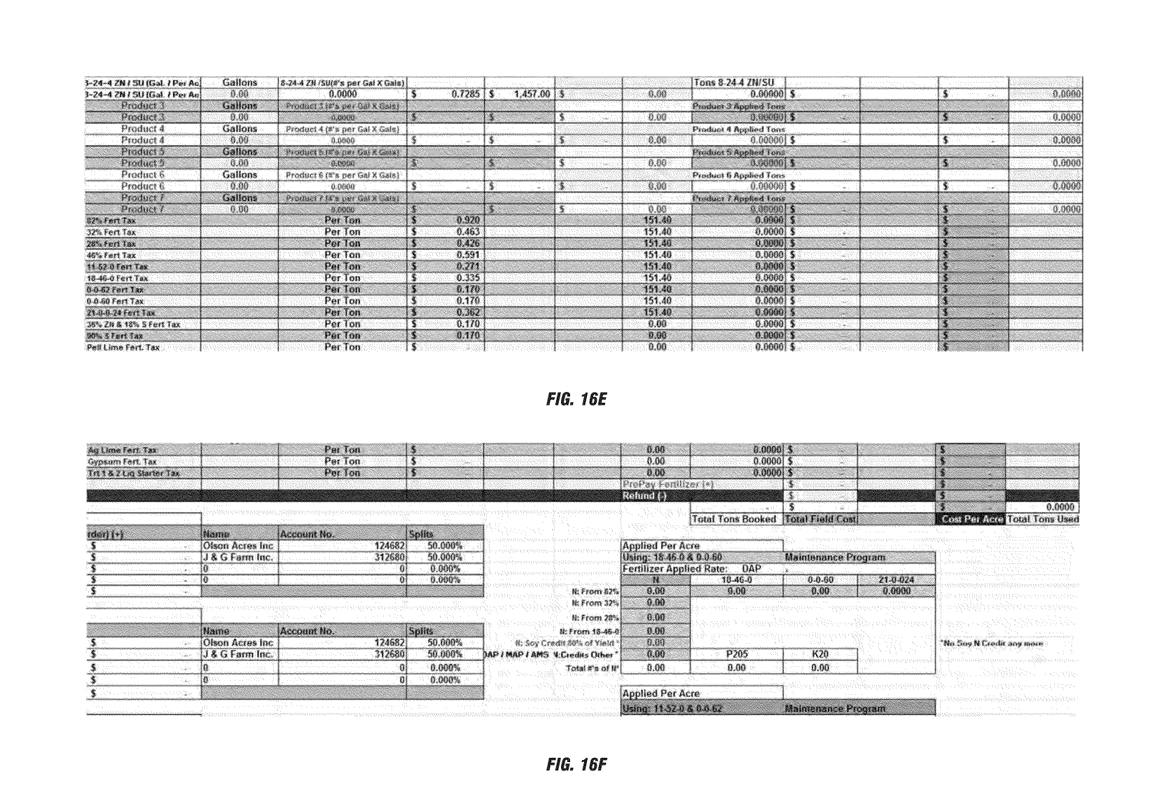

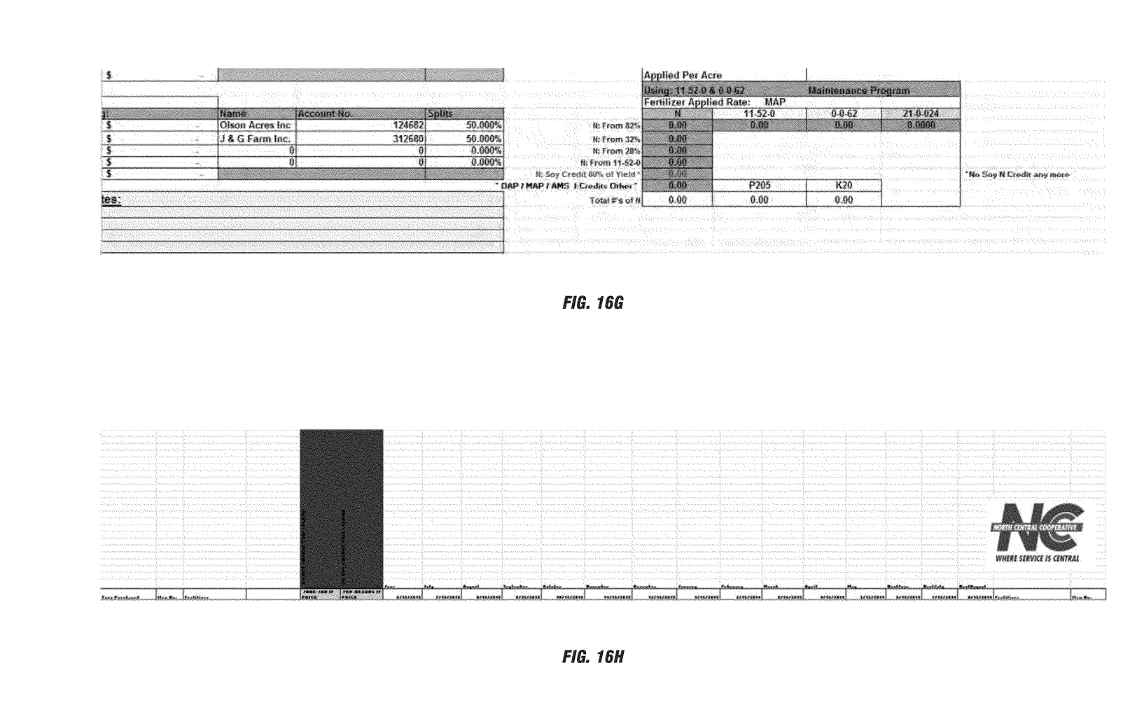

FIGS. 16A-16H illustrate one example of a field fertilizer needs worksheet showing a summary for a producer for fertilizer planning showing all fields of the producer. Such a plan can be particularly useful for a producer as compliance with regulations or government recommendations on fertilizer use can be quickly determined.

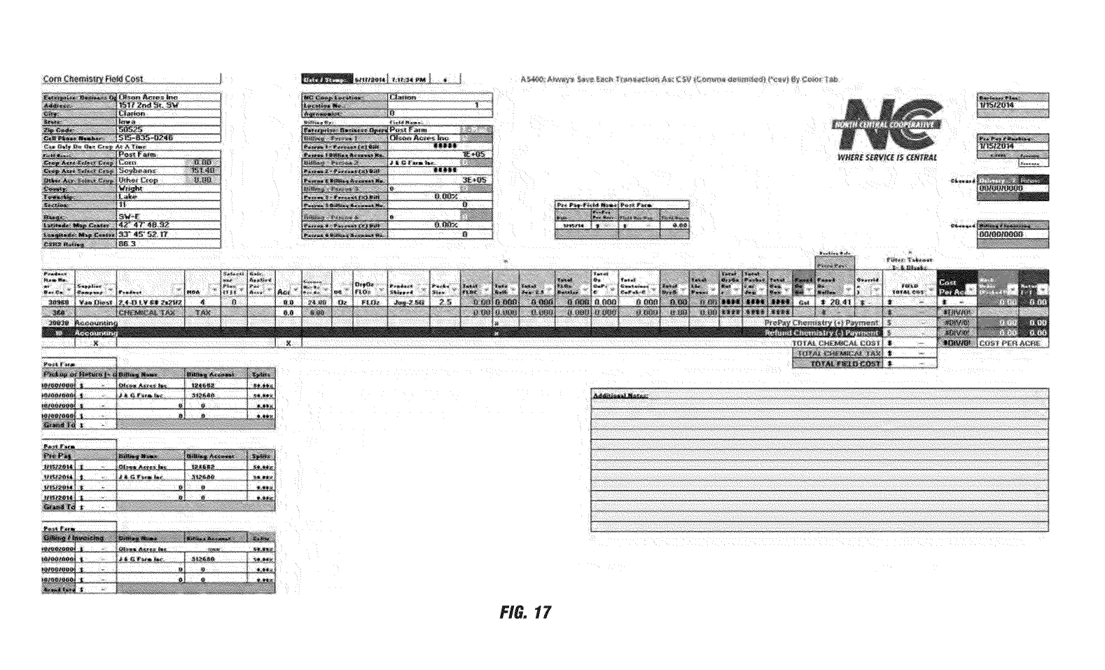

FIG. 17 illustrate an example of a worksheet for corn chemistry.

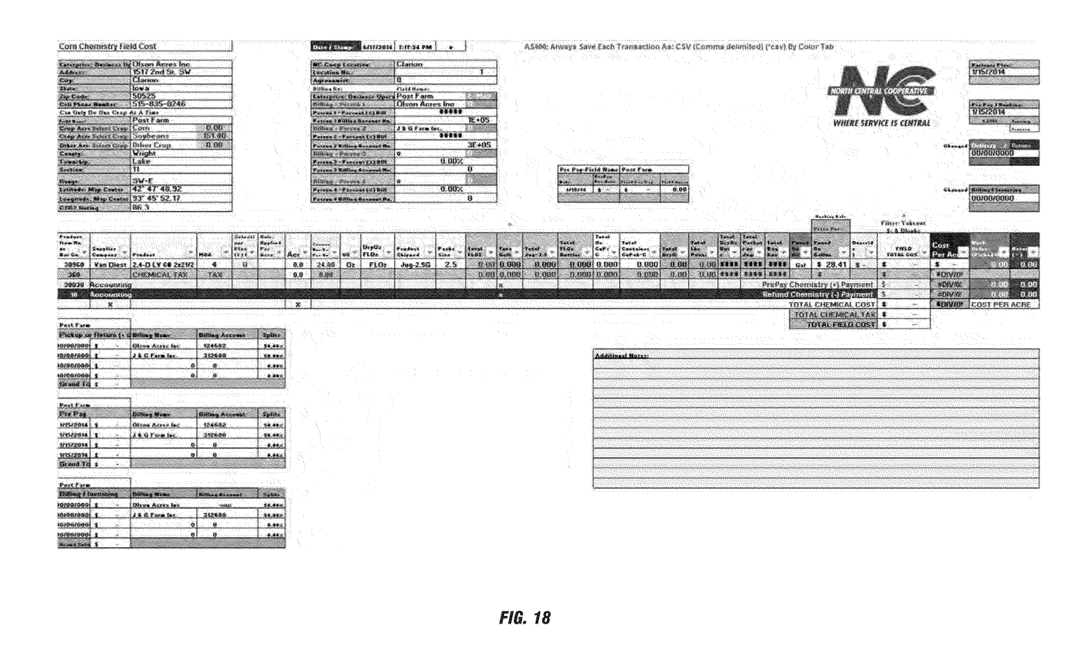

FIG. 18 is an example of a worksheet for soybean chemistry.

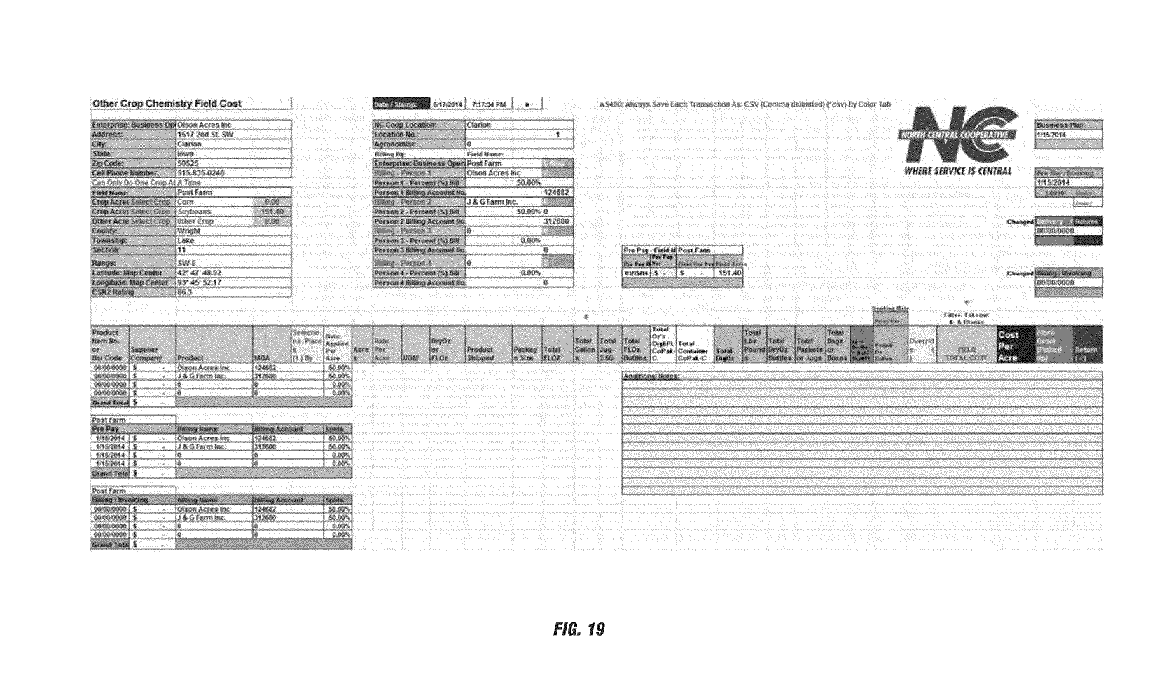

FIG. 19 illustrate an example of a worksheet for other crop chemistry.

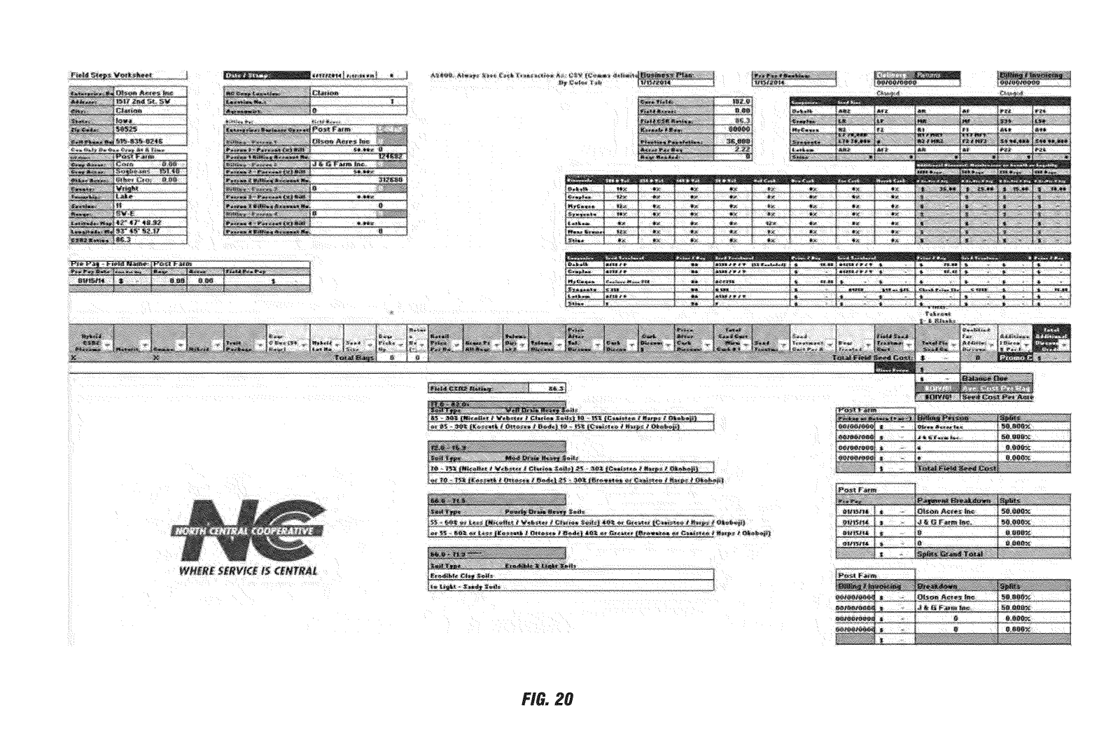

FIG. 20 illustrate an example of a worksheet for corn hybrids.

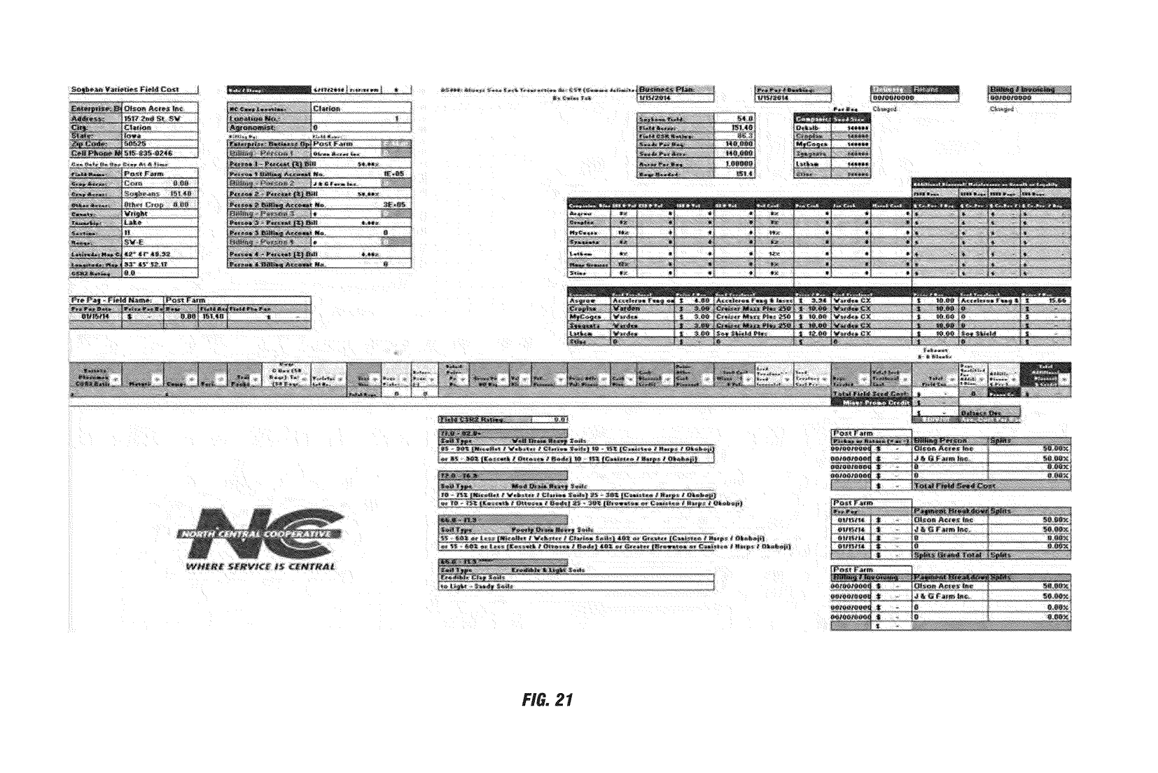

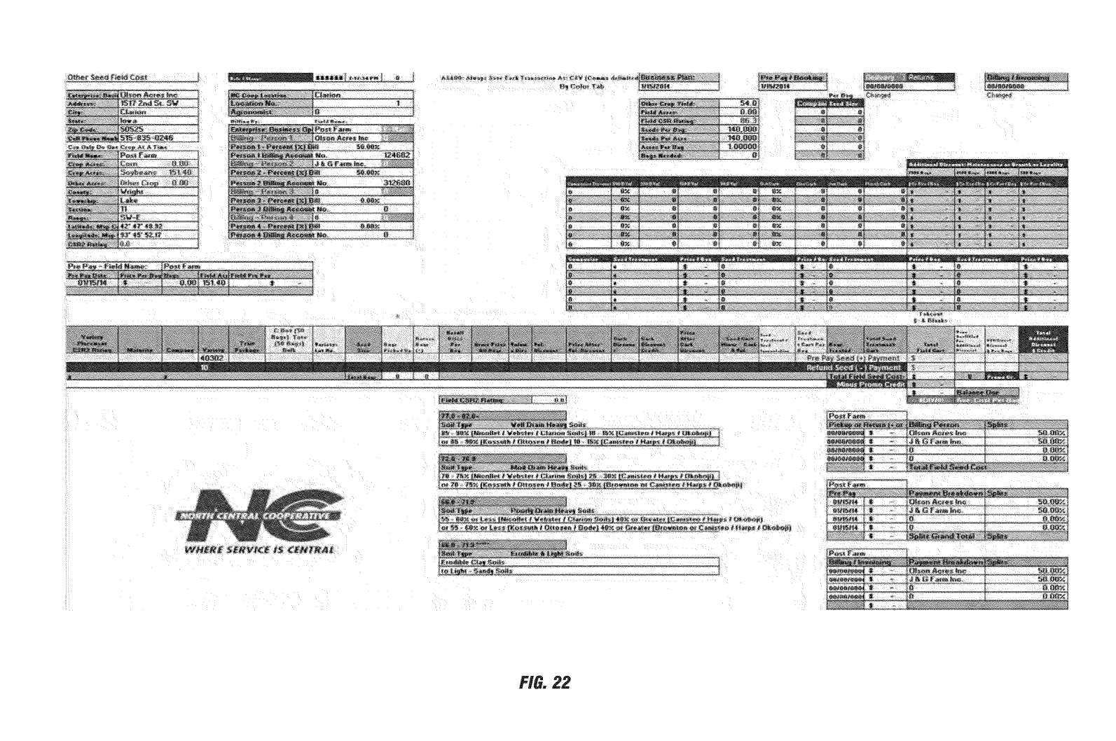

FIG. 21 illustrate an example of worksheet for soybean varieties.

FIG. 22 illustrate a worksheet for other seed cost.

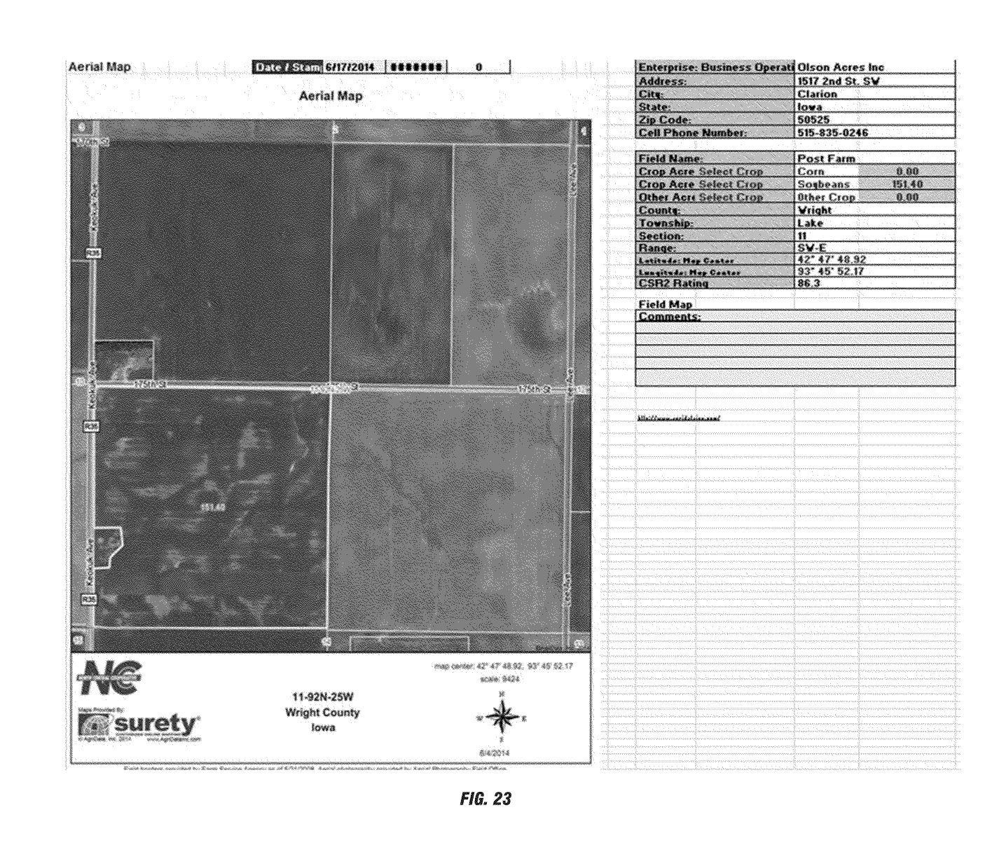

FIG. 23 illustrates a worksheet associated with a field map.

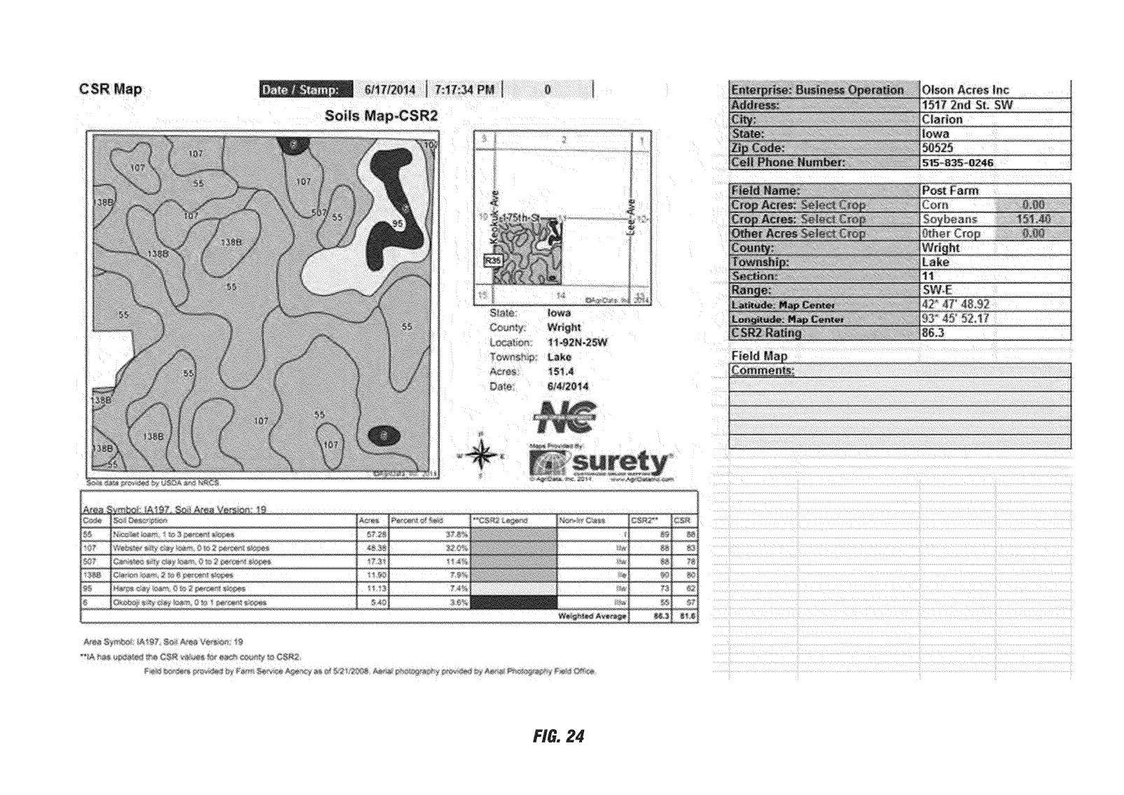

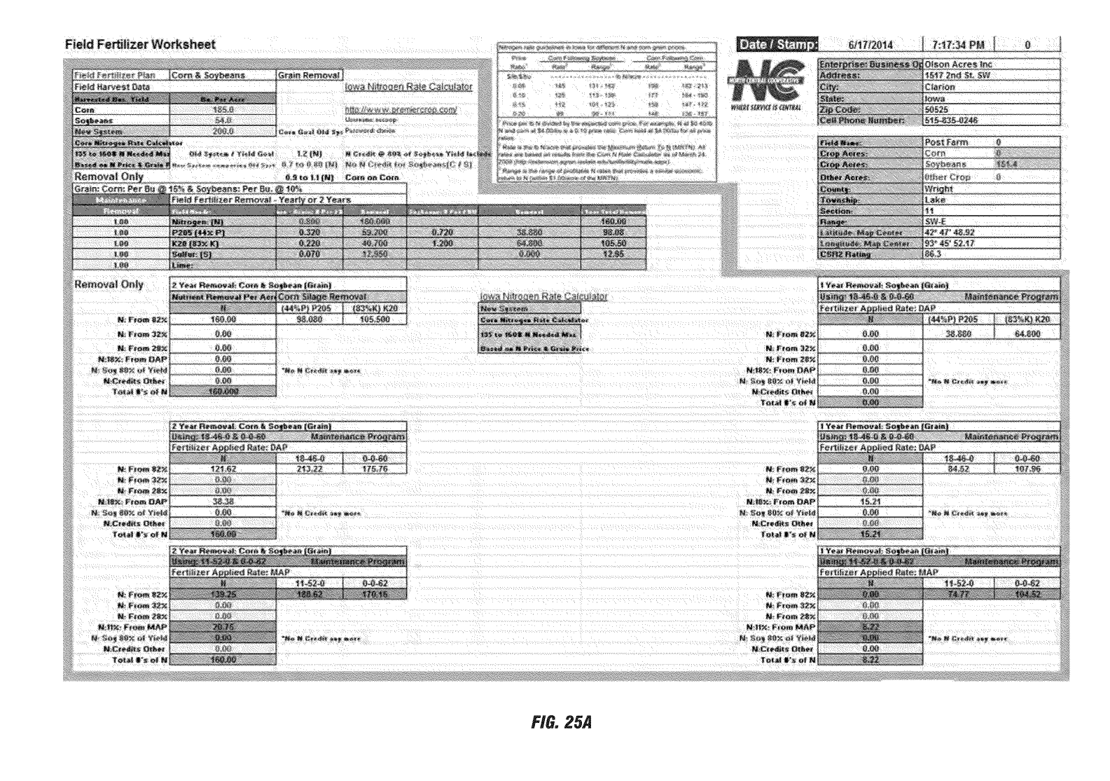

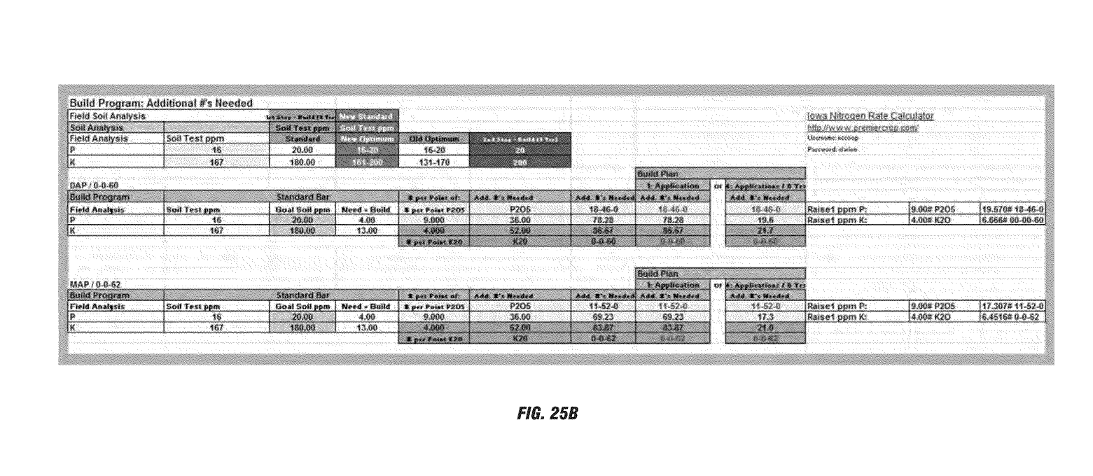

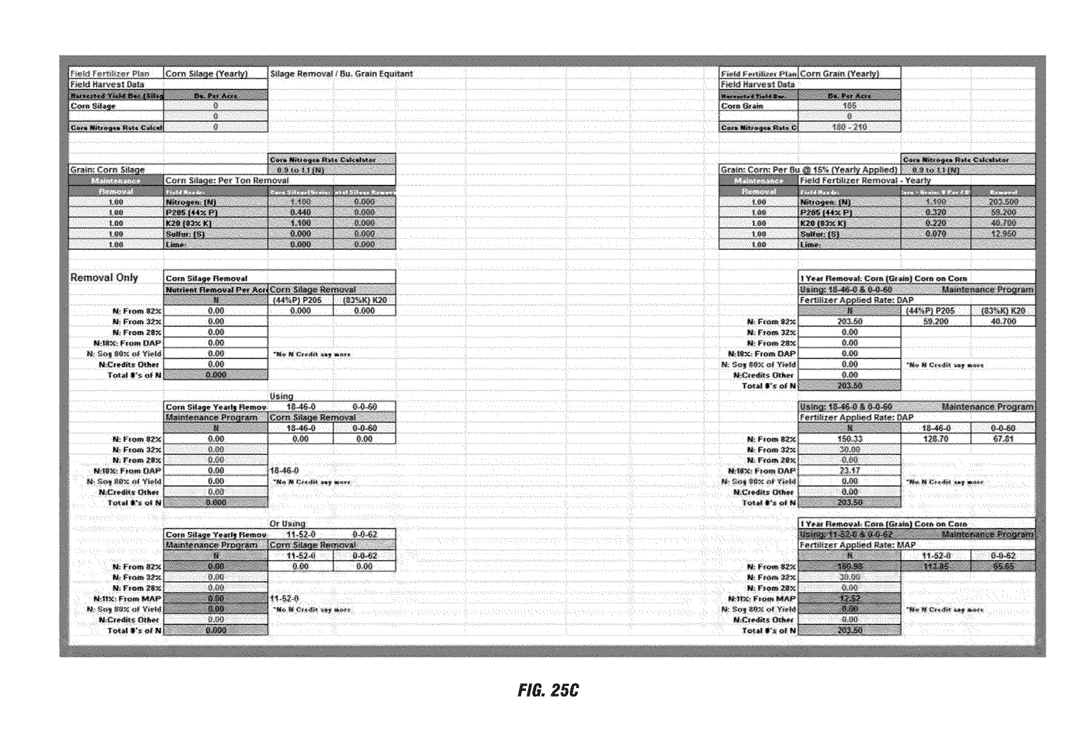

FIG. 24 illustrates a worksheet associated with a soil map.

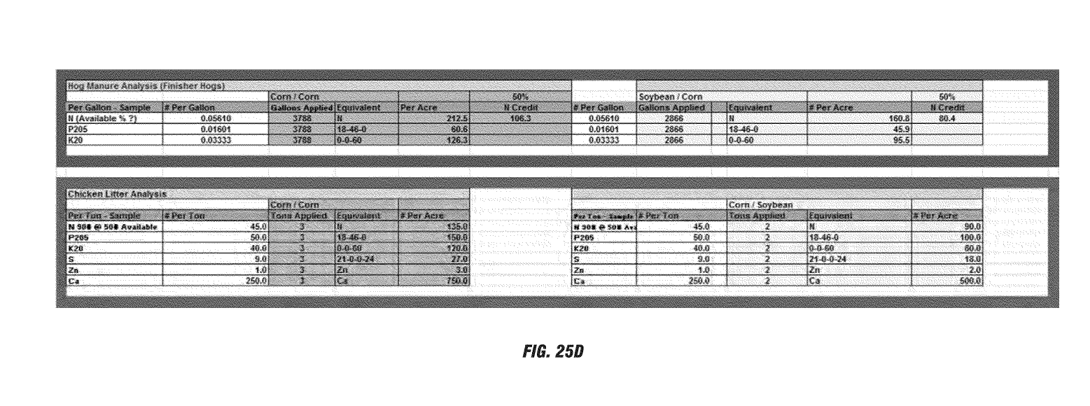

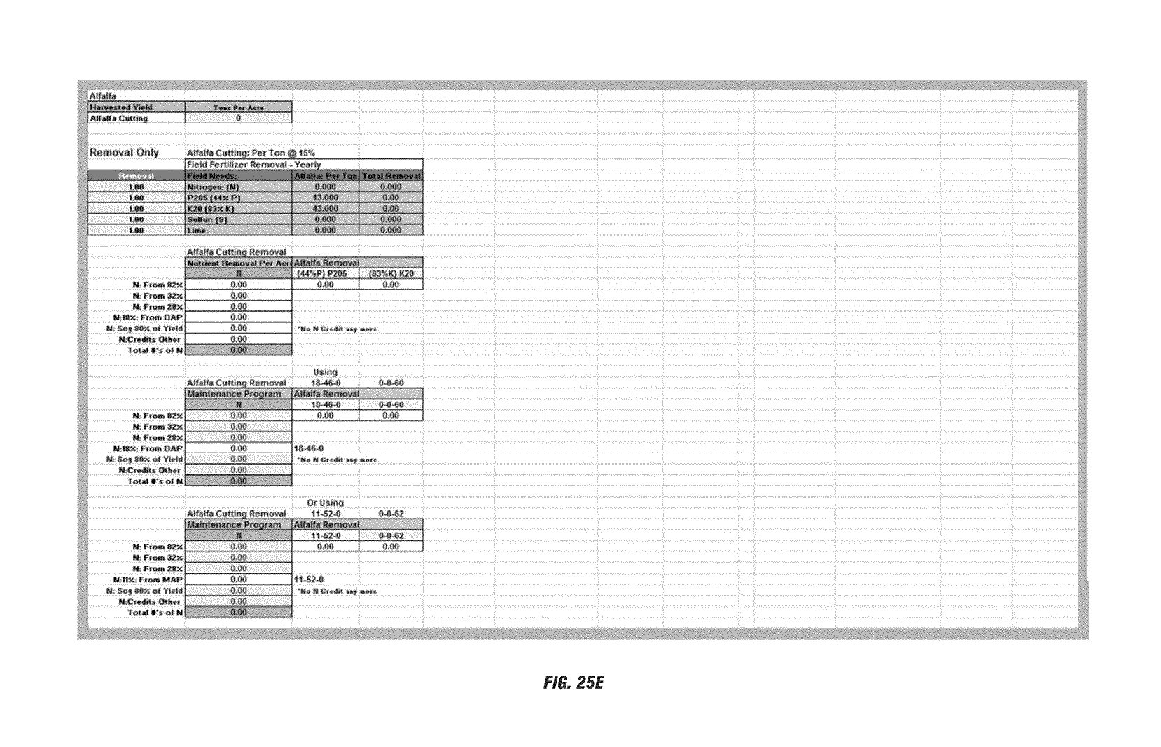

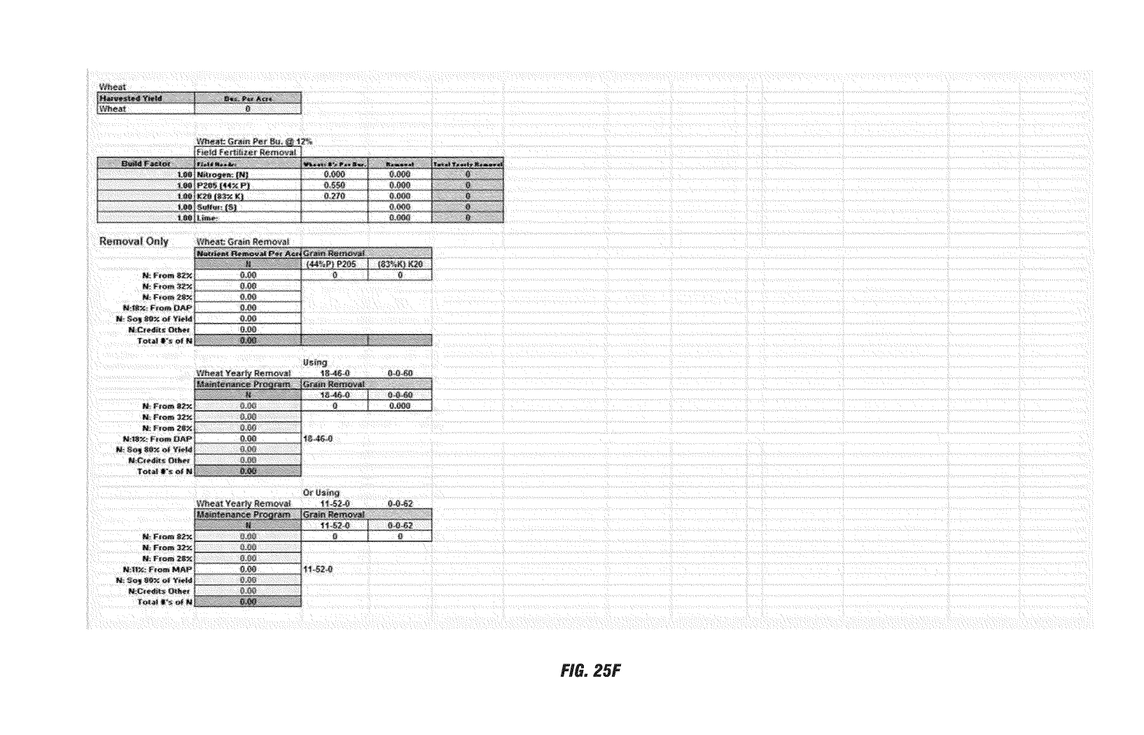

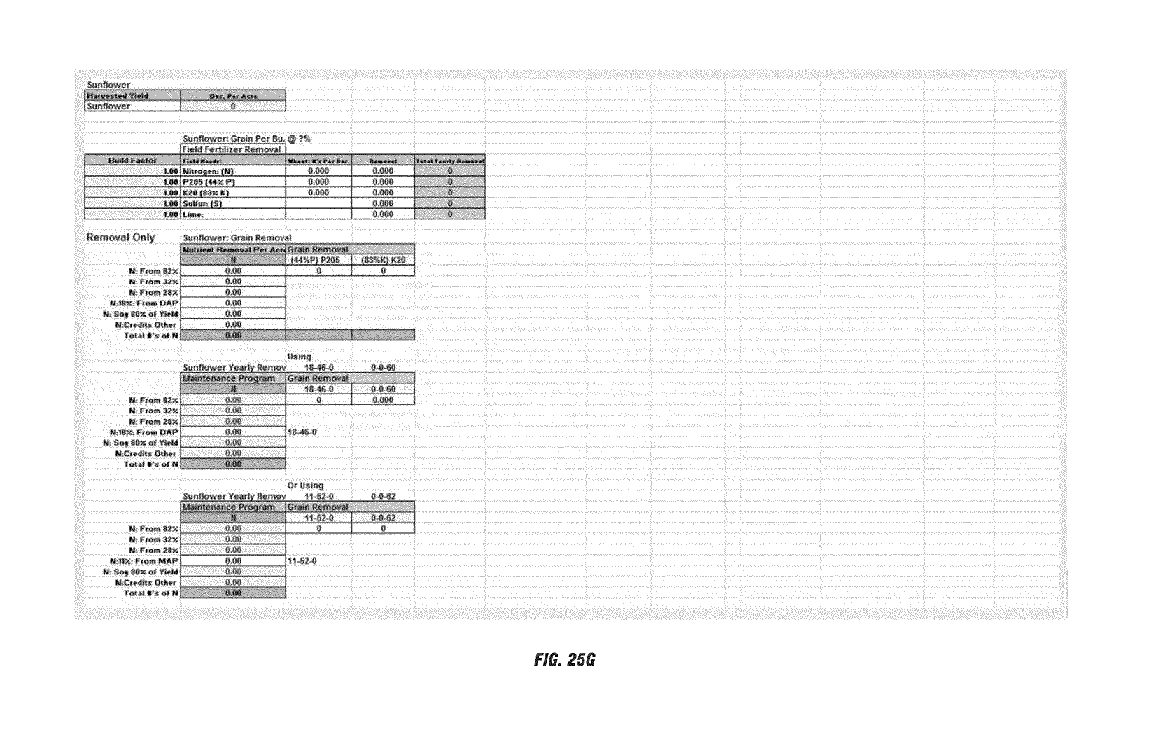

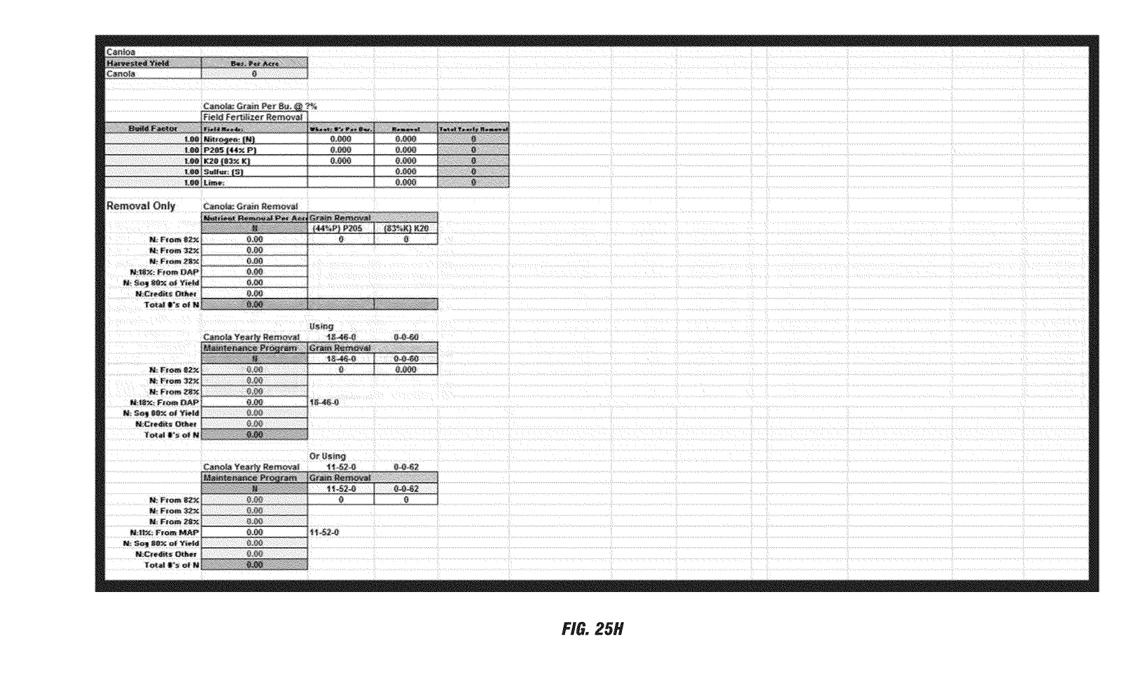

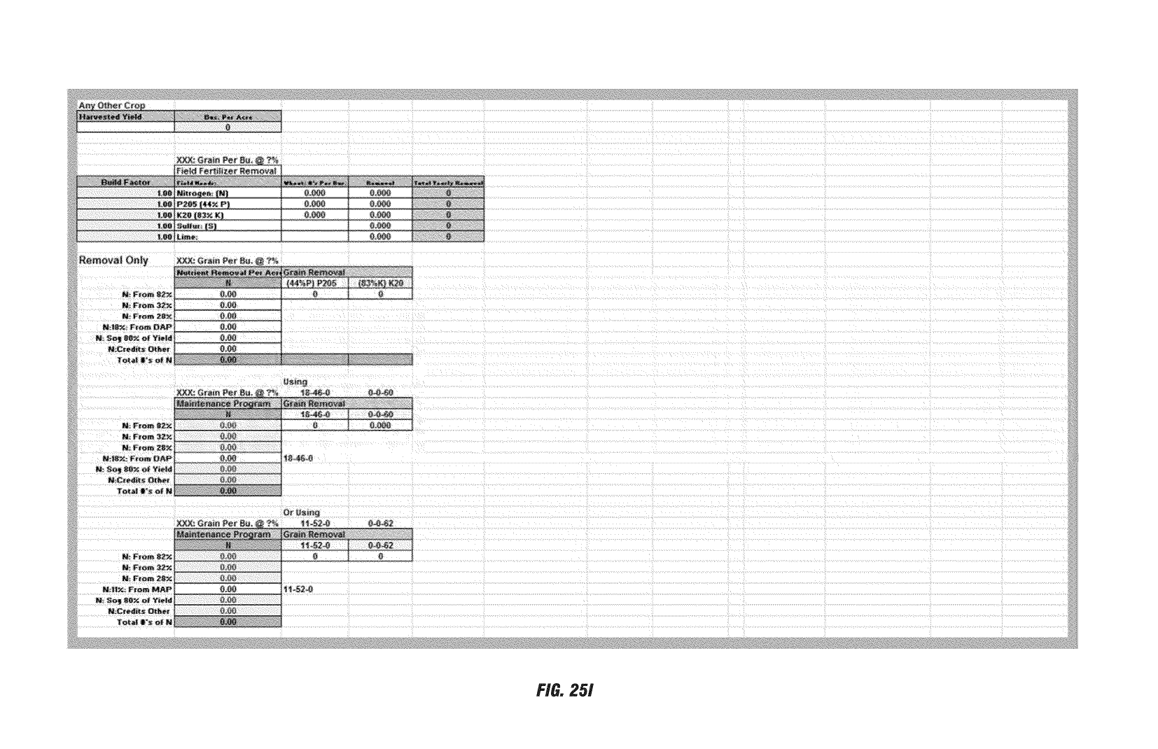

FIGS. 25A-25I illustrate a worksheet for fertilizer cost.

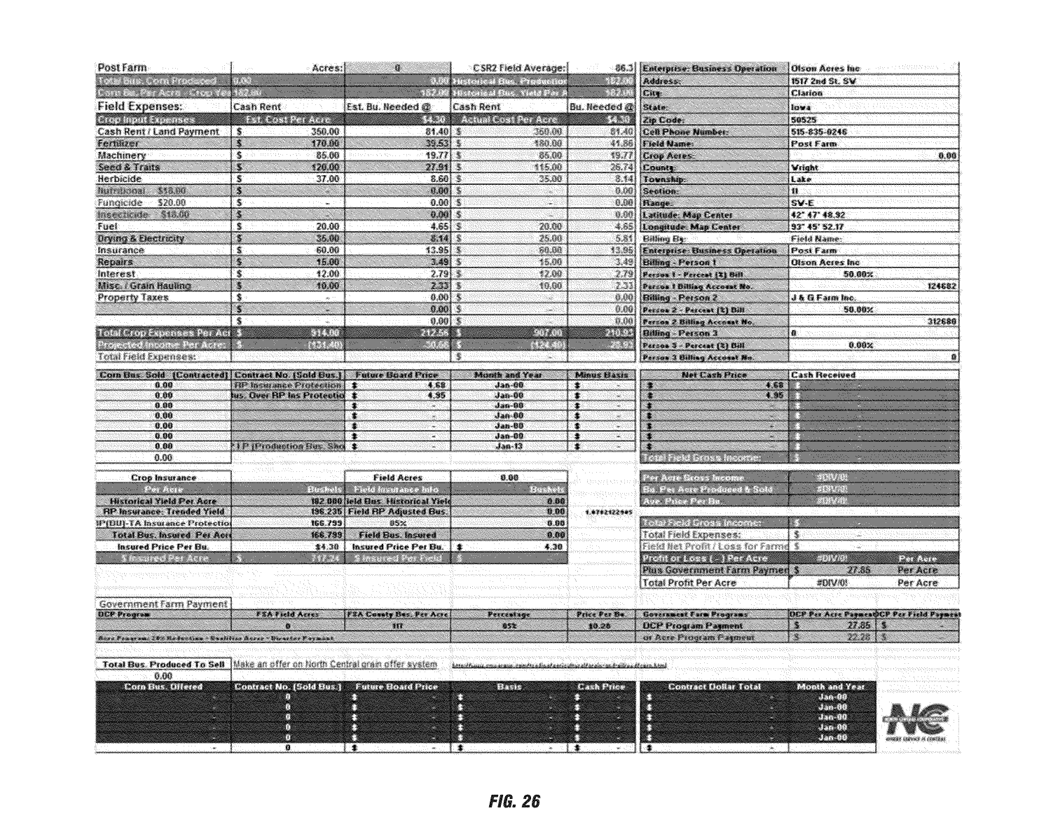

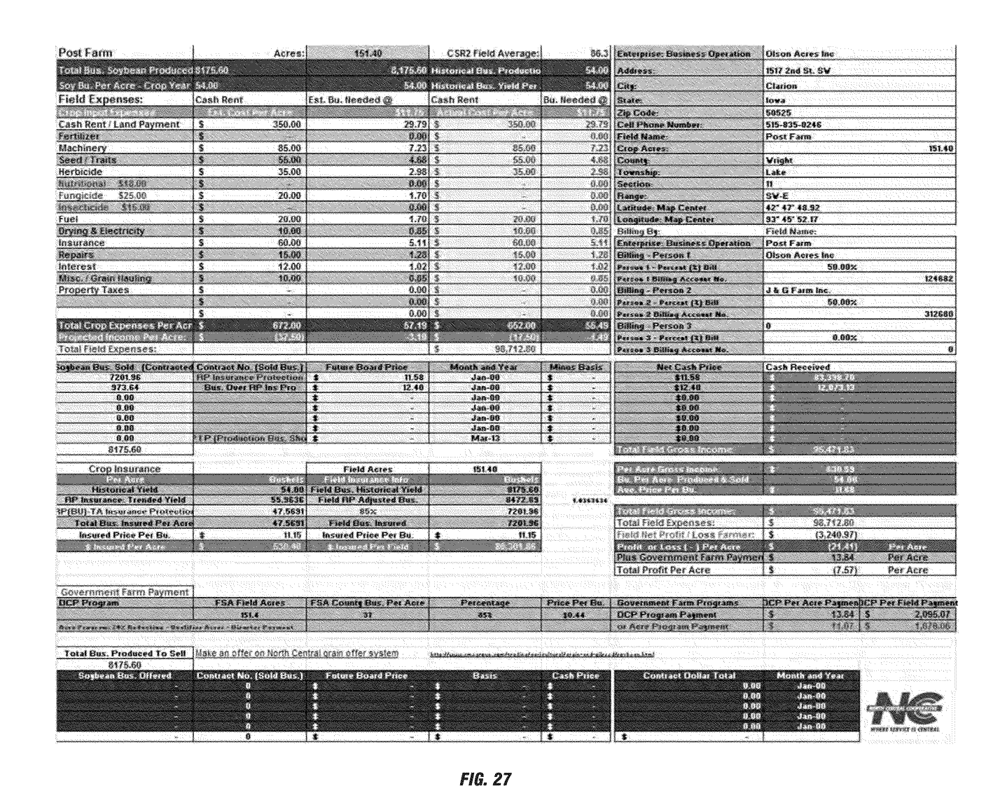

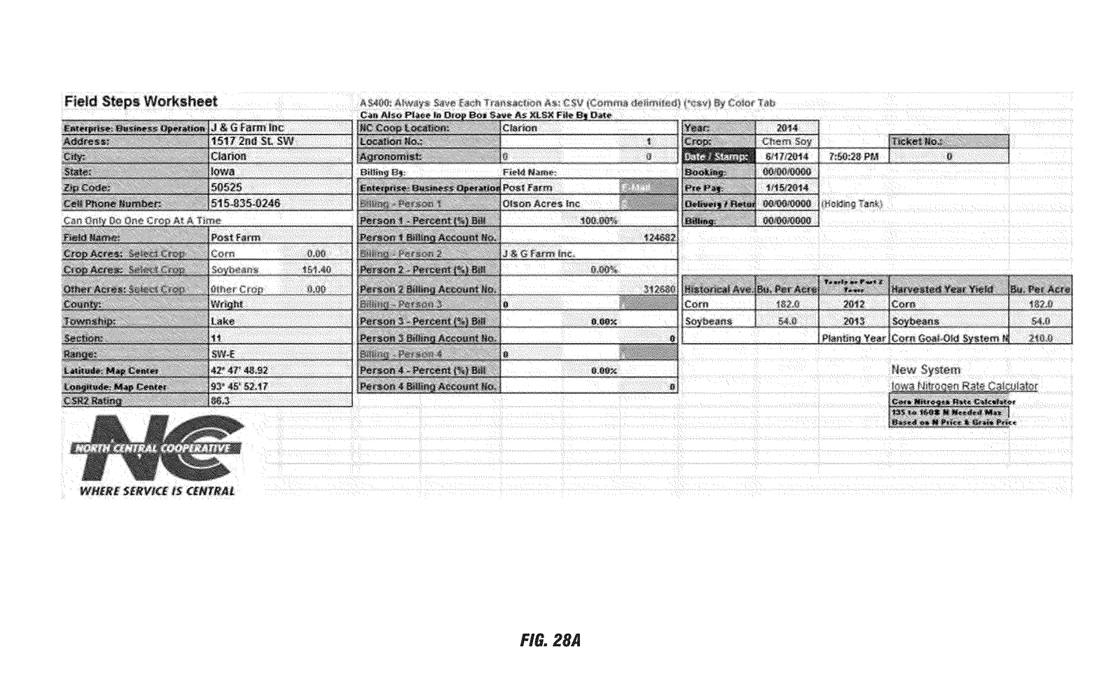

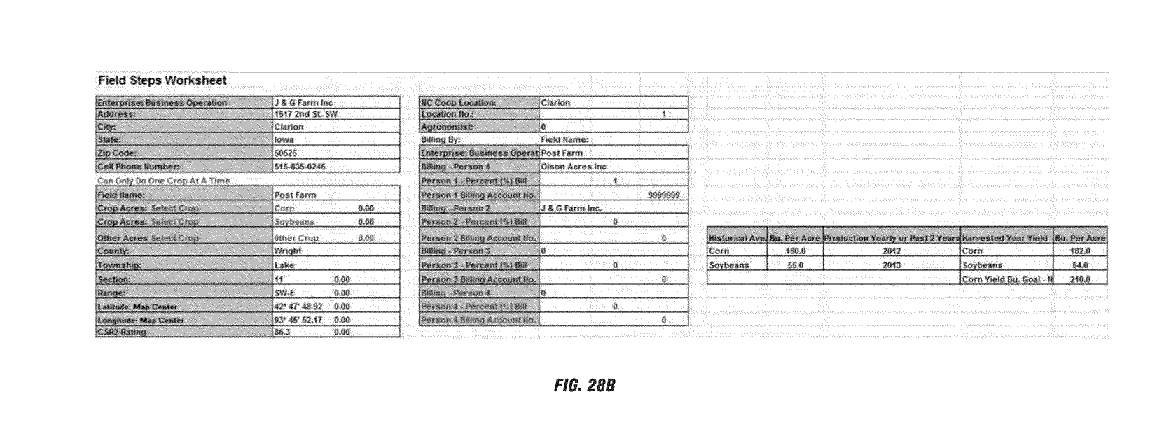

FIG. 26 illustrates another example of a worksheet.

FIG. 27 illustrates another example of a worksheet.

FIGS. 28A-28B illustrates an example of a worksheet associated with field steps.

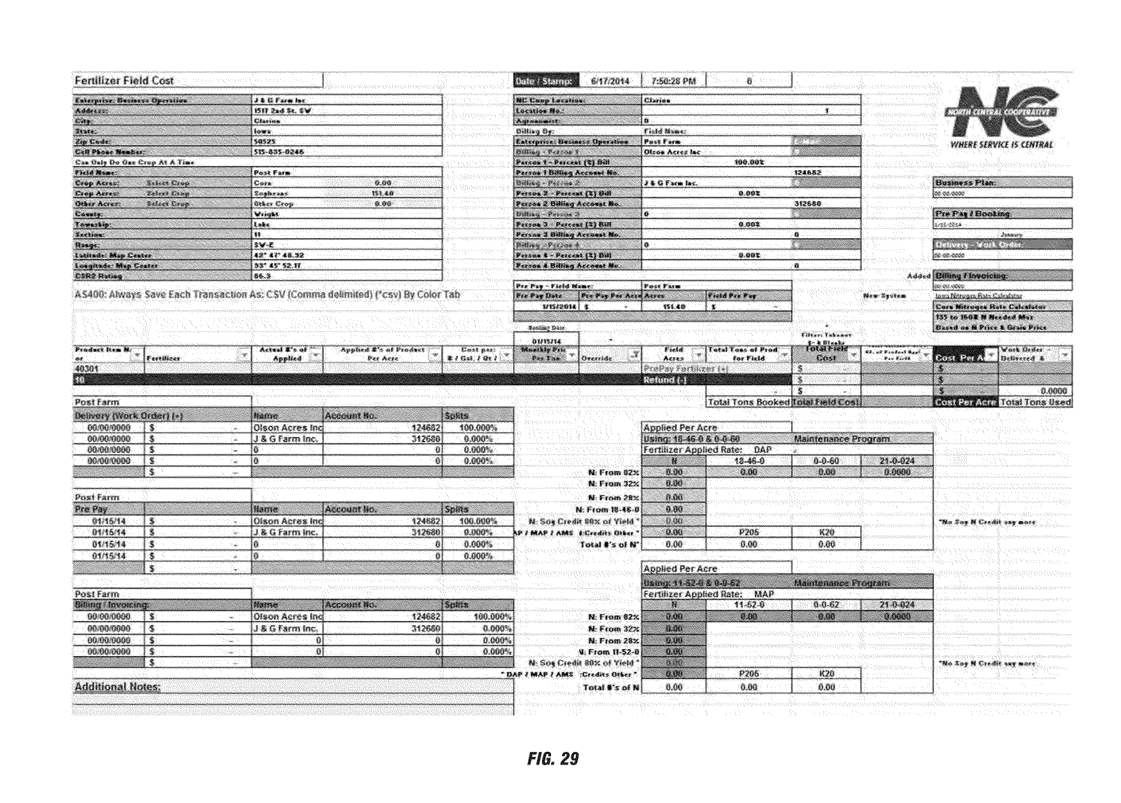

FIG. 29 illustrate one example of a field fertilizer needs worksheet.

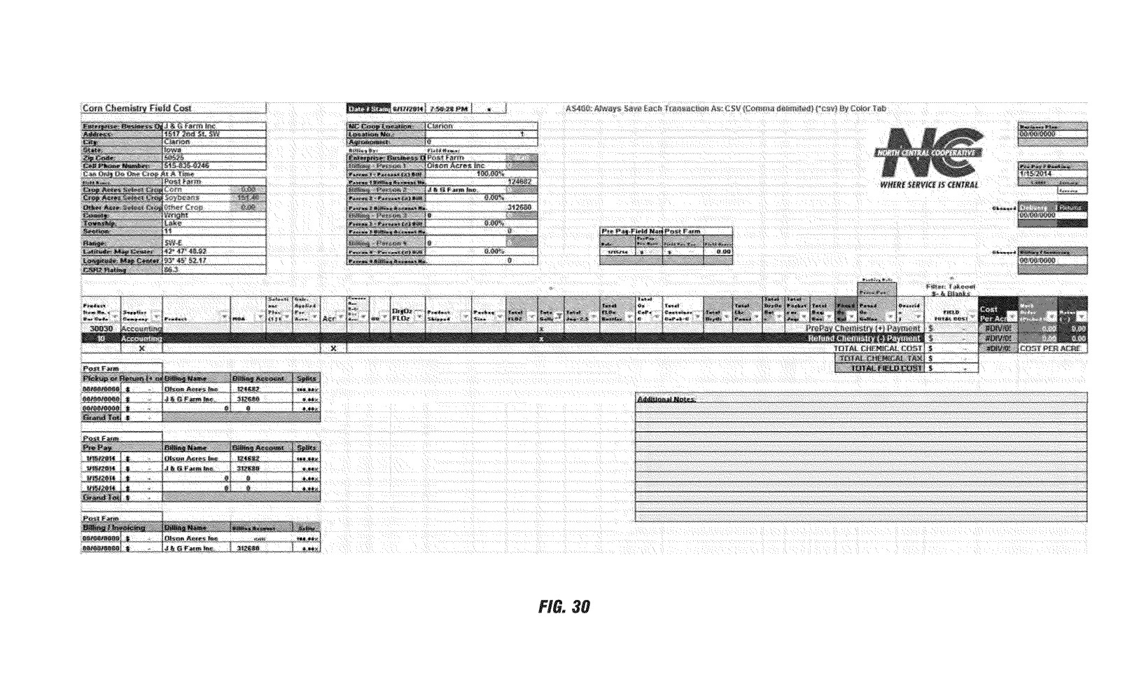

FIG. 30 illustrate an example of a worksheet for corn chemistry.

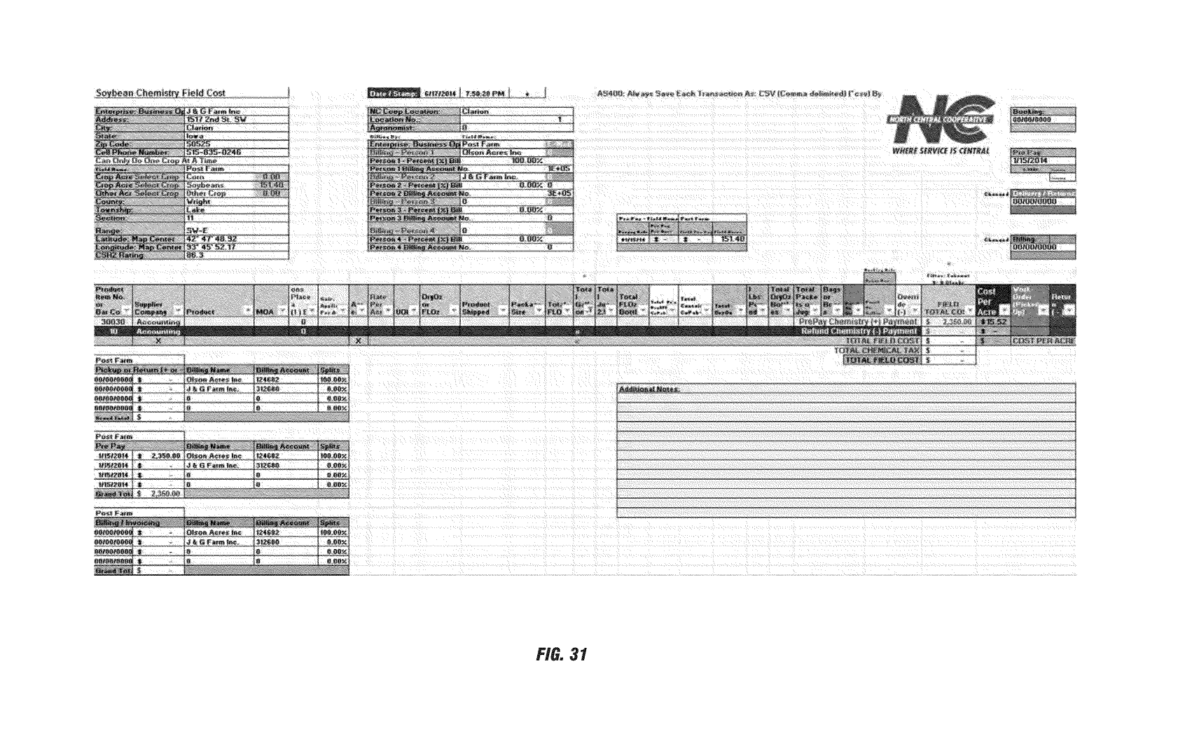

FIG. 31 an example of a worksheet for soybean chemistry.

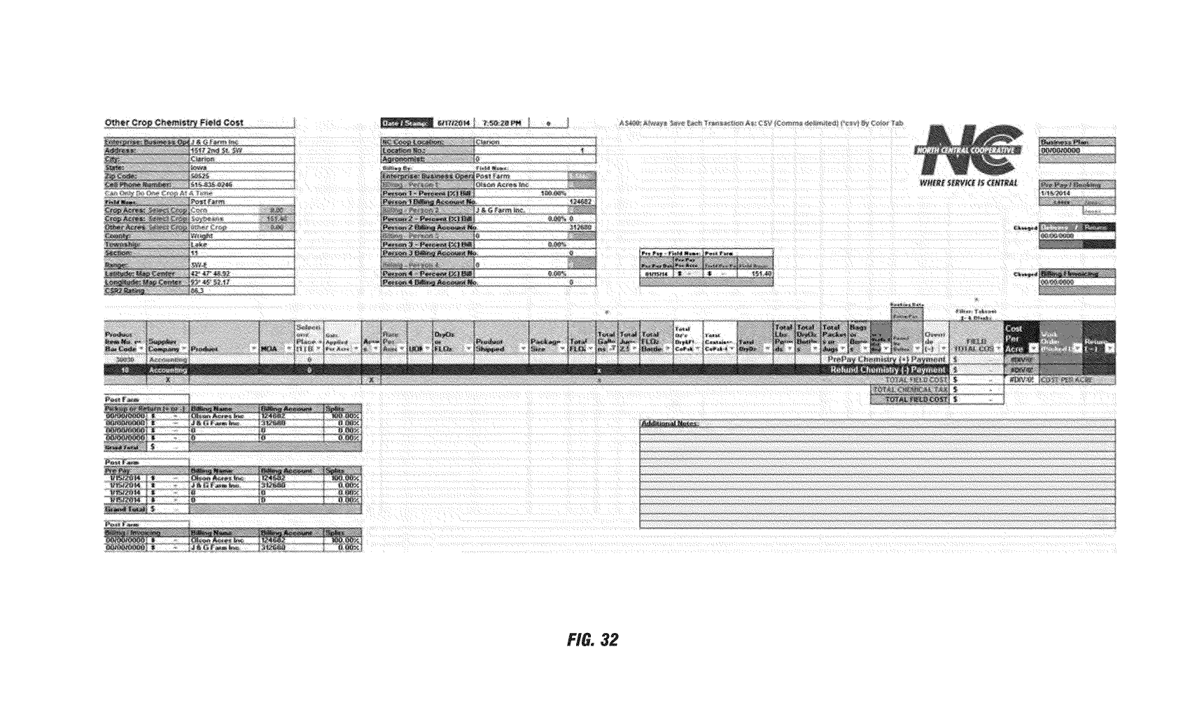

FIG. 32 illustrate an example of a worksheet for other crop chemistry.

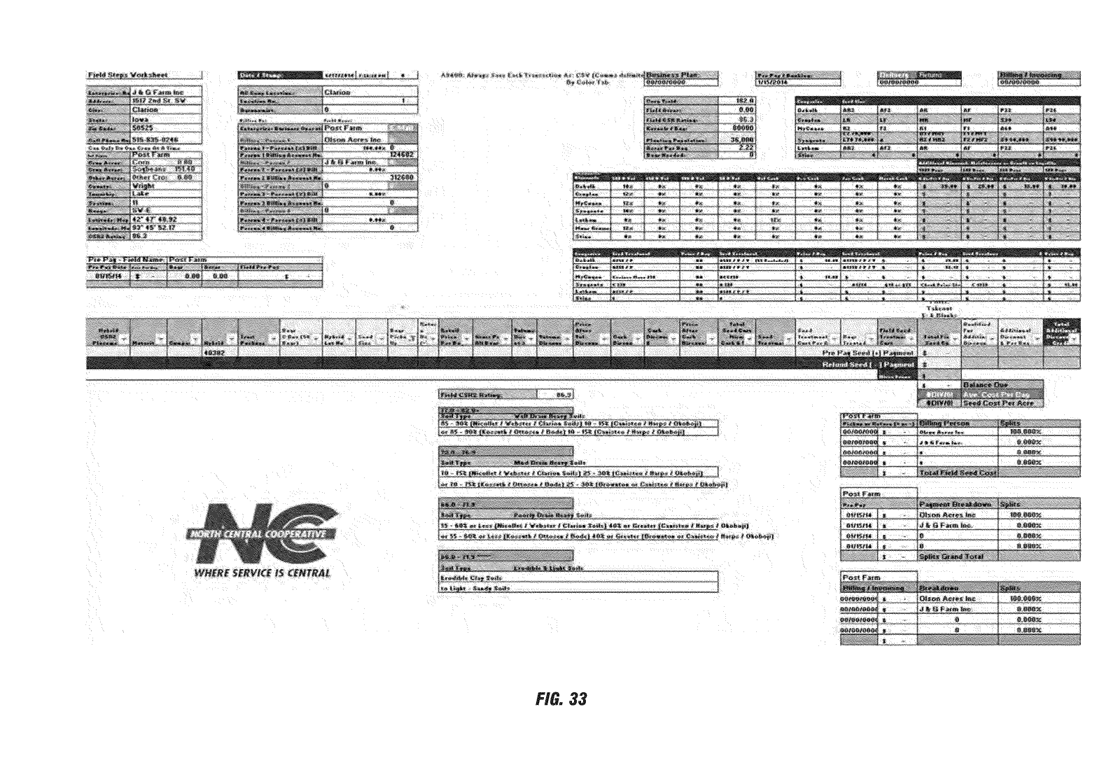

FIG. 33 illustrate an example of a worksheet for corn hybrids.

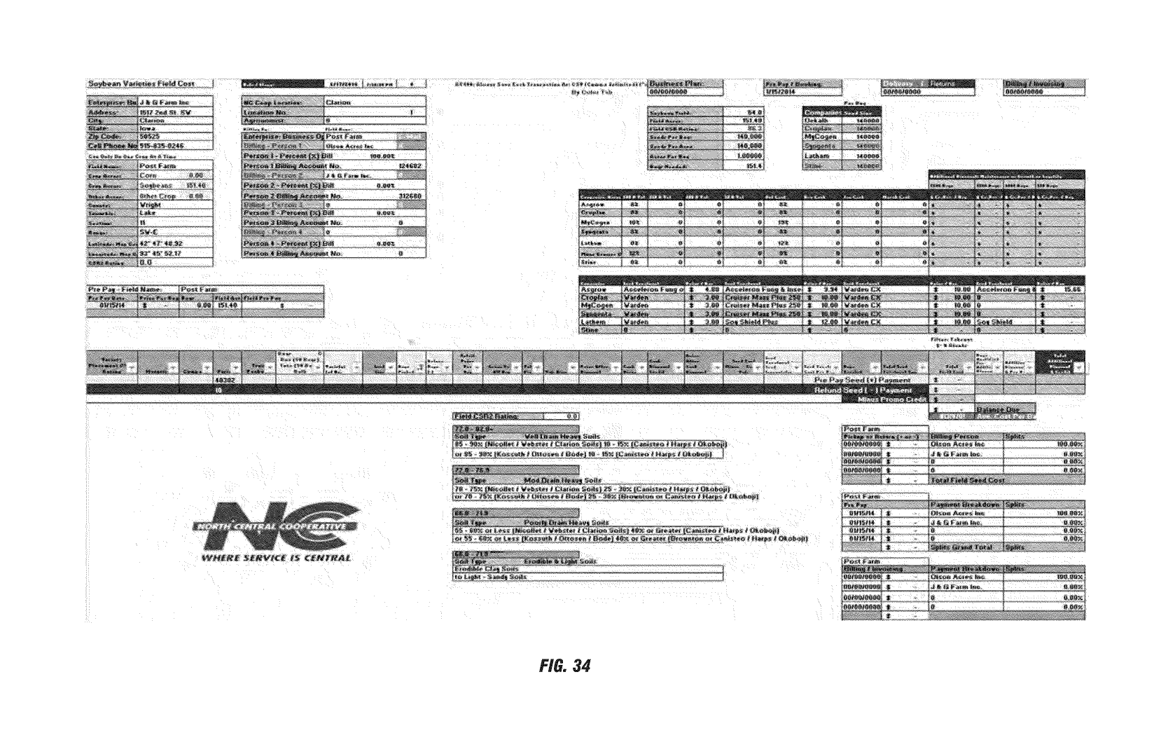

FIG. 34 illustrate an example of worksheet for soybean varieties.

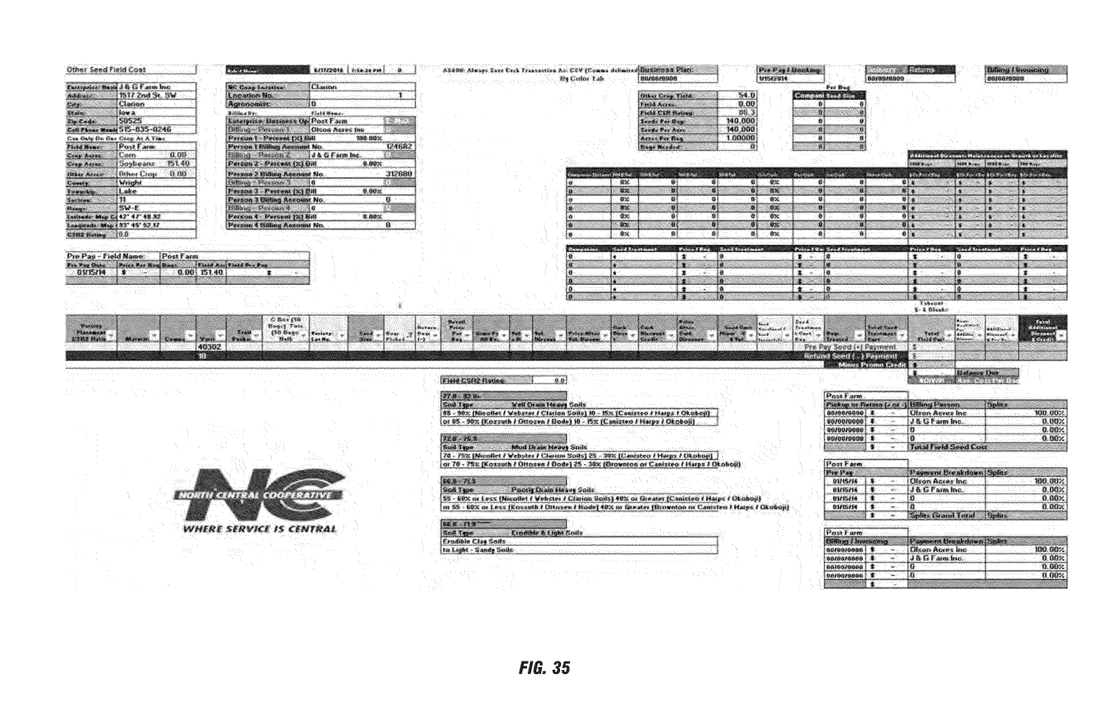

FIG. 35 illustrate a worksheet for other seed cost.

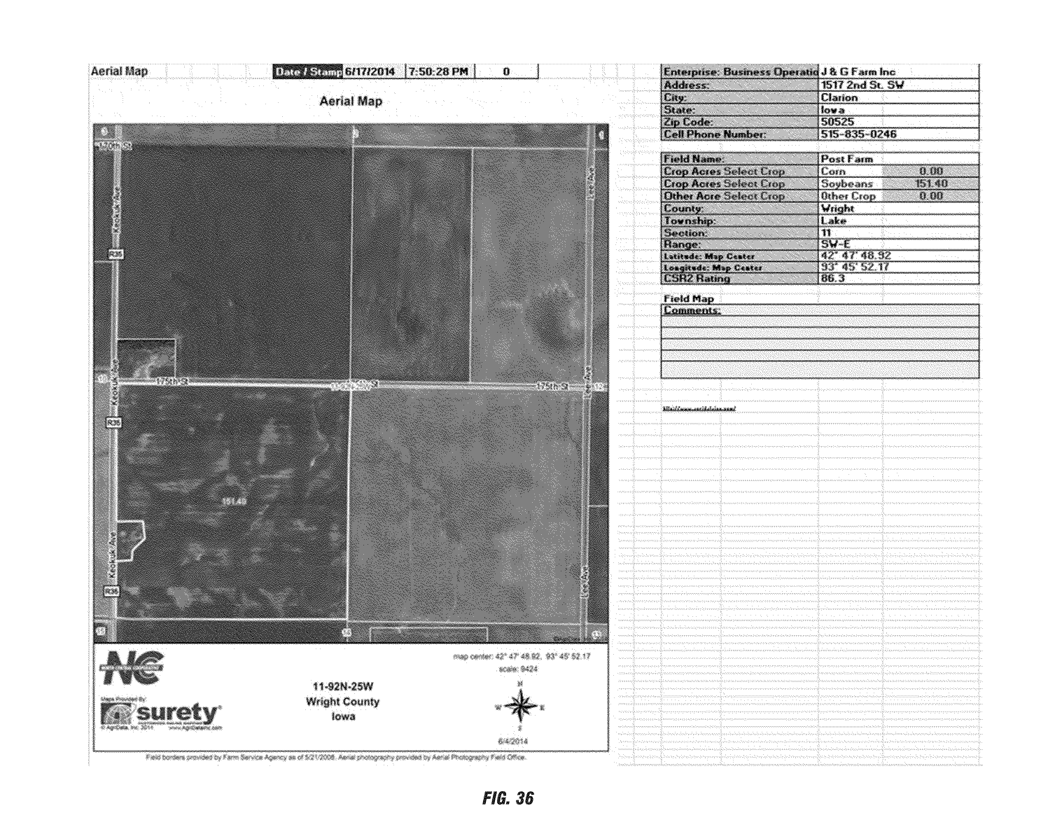

FIG. 36 illustrates a worksheet associated with a field map.

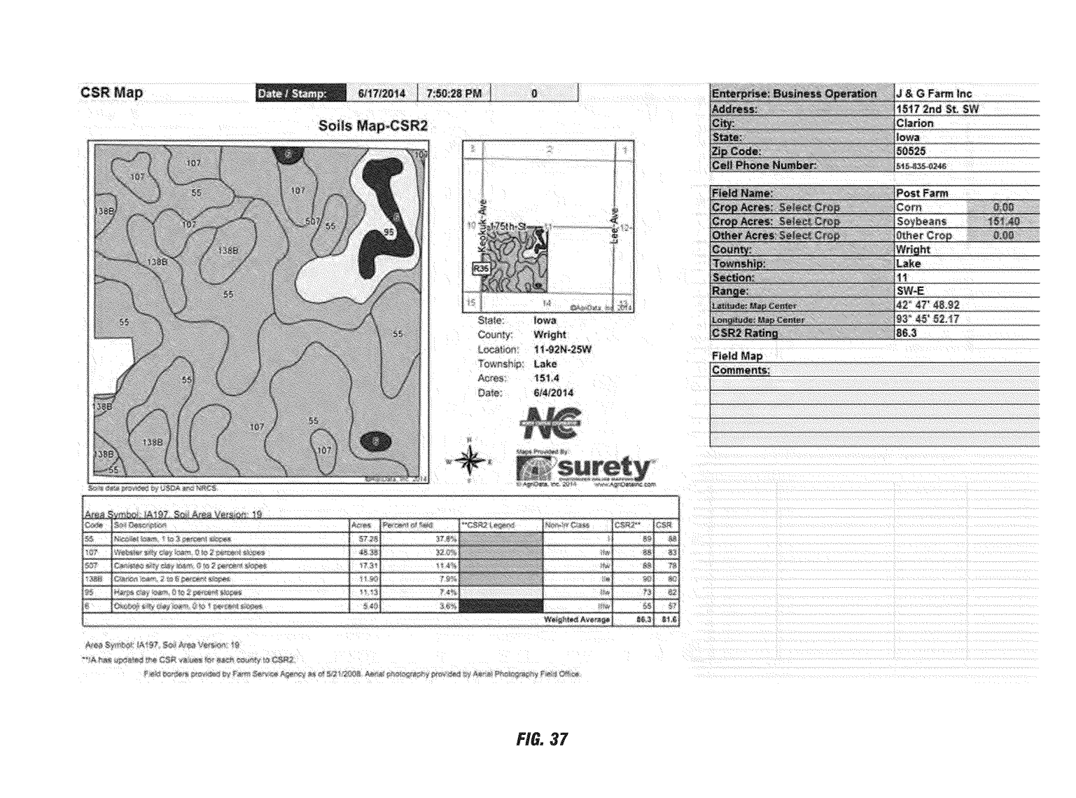

FIG. 37 illustrates a worksheet associated with a soil map.

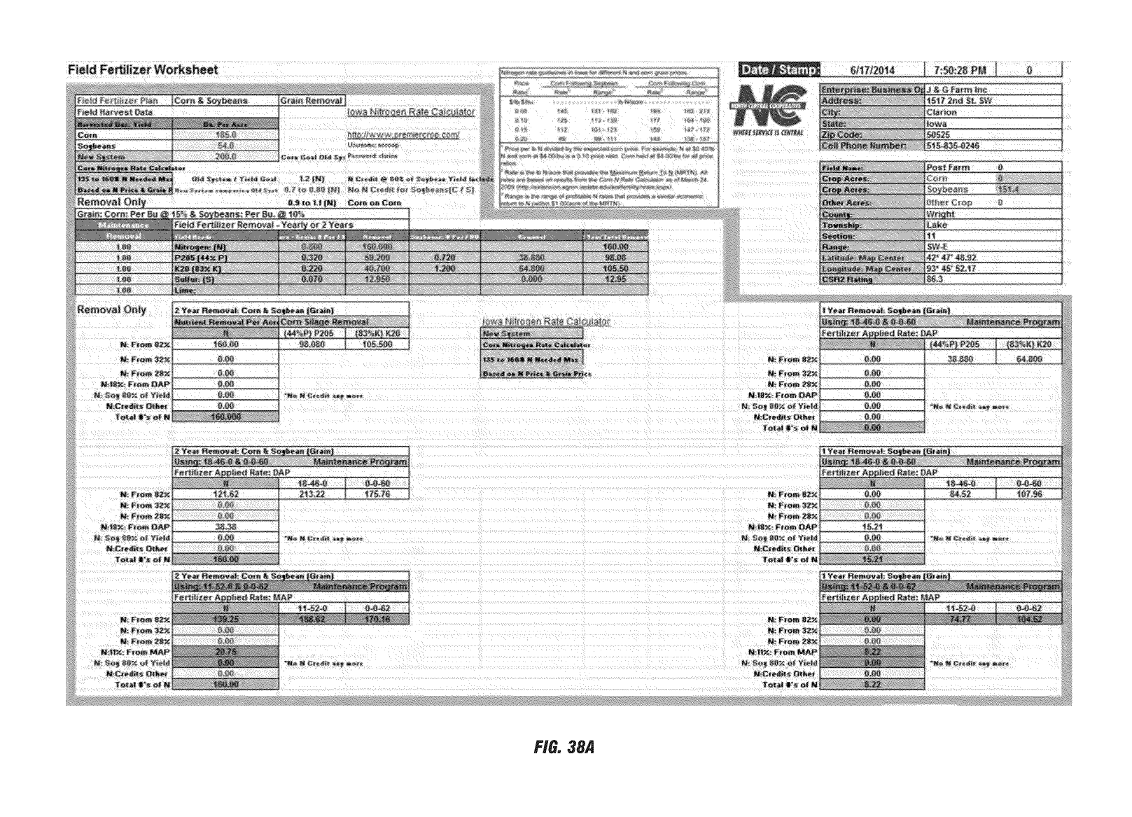

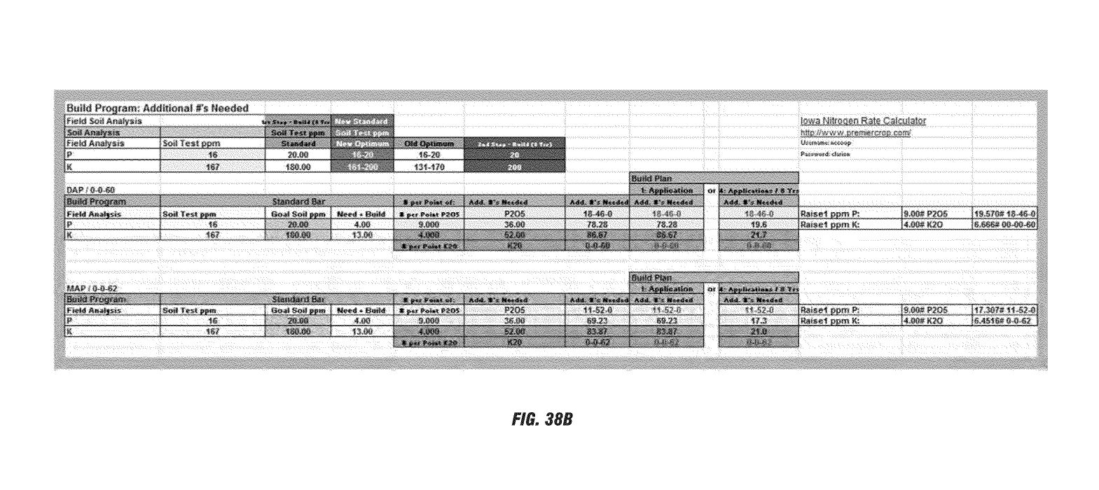

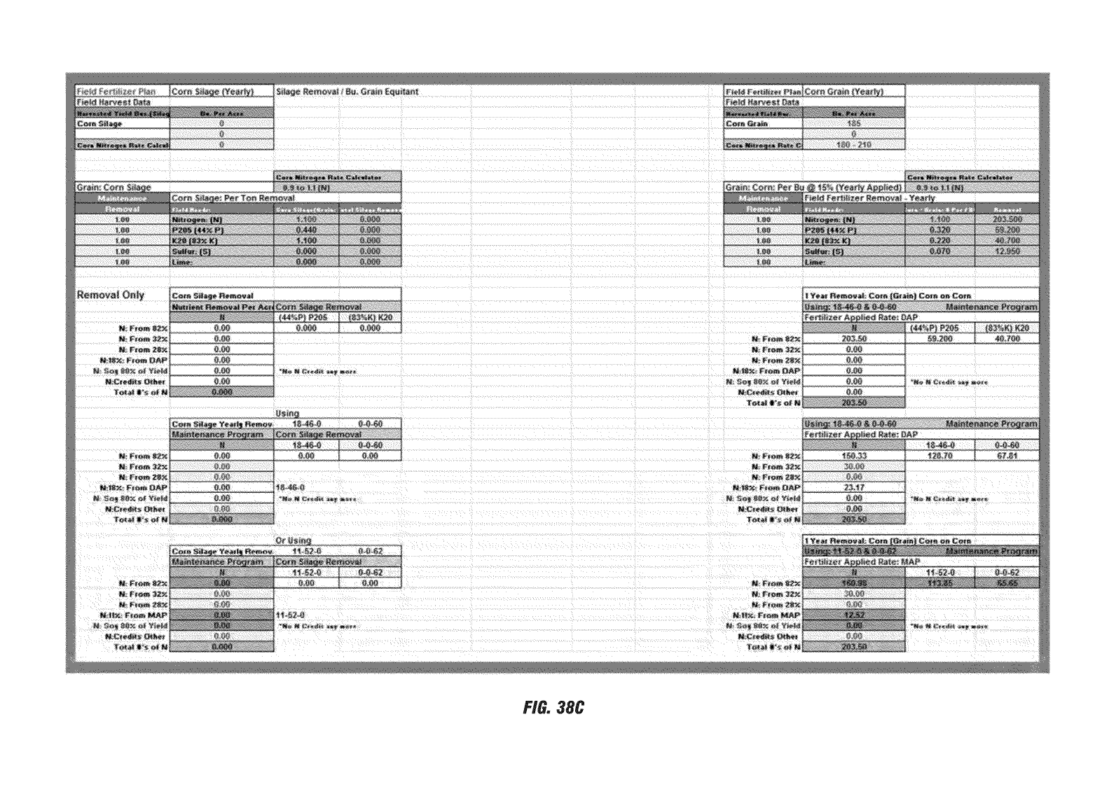

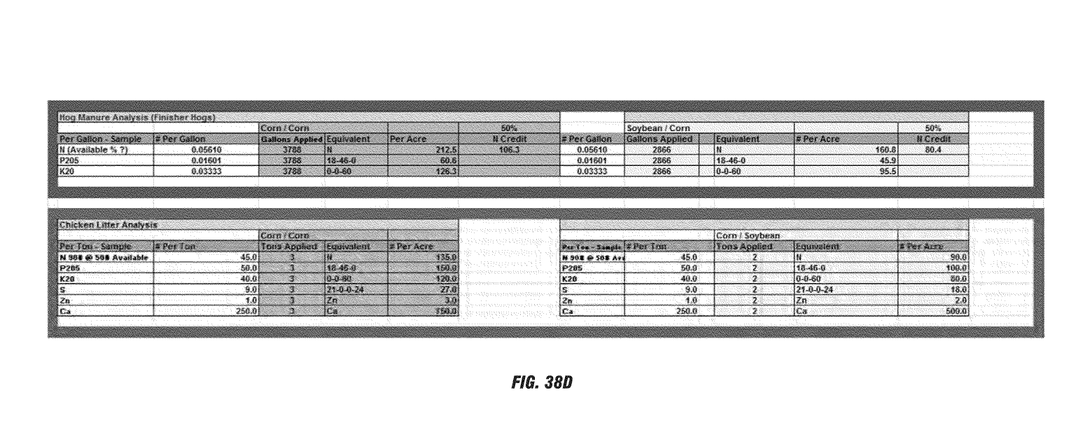

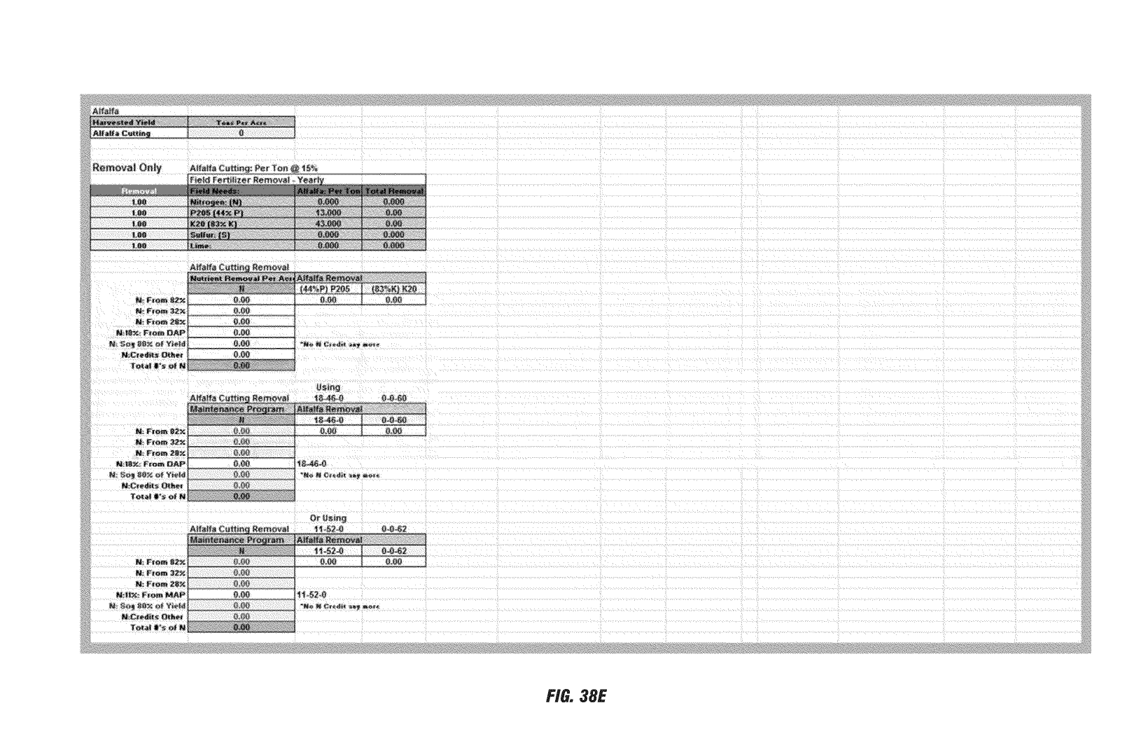

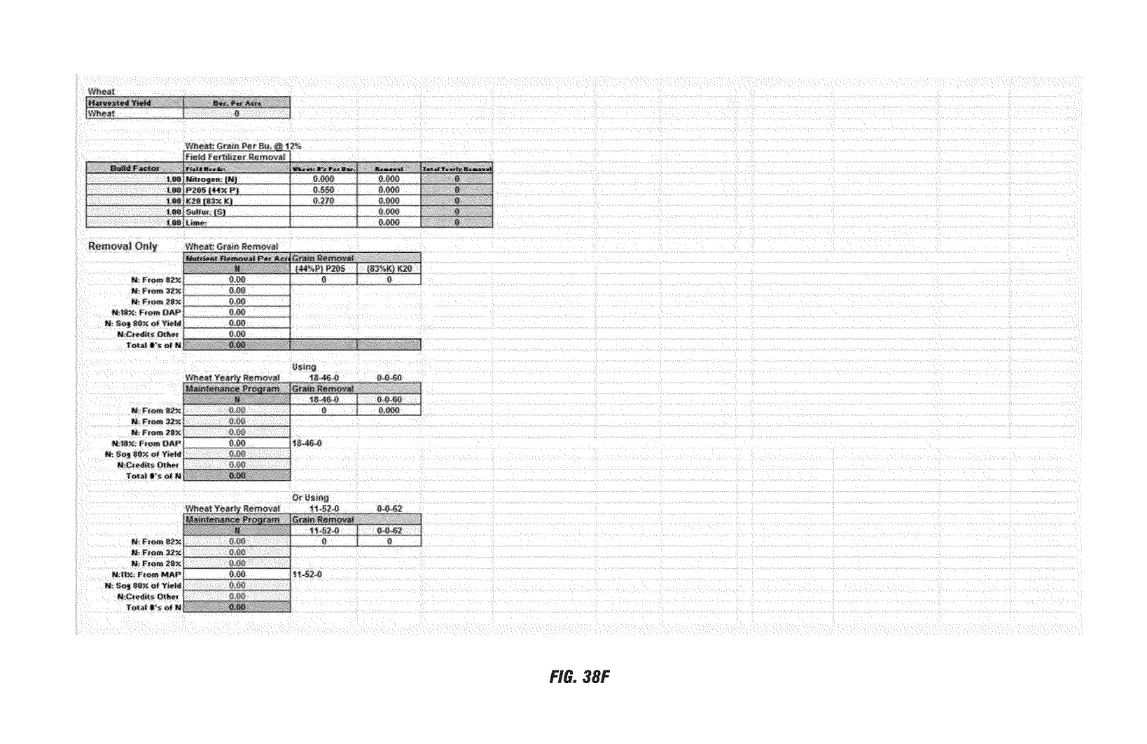

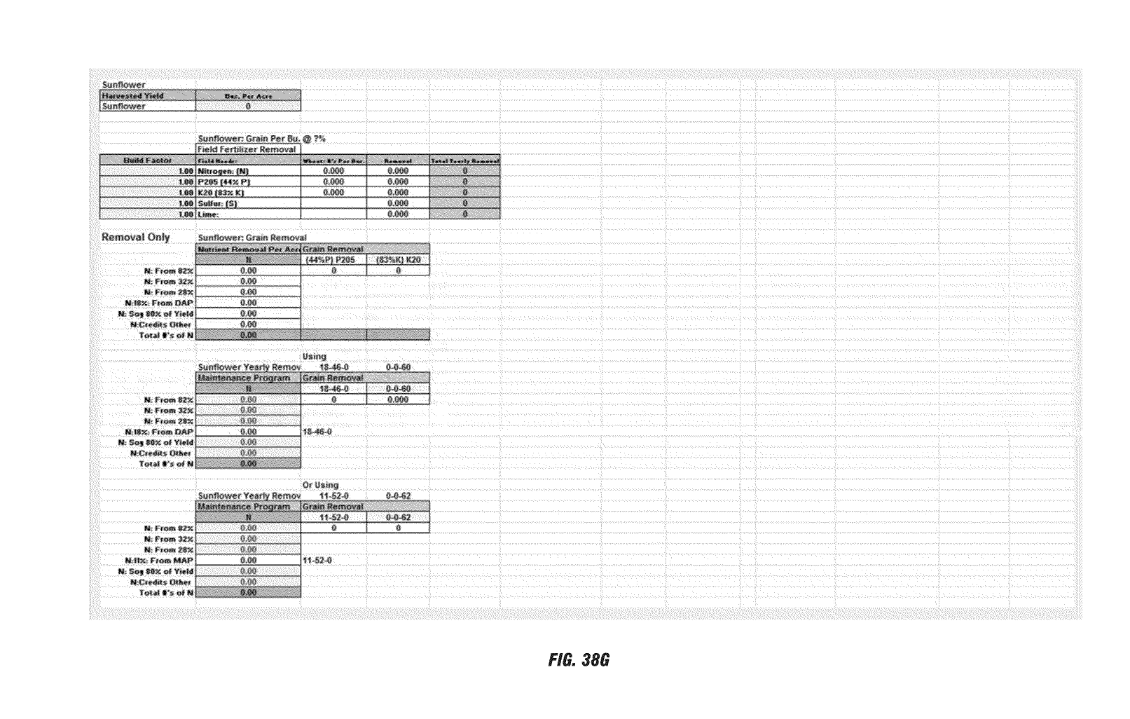

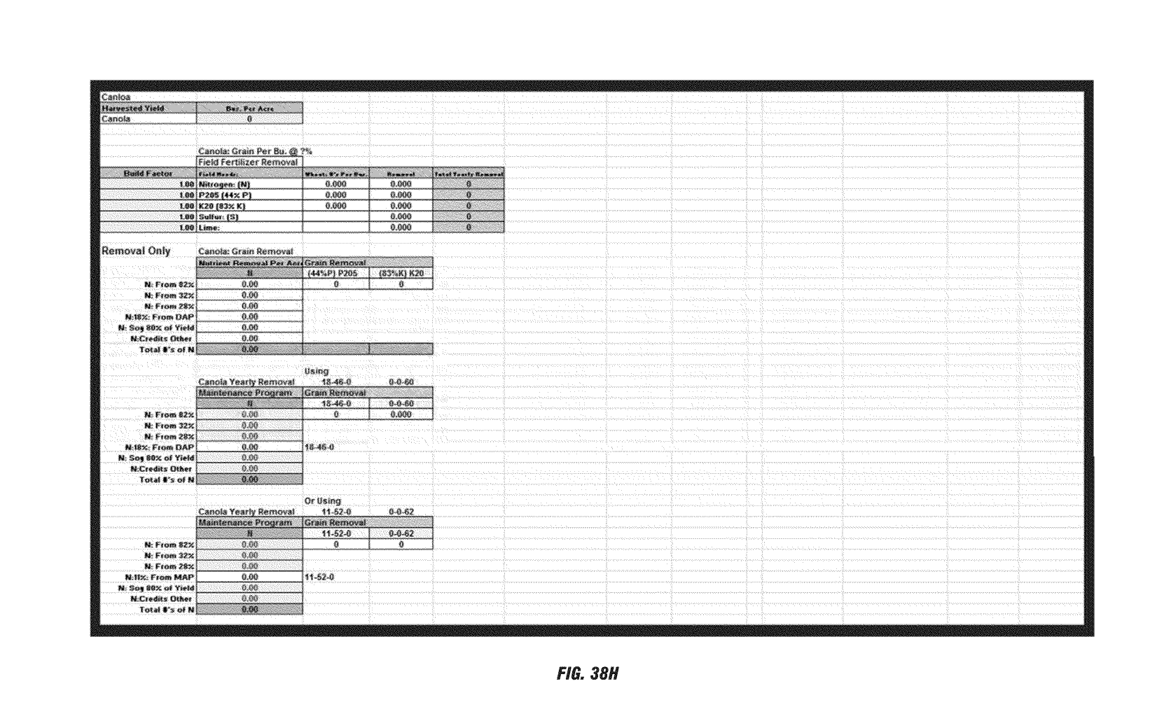

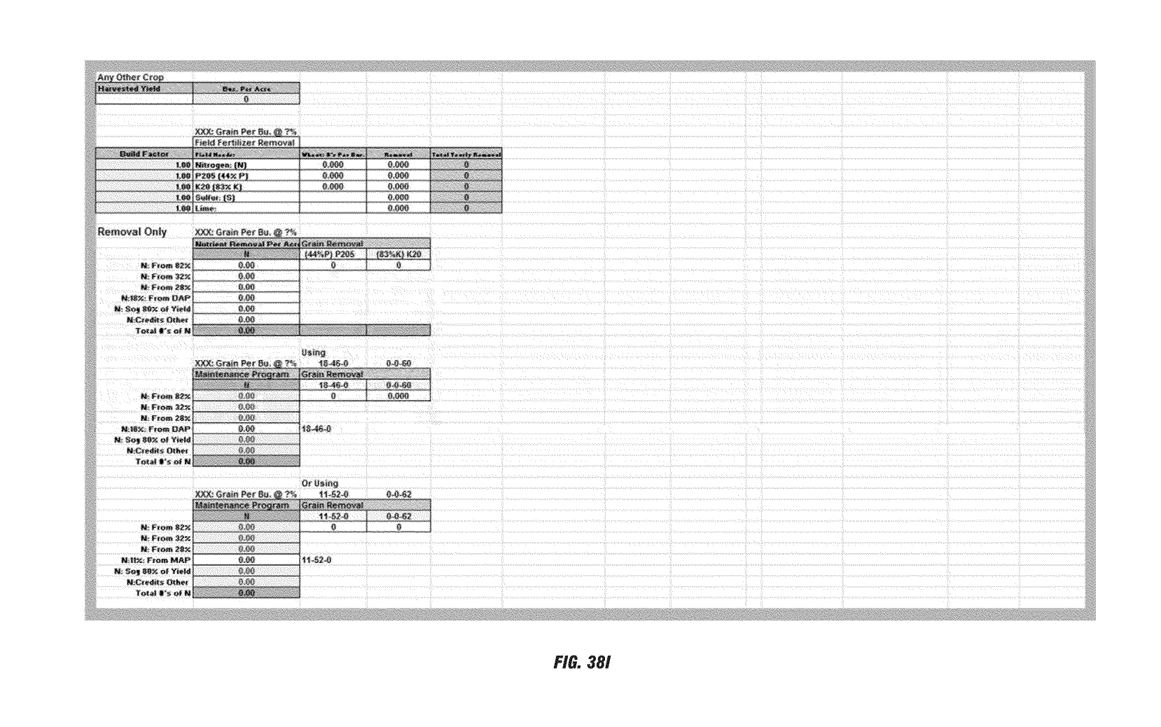

FIGS. 38A-38I illustrate a worksheet for fertilizer cost.

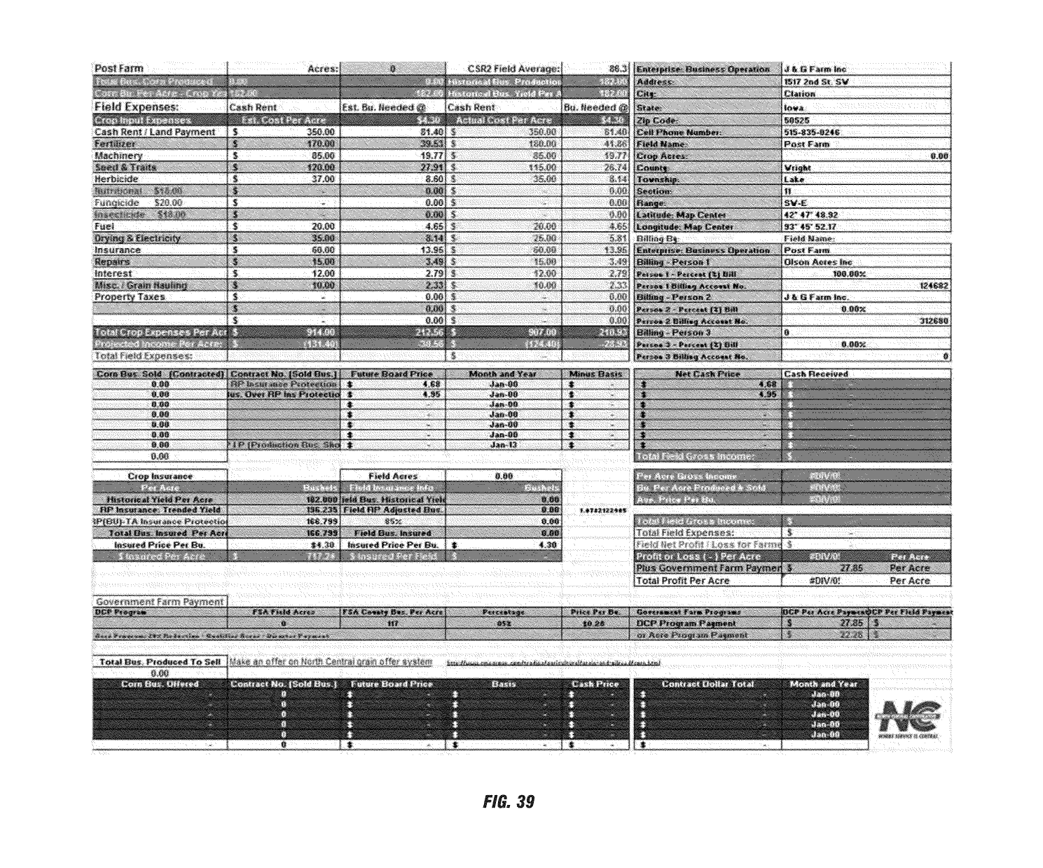

FIG. 39 illustrates another example of a worksheet.

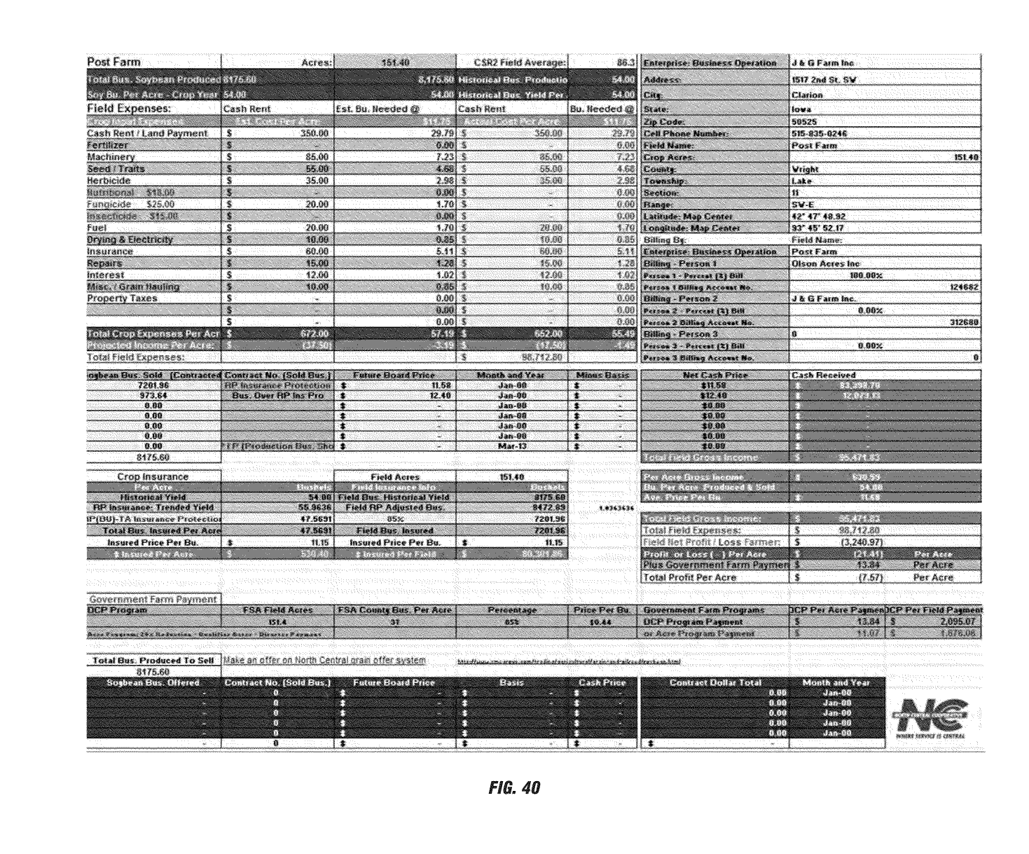

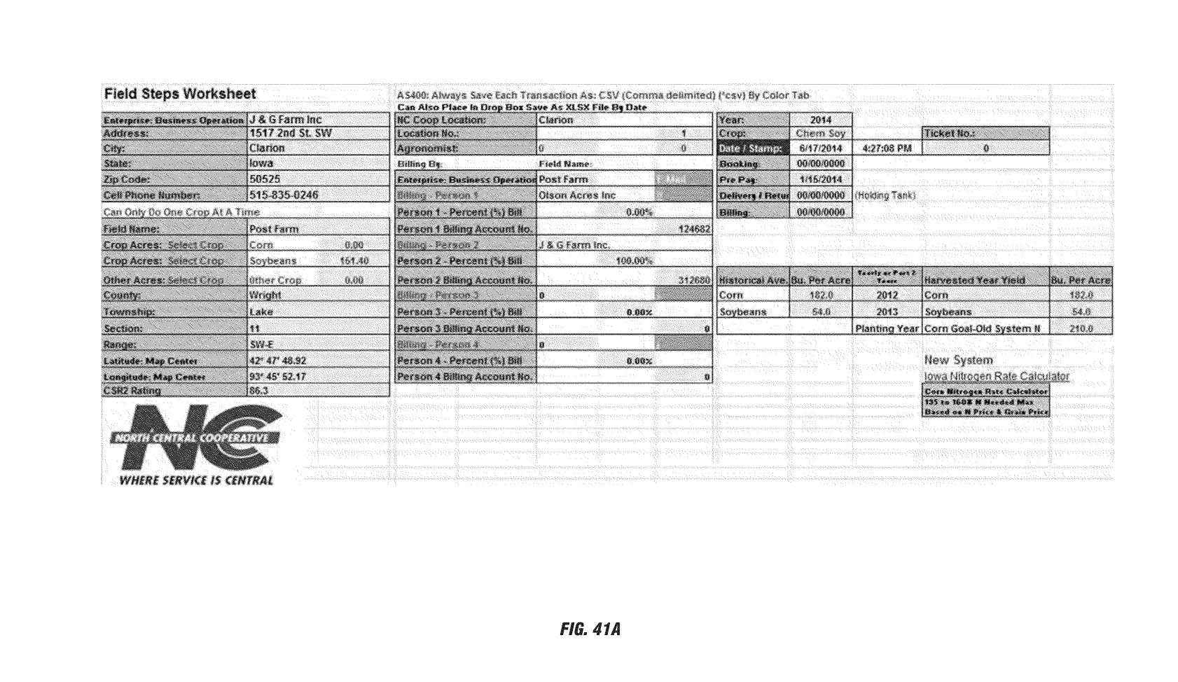

FIG. 40 illustrates another example of a worksheet.

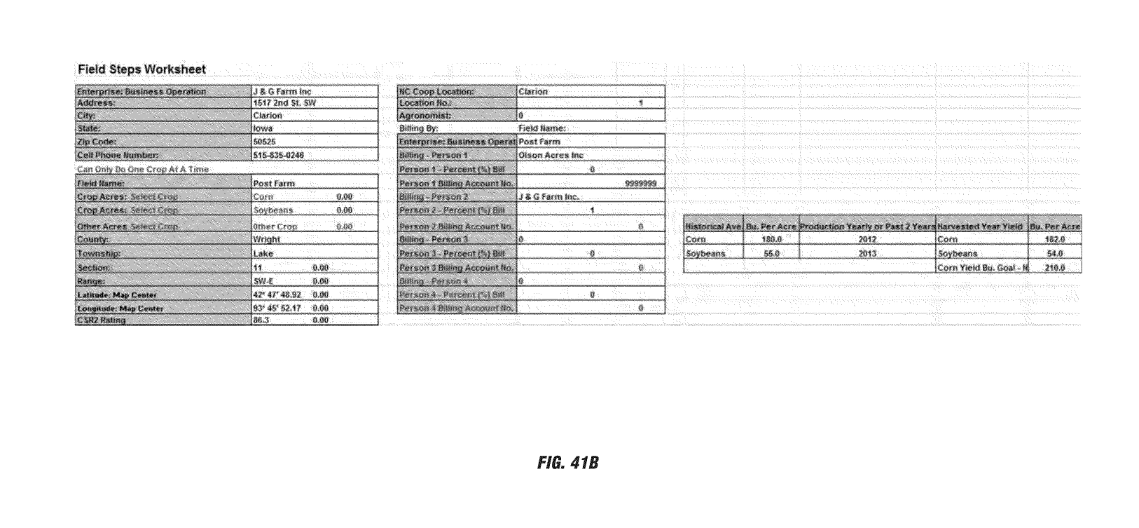

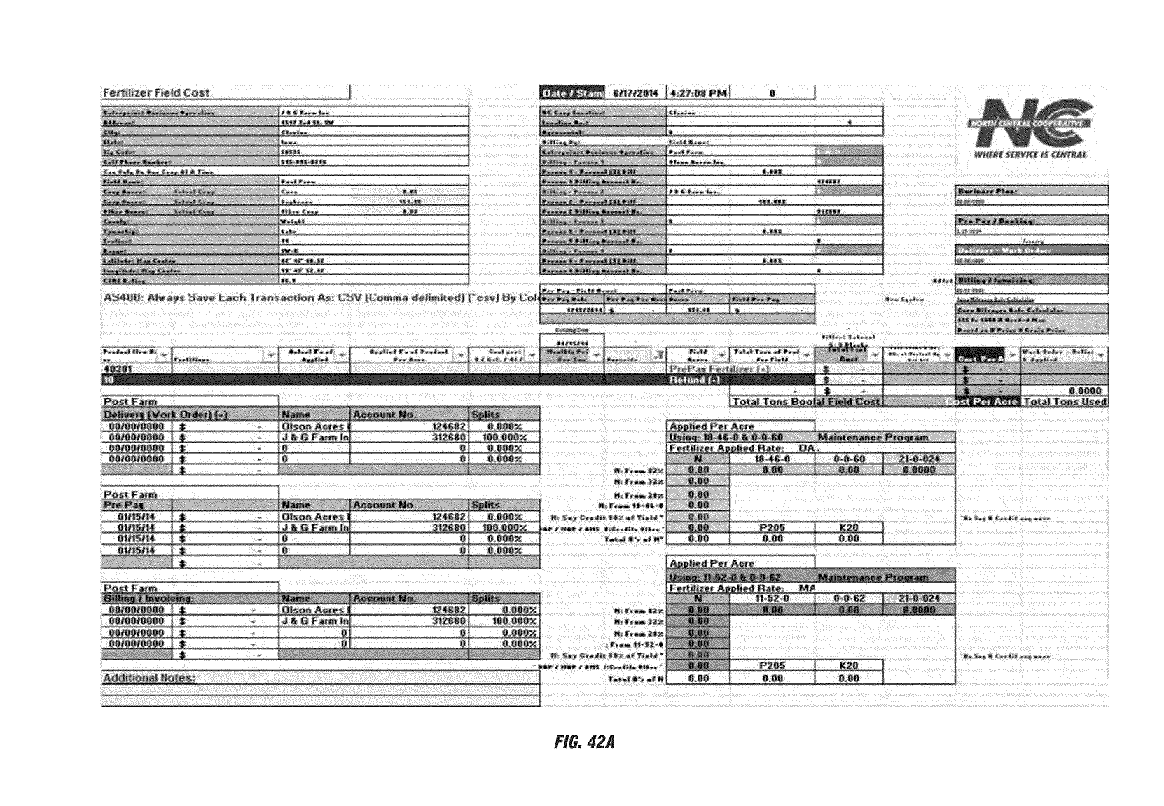

FIGS. 41A-41B illustrates an example of a worksheet associated with field steps.

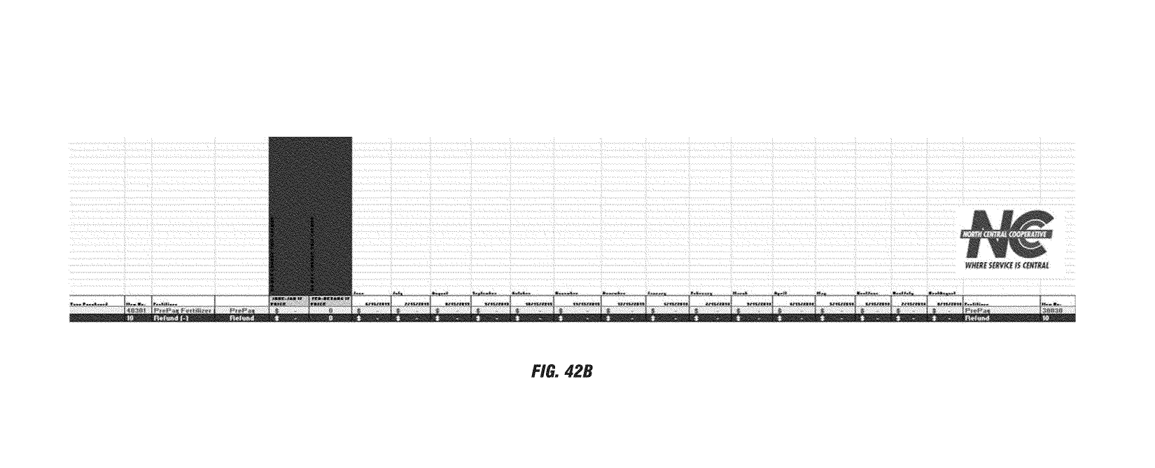

FIGS. 42A-42B illustrate one example of a field fertilizer needs worksheet.

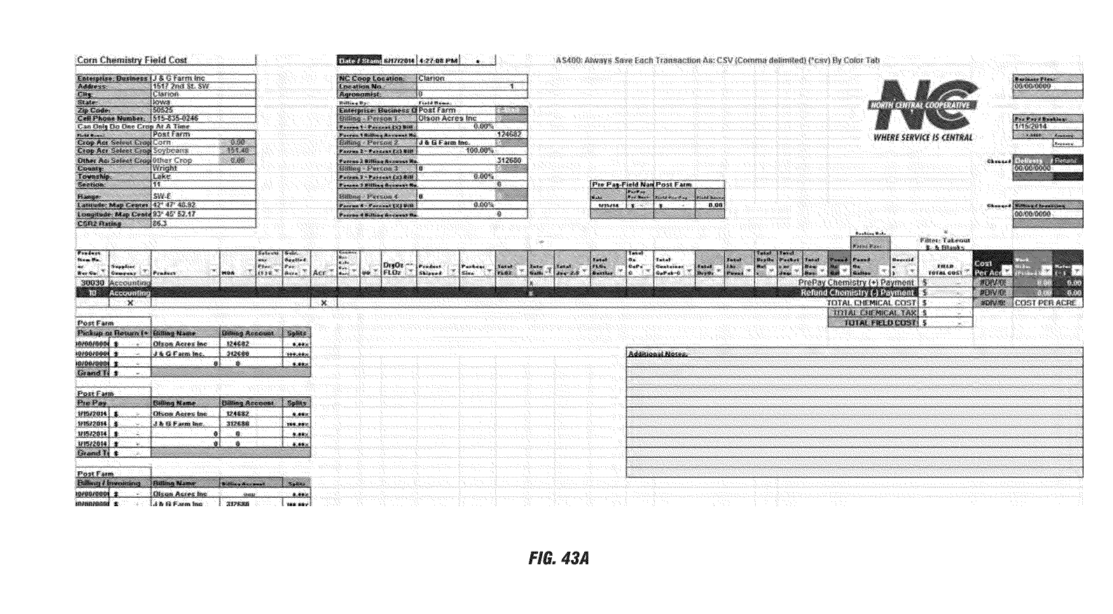

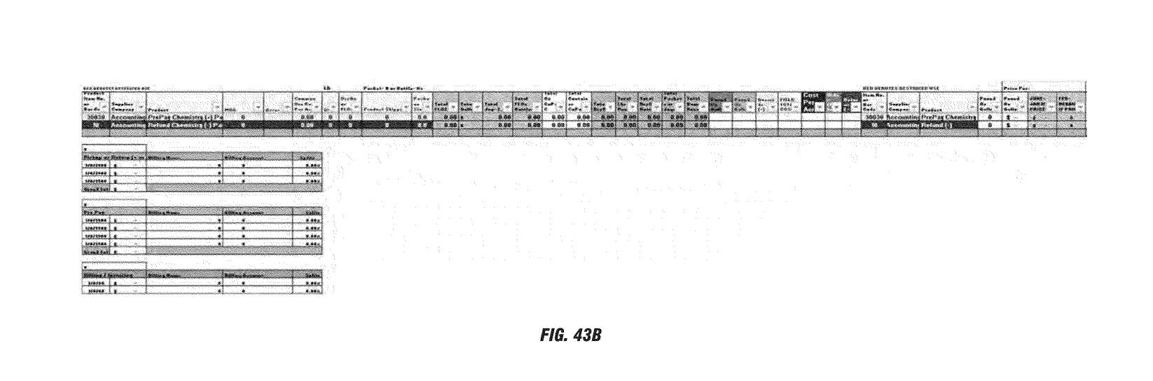

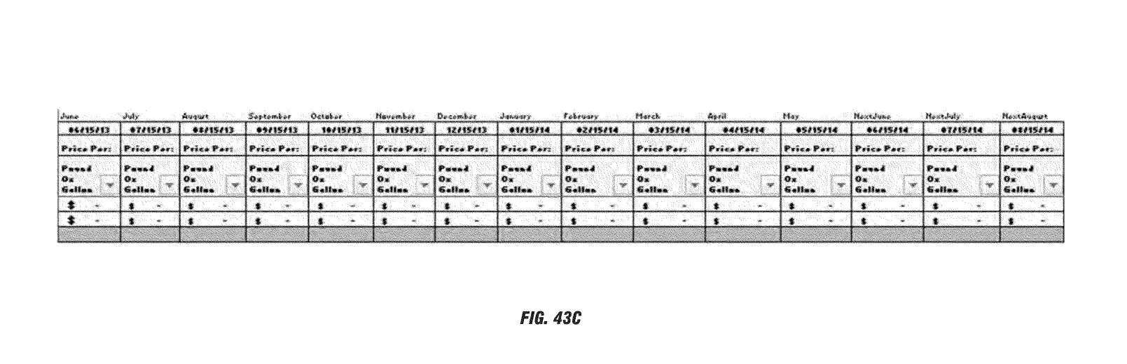

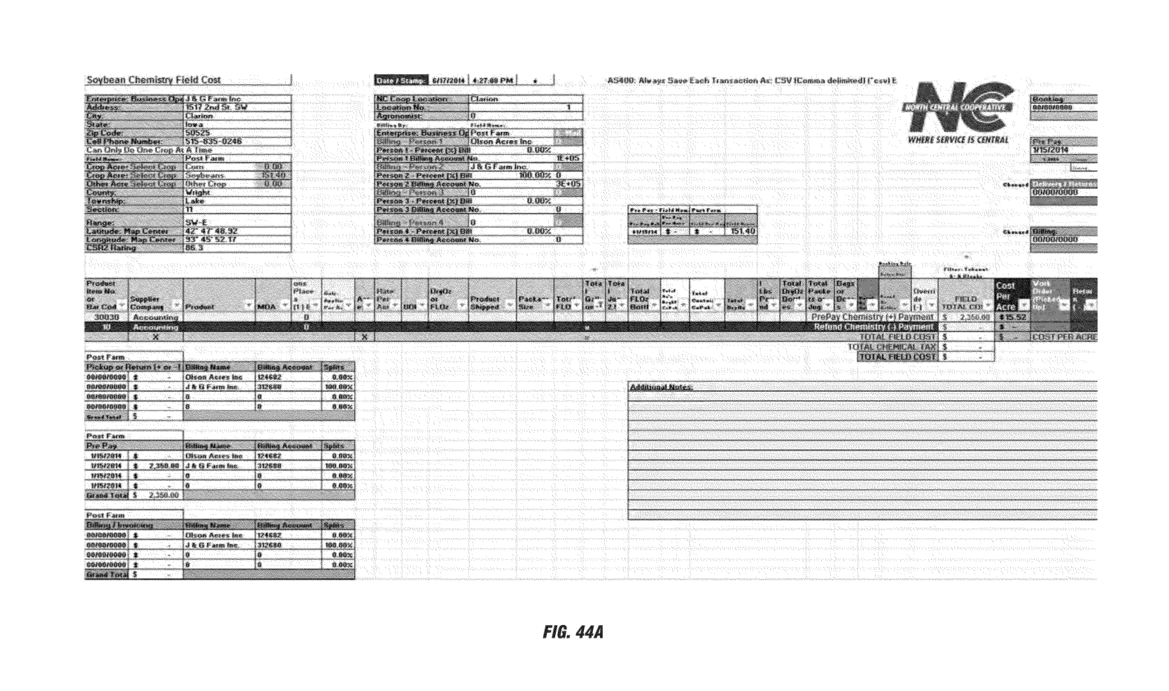

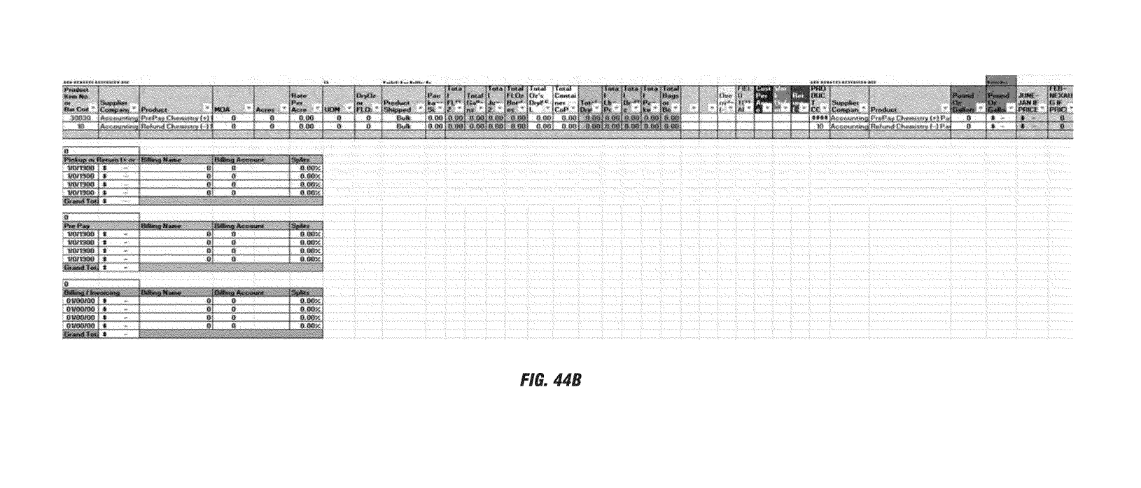

FIGS. 43A-43C illustrate an example of a worksheet for corn chemistry.

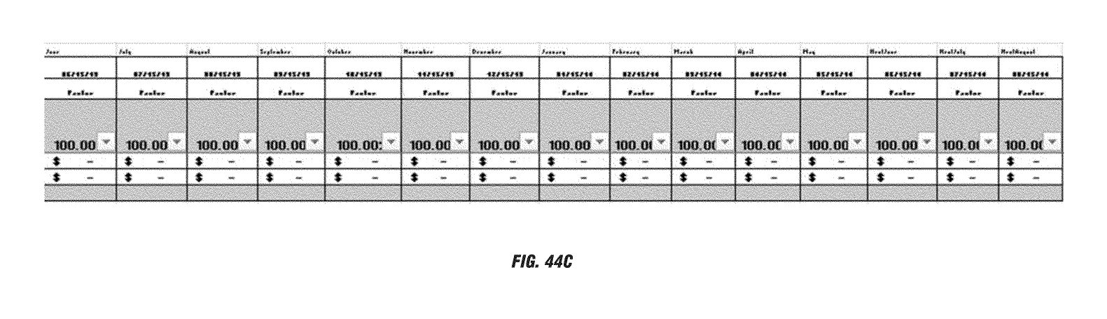

FIG. 44A-44C an example of a worksheet for soybean chemistry.

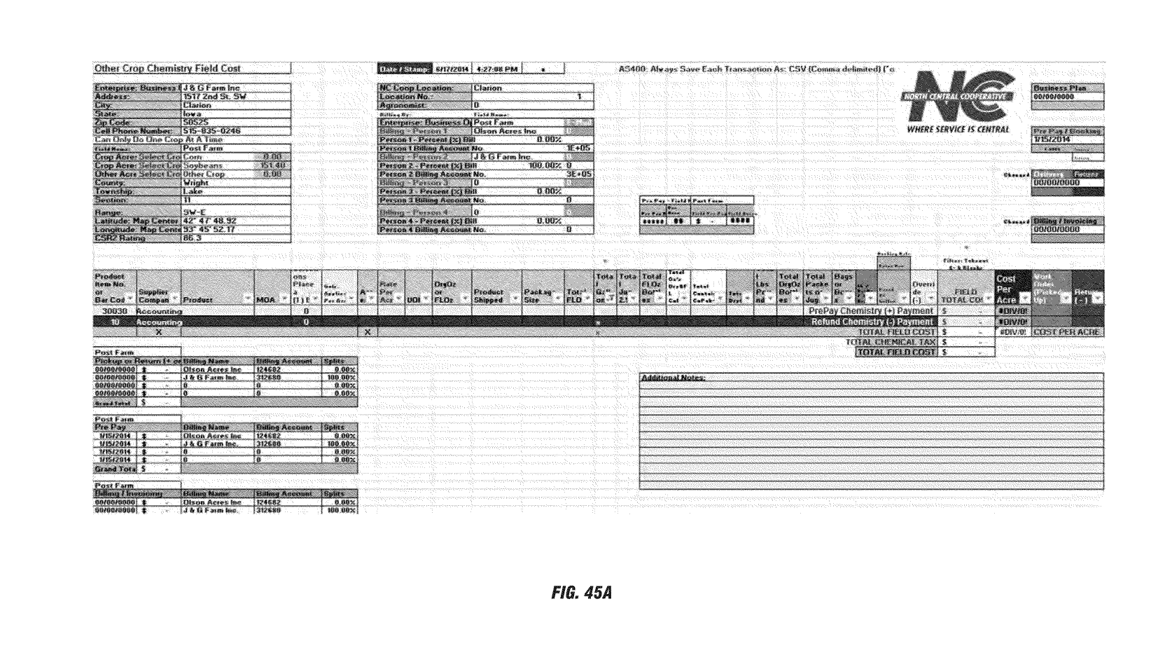

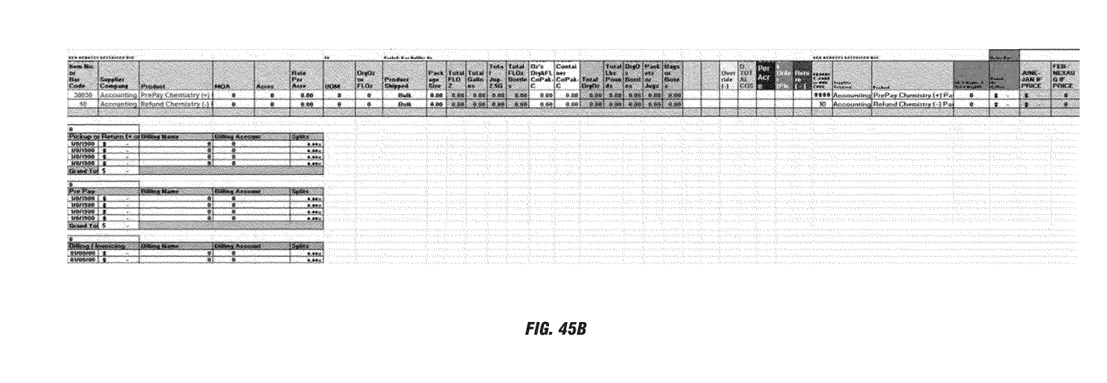

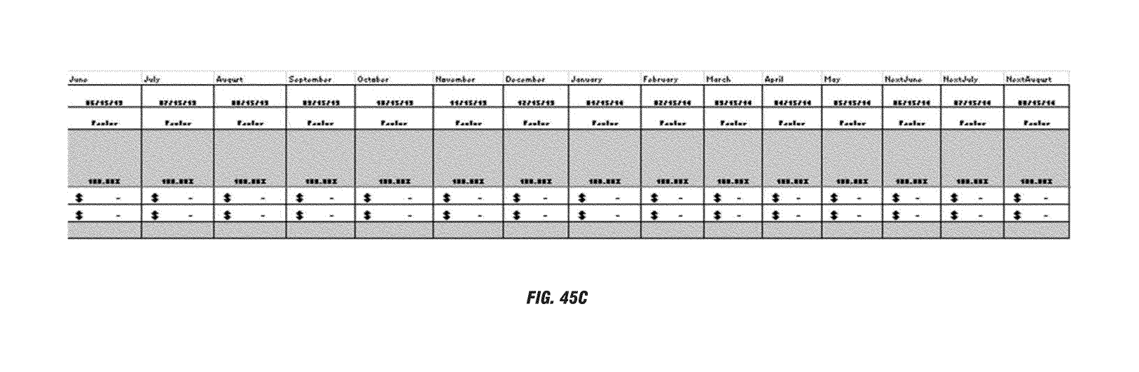

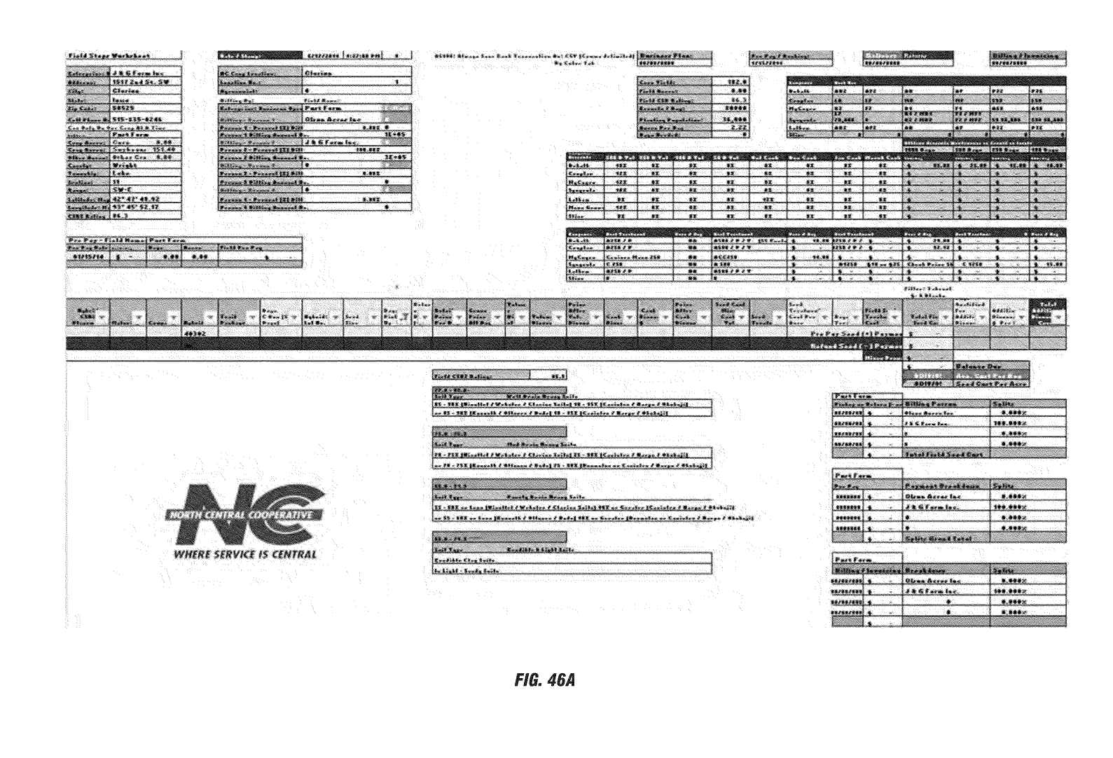

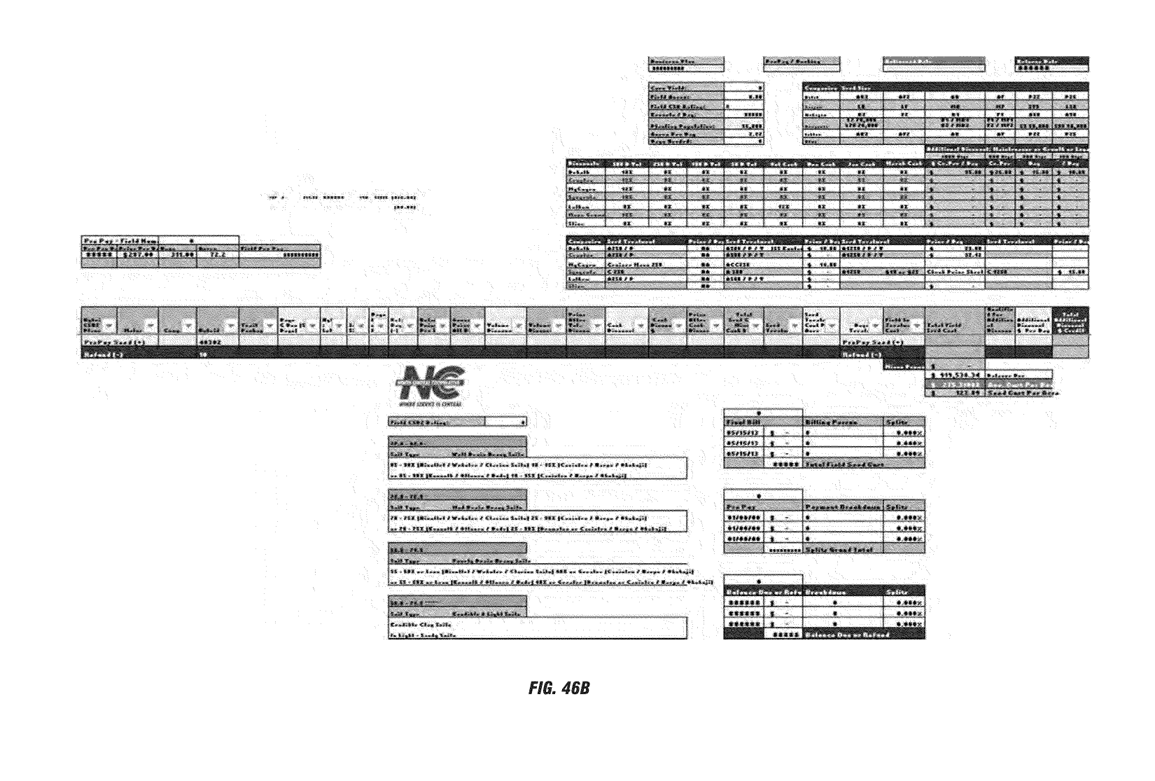

FIGS. 45A-45C illustrate an example of a worksheet for other crop chemistry.

FIGS. 46A-46B illustrate an example of a worksheet for corn hybrids.

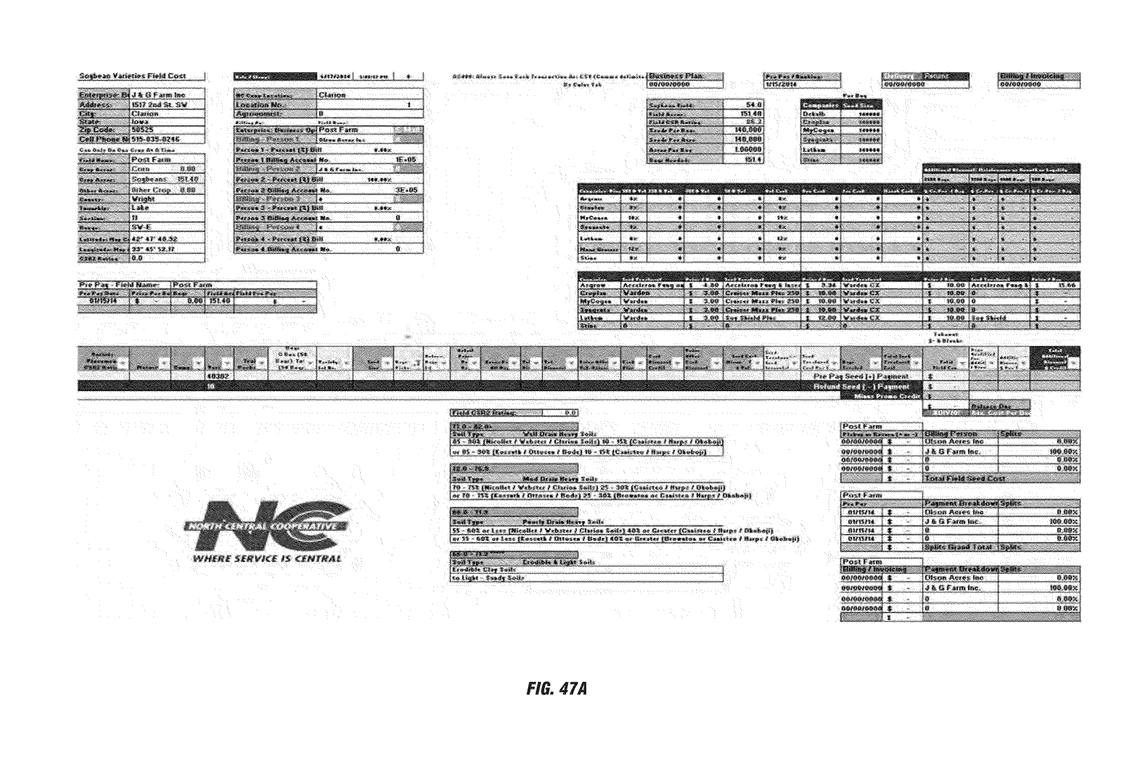

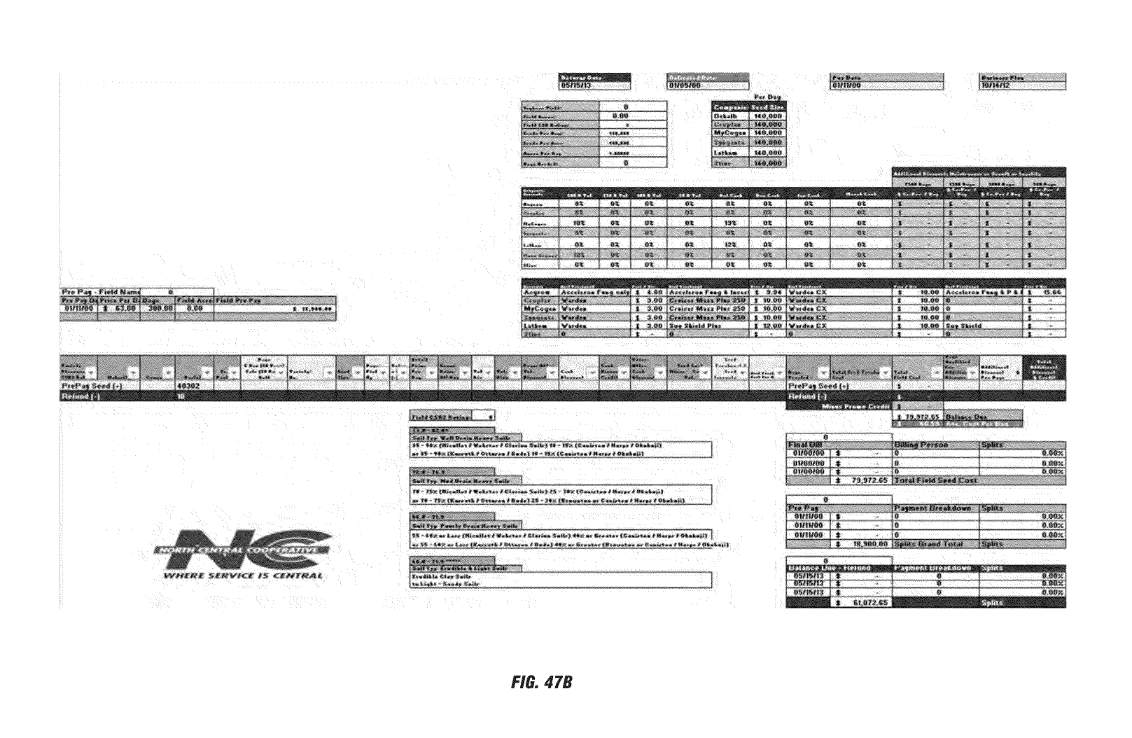

FIGS. 47A-47B illustrate an example of worksheet for soybean varieties.

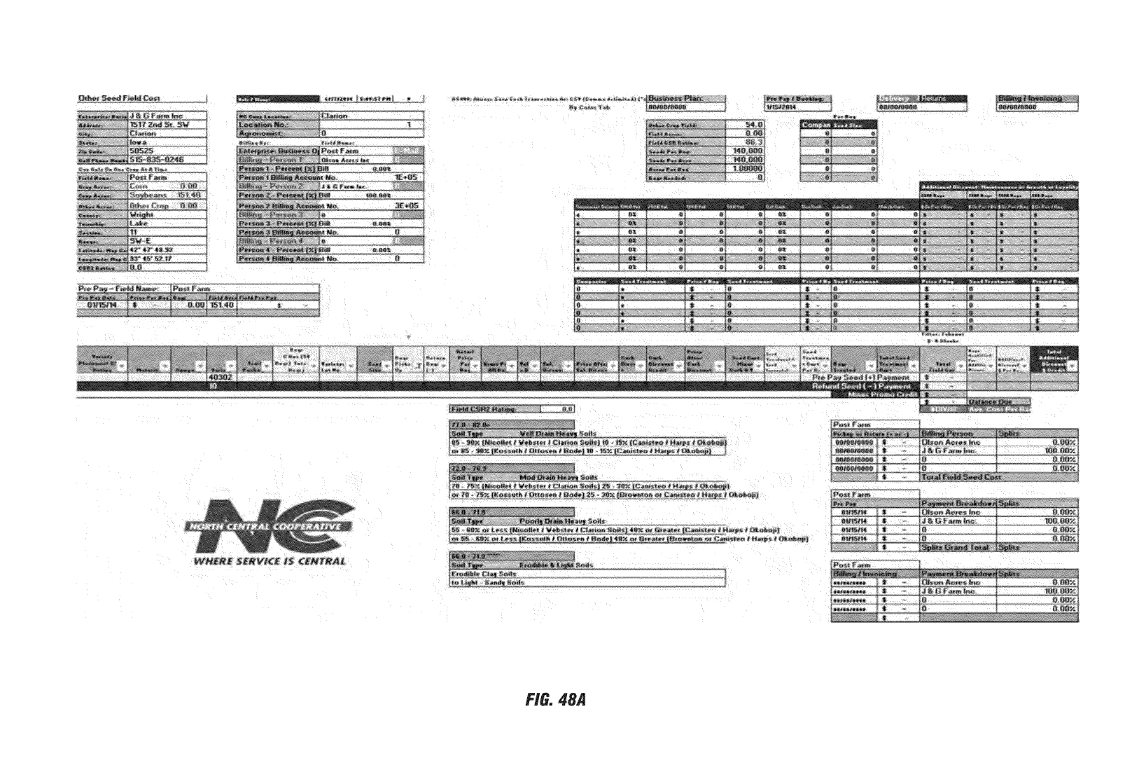

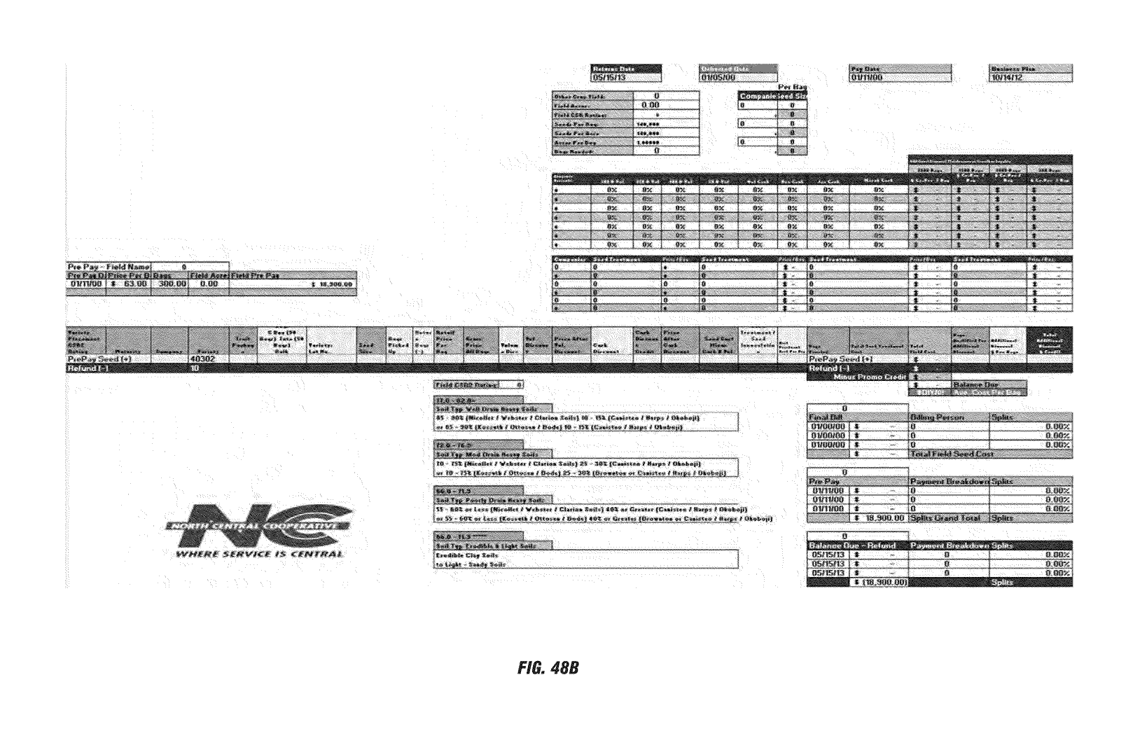

FIGS. 48A-48B illustrate a worksheet for other seed cost.

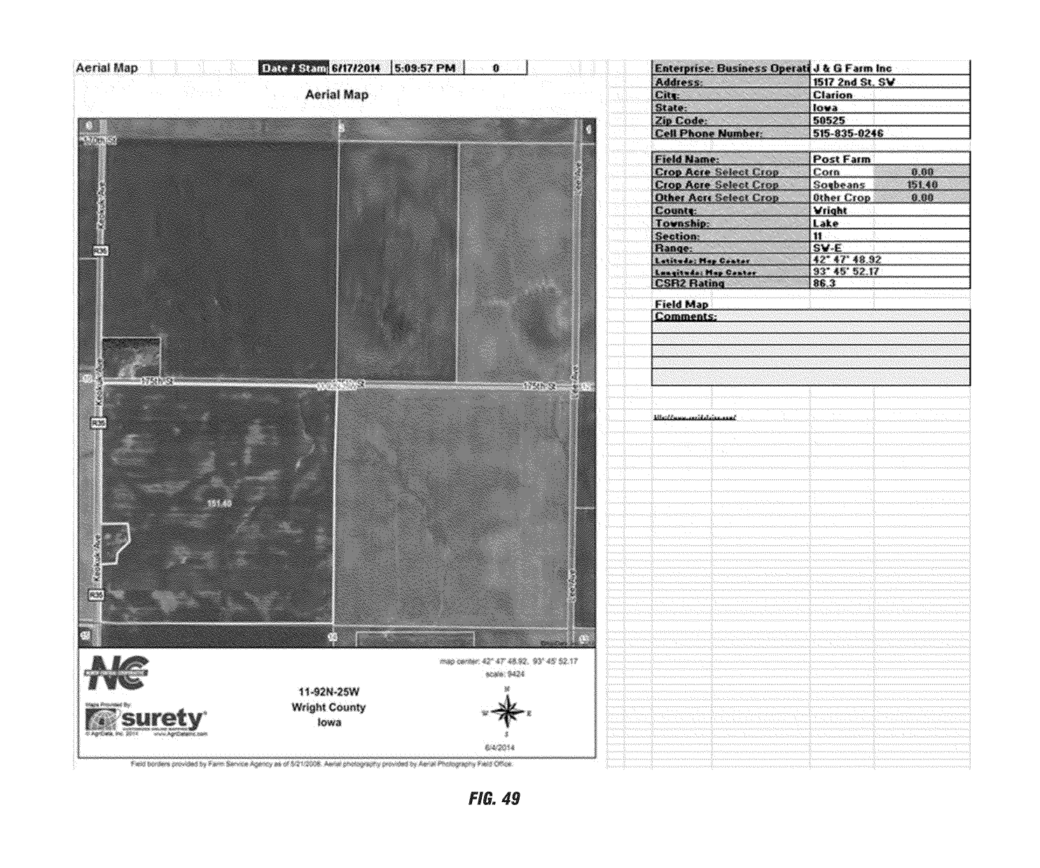

FIG. 49 illustrates a worksheet associated with a field map.

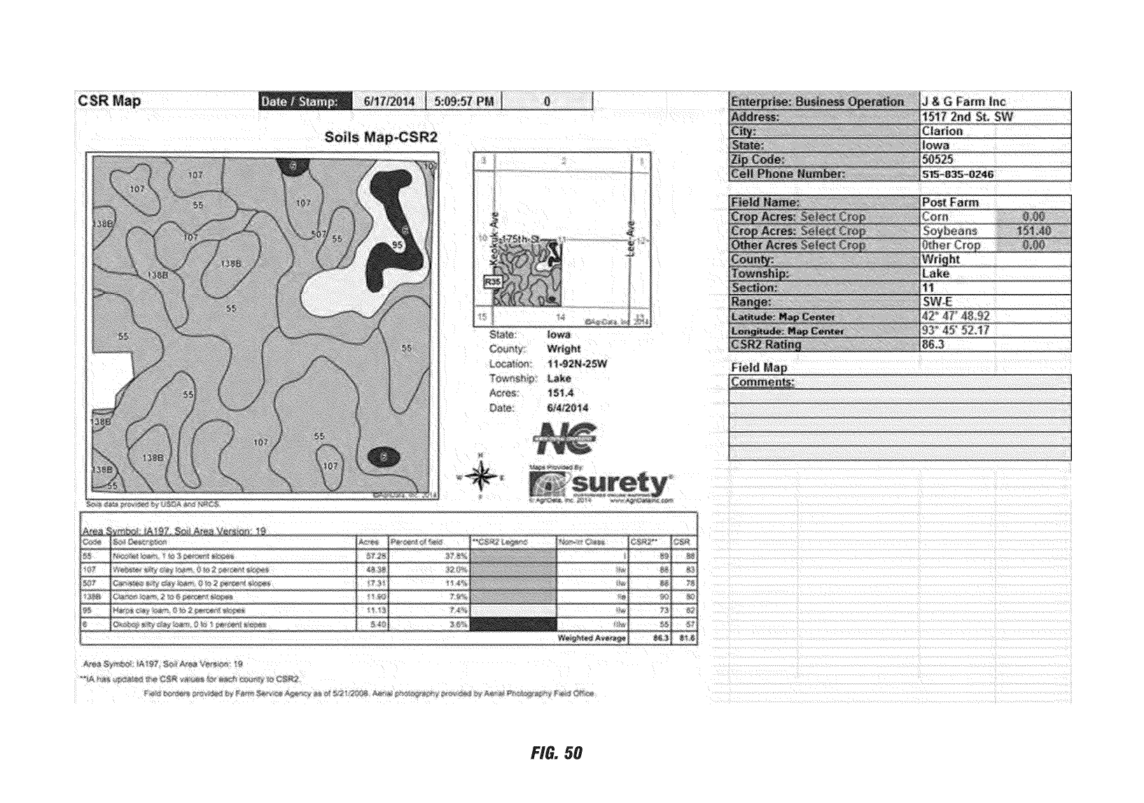

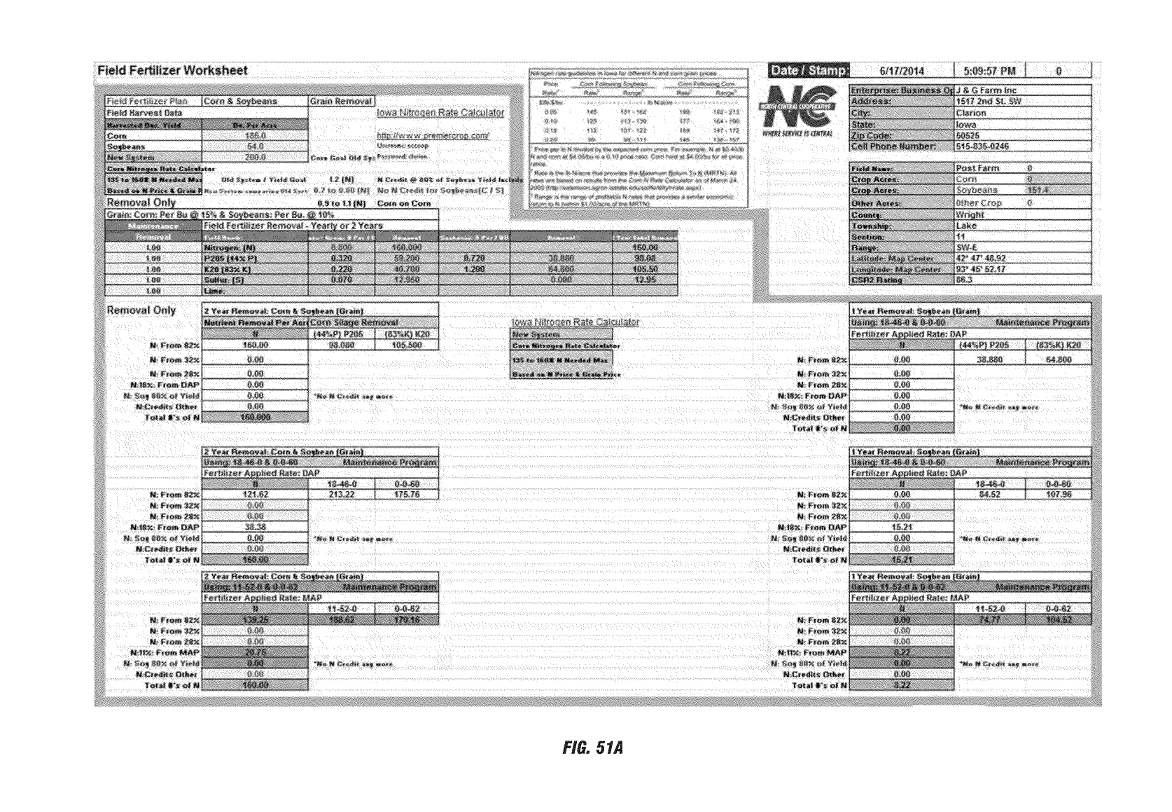

FIG. 50 illustrates a worksheet associated with a soil map.

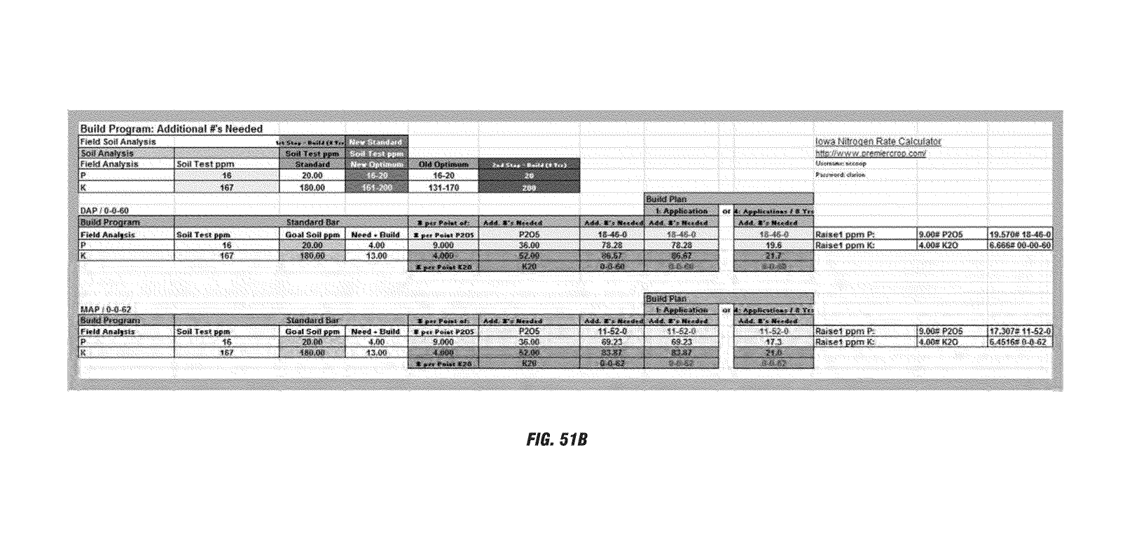

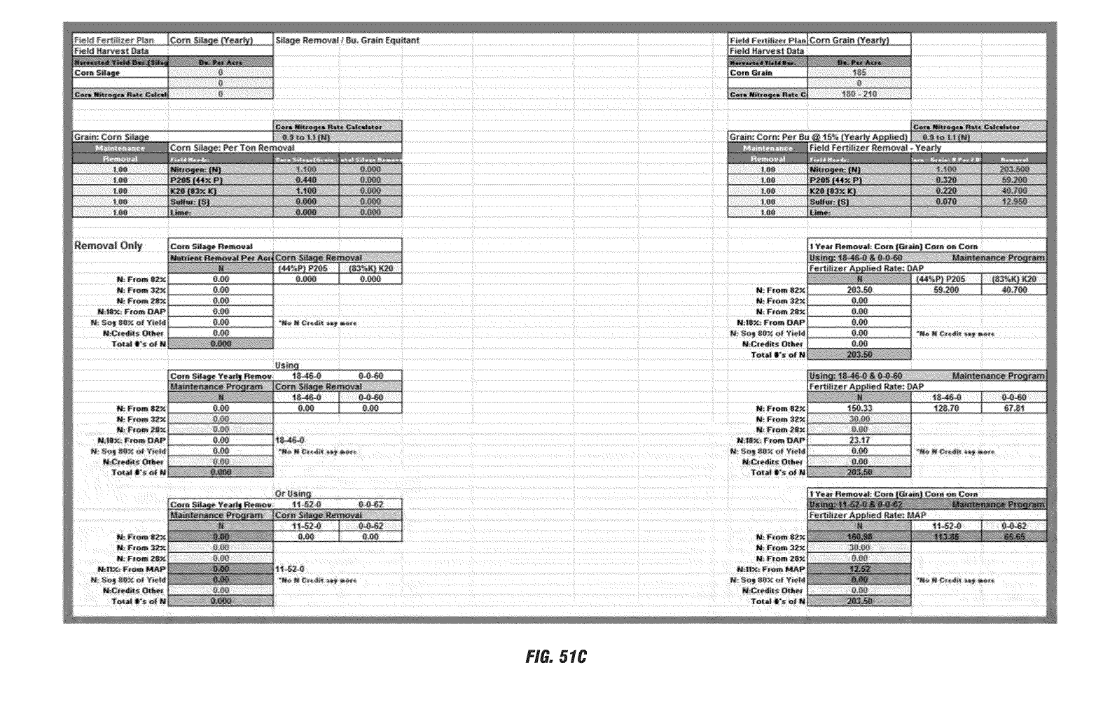

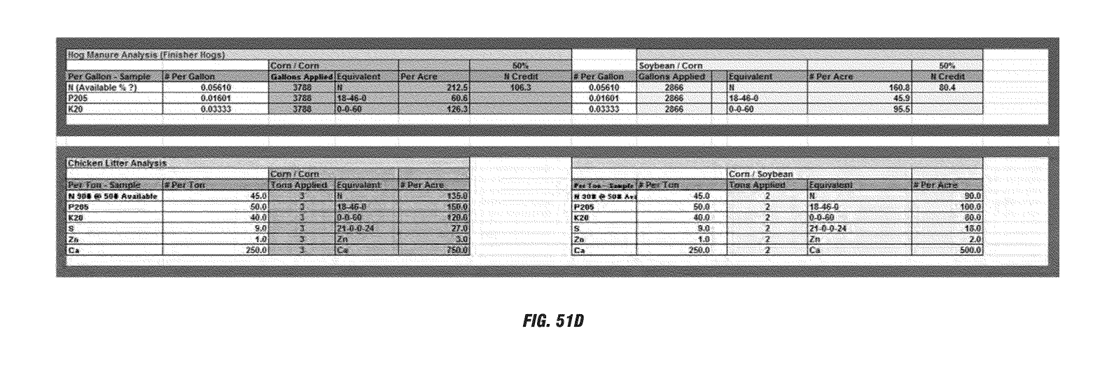

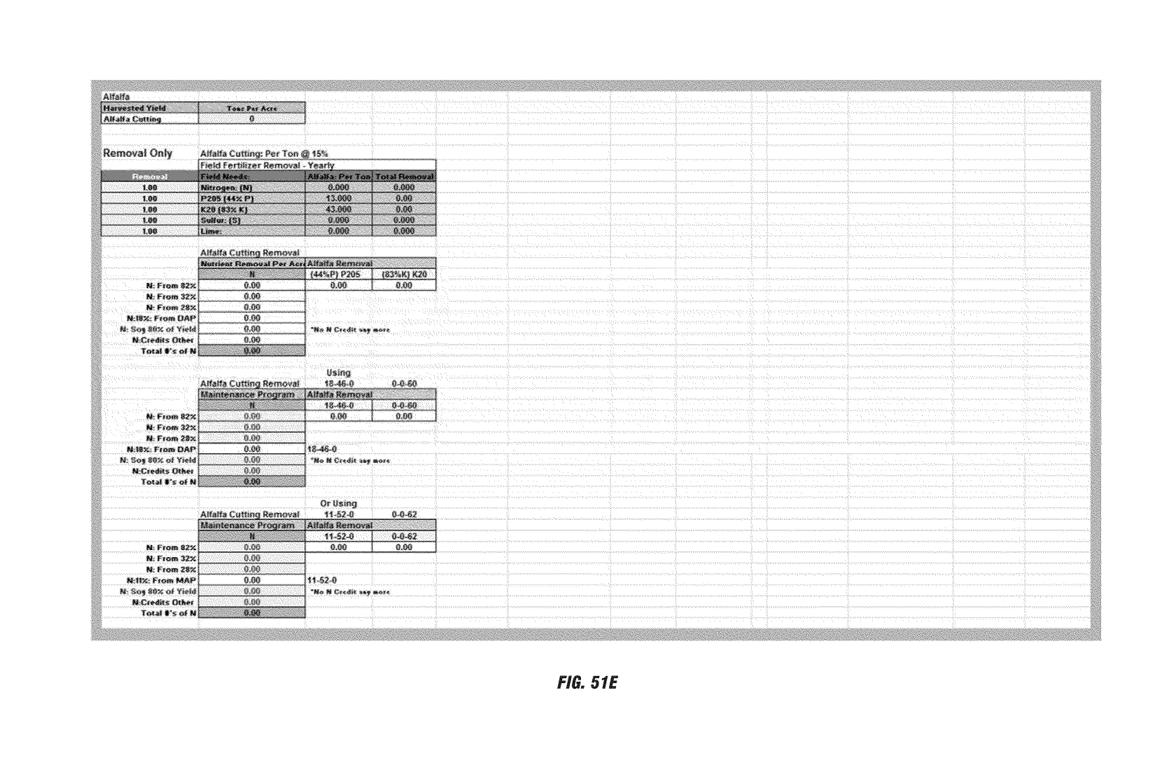

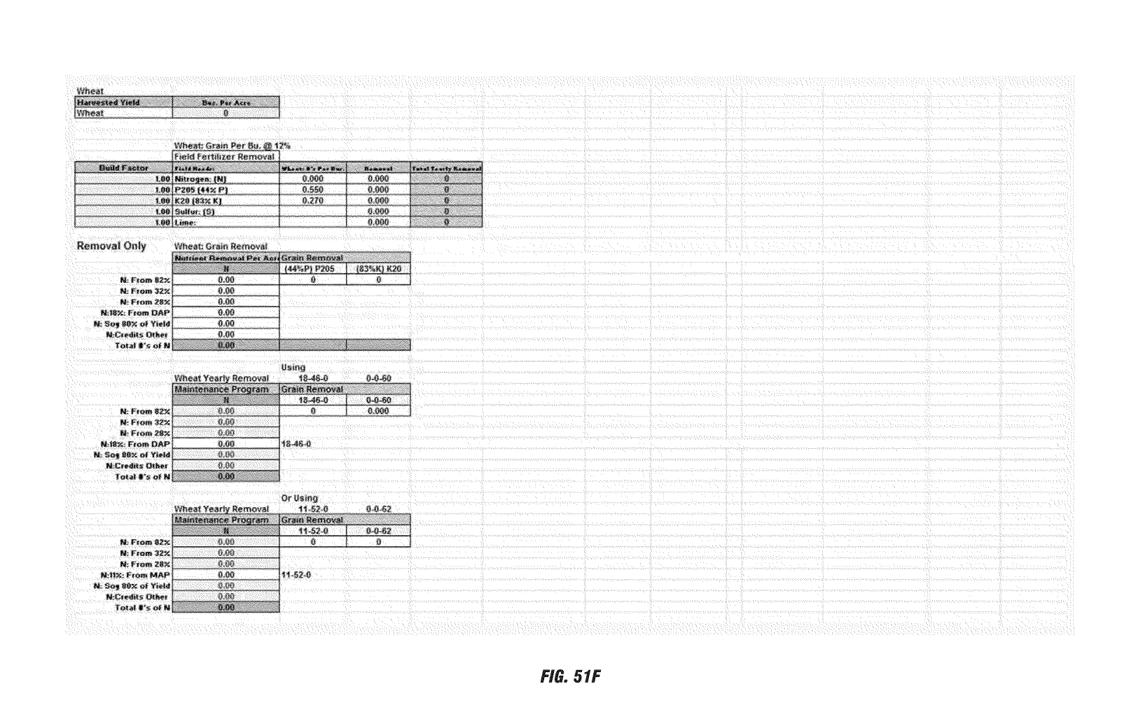

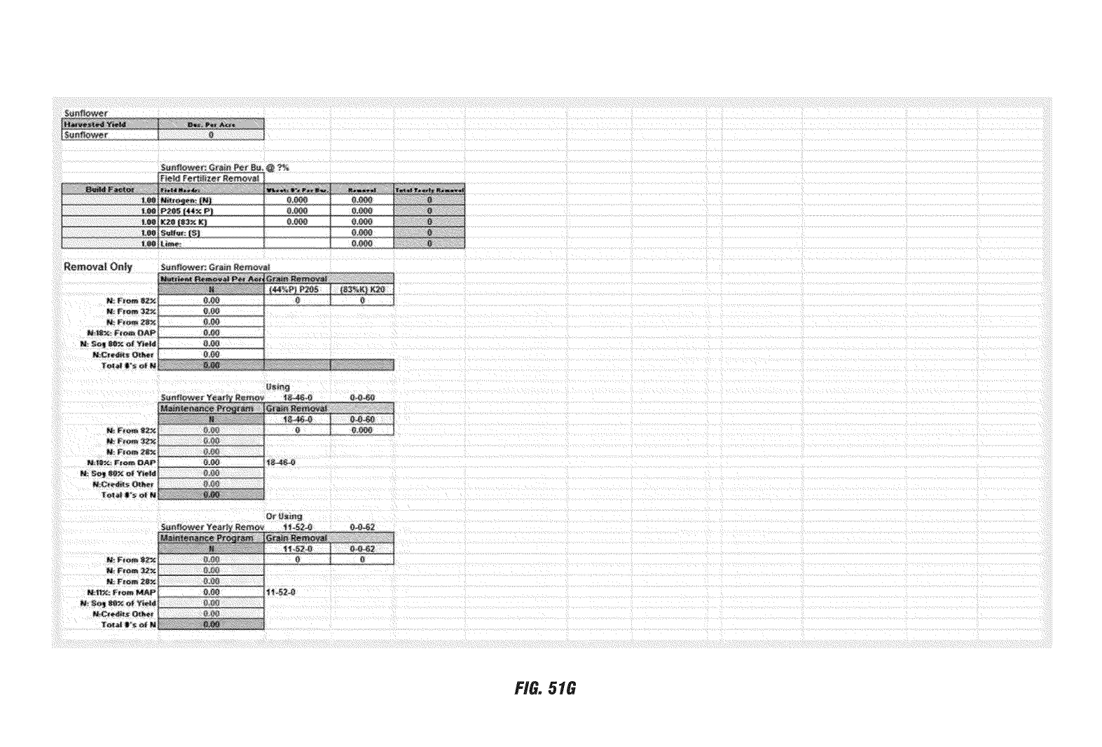

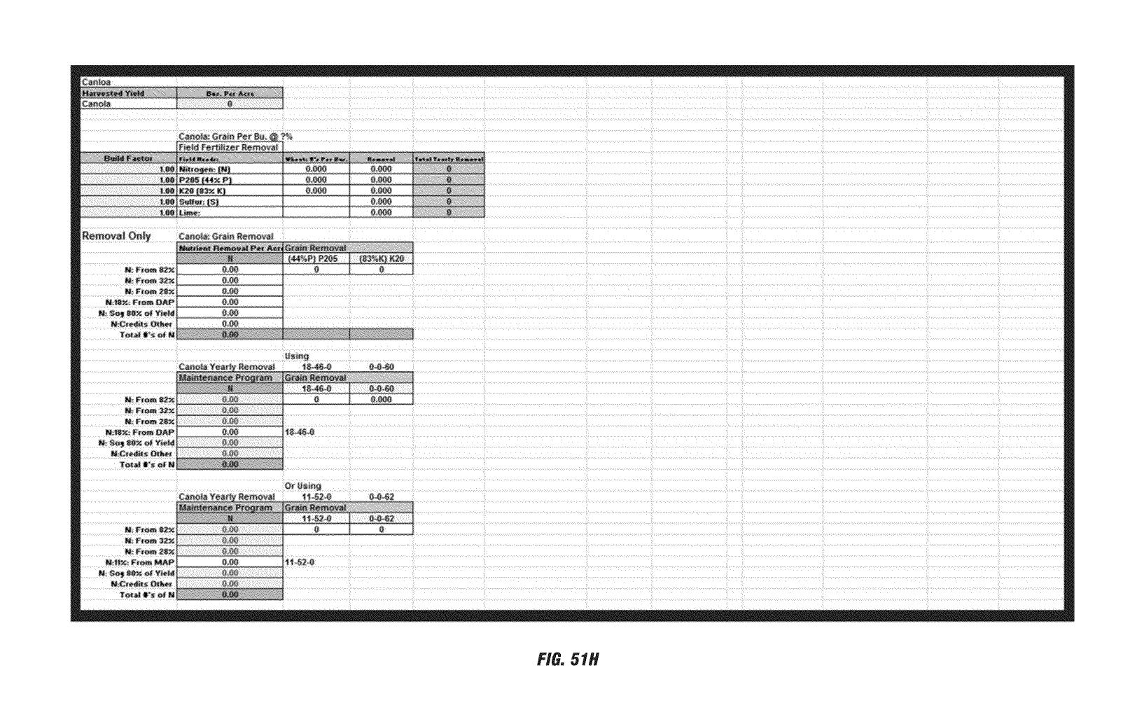

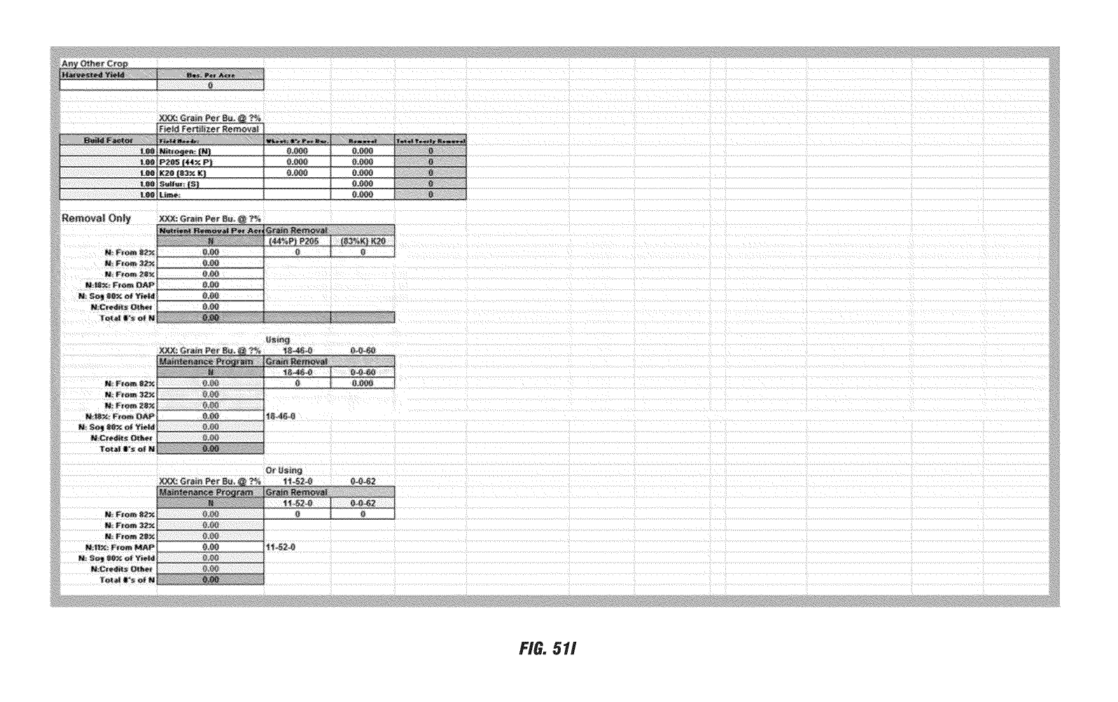

FIGS. 51A-51I illustrate a worksheet for fertilizer cost.

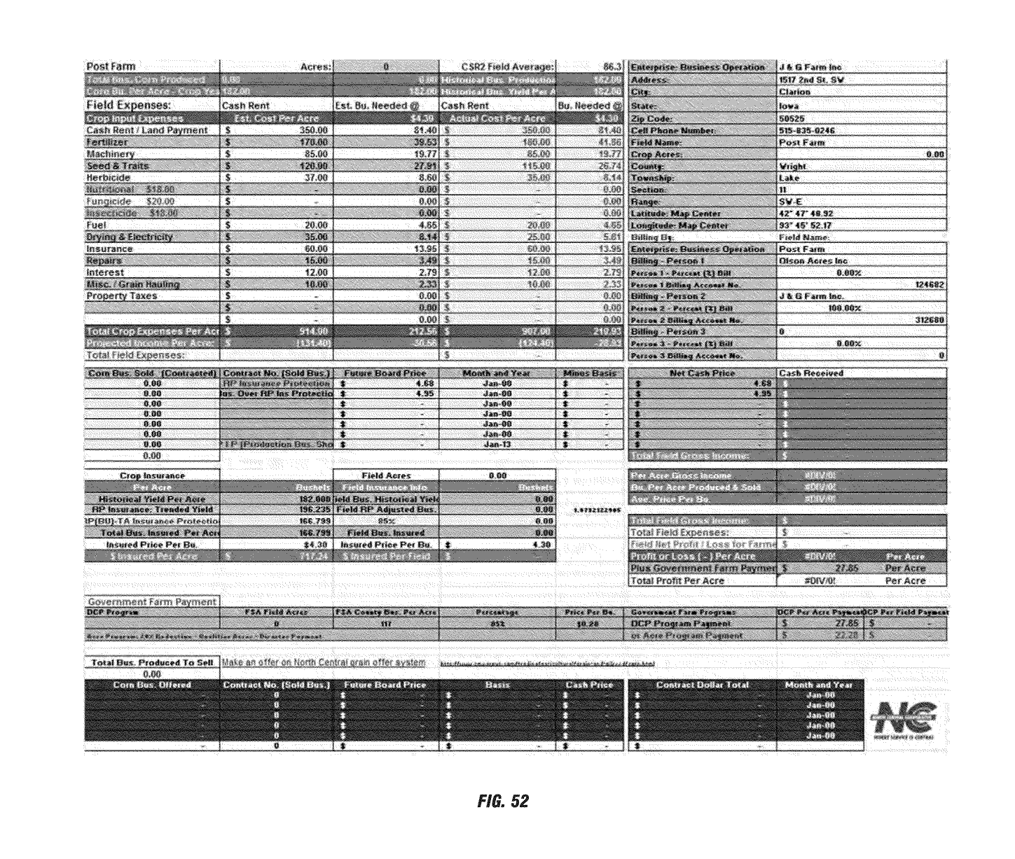

FIG. 52 illustrates another example of a worksheet.

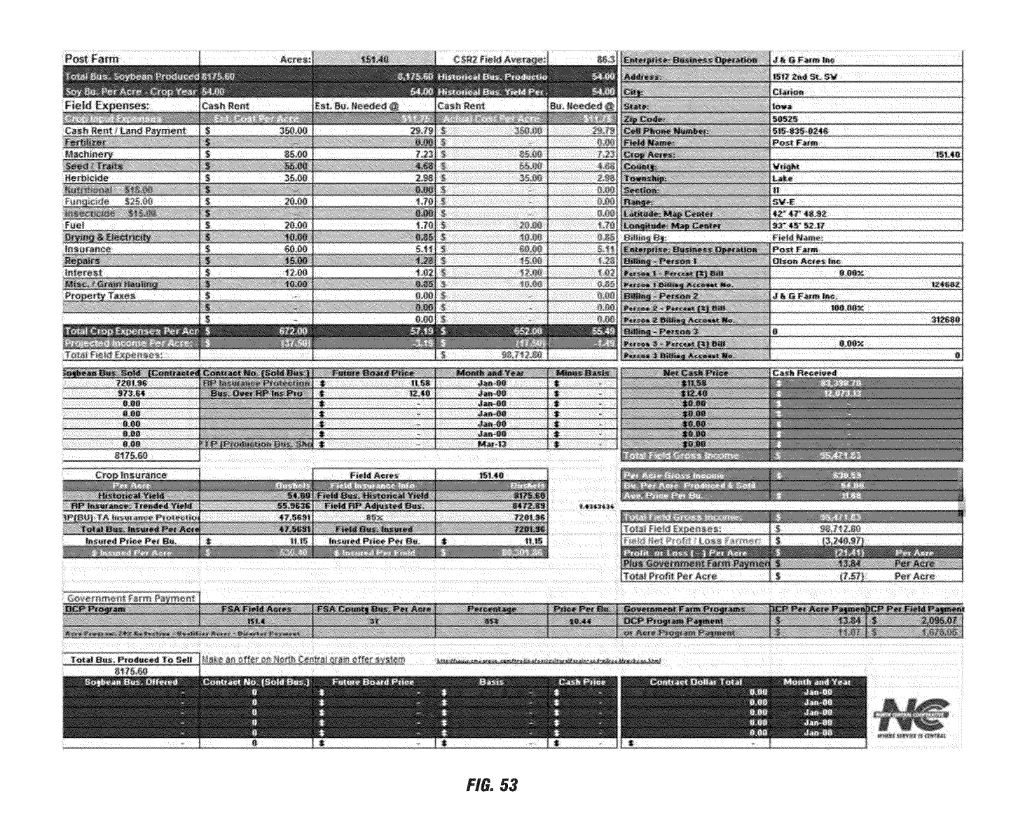

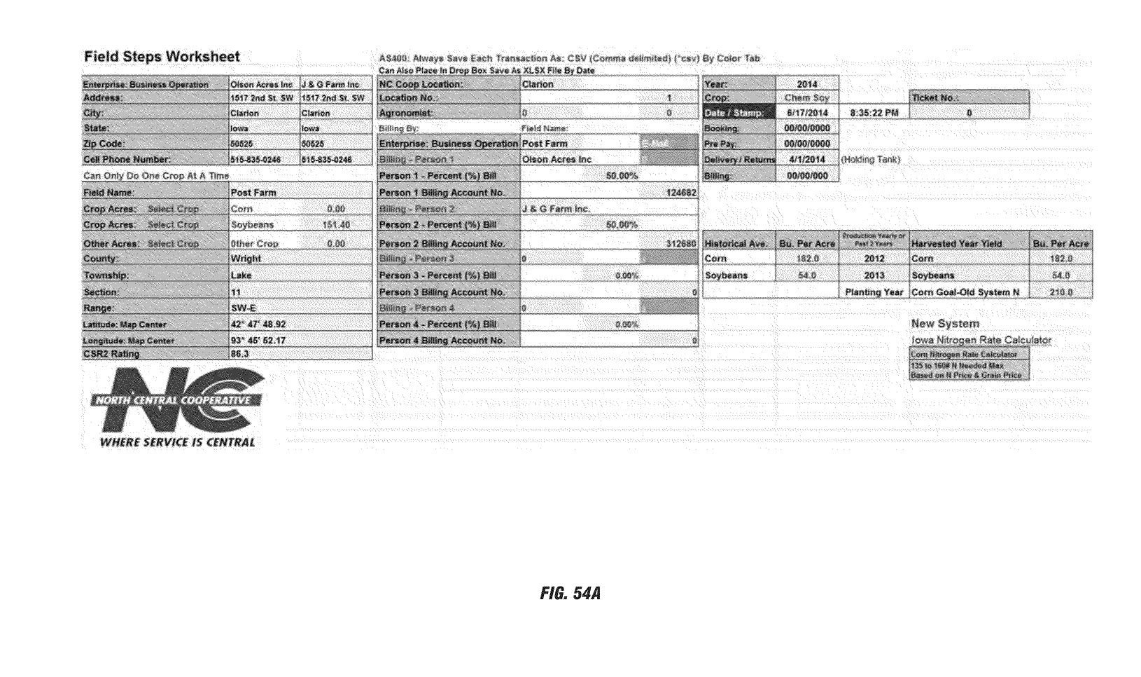

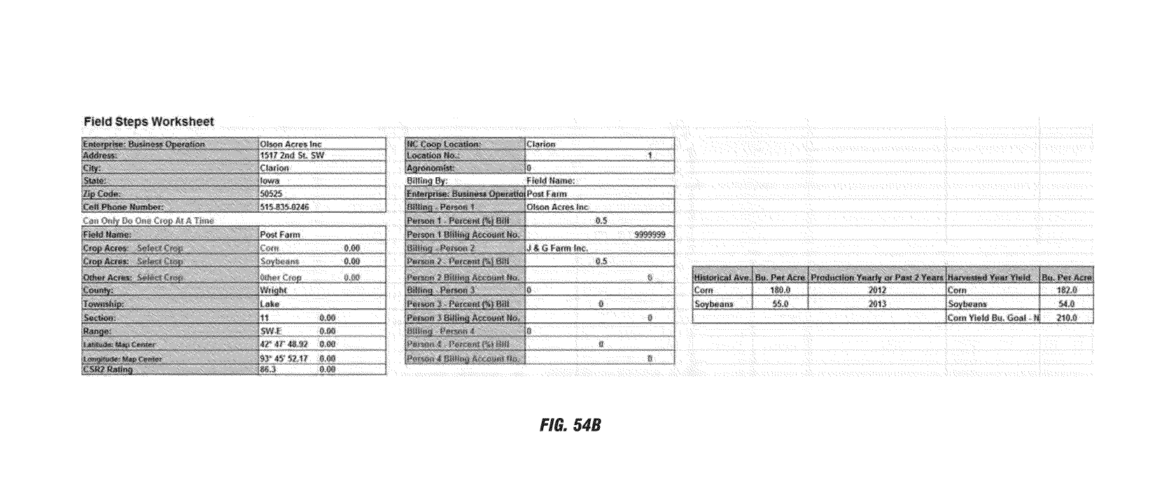

FIG. 53 illustrates another example of a worksheet.

FIGS. 54A-54B illustrates an example of a worksheet associated with field steps.

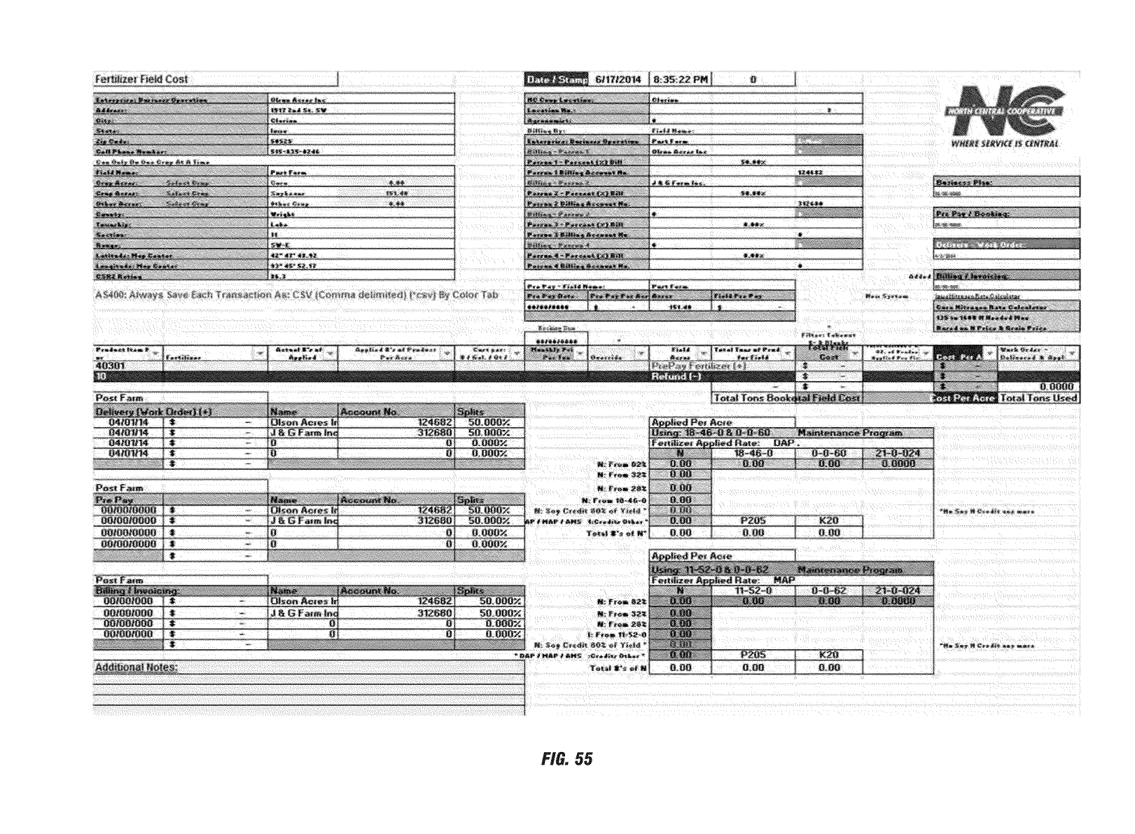

FIG. 55 illustrate one example of a field fertilizer needs worksheet.

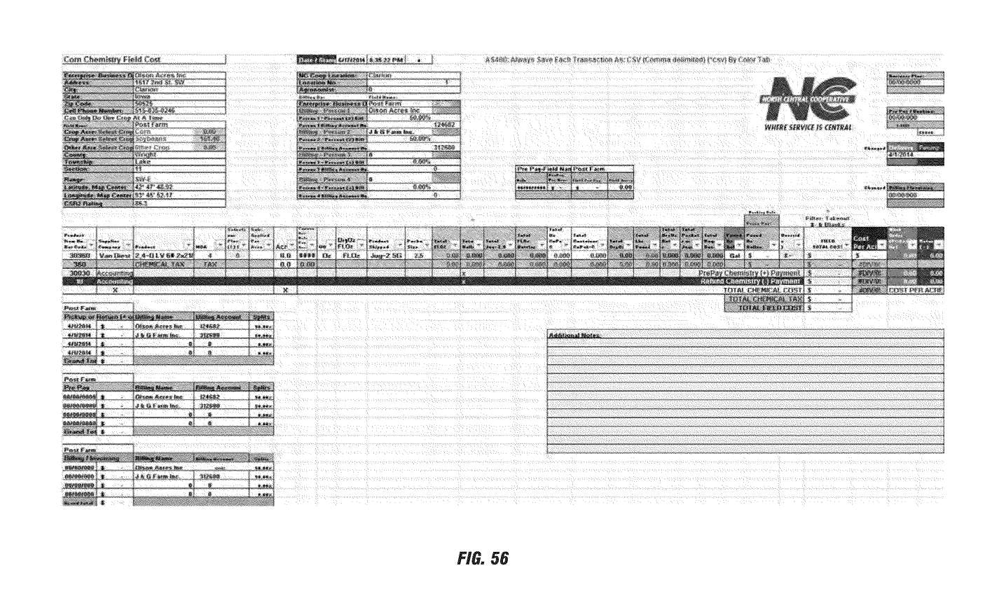

FIG. 56 illustrate an example of a worksheet for corn chemistry.

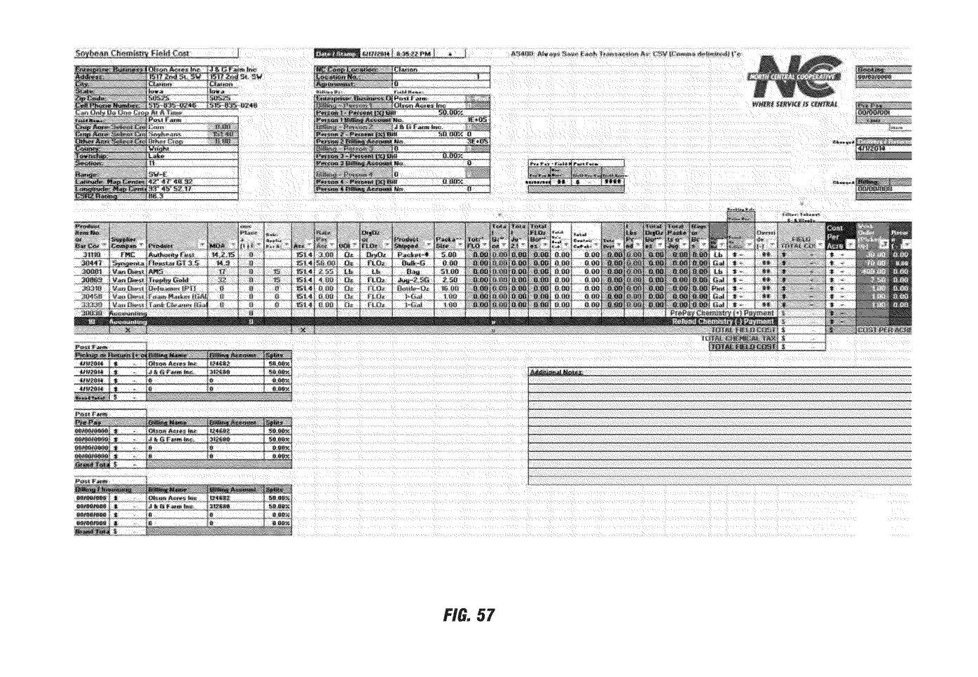

FIG. 57 an example of a worksheet for soybean chemistry.

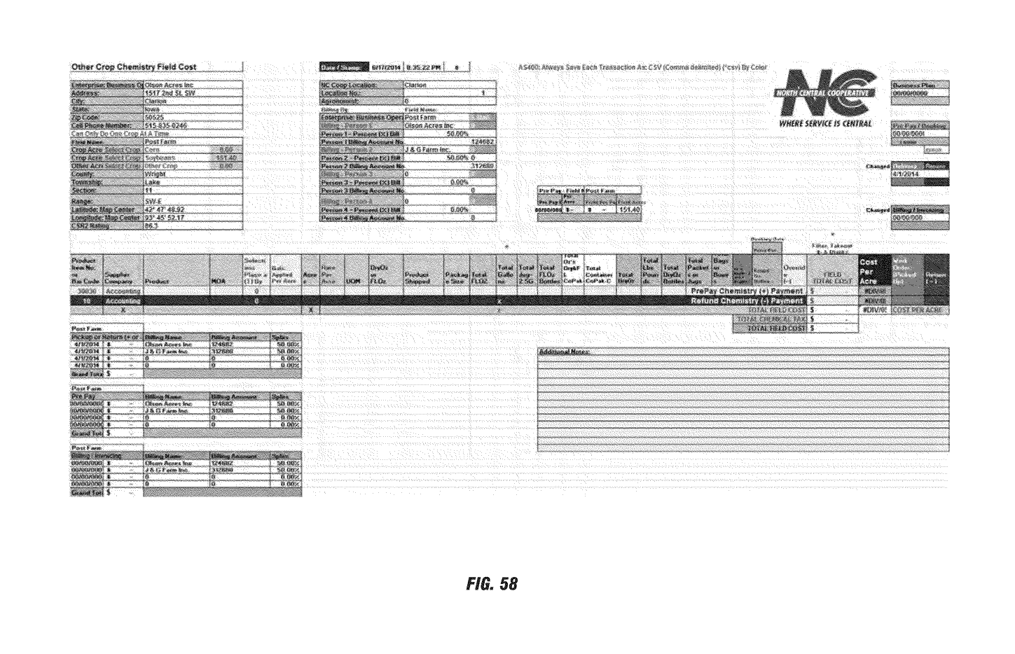

FIG. 58 illustrate an example of a worksheet for other crop chemistry.

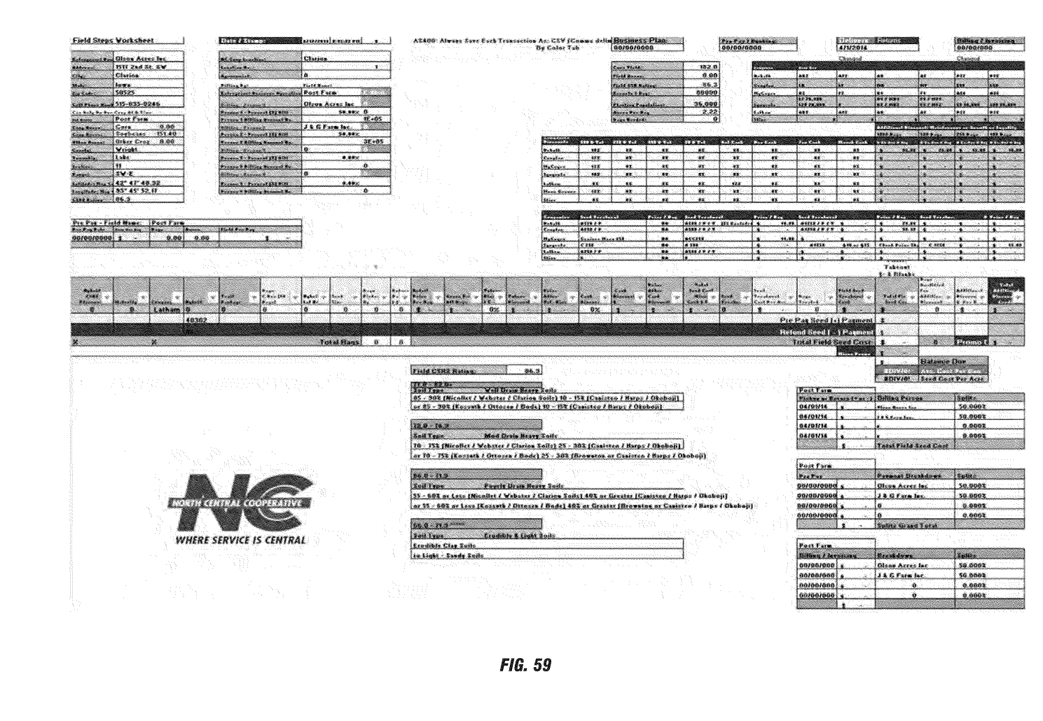

FIG. 59 illustrate an example of a worksheet for corn hybrids.

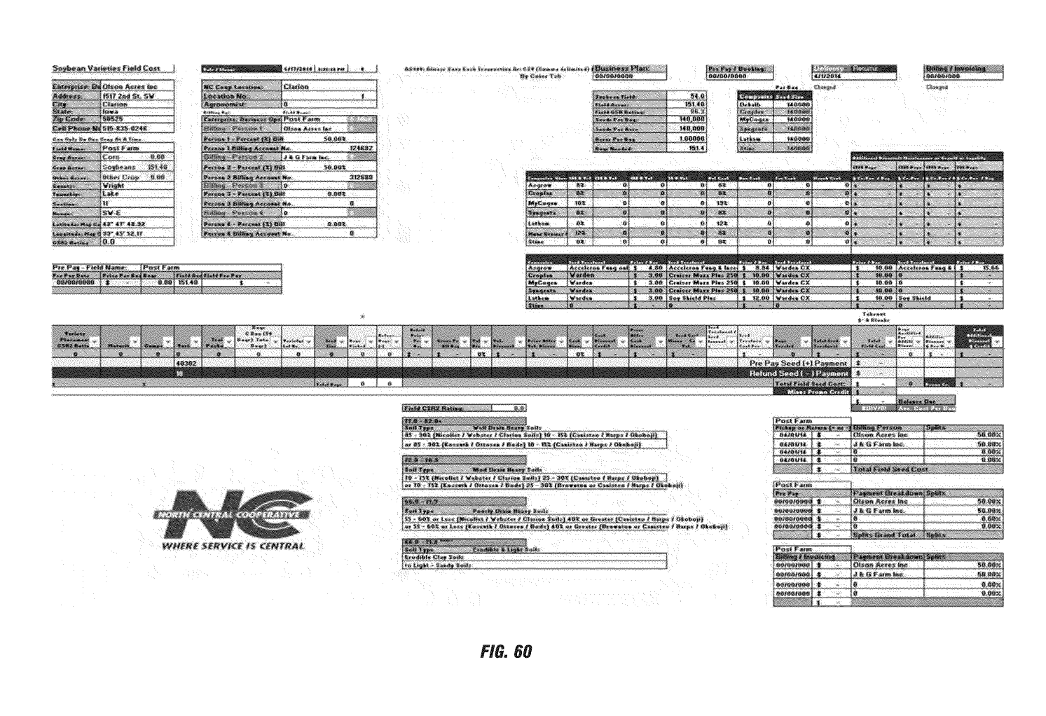

FIG. 60 illustrate an example of worksheet for soybean varieties.

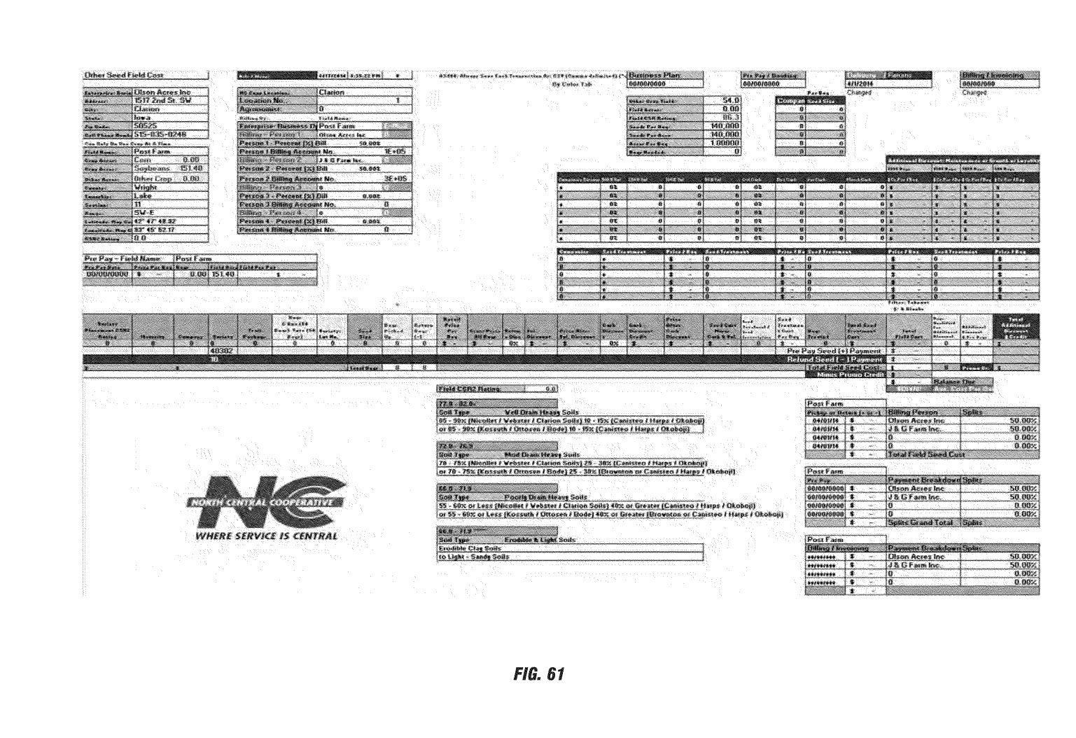

FIG. 61 illustrate a worksheet for other seed cost.

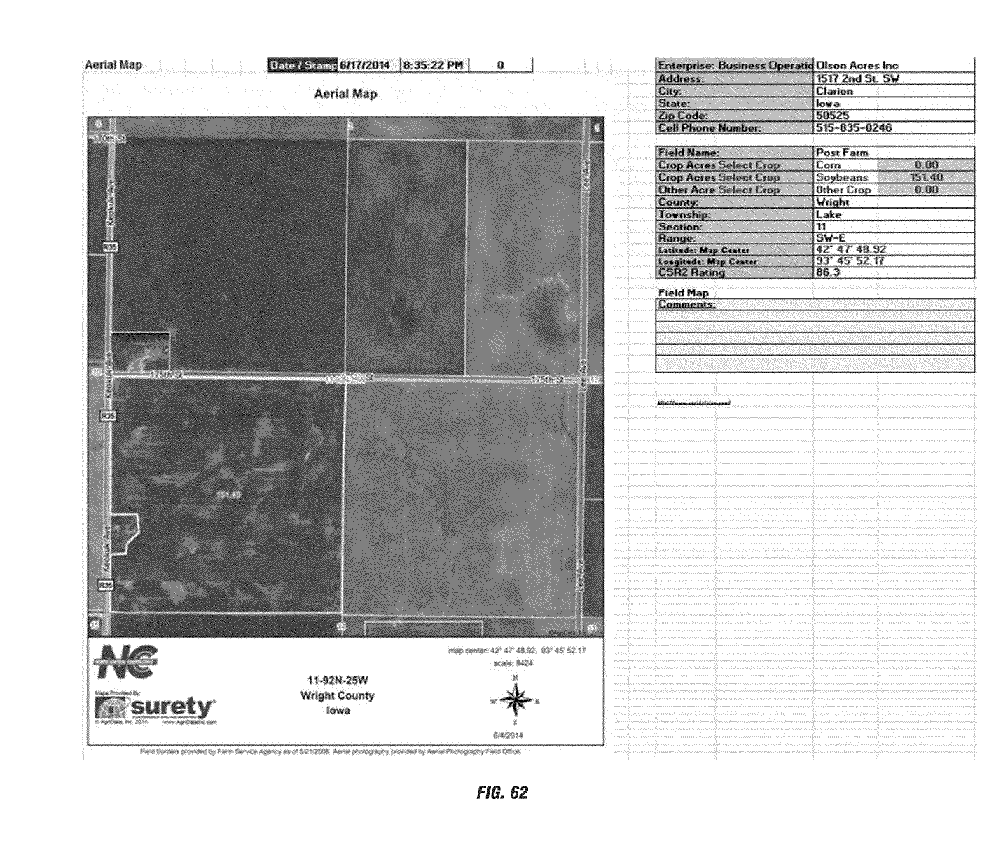

FIG. 62 illustrates a worksheet associated with a field map.

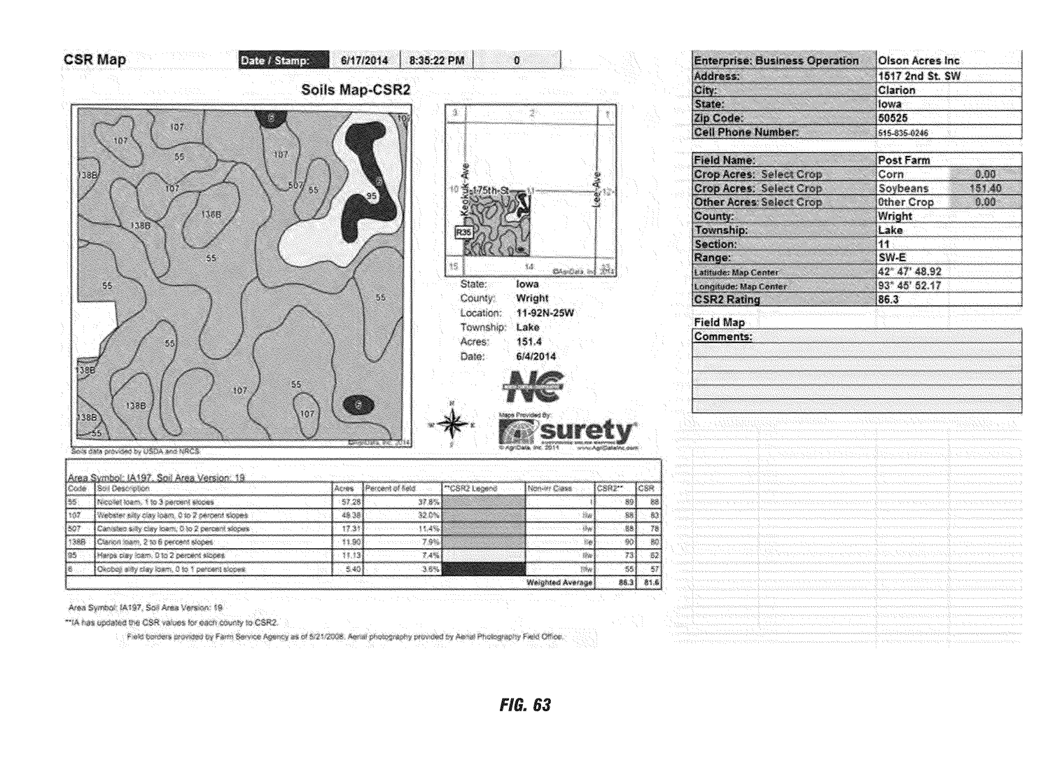

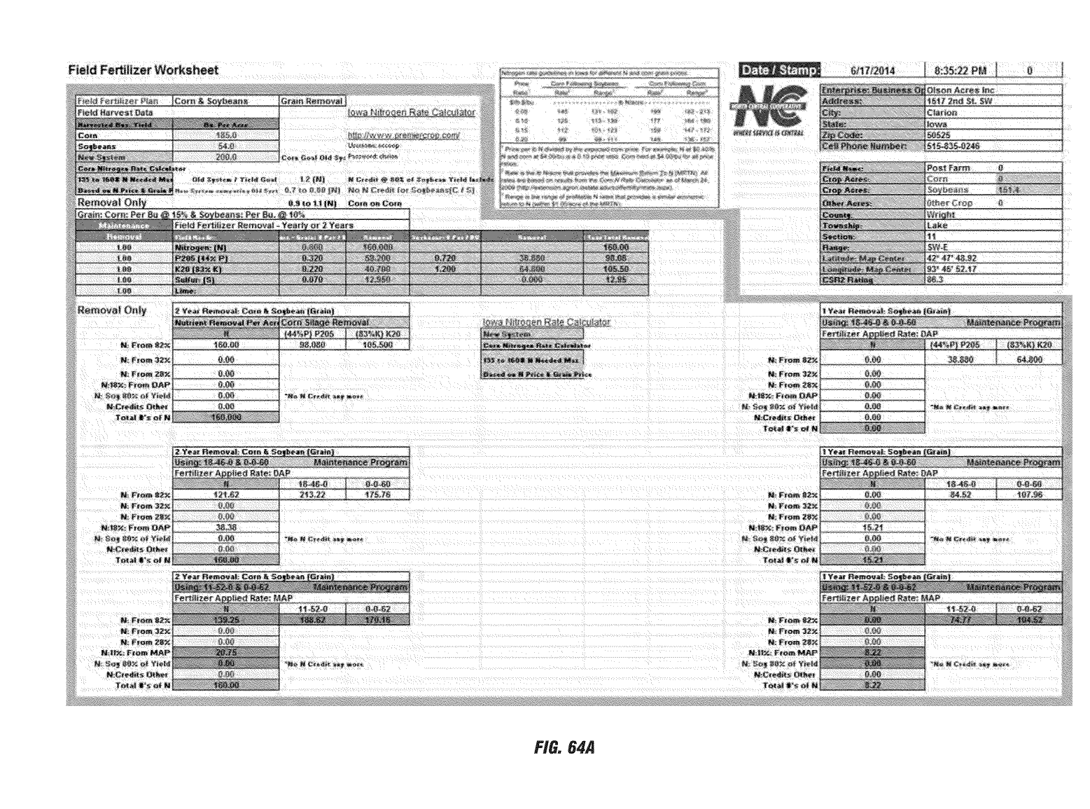

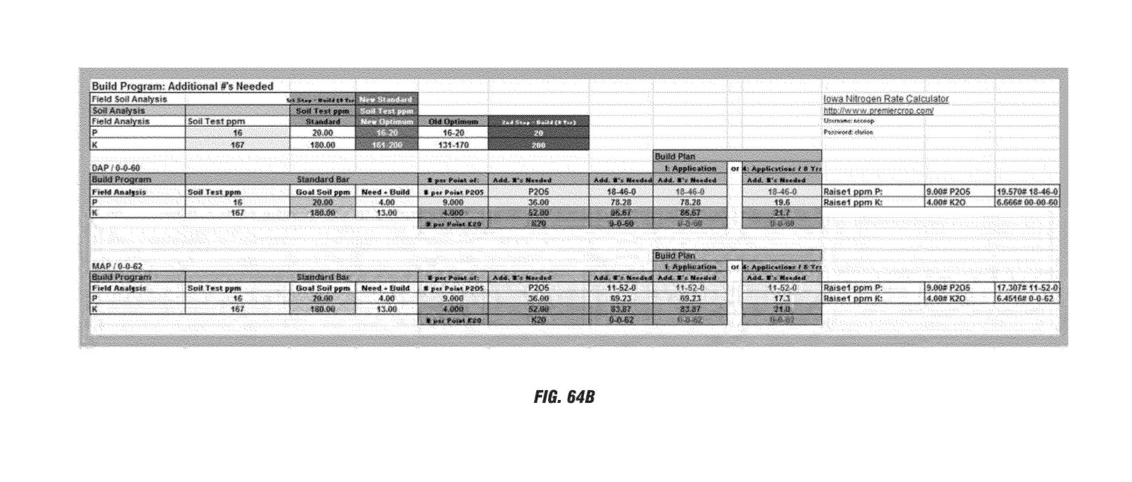

FIG. 63 illustrates a worksheet associated with a soil map.

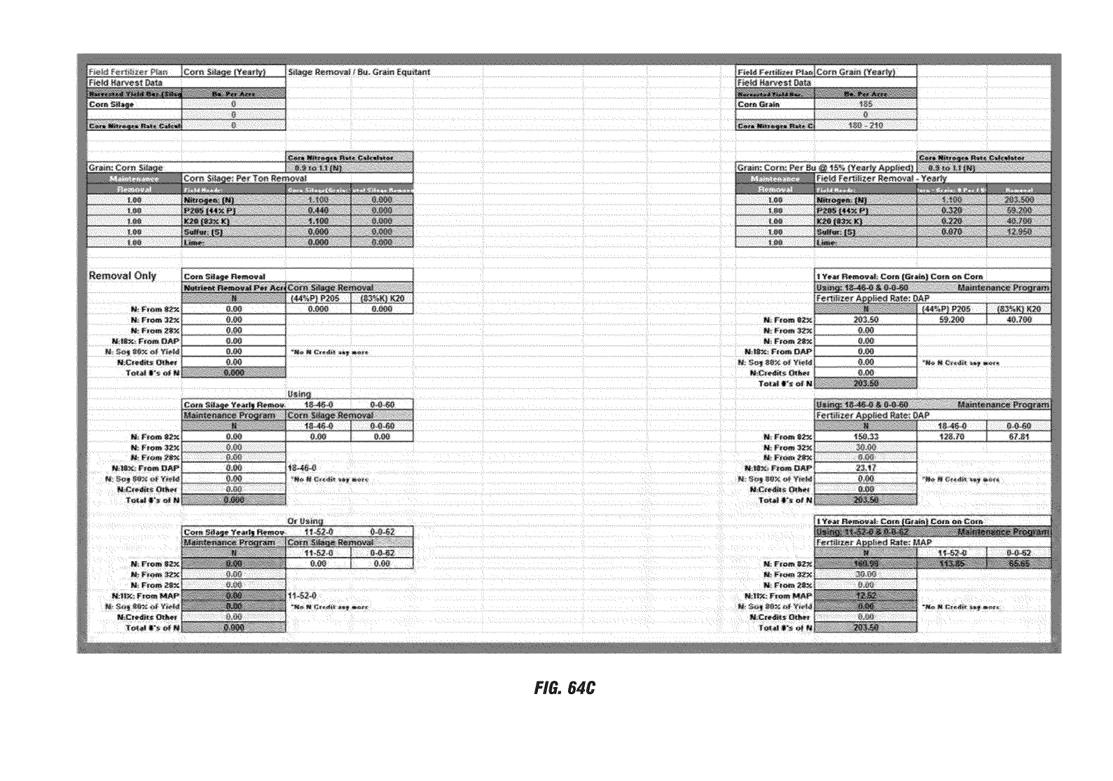

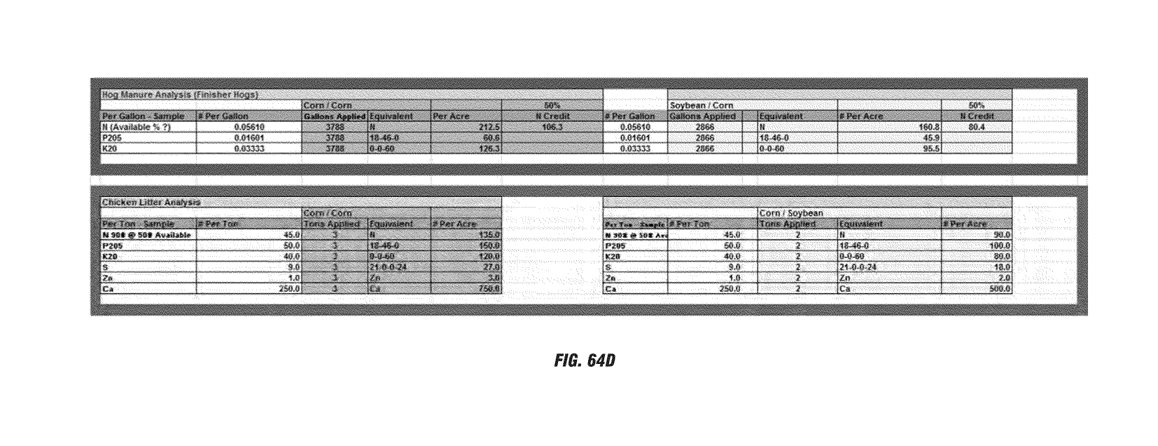

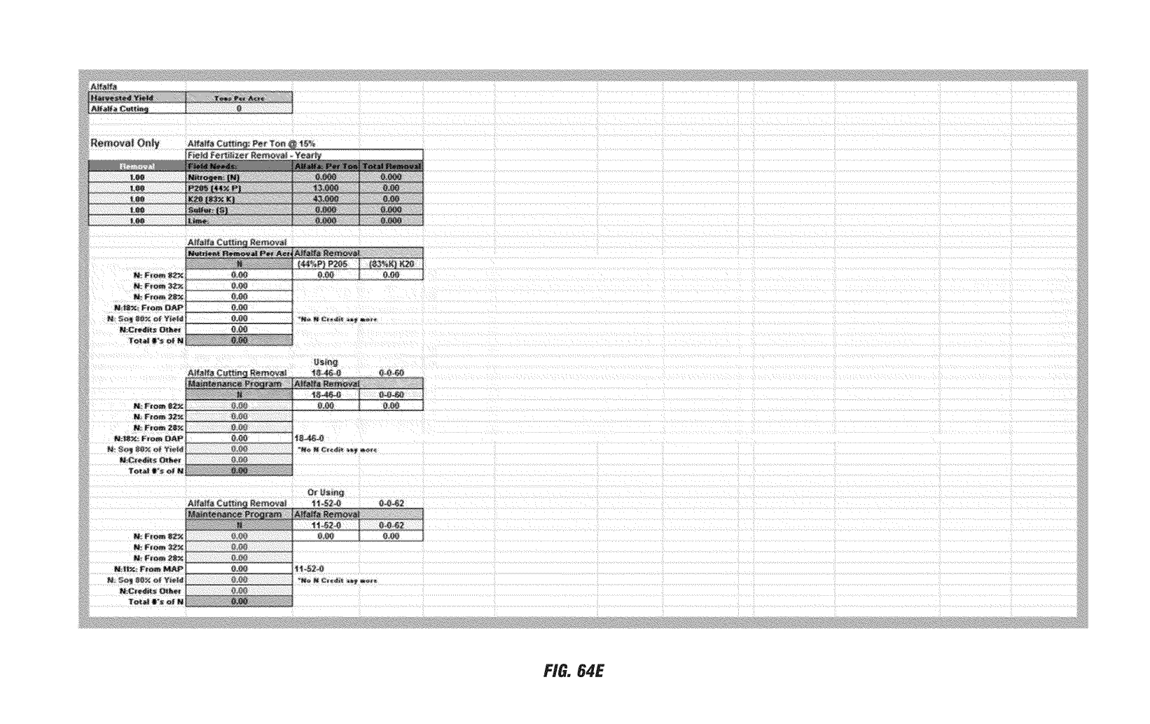

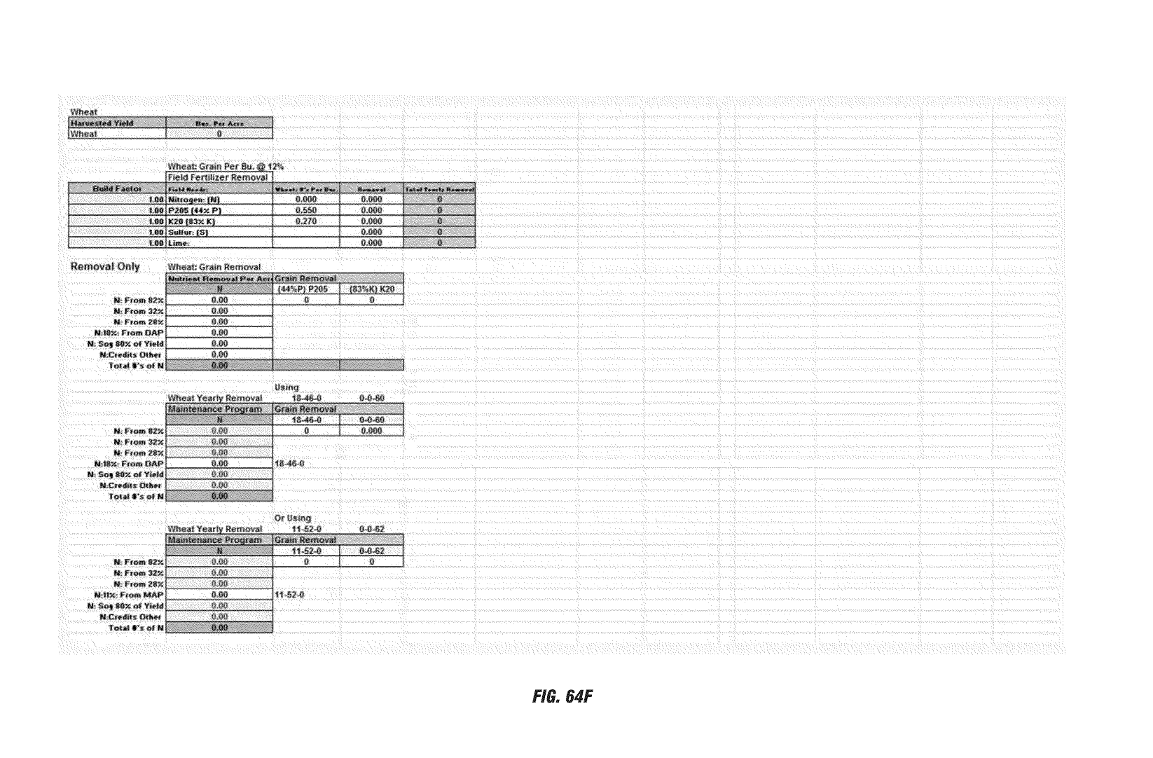

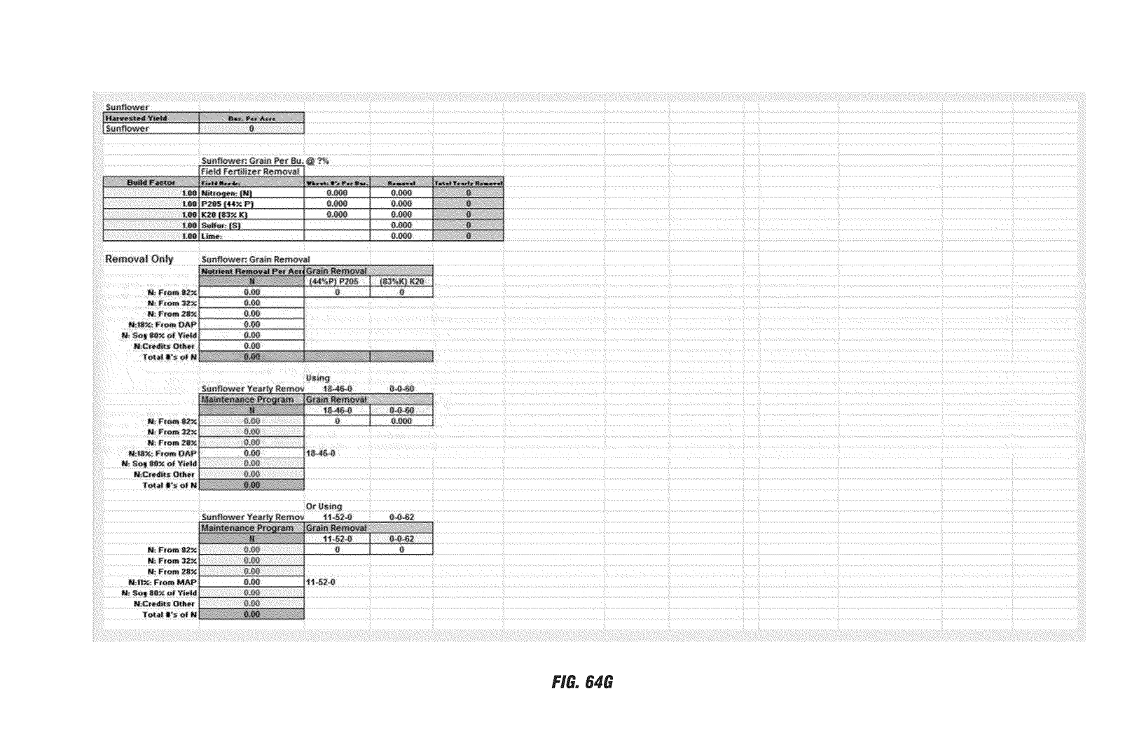

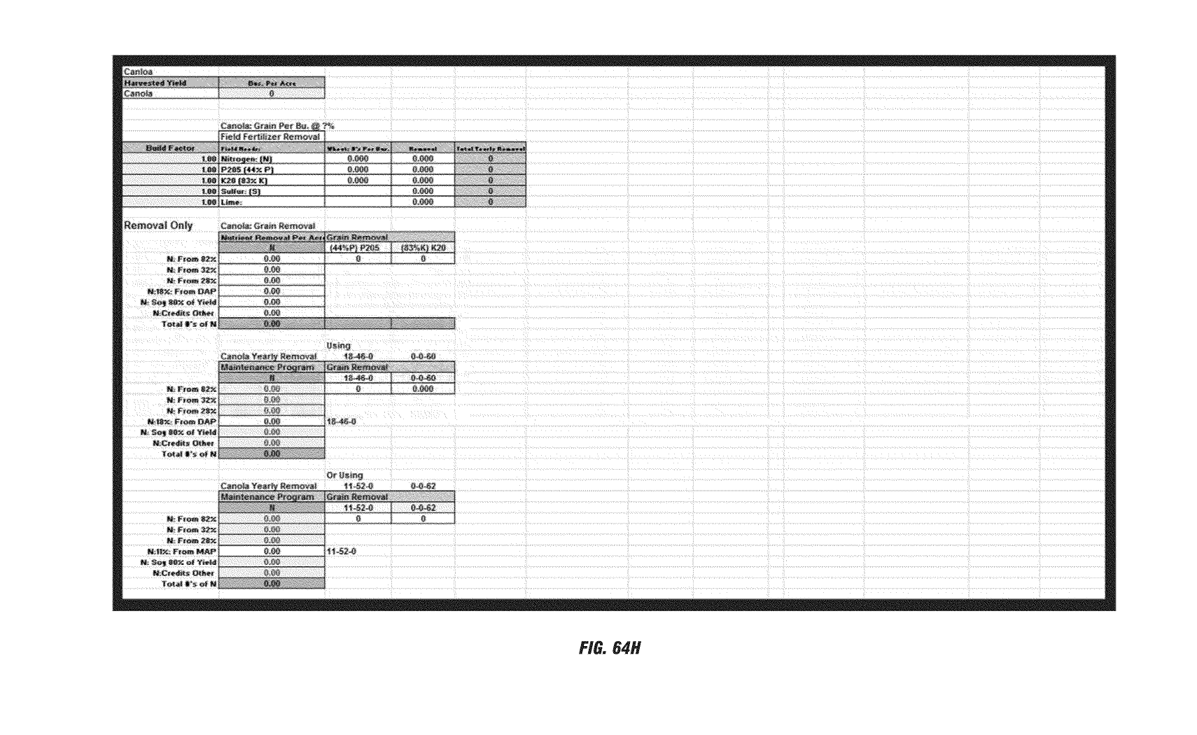

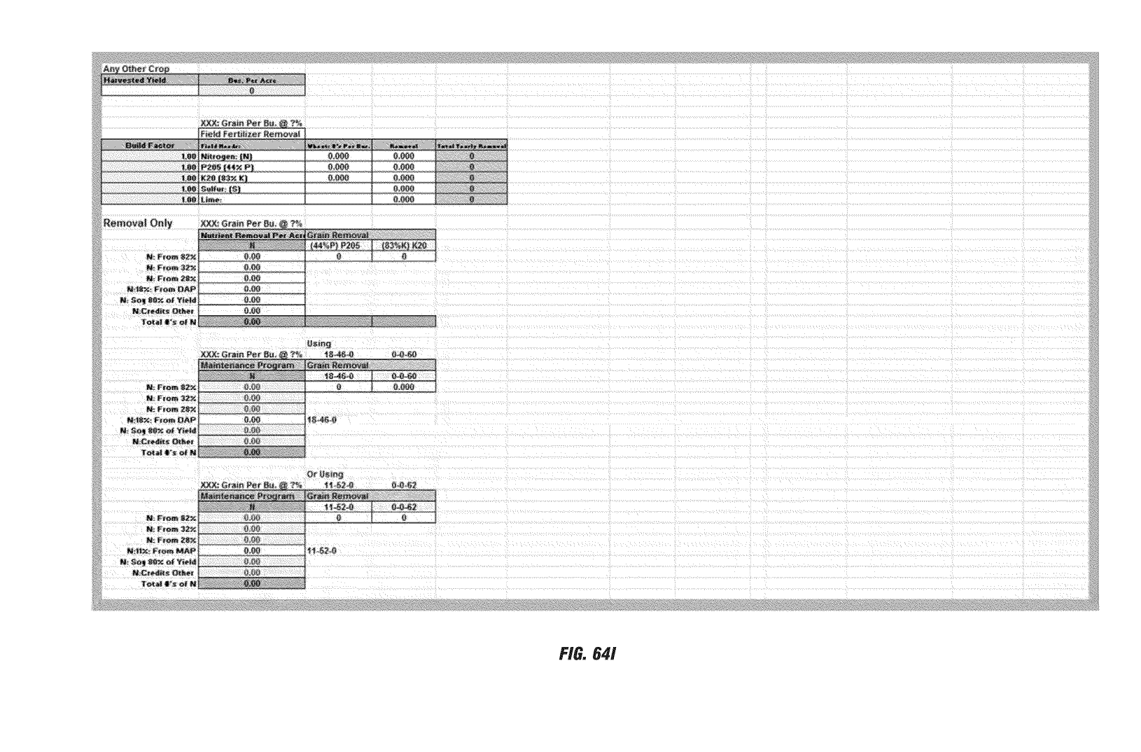

FIGS. 64A-64I illustrate a worksheet for fertilizer cost.

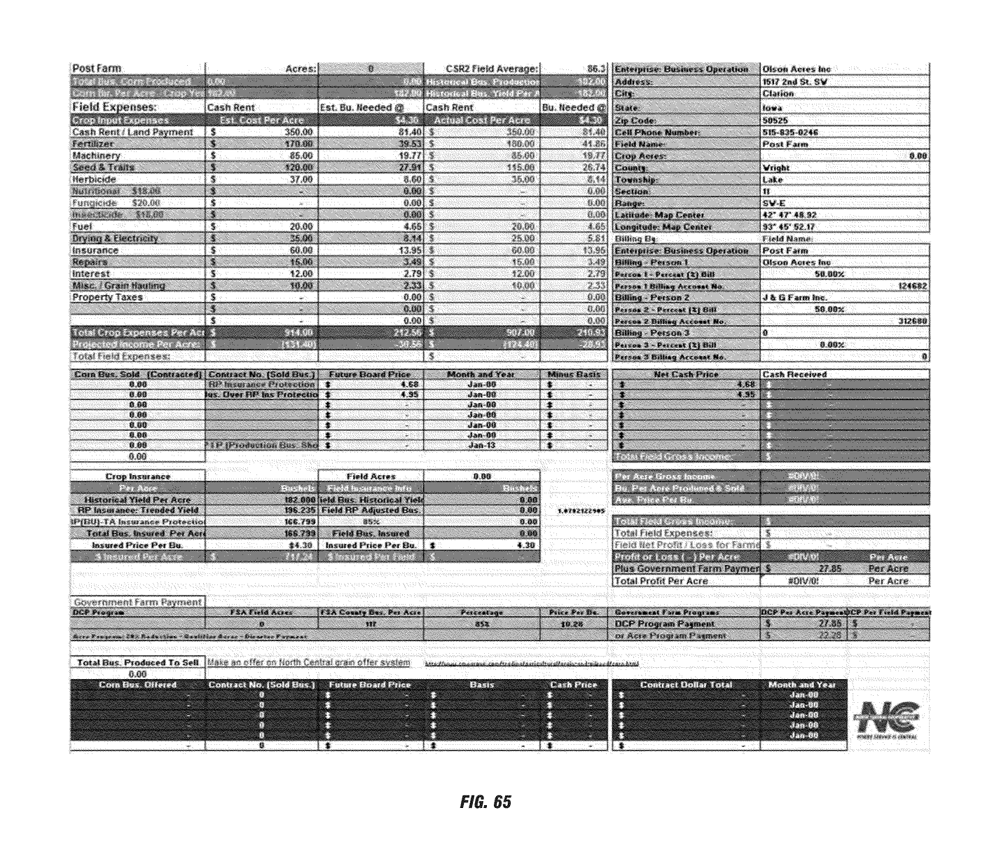

FIG. 65 illustrates another example of a worksheet.

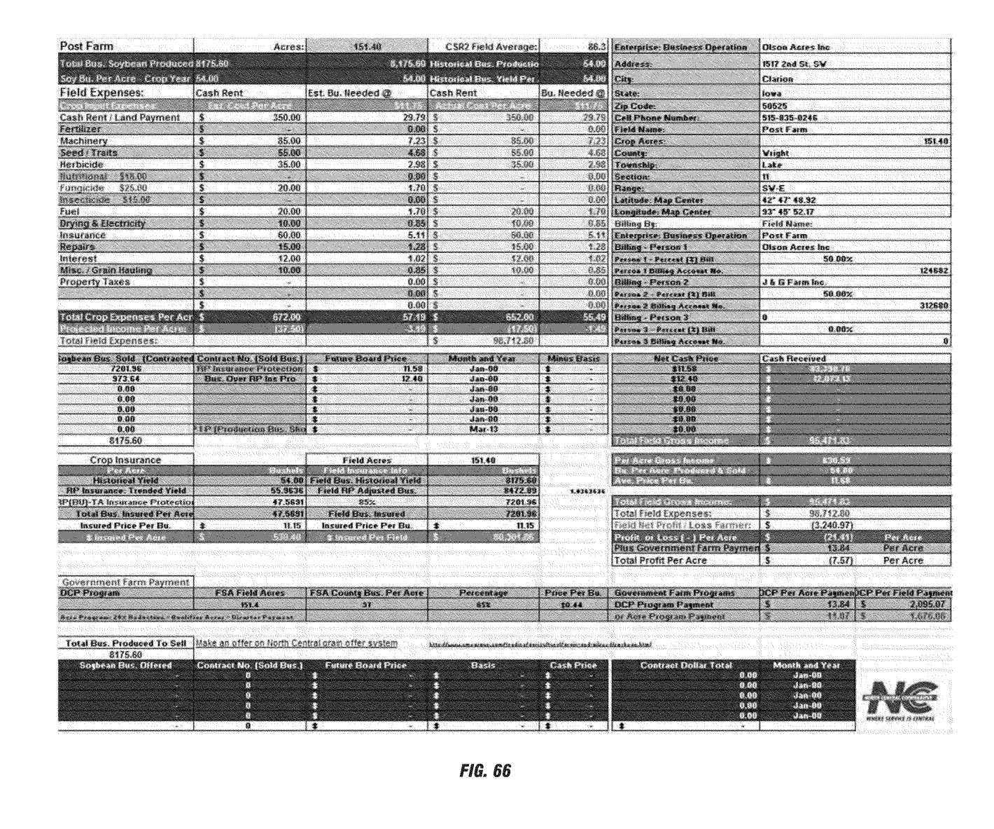

FIG. 66 illustrates another example of a worksheet.

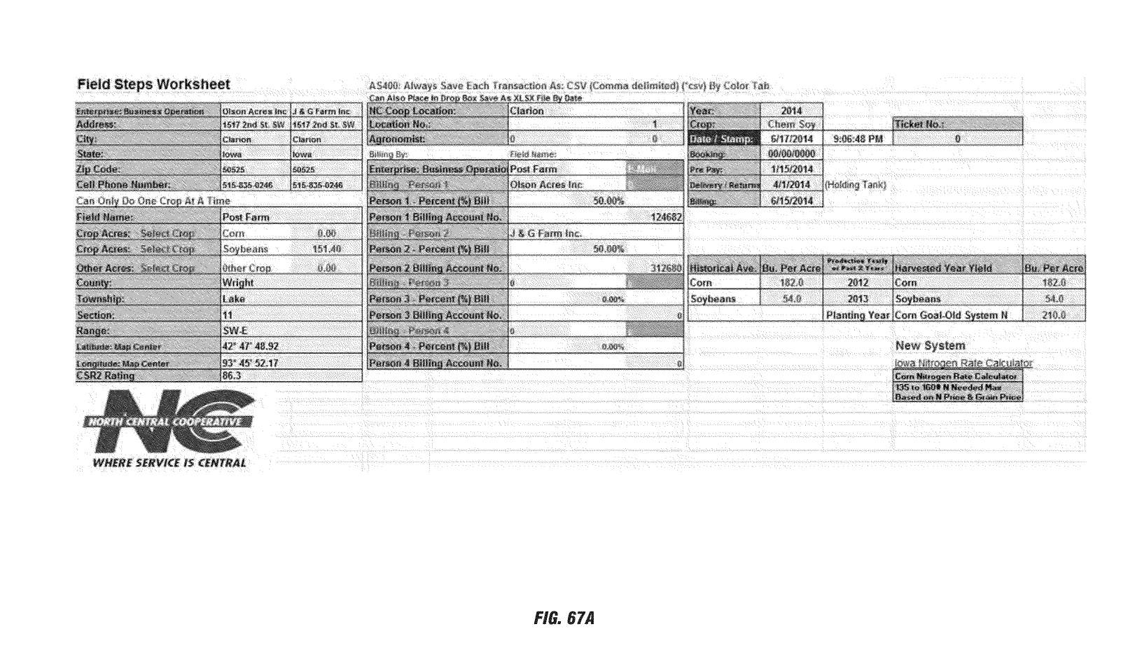

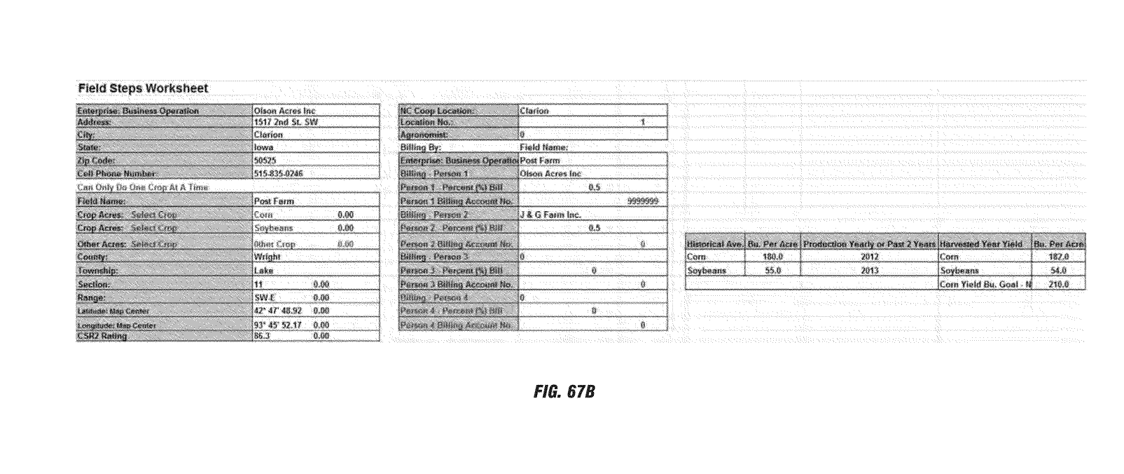

FIGS. 67-67B illustrates an example of a worksheet associated with field steps.

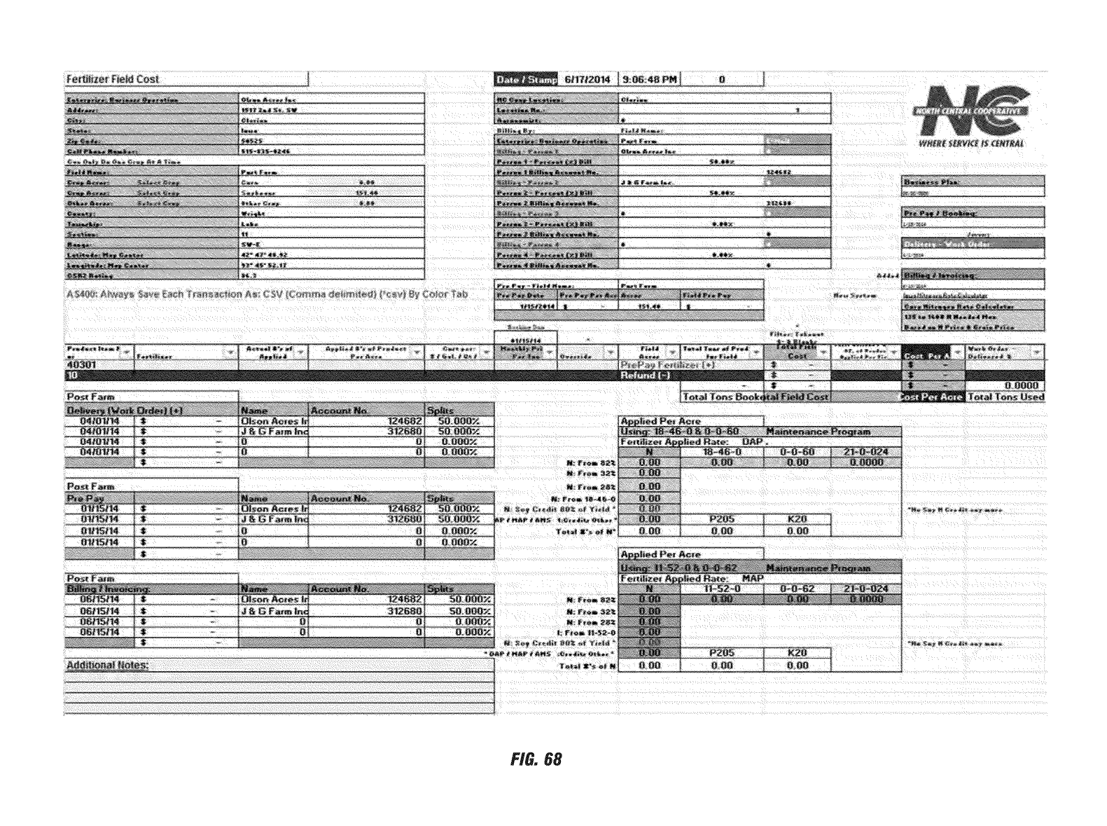

FIG. 68 illustrate one example of a field fertilizer needs worksheet.

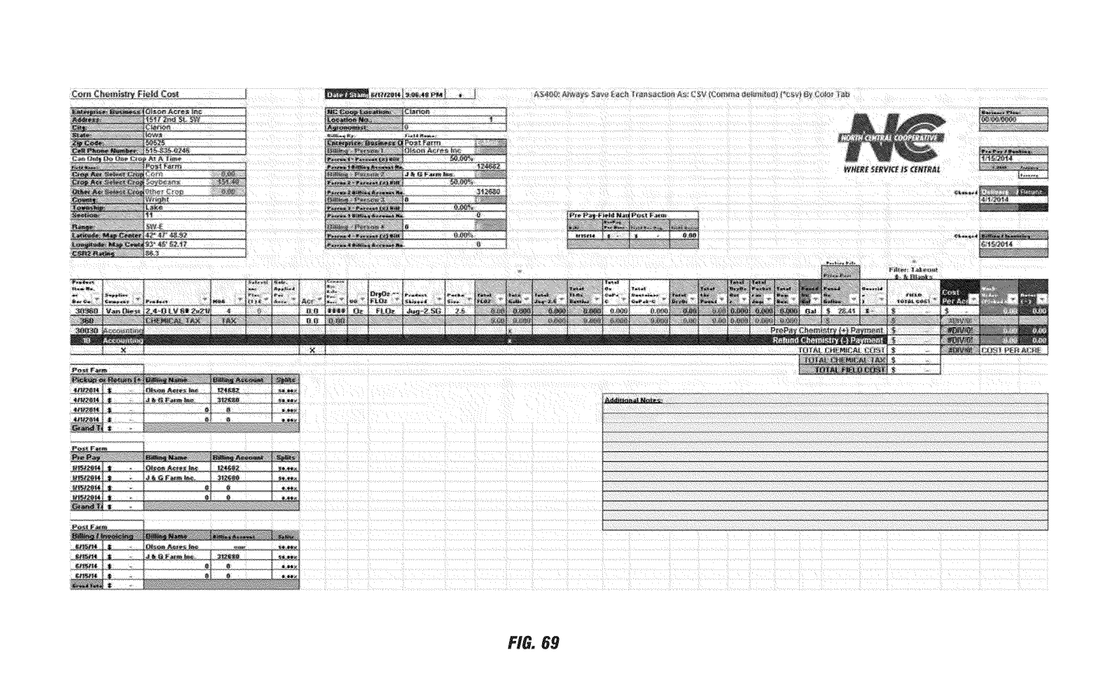

FIG. 69 illustrate an example of a worksheet for corn chemistry.

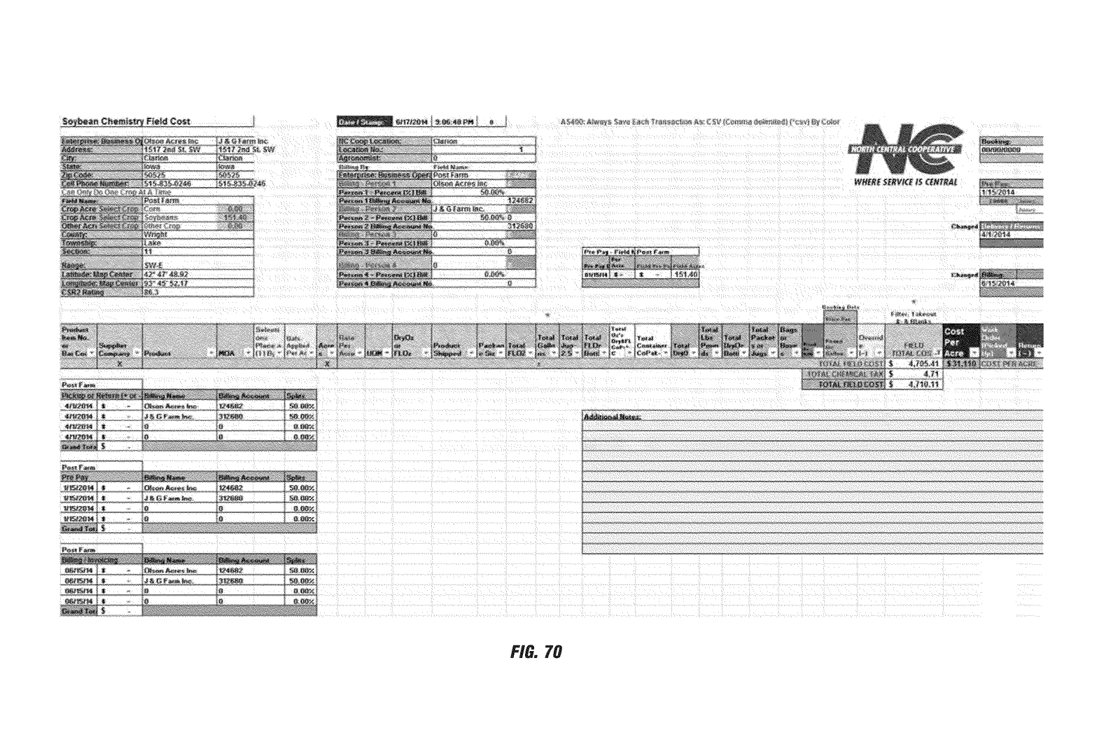

FIG. 70 an example of a worksheet for soybean chemistry.

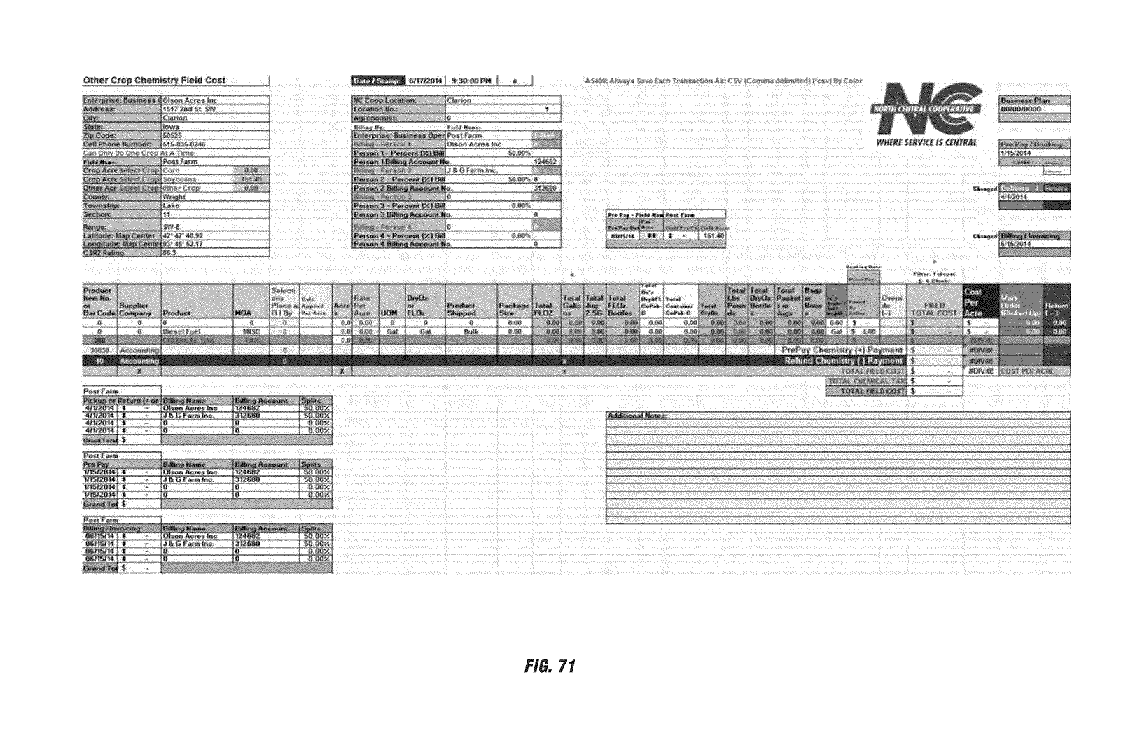

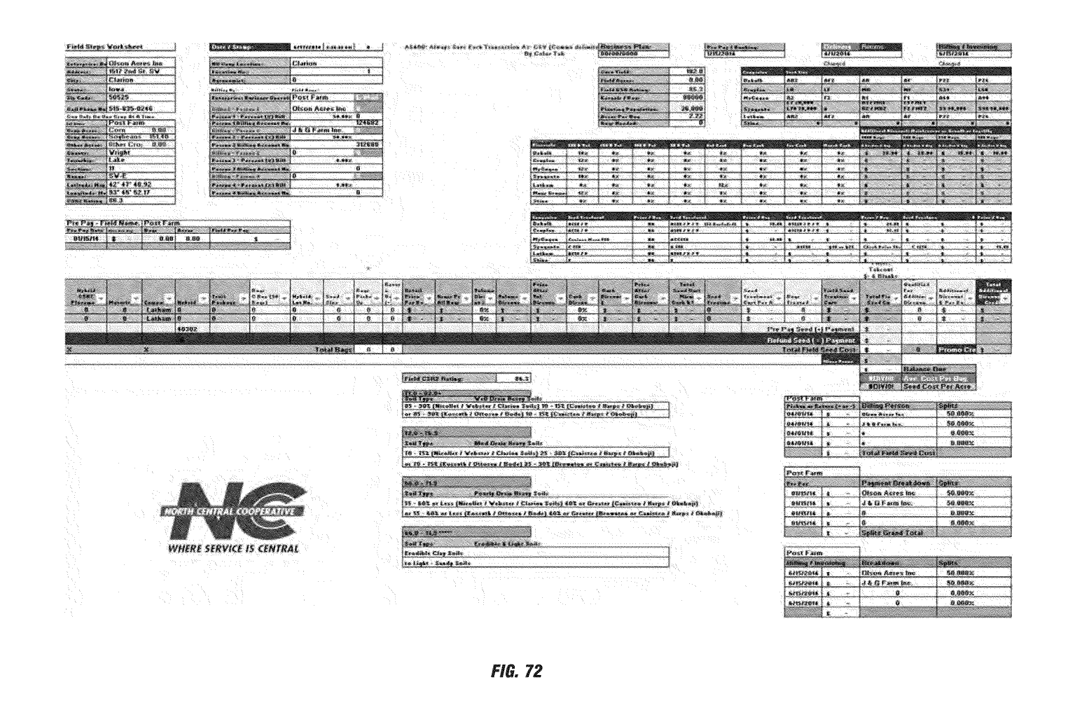

FIG. 71 illustrate an example of a worksheet for other crop chemistry.

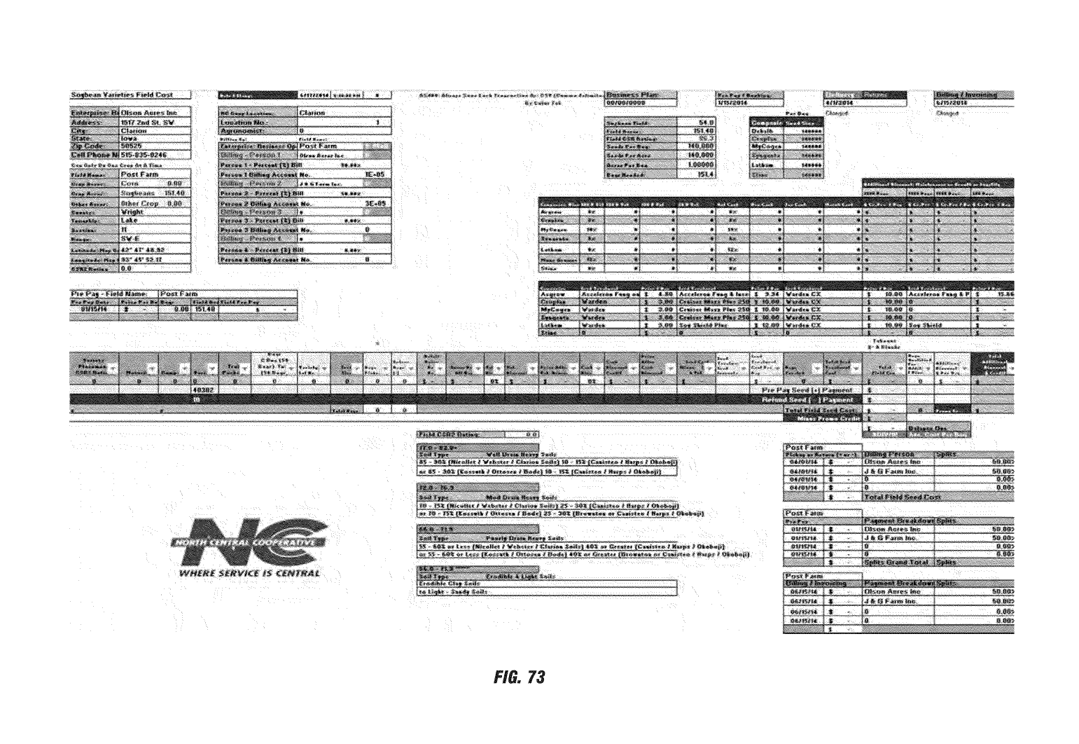

FIG. 72 illustrate an example of a worksheet for corn hybrids.

FIG. 73 illustrate an example of worksheet for soybean varieties.

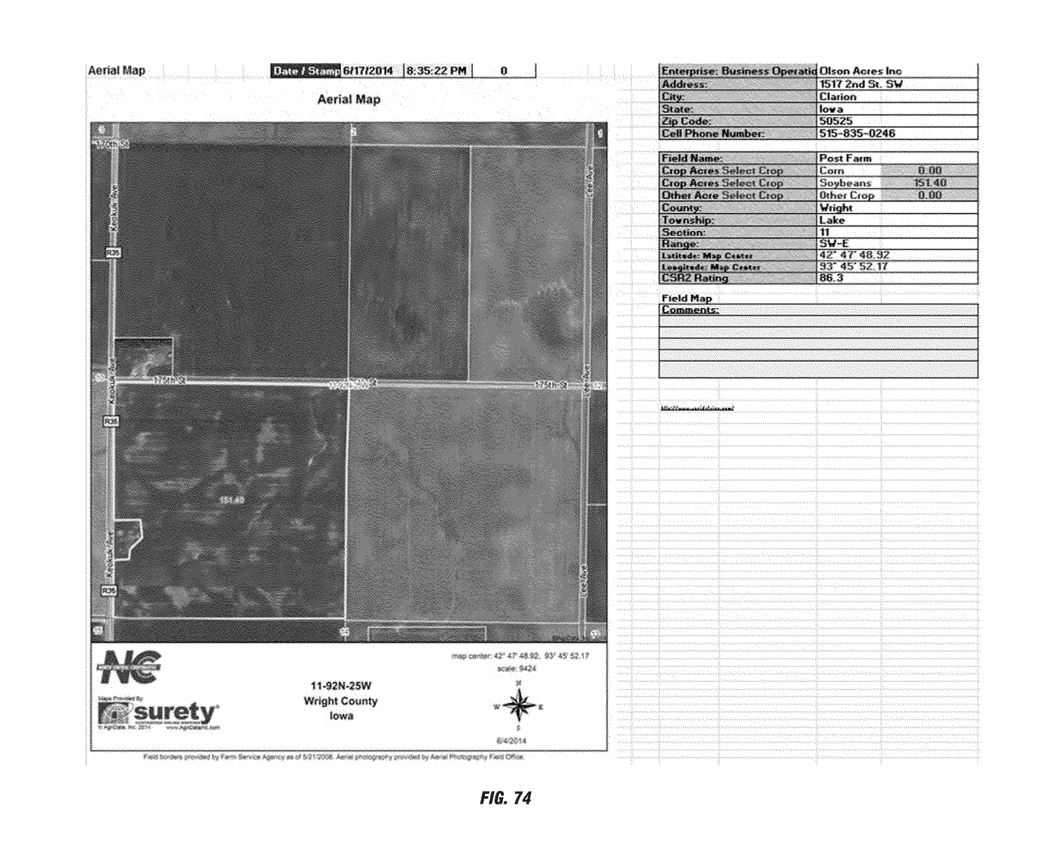

FIG. 74 illustrates a worksheet associated with a field map.

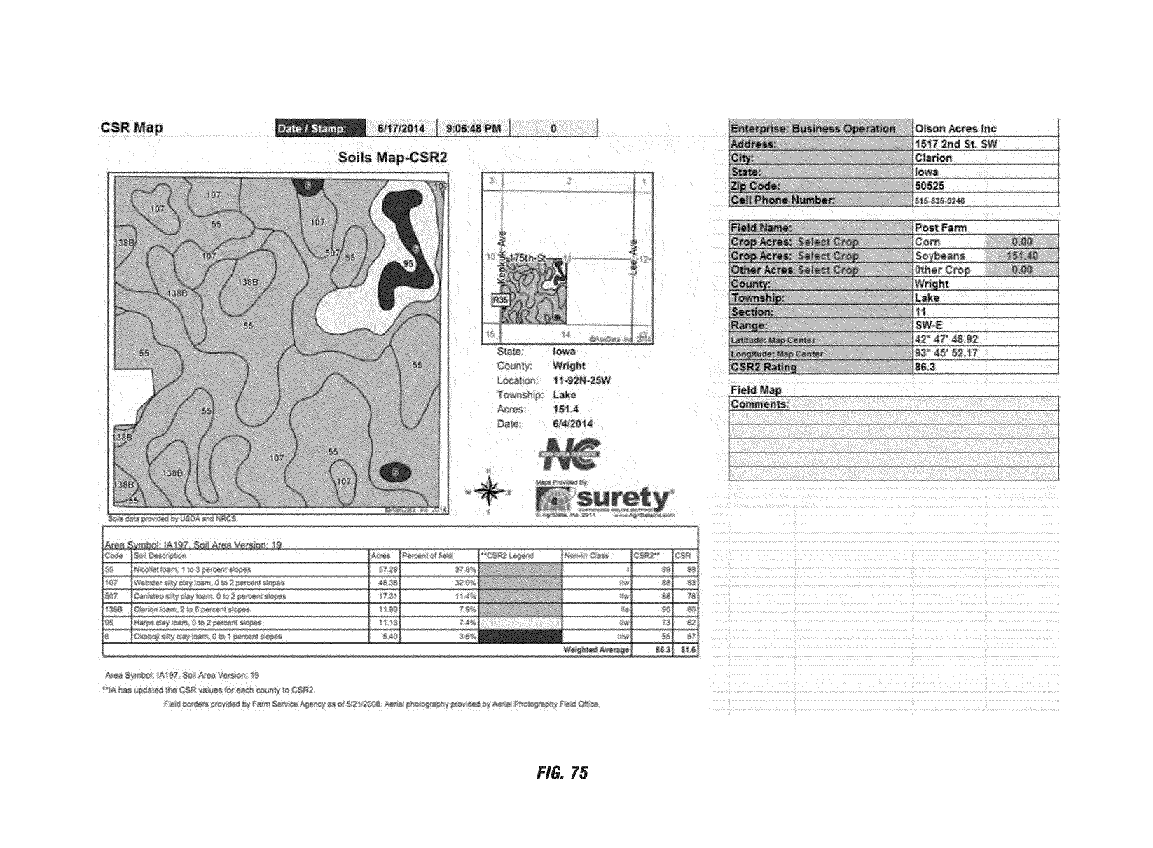

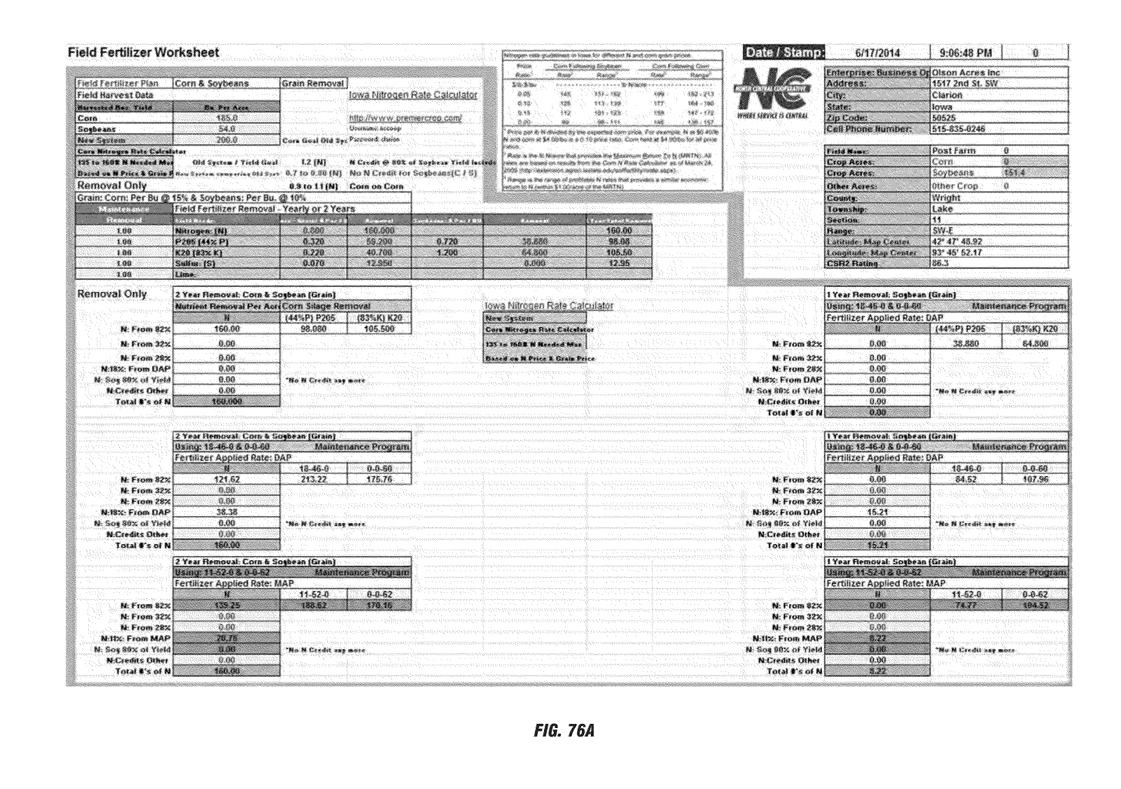

FIG. 75 illustrates a worksheet associated with a soil map.

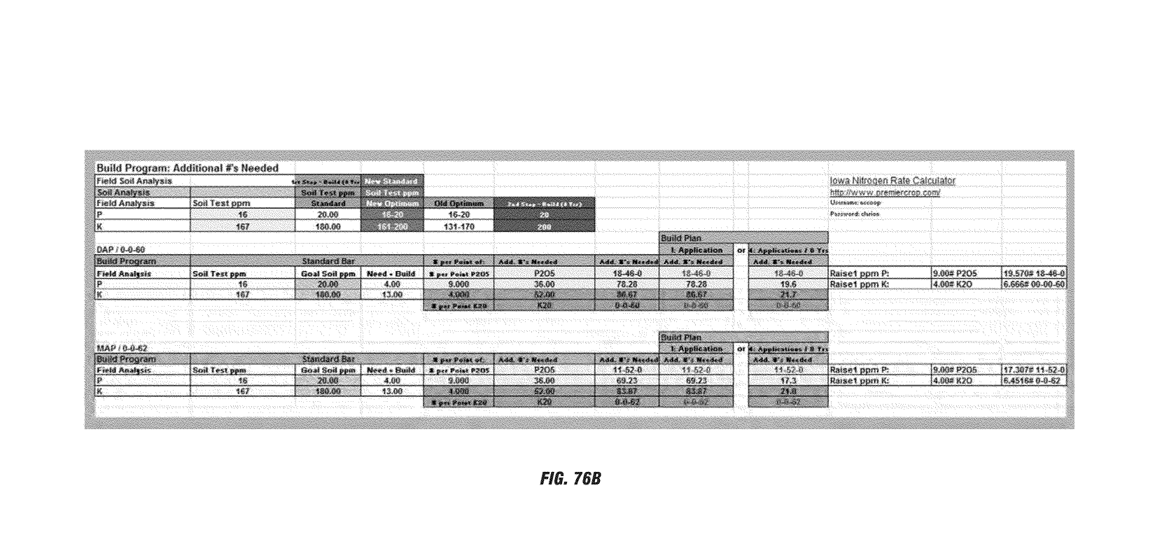

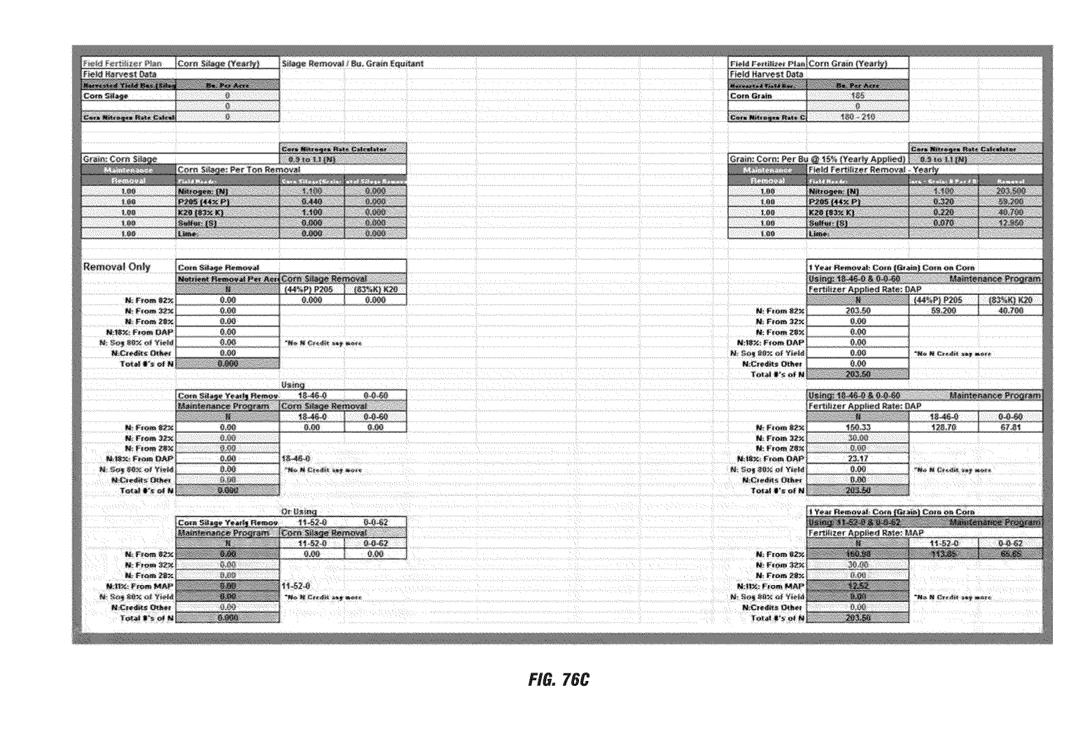

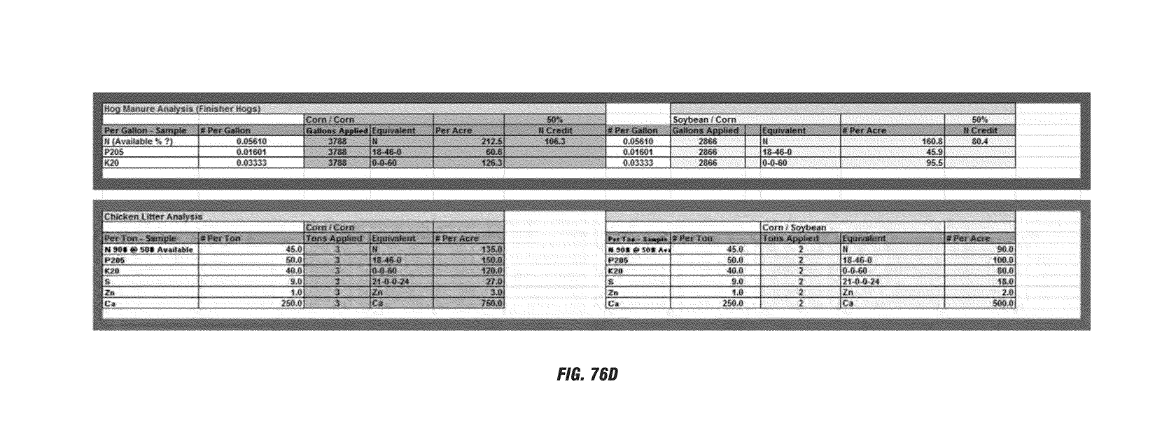

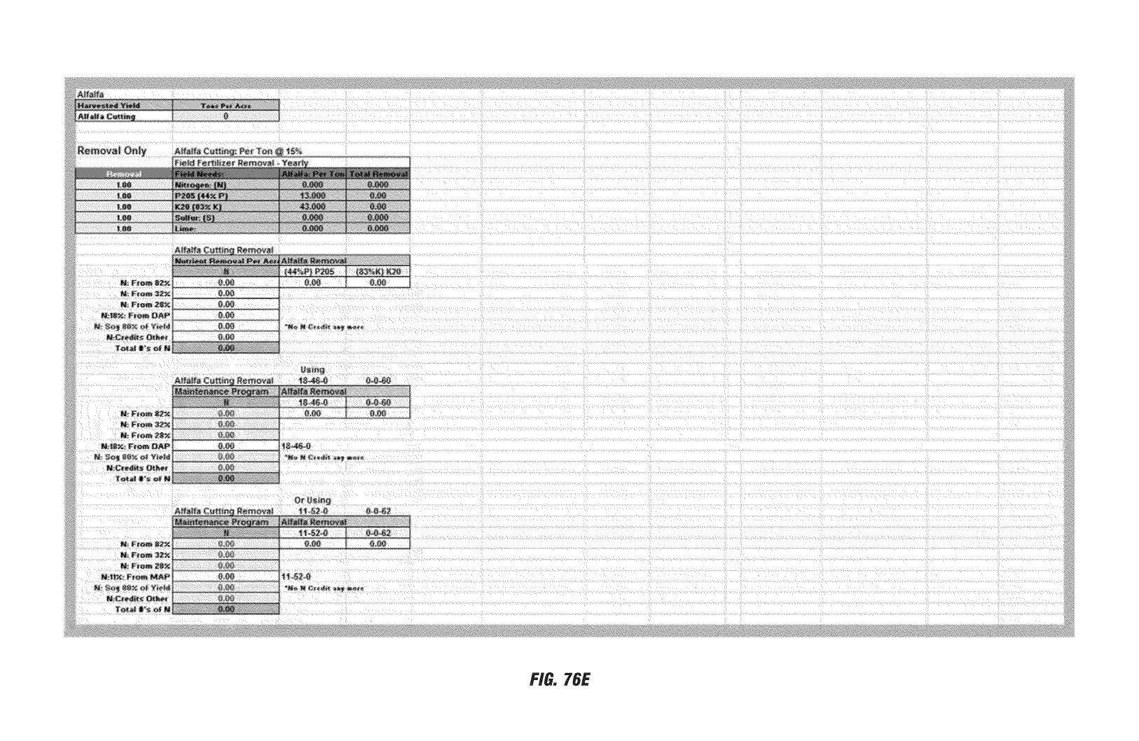

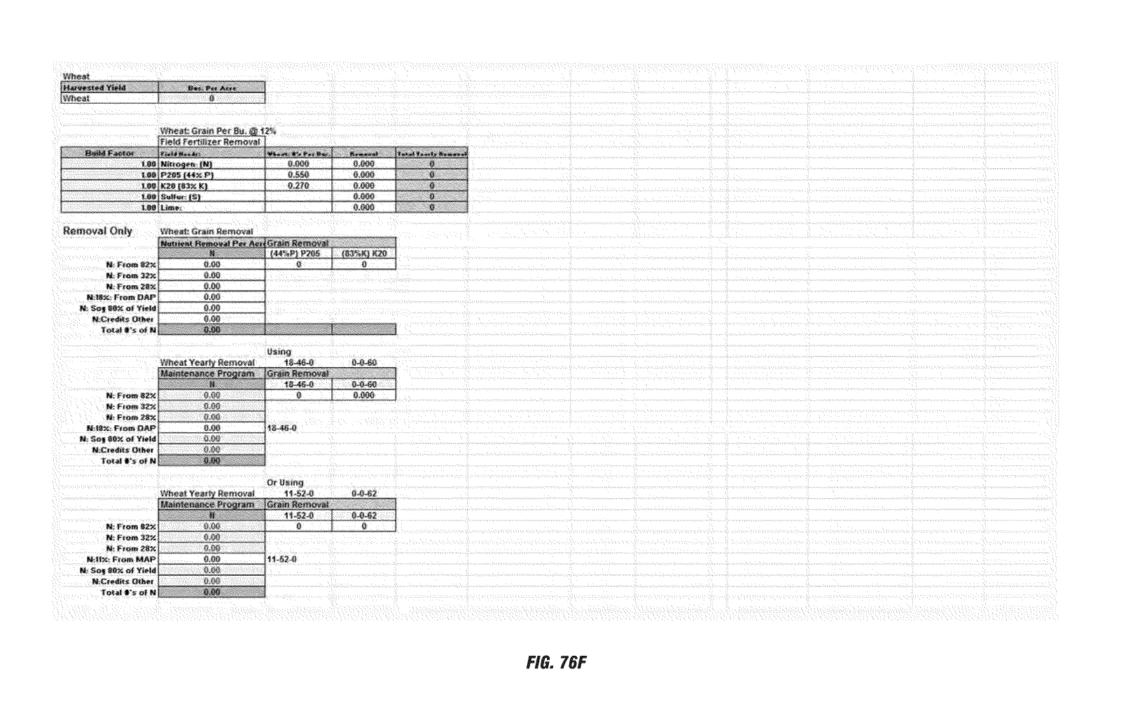

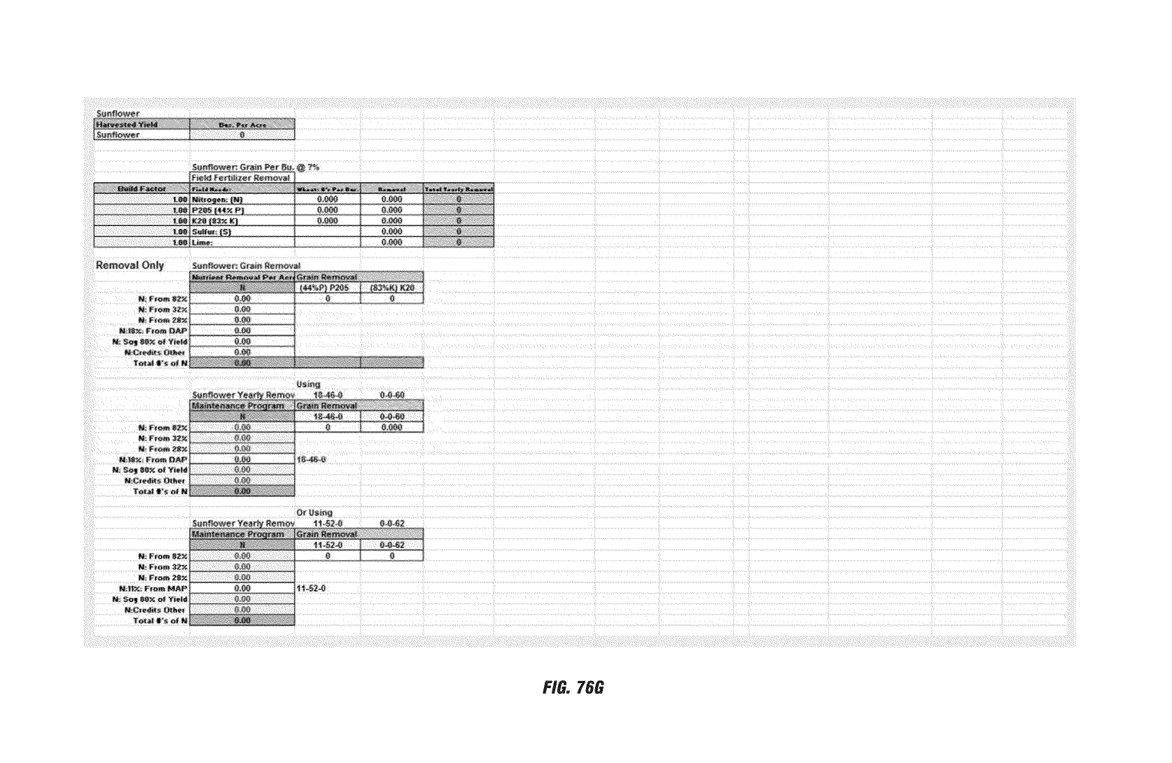

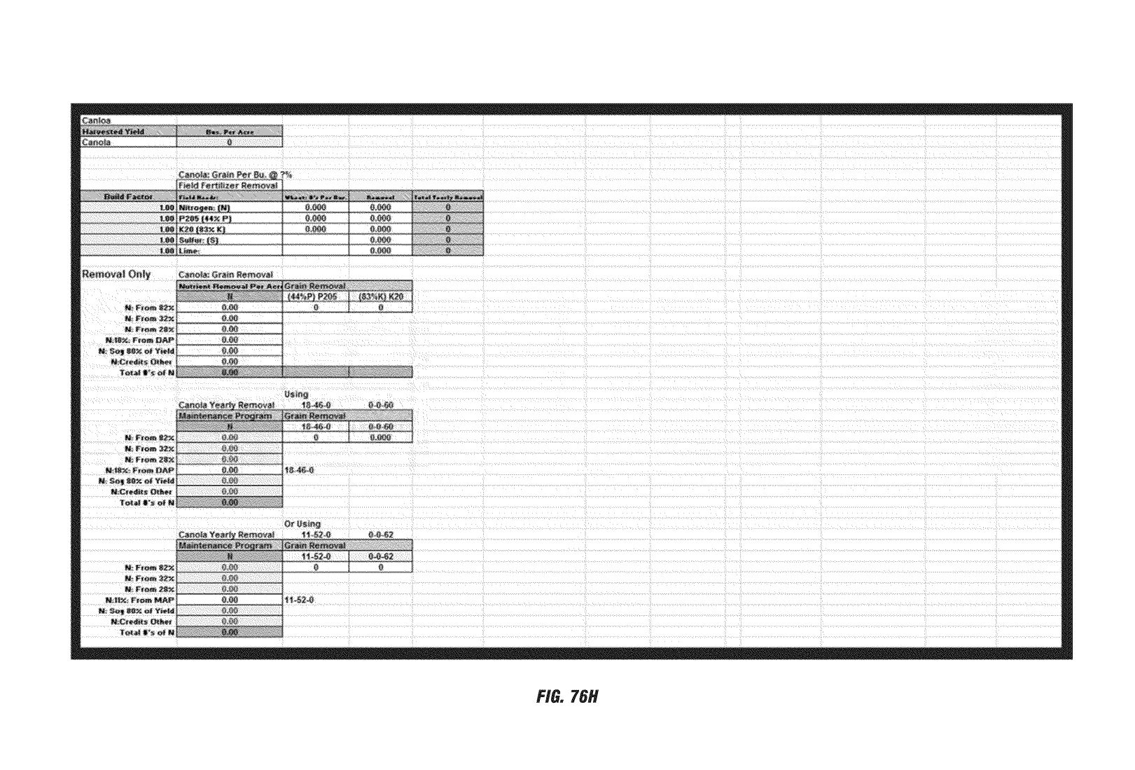

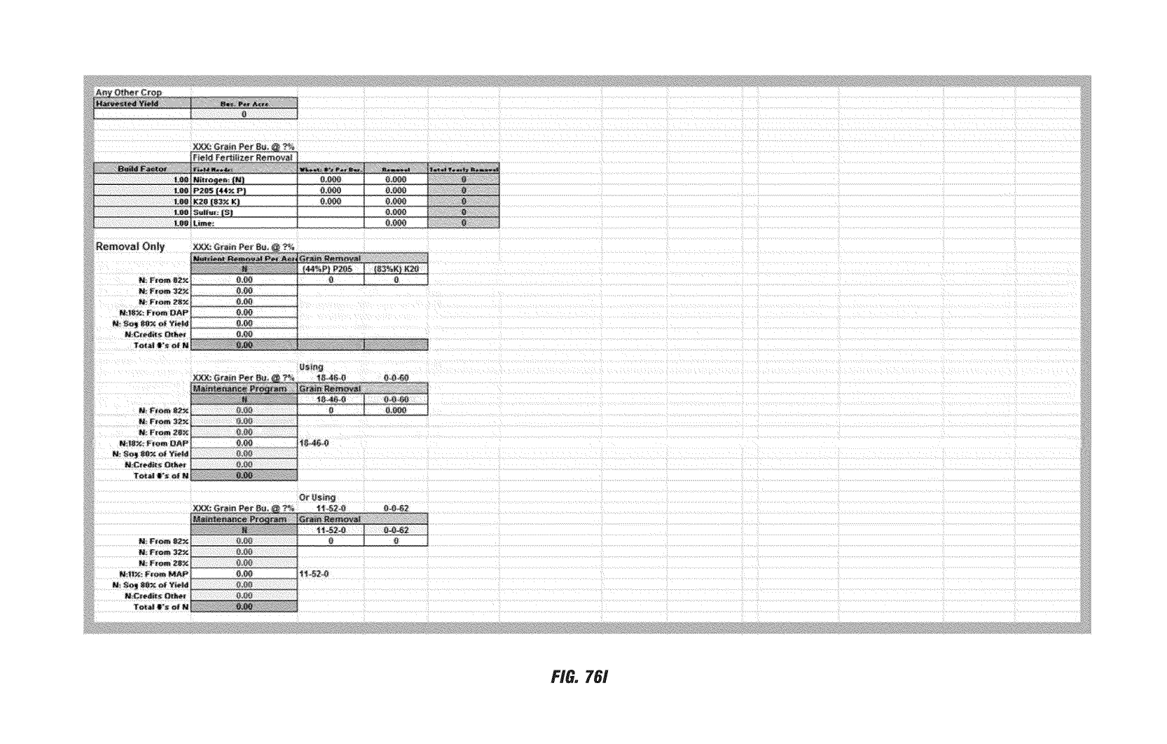

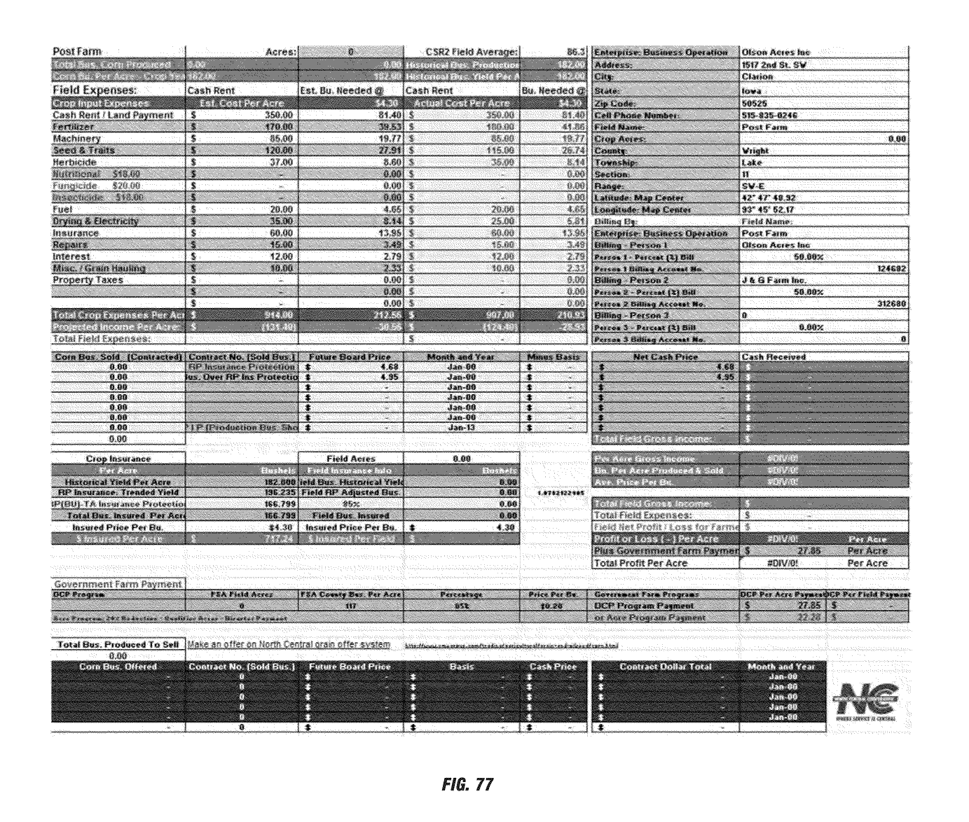

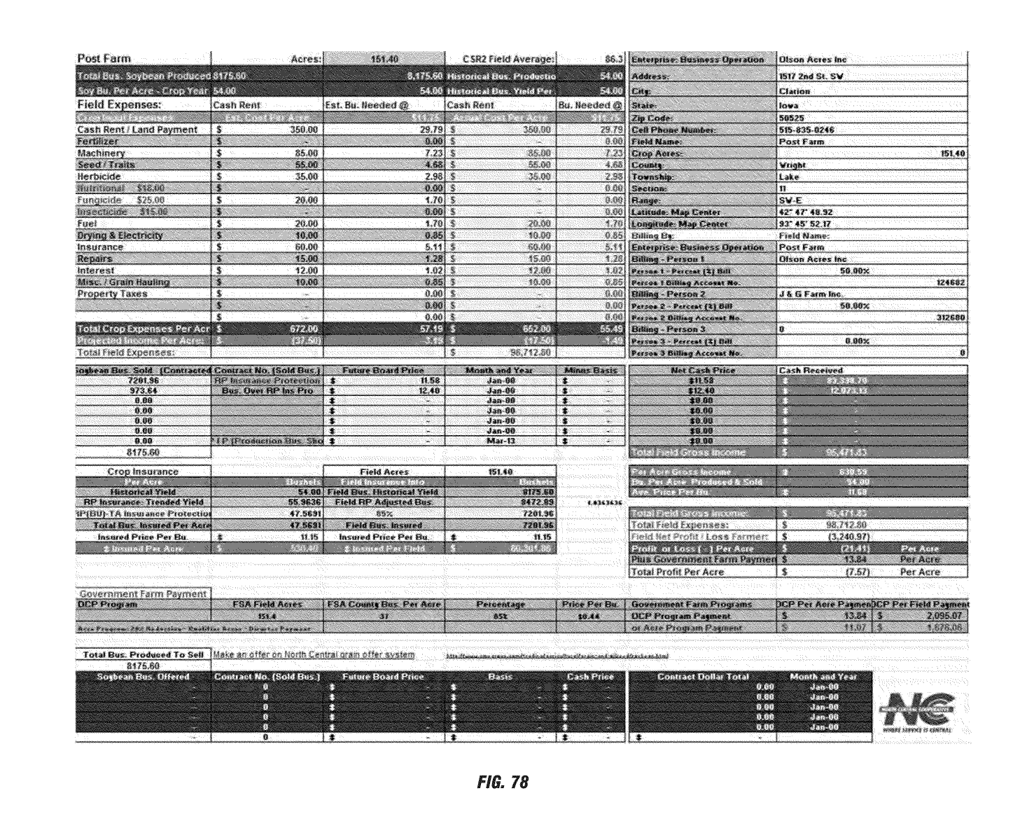

FIGS. 76A-76I illustrate a worksheet for fertilizer cost.

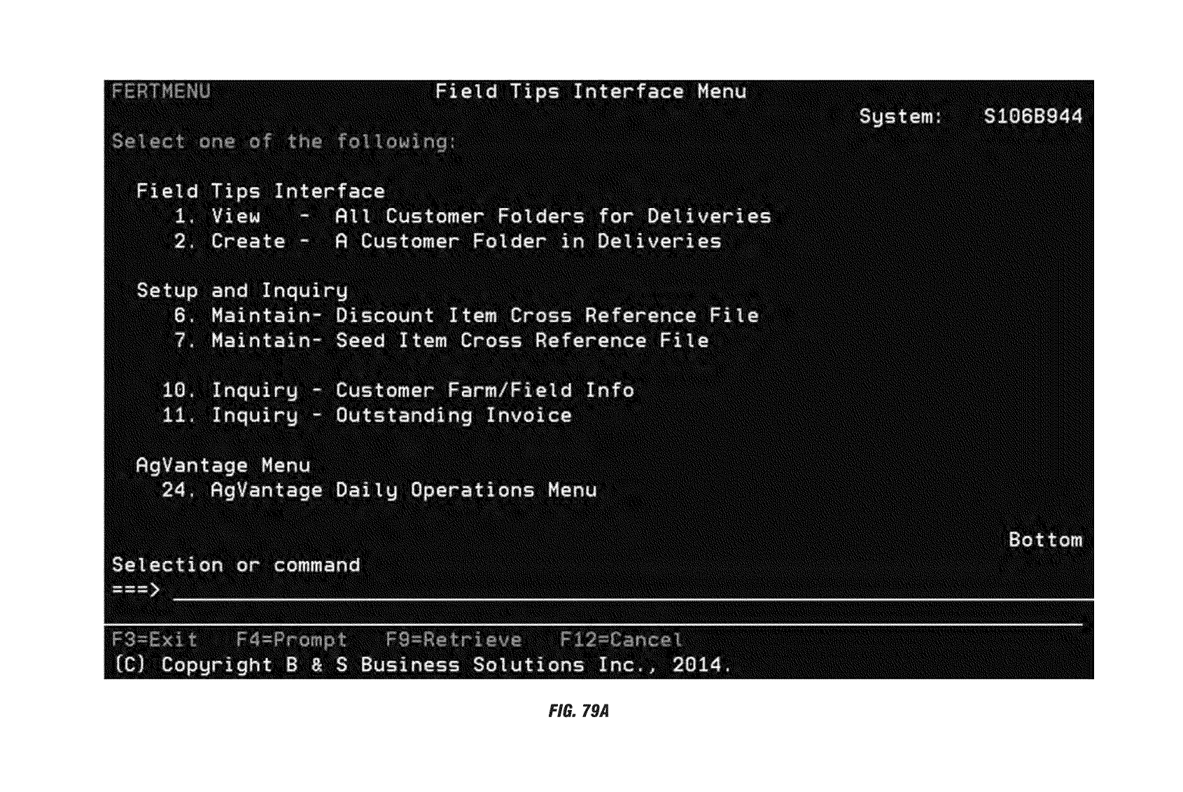

FIG. 78 illustrates another example of a worksheet.

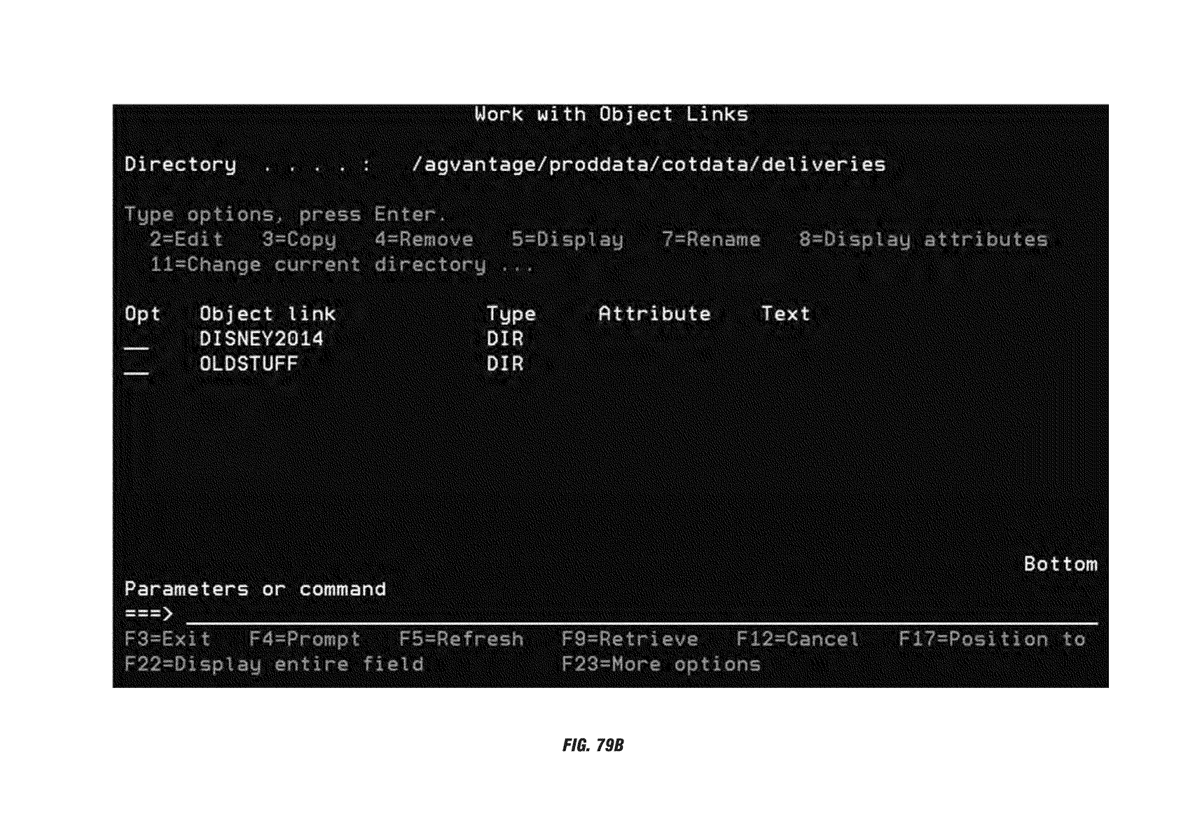

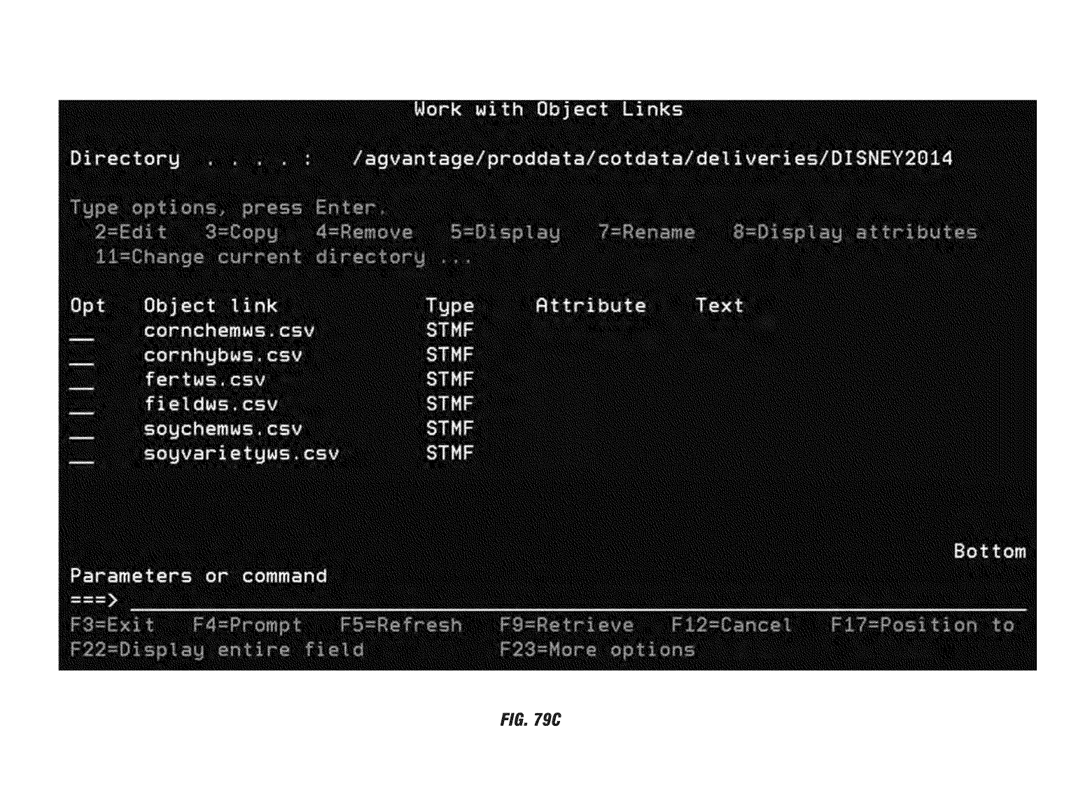

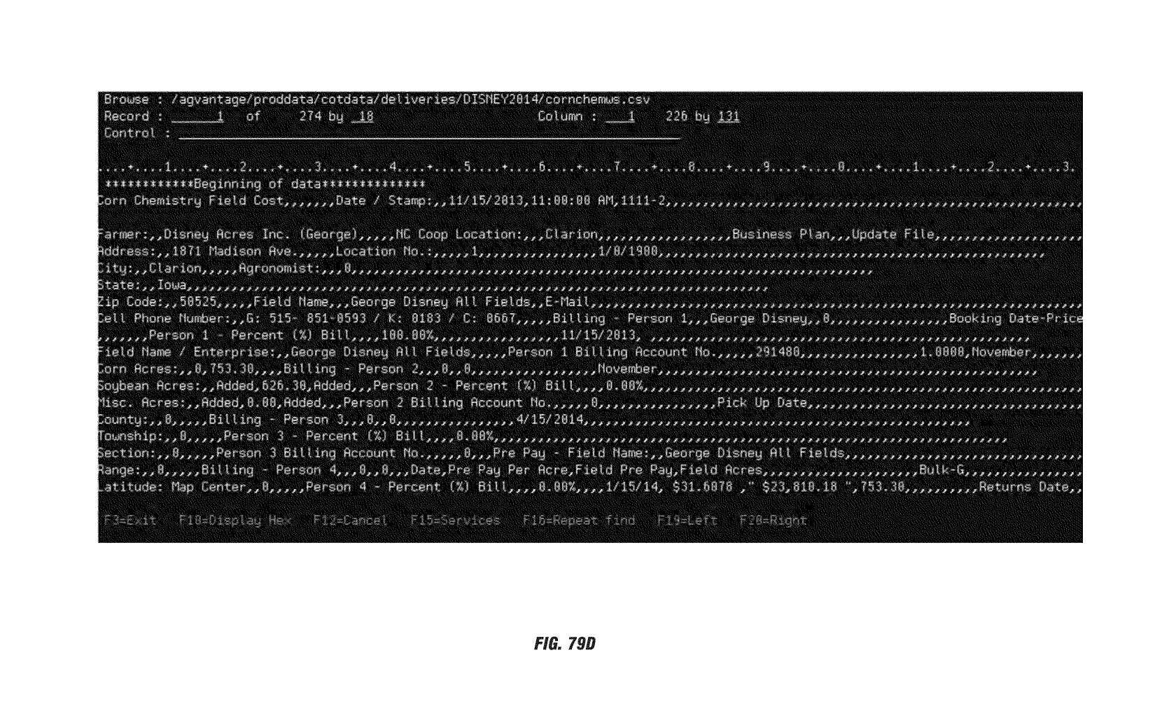

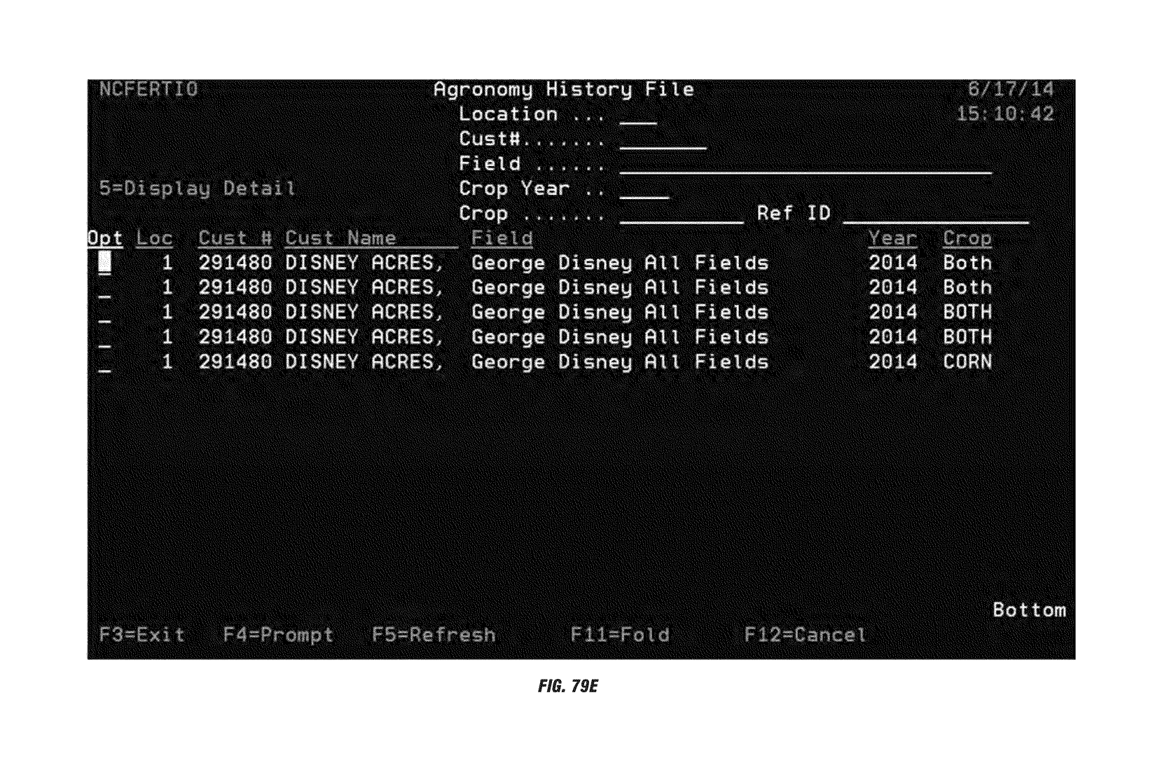

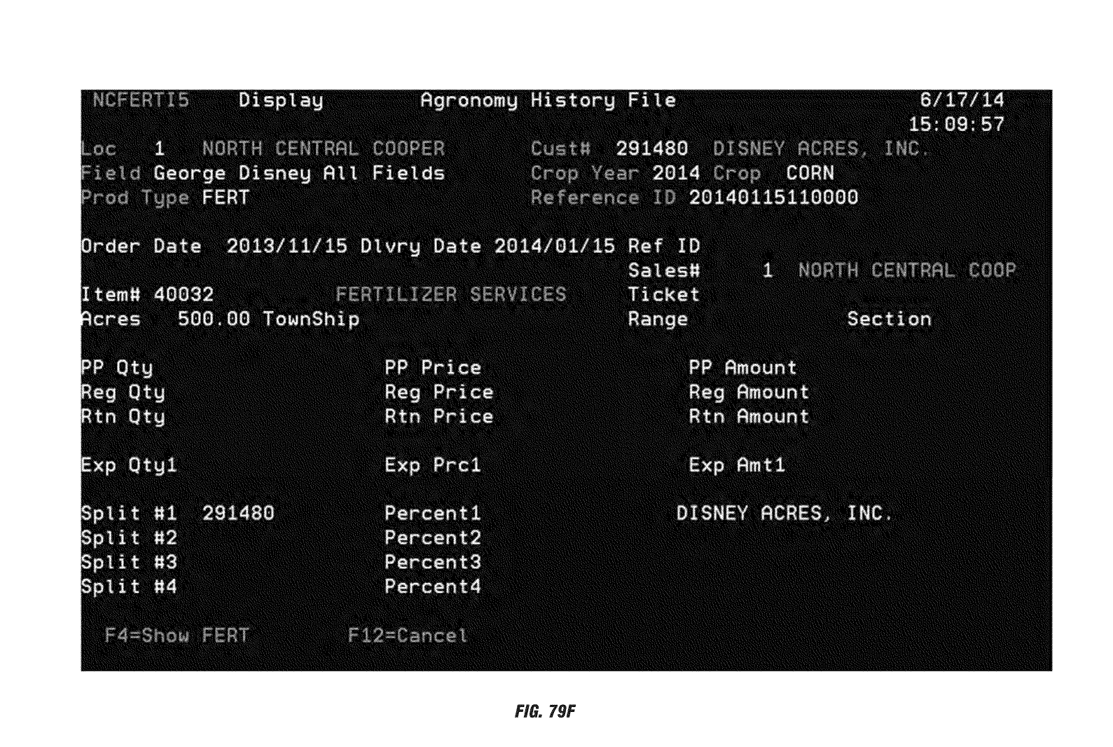

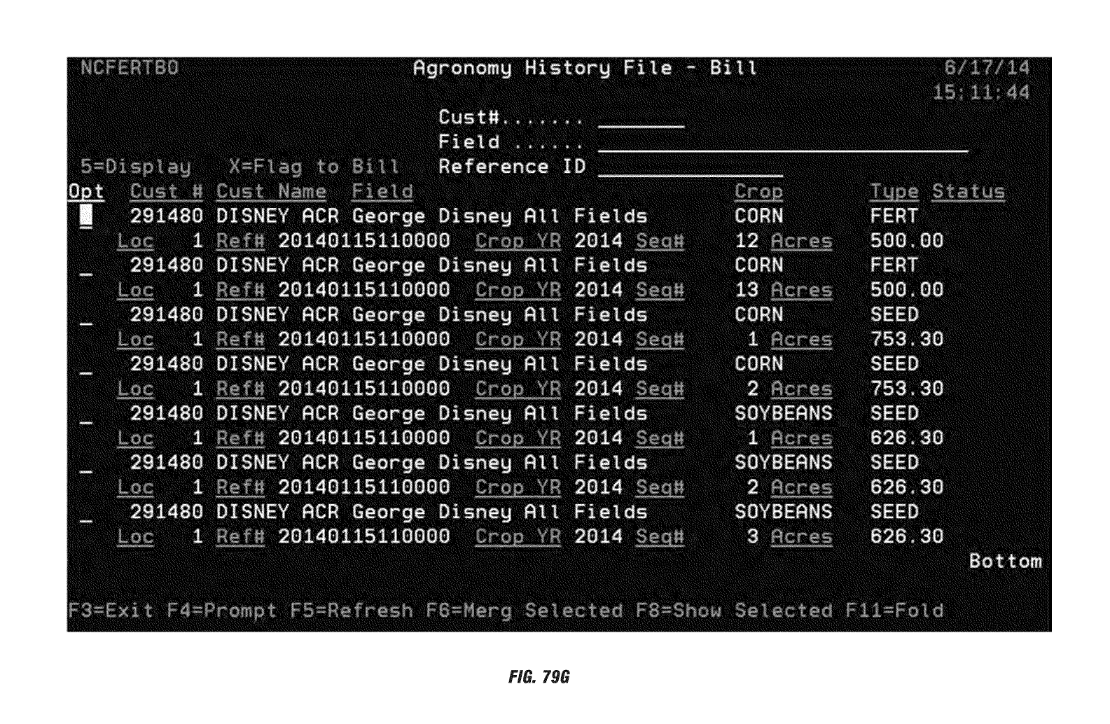

FIGS. 79A-79G illustrate server data associated with a backend system.

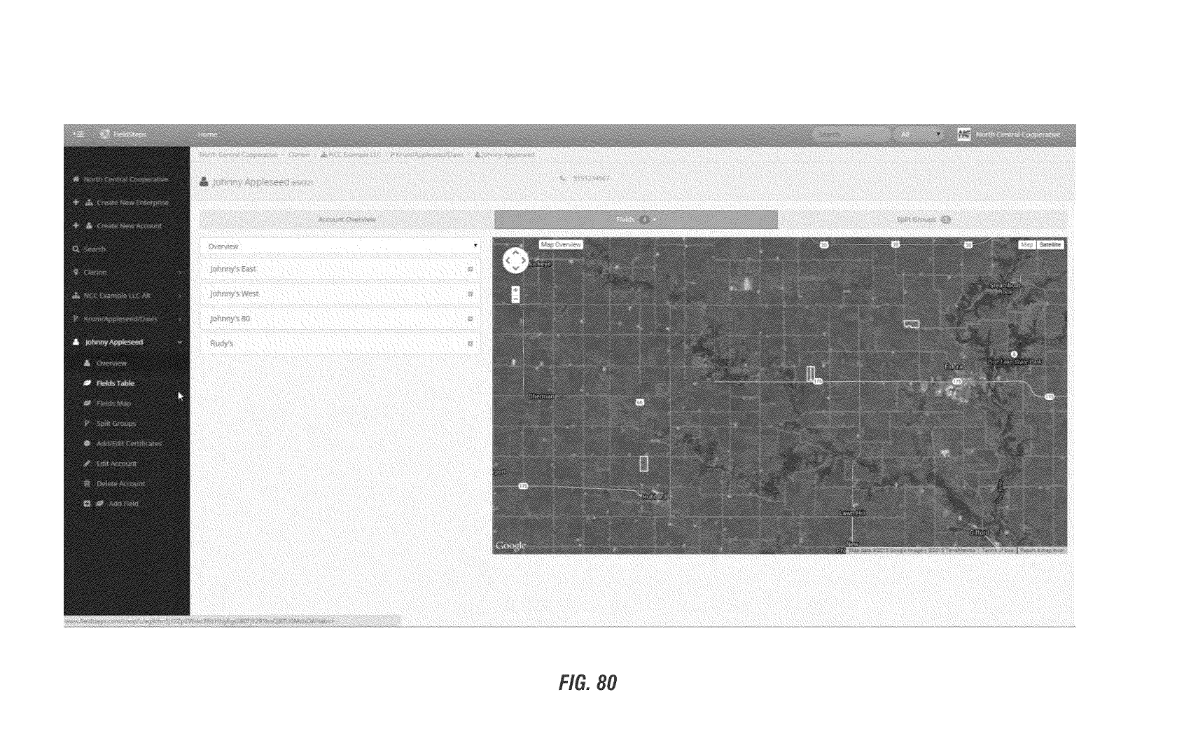

FIG. 80 through FIG. 117 illustrate another example of a system which is a web-based system. Various users may access the system using an appropriate user name and password. It is further contemplated that different users may be assigned different levels of access. For example, users from a coop may be able to enter new products and set prices whereas a producer does not have that functionality. Moreover, both users from a coop and crop producers may have access rights which allow them to update field information, add or delete fields, select seed products or chemistry, or other functions. It is also contemplated that the system can track which users make which changes and when.

FIG. 80 is a screen display illustrating an account fields map view. Note that for a particular account, all fields are listed by the names that a crop producer typically gives to the fields. Note that this has been historically been a difficult issue as crop producers prefer to name their fields as opposed to using legal descriptions or geospatial coordinates. Moreover, crop producers may re-name their fields. This can create confusion when field information is conveyed to others by field name. For the particular account selected, each of the field names is listed and each of the fields are shown on a map. Map data may be acquired from various sources. One example of a map data provider is Google, Inc.

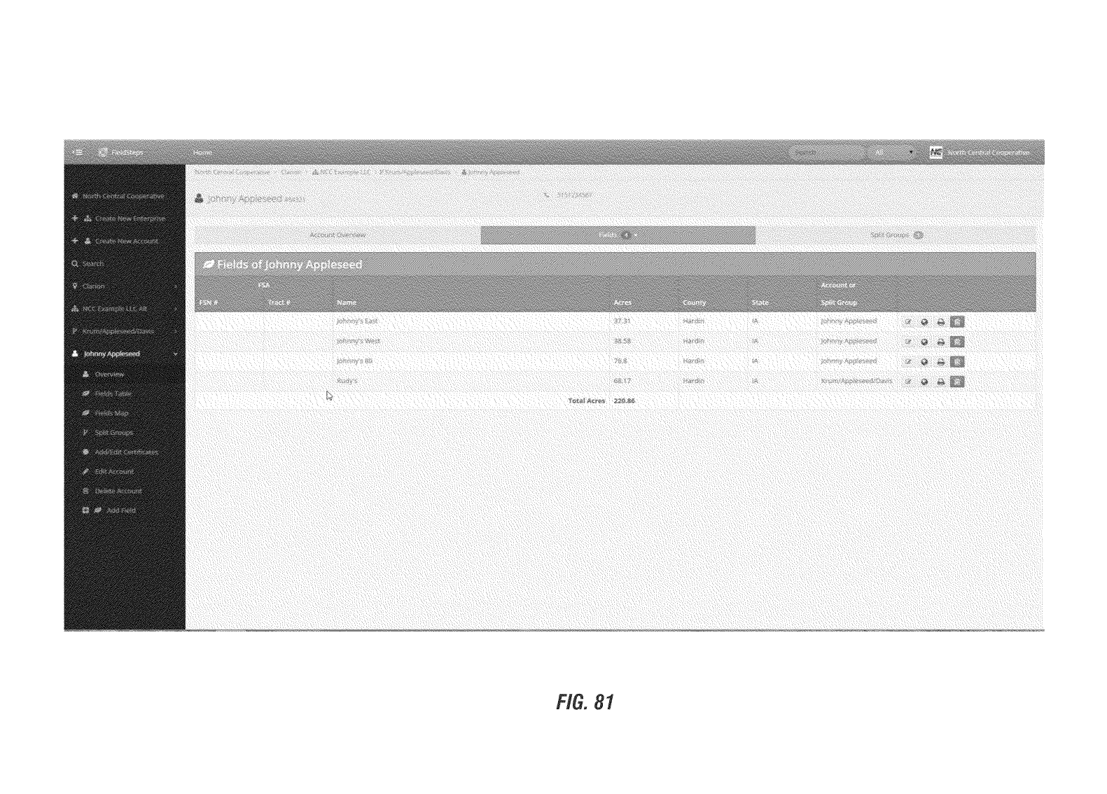

FIG. 81 is a screen display illustrating an account fields table. Here the name of each field associated with an account is given as well as additional information such as the FSA Farm Serial Number (FSN), the track number, the name of the field (as given by the crop producer or account holder), the number of acres of the filed, the county in which the field is located, and the state in which the field is located. Of course, other geopolitical identifiers may be used. The account or split group is also given. The total number of acres (summed across all fields in the account) may be also be given.

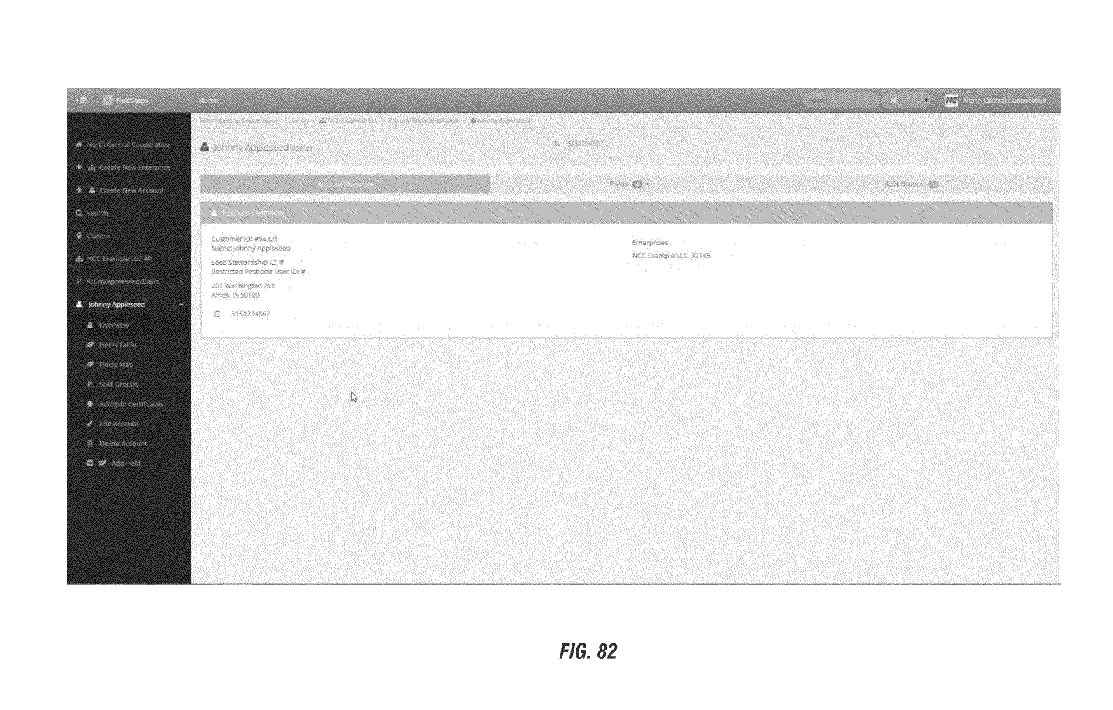

FIG. 82 is a screen display illustrating an account home screen. Information about the account may include the name of the account, the number of the account, a seed stewardship identification number, a restricted pesticide use identification number, an address, a phone number, and the name of an enterprise associated with the account.

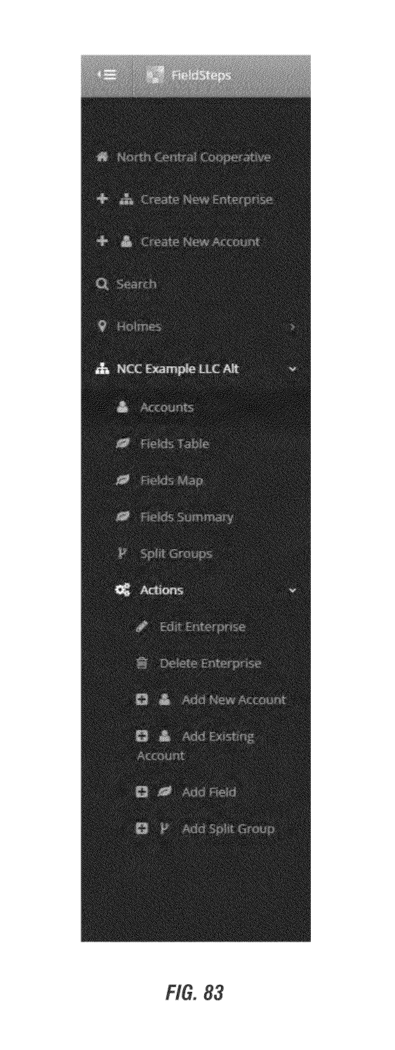

FIG. 83 is a screen display illustrating an actions list. The actions list may include the ability to create a new enterprise, create a new account, search, or for an existing enterprise, show the accounts associated with an enterprise, a table of fields associated with the enterprise, a map of the fields, a summary of the fields, a listing of split groups associated with the enterprise, and actions associated with the enterprise. These actions may include editing the enterprise, deleting the enterprise, adding a new account adding an existing account, adding a field, and adding a split group.

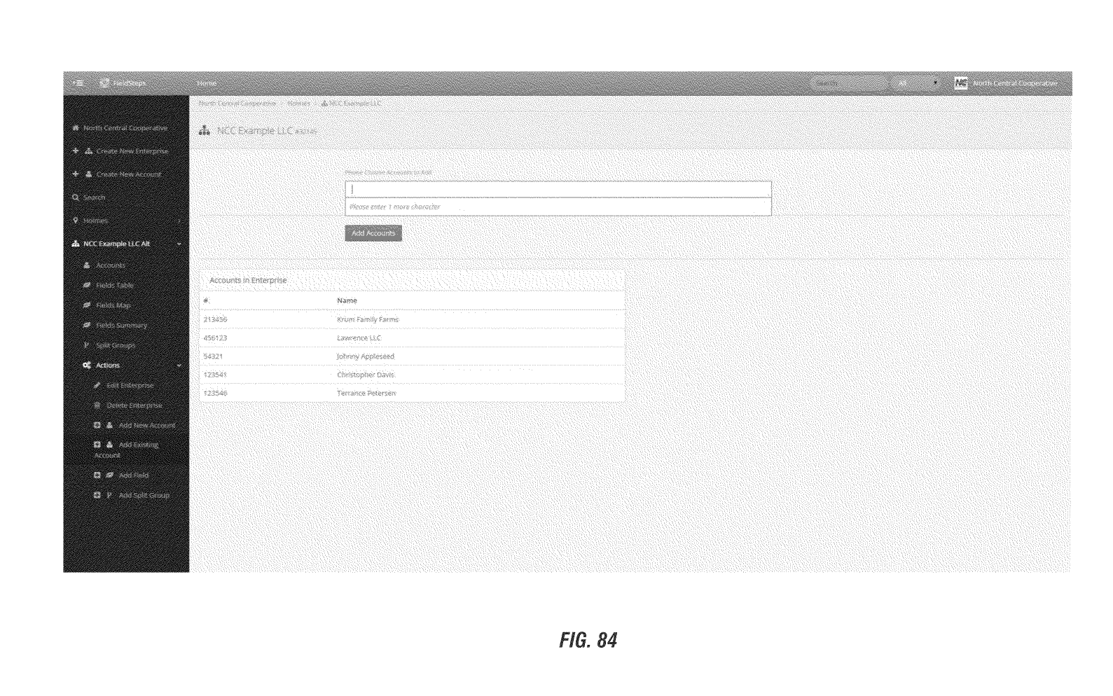

FIG. 84 is a screen display illustrating an add existing account page. A user may select an account to add to an existing enterprise. Accounts already associated with the enterprise are also shown.

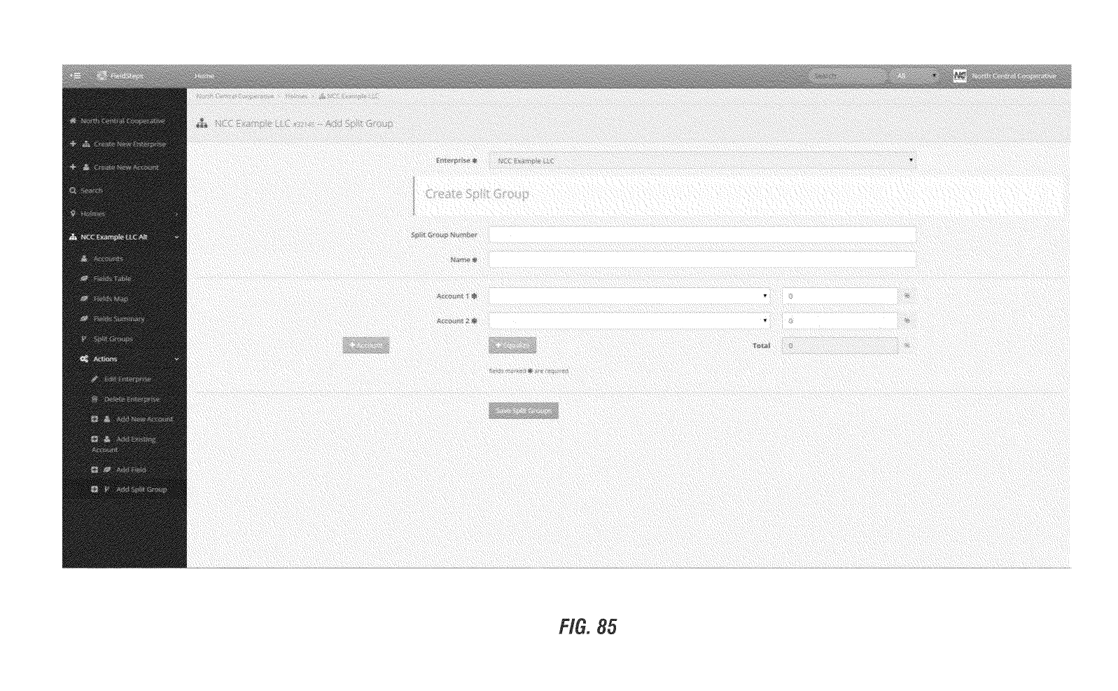

FIG. 85 is a screen display illustrating an add split group page. The name of the enterprise is shown along with information for creating a new split group. A split group number may be assigned as well as a name for the split group and two or more accounts associated with the split group. The percentage each account should be charged is also shown.

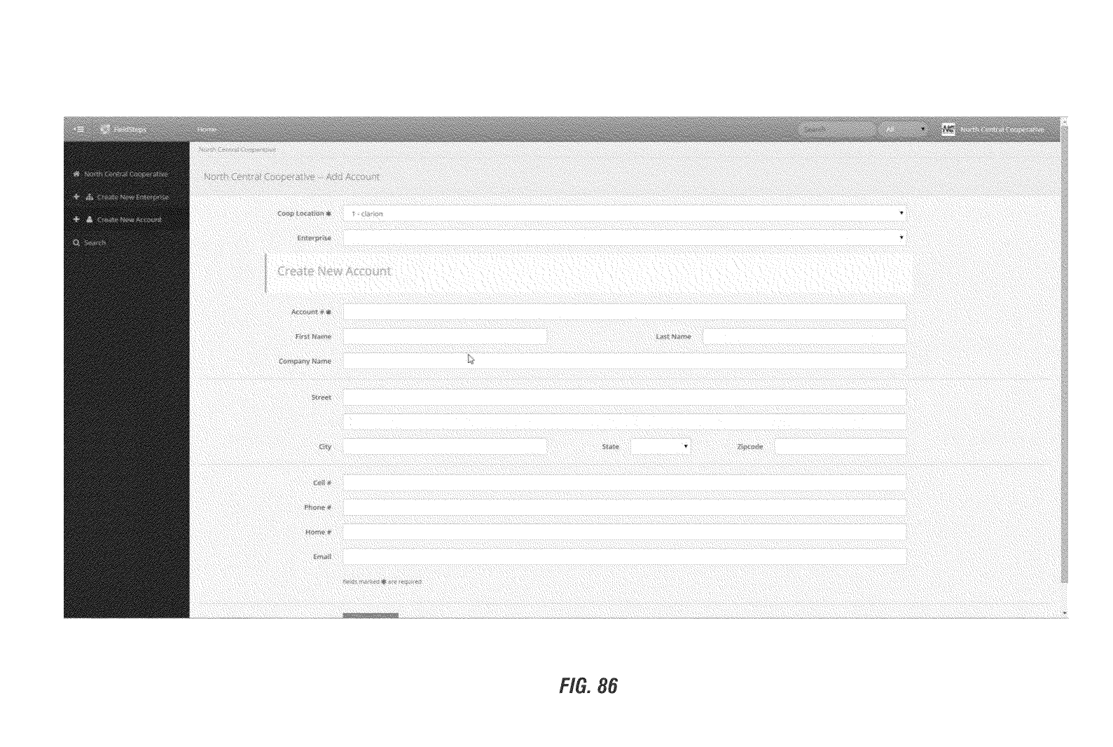

FIG. 86 is a screen display illustrating a create new account page. Information about the account may specified such as the location of a coop associated with the account, an enterprise associated with the account, an account number, a first name and a last name of an individual associated with the account, a company name, a street address, a city, state, and zip code, a cell phone number, a phone number, a home phone number, and an email address. It is contemplated that not every field need be required and that only a subset of fields need be required in order to add an account.

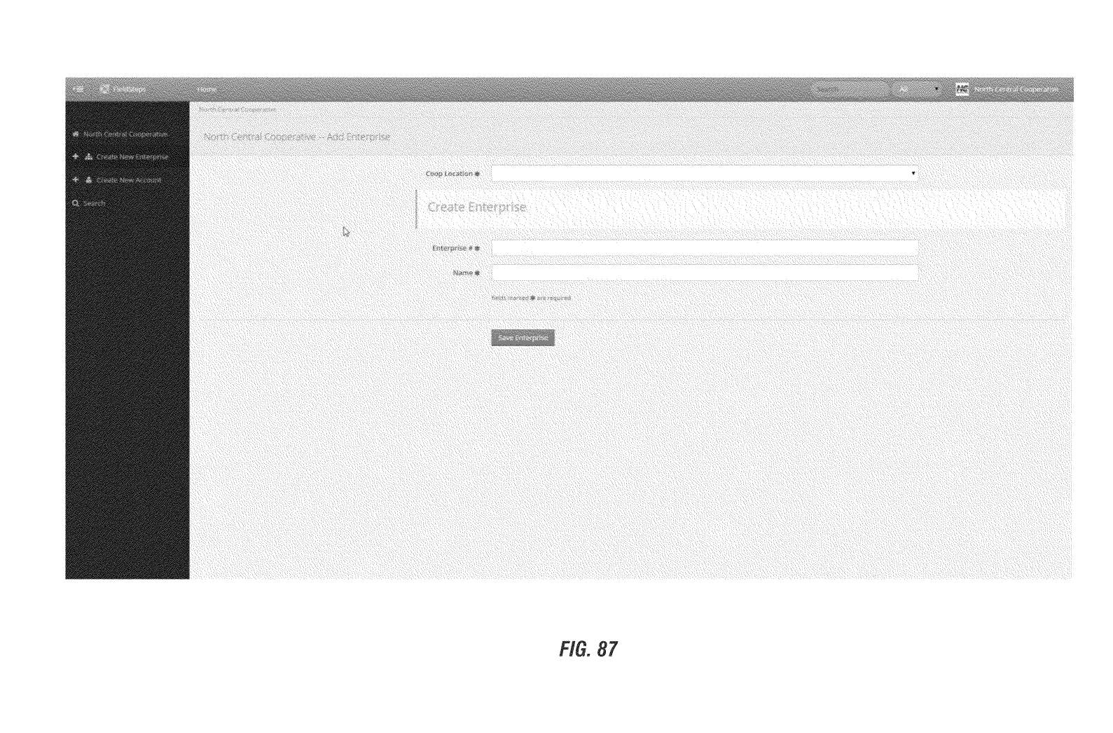

FIG. 87 is a screen display illustrating a create new enterprise page. Information for the new enterprise may be specified such as a location for a coop associated with the enterprise, an enterprise number, and an enterprise name.

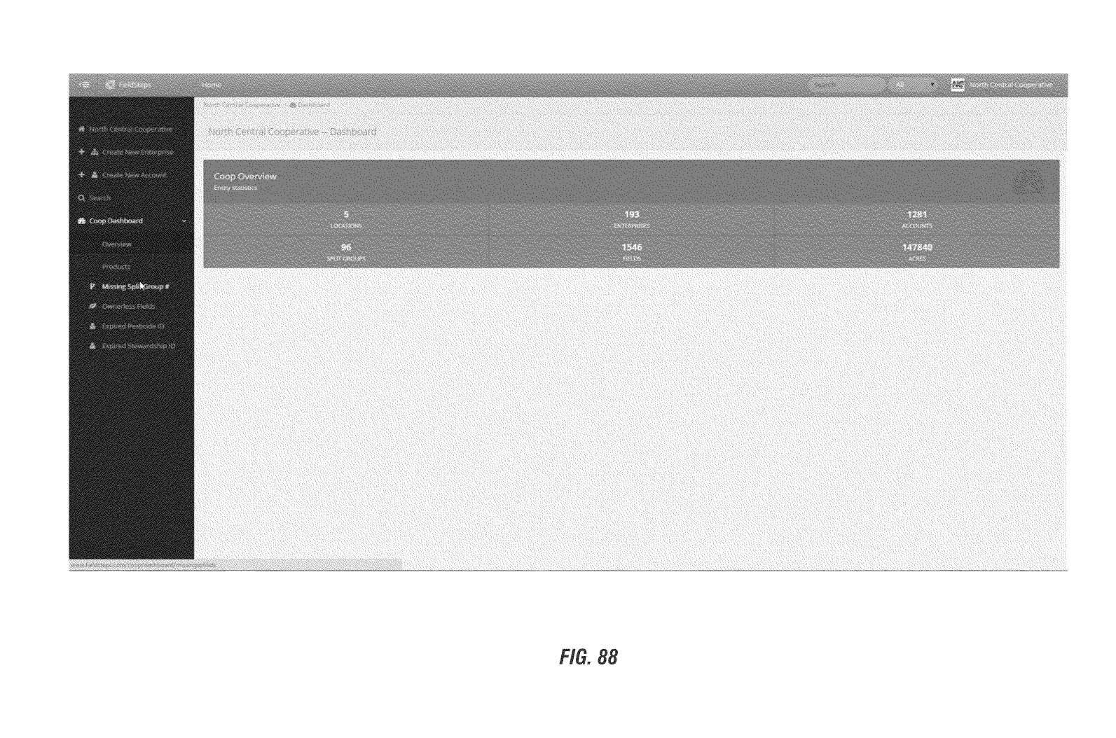

FIG. 88 is a screen display illustrating a dashboard page. For a coop information on the dashboard page includes the number of locations for the coop, the number of enterprises served by the coop, the number of accounts services by the coop, the number of split groups serviced by the coop, the number of fields serviced by the coop, and the total number of acres serviced by the coop.

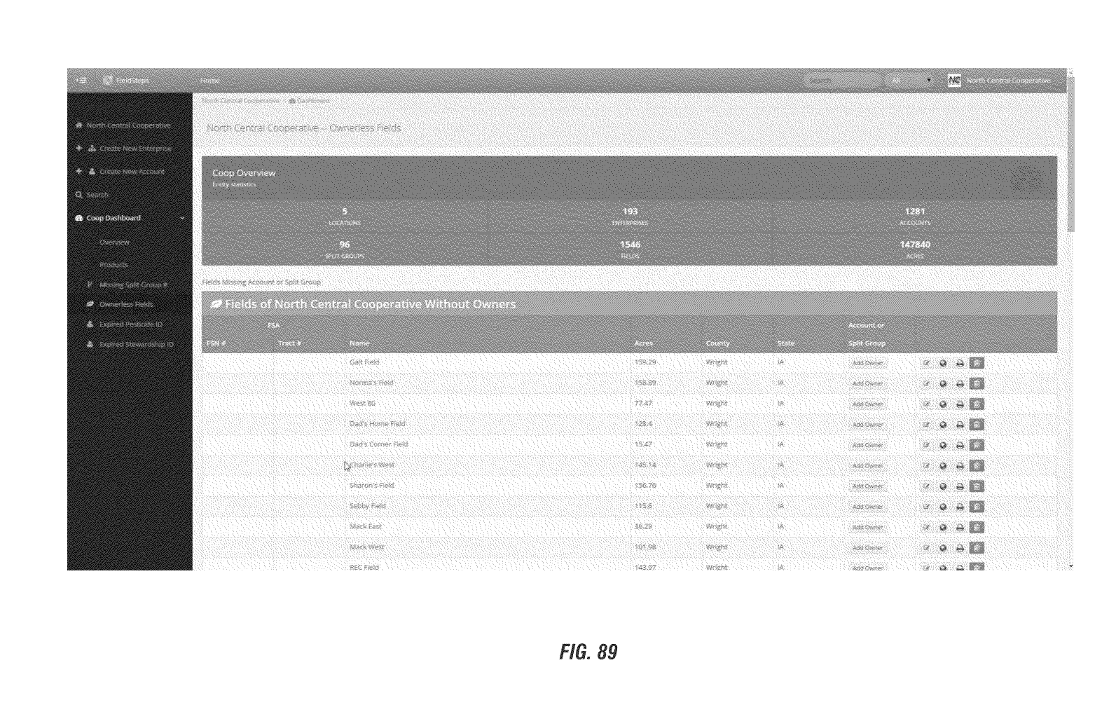

FIG. 89 is a screen display illustrating a dashboard ownerless fields page. This page identifies fields associated with a coop which do not have an owner associated with them. From this page a user can select to add an owner to one of the ownerless fields.

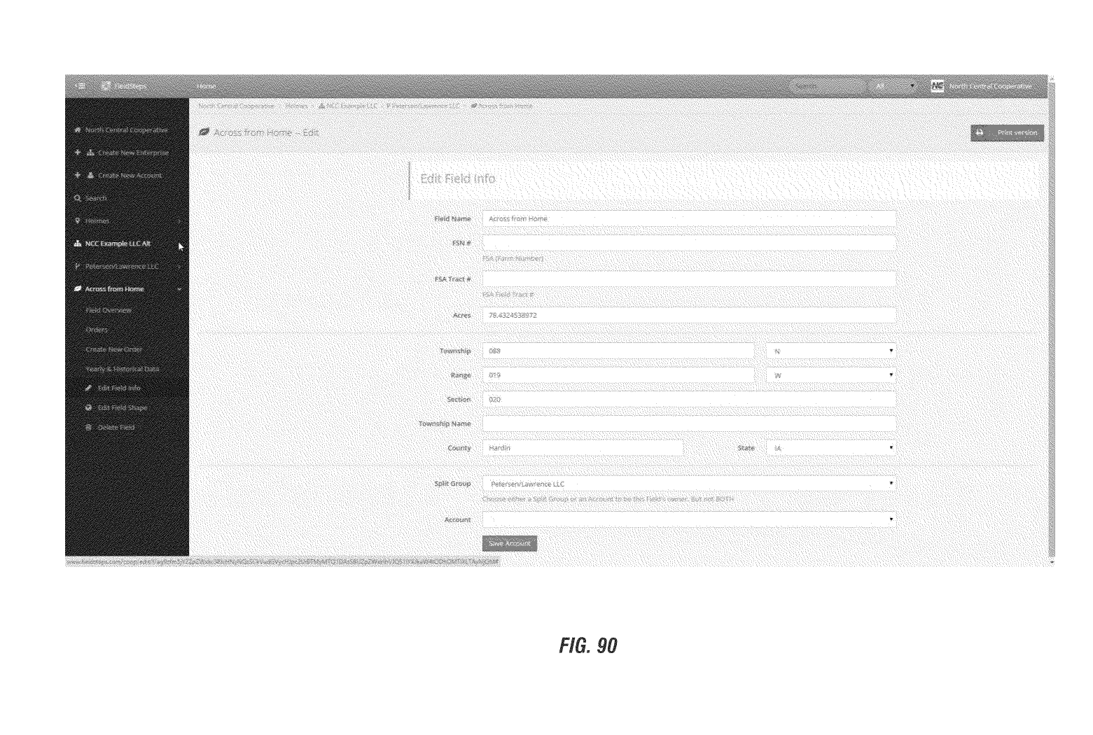

FIG. 90 is a screen display illustrating an edit field info page. This page allows a user to edit field information such as filed name FSN, FSA Tract number, the number of acres, the township, range, and section, the township name, the county, the state, the split group, and the account.

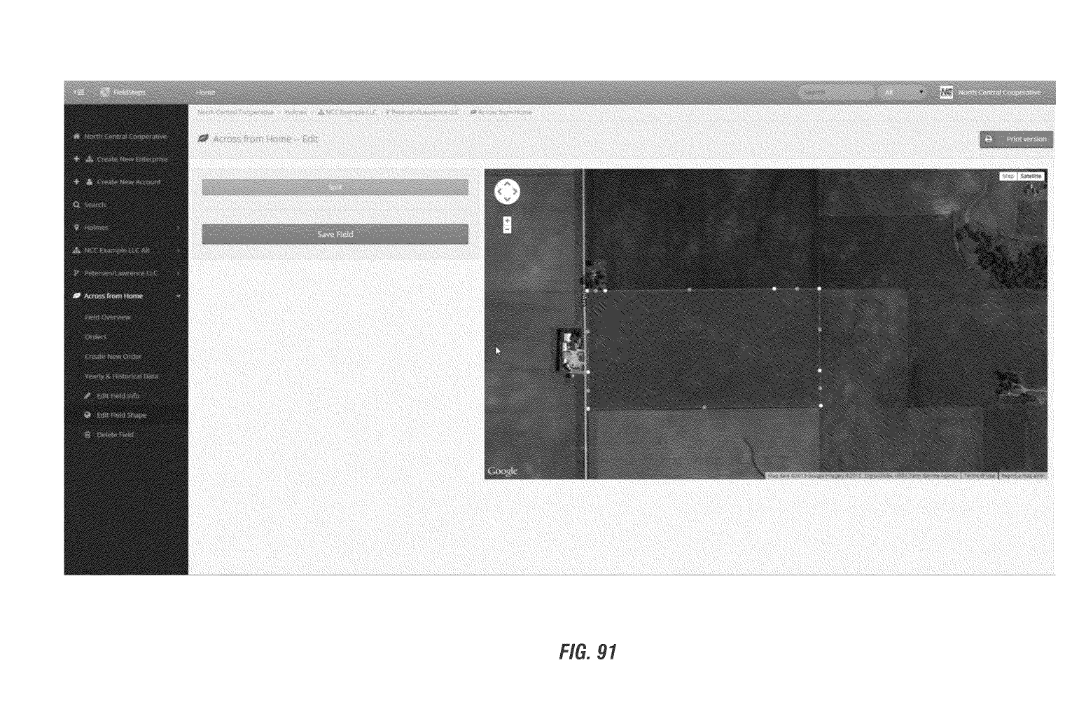

FIG. 91 is a screen display illustrating an edit field info page. This page allows a user to edit the boundaries associated with a field, to split the field, or save the field.

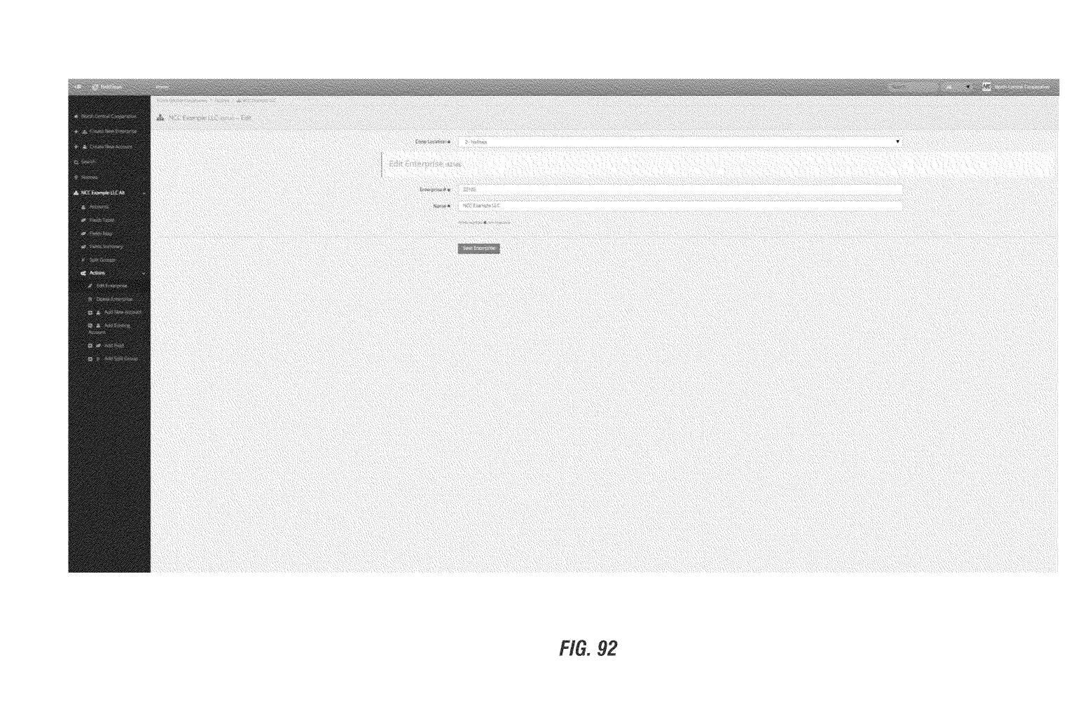

FIG. 92 is a screen display illustrating an enterprise edit page. This page allows a user to change the coop location, the enterprise name, or the enterprise number.

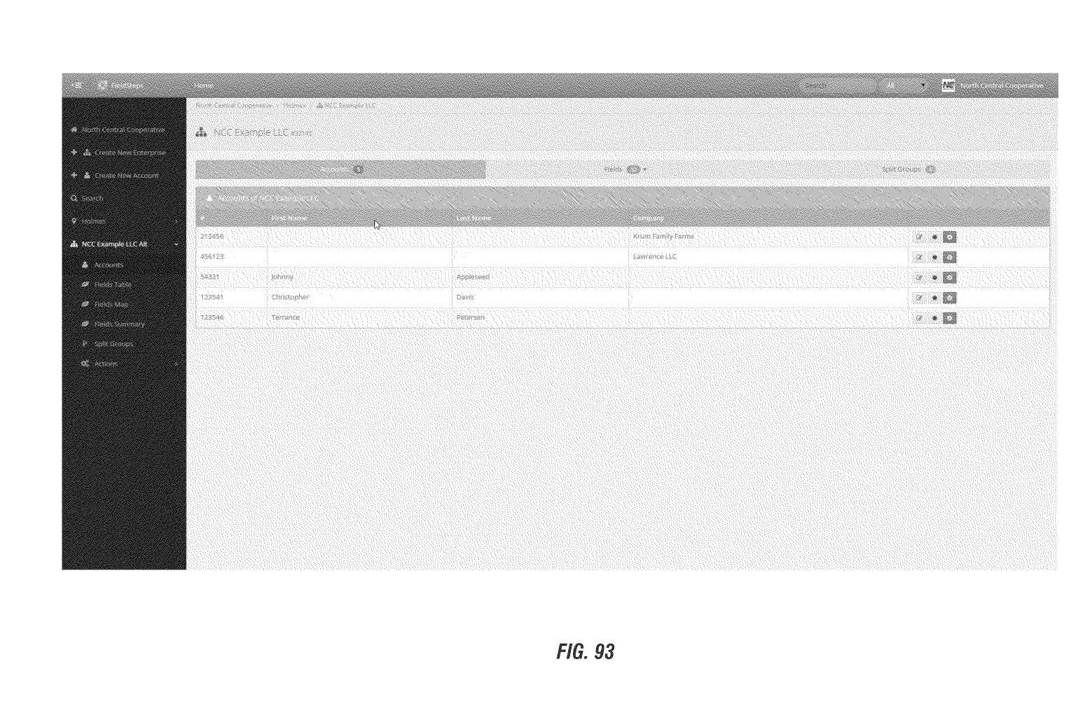

FIG. 93 is a screen display illustrating an enterprise home screen page. This page shows all of the accounts associated with an enterprise, the number of accounts, the number of fields, and the number of split groups associated with the enterprise.

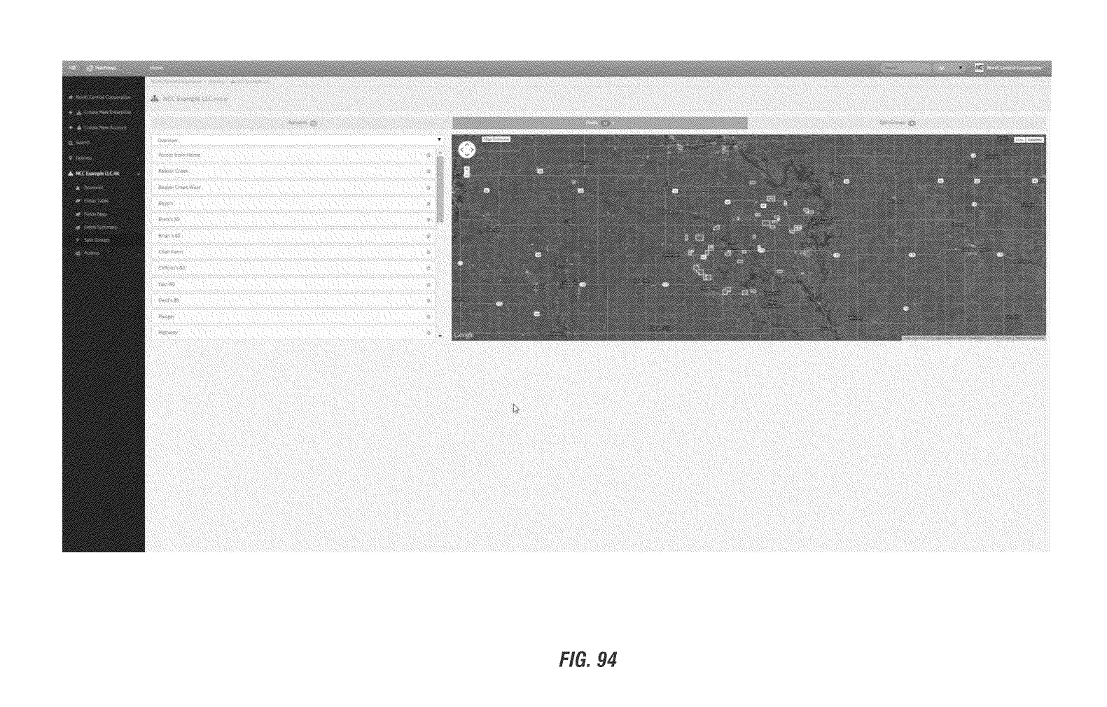

FIG. 94 is a screen display illustrating an enterprise map view page. Note that all of the fields associated with the enterprise are listed and also shown on the map.

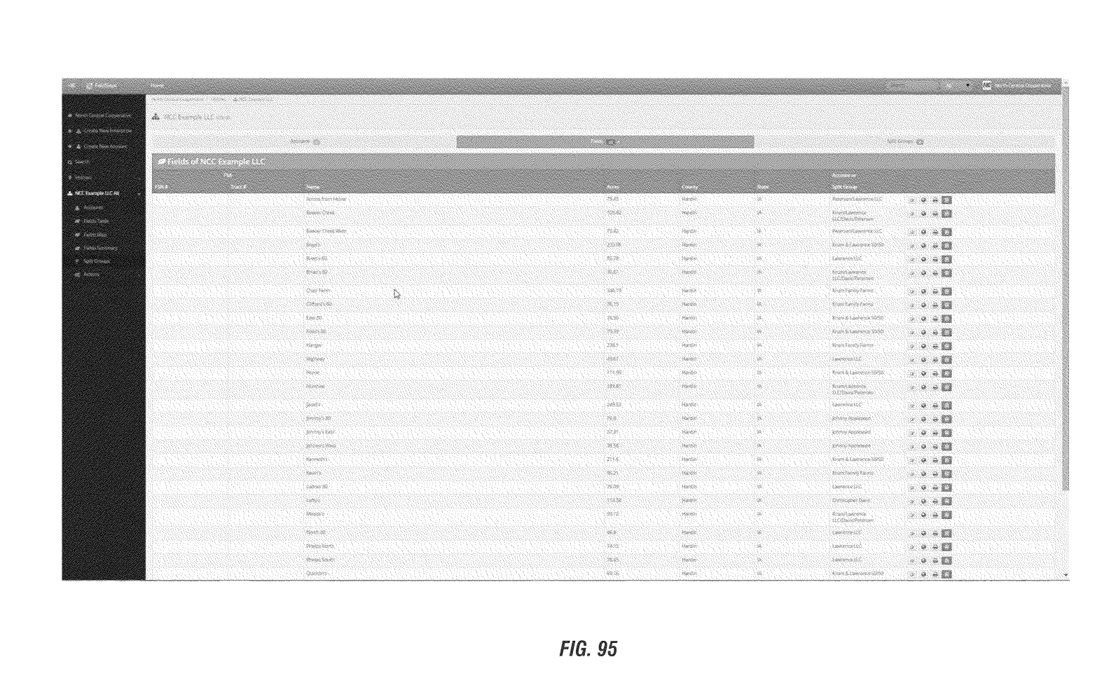

FIG. 95 is a screen display illustrating an enterprise table view page. The page lists all of the fields associated with the enterprise including the FIN number, the tract number, the name of the field, the number of acres, the county, the state, and the account or split group.

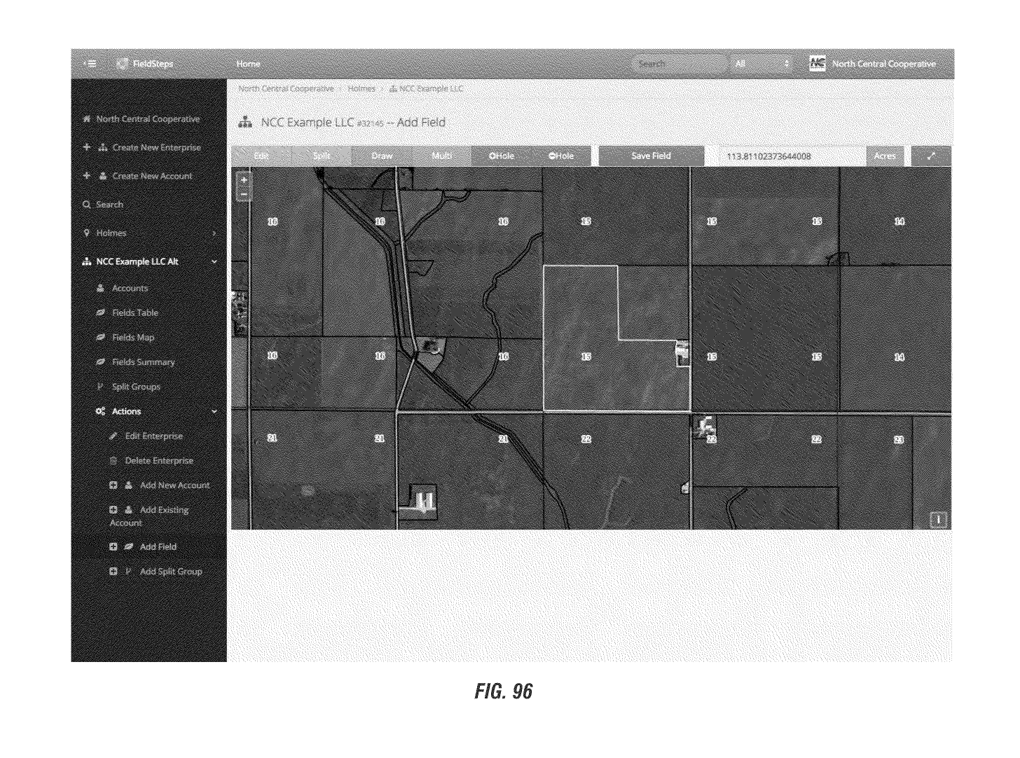

FIG. 96 is a screen display illustrating a field creator page. A field may be selected on a map.

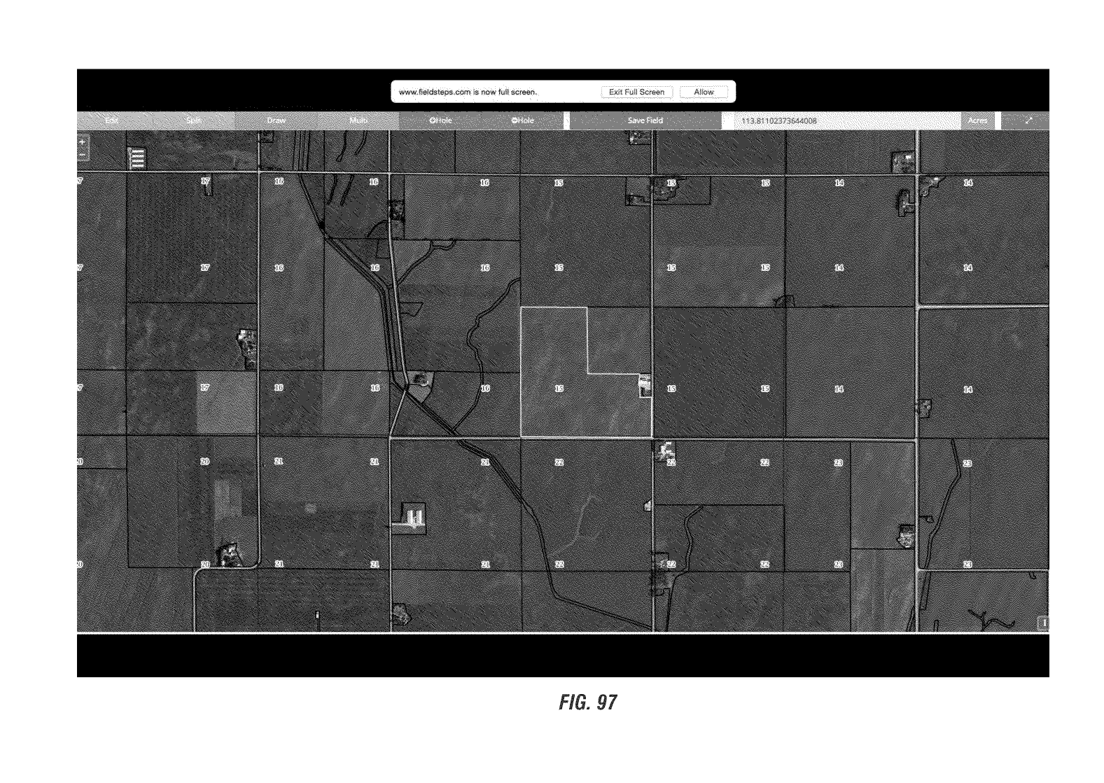

FIG. 97 is a screen display illustrating a field creator full screen. A field may be selected on the map. Tools are available to assist in identifying the field allowing one to draw the field, select multiple fields, specify holes or remove holes from a field.

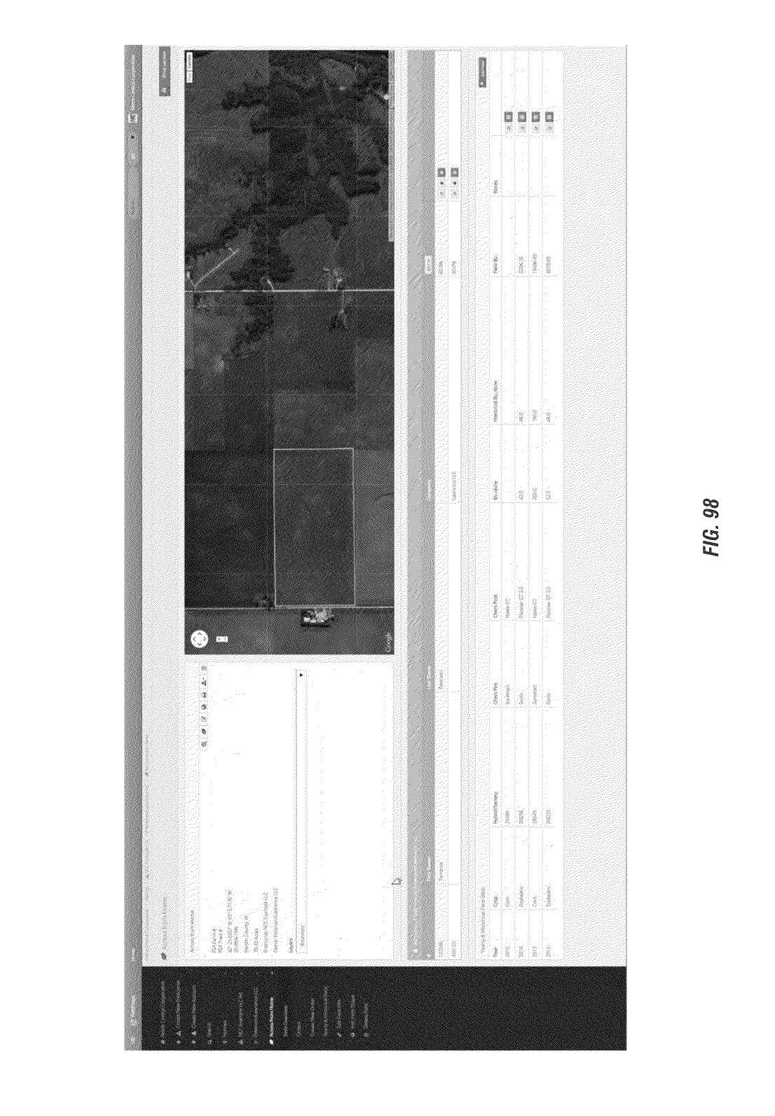

FIG. 98 is a screen display illustrating a field overview page. Information present may include basic information, a map, as well as information from previous years such as year, type of crop, hybrid/variety, chemicals applied (pre and post), the bushels per acre, the historical bushels per acre, and a total number of bushels for the field.

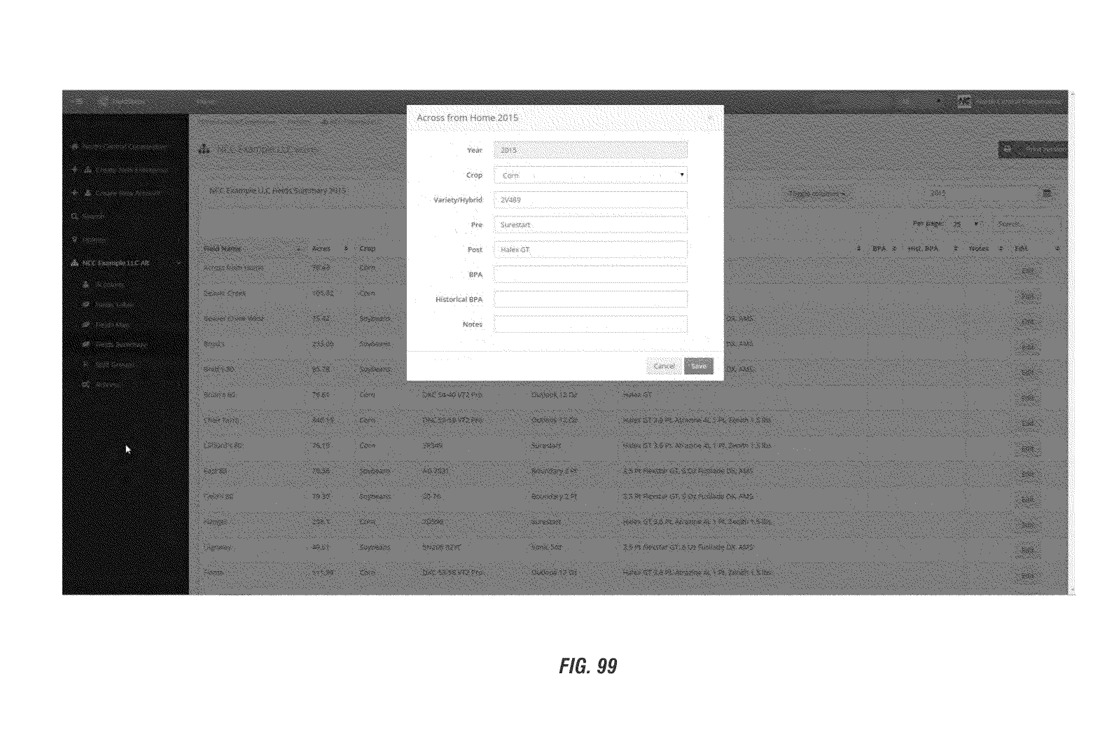

FIG. 99 is a screen display illustrating a field summary table edit page. For a particular field, information such as a year, the crop grown in the year, the variety or hybrid grown, pre- and post-emergence chemicals applied, the bushels per acre, the historical bushels per acre, and notes.

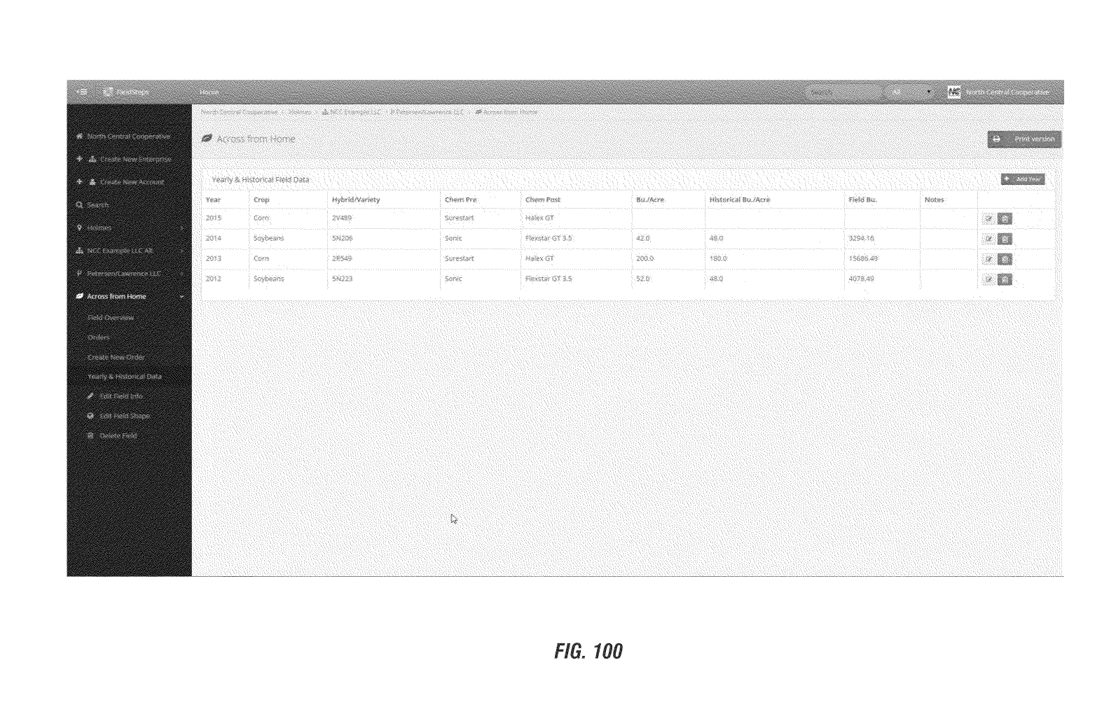

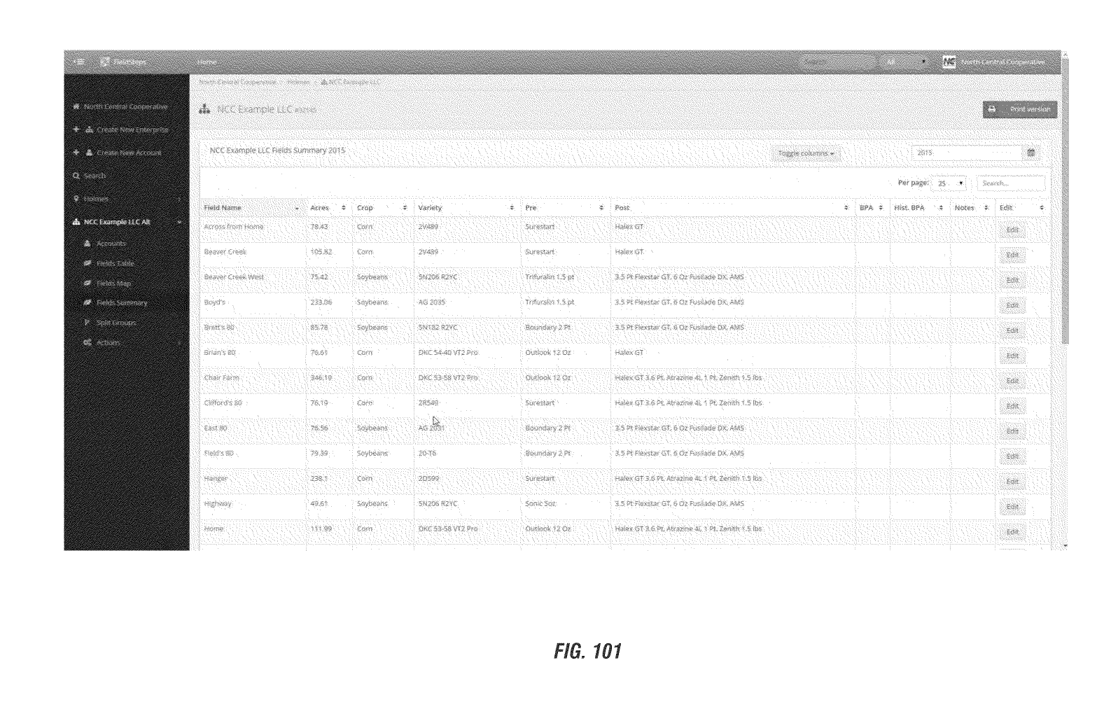

FIG. 100 is a screen display illustrating a field yearly and historical data page. For each year included information may include the type of crop, the hybrid or variety planted, the pre-emergence chemical applied, the post emergence chemical applied, the number of bushels per acre, the historical bushels per acre, the number of bushels within the field, and notes.

FIG. 101 is a screen display illustrating a field summary table page. Information includes field name, acres, crop, variety, pre-emergence, post-emergence, bushels per acre, historical bushels per acre, and notes for each field associated with an enterprise.

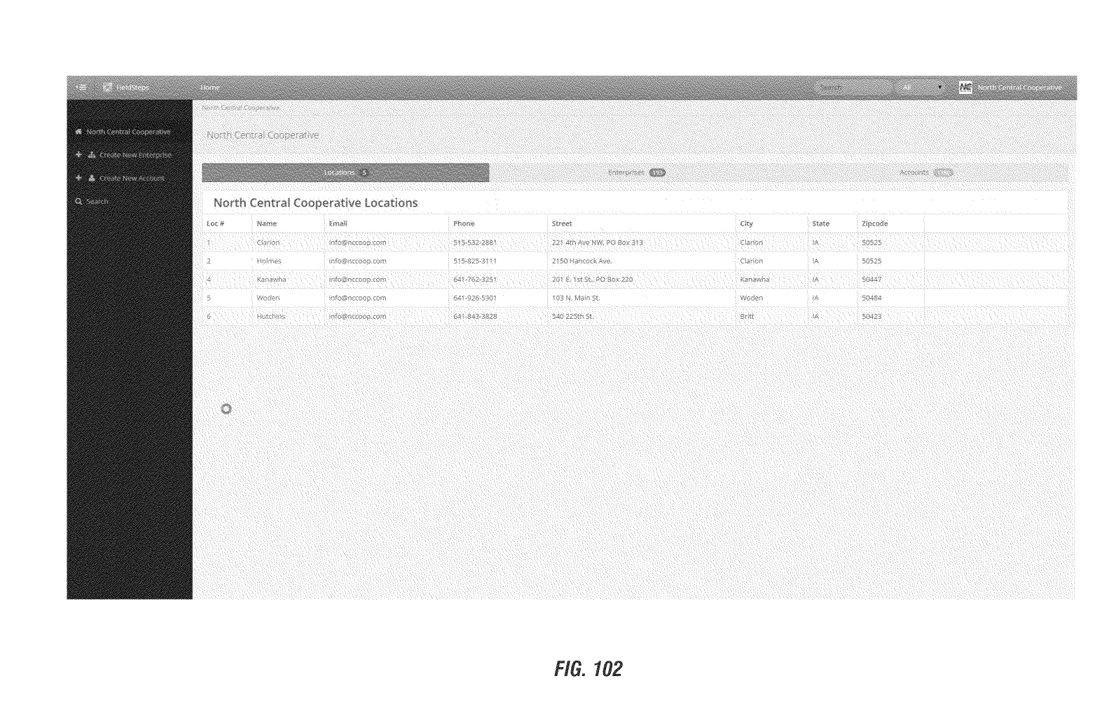

FIG. 102 is a screen display illustrating a home screen page. Each coop location is shown including the location number, the name, an email address, a phone number, a street address, a city, a state, and a zip code.

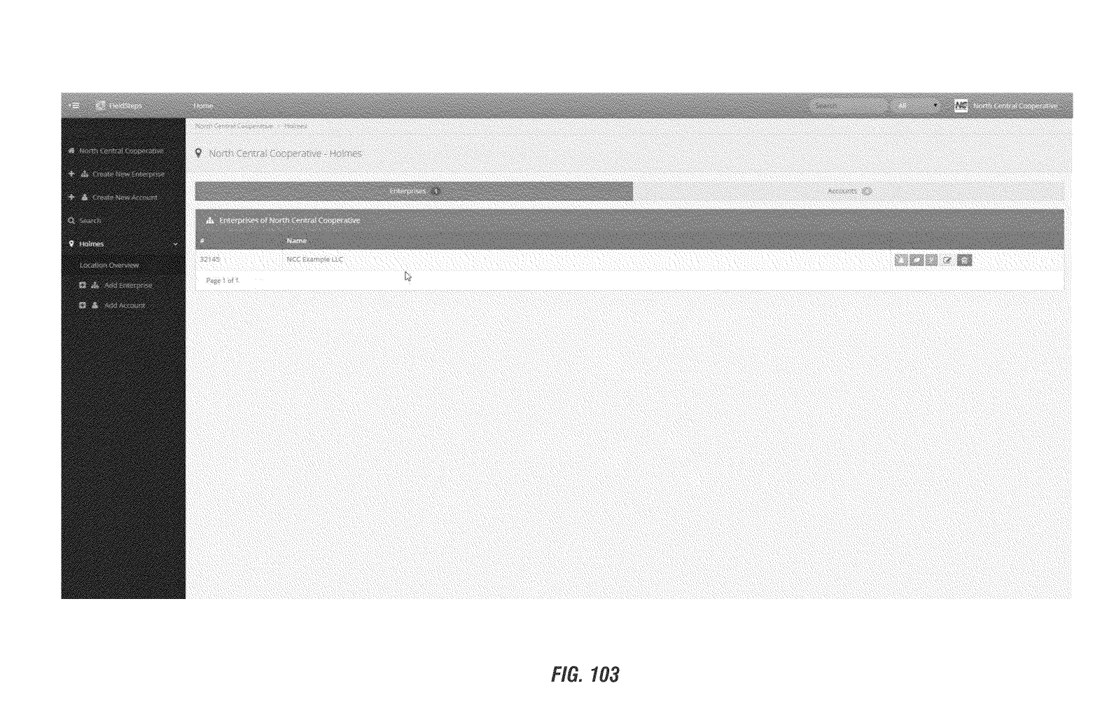

FIG. 103 is a screen display illustrating a location home screen page listing enterprises.

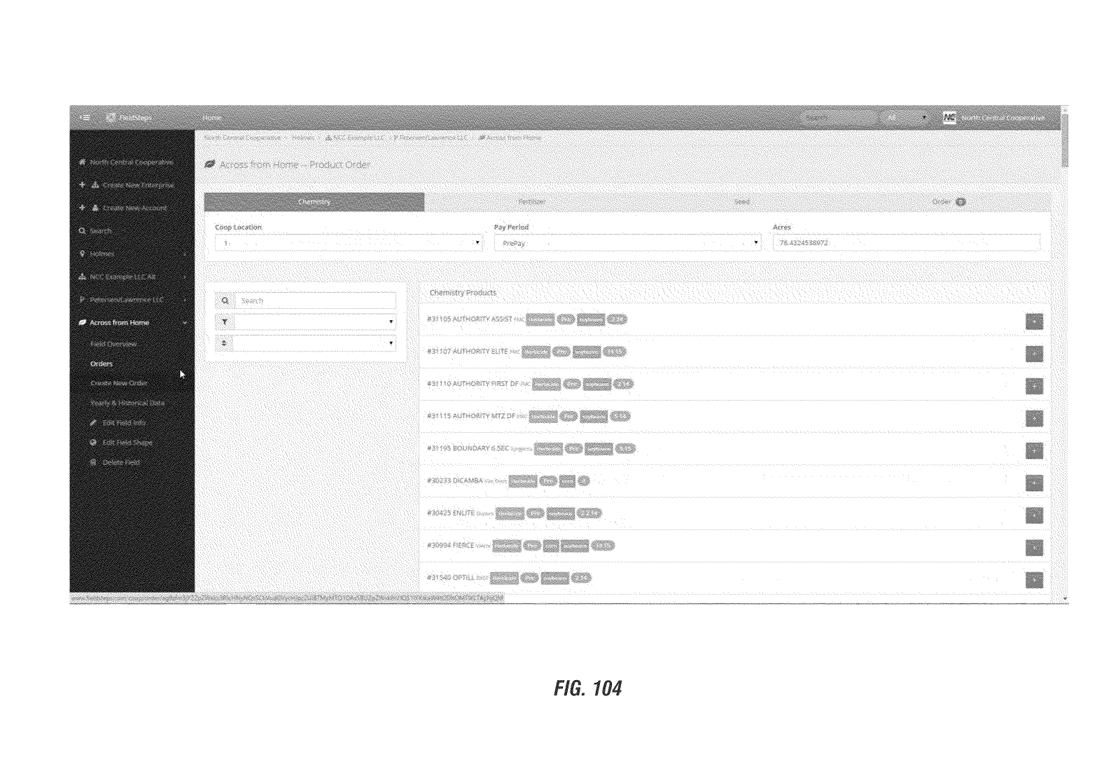

FIG. 104 is a screen display illustrating a chemical new order page. Ordering may be performed for chemistry, fertilizer, or seed. As shown in FIG. 104, various chemistry products are listed which may be added to the order. For each chemistry product information regarding the type of chemical (e.g. herbicide), whether the product is applied pre-emergence or post-emergence, the type of crop, and the application rate may be shown.

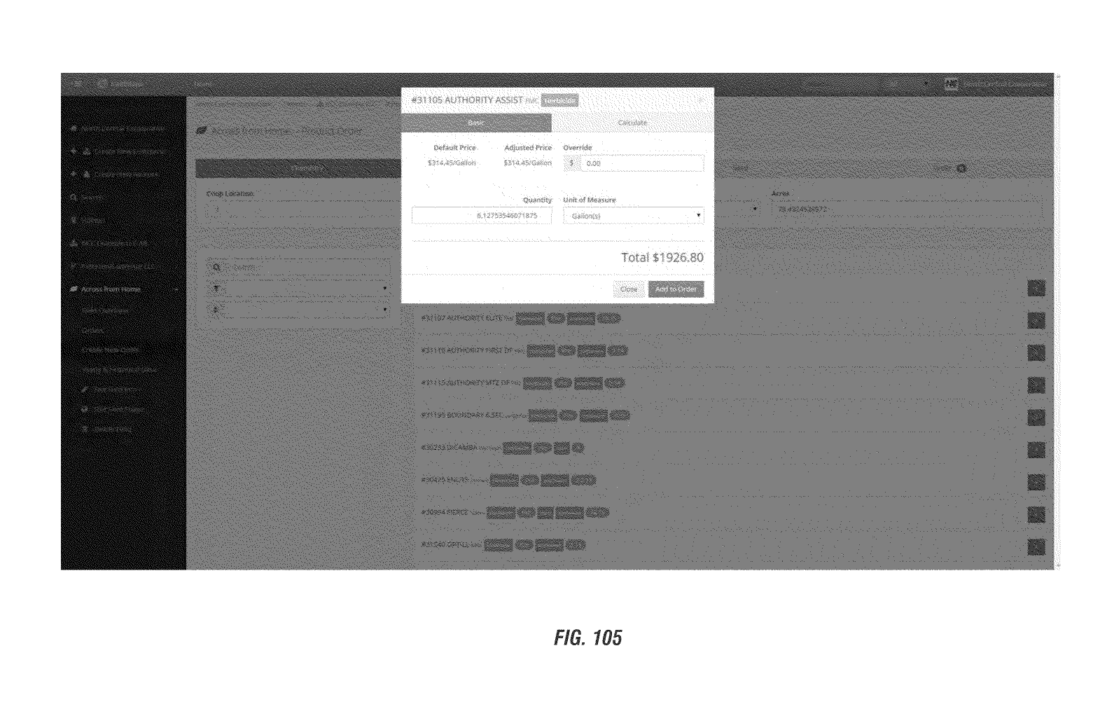

FIG. 105 is a screen display illustrating a chemical new order page with price override. This allows an authorized user (such as an agronomist) to specify a per unit price. The quantity of product and the unit of measure may also be shown as well as the total price for the field.

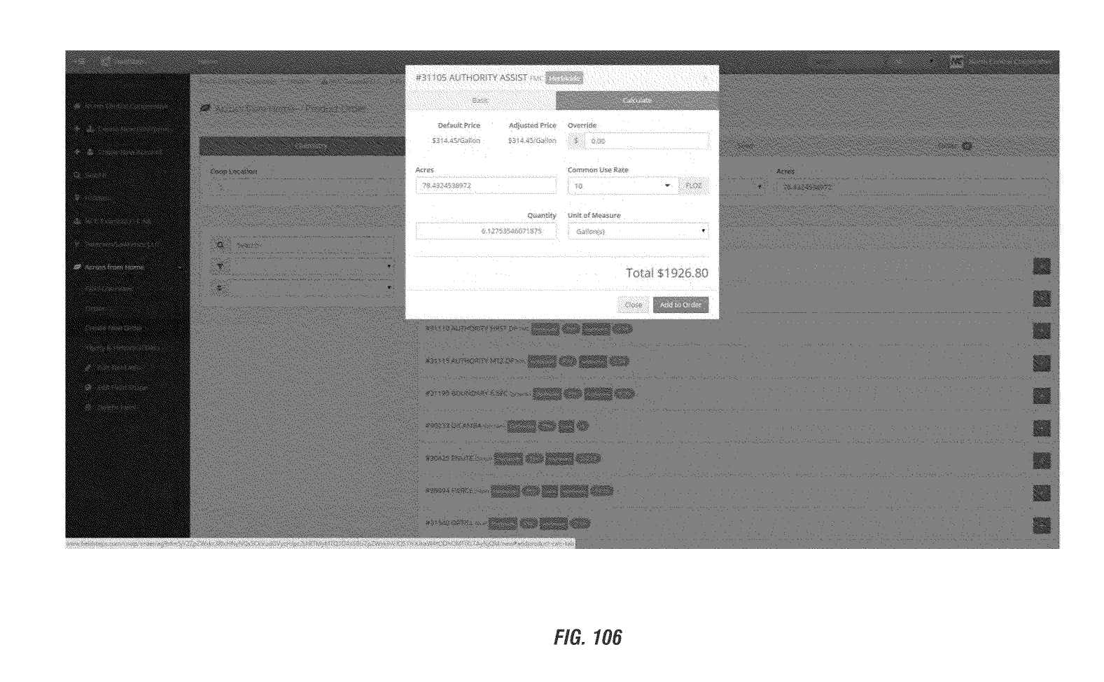

FIG. 106 is a screen display illustrating a chemical new order calculate page. Note that in FIG. 106, the number of acres and the desired use rate is used to calculate the amount of chemical for the field.

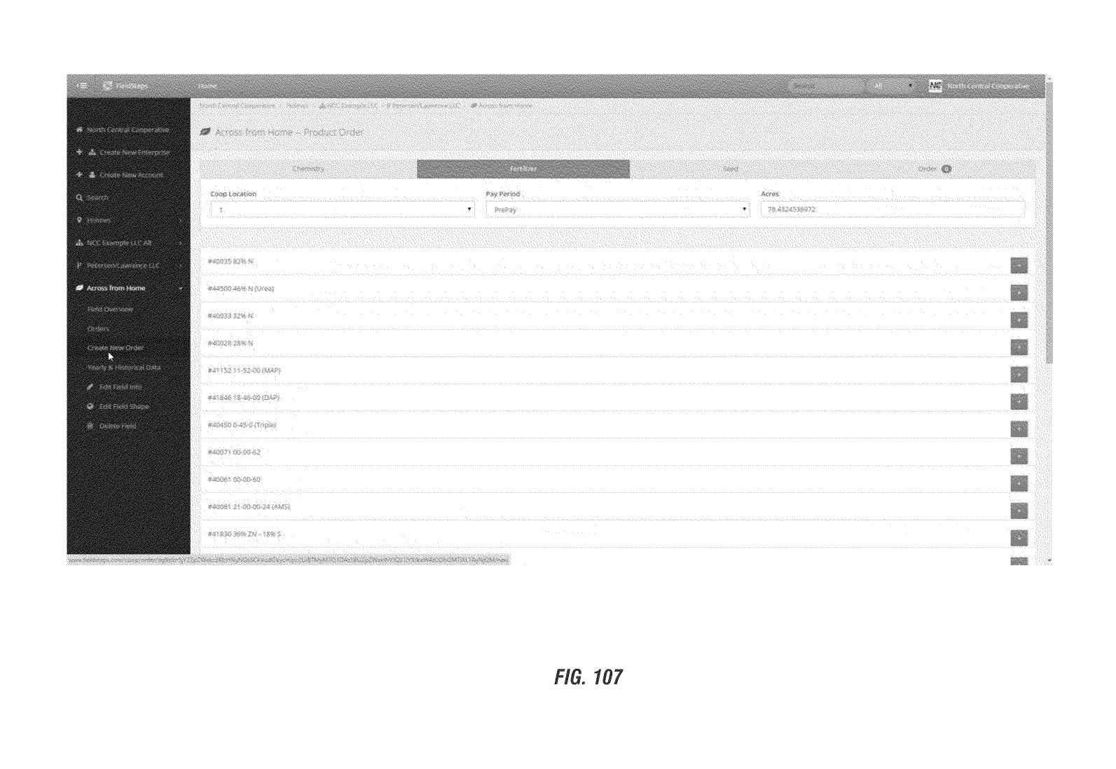

FIG. 107 is a screen display illustrating a fertilizer new order page. A number of different fertilizers are listed.

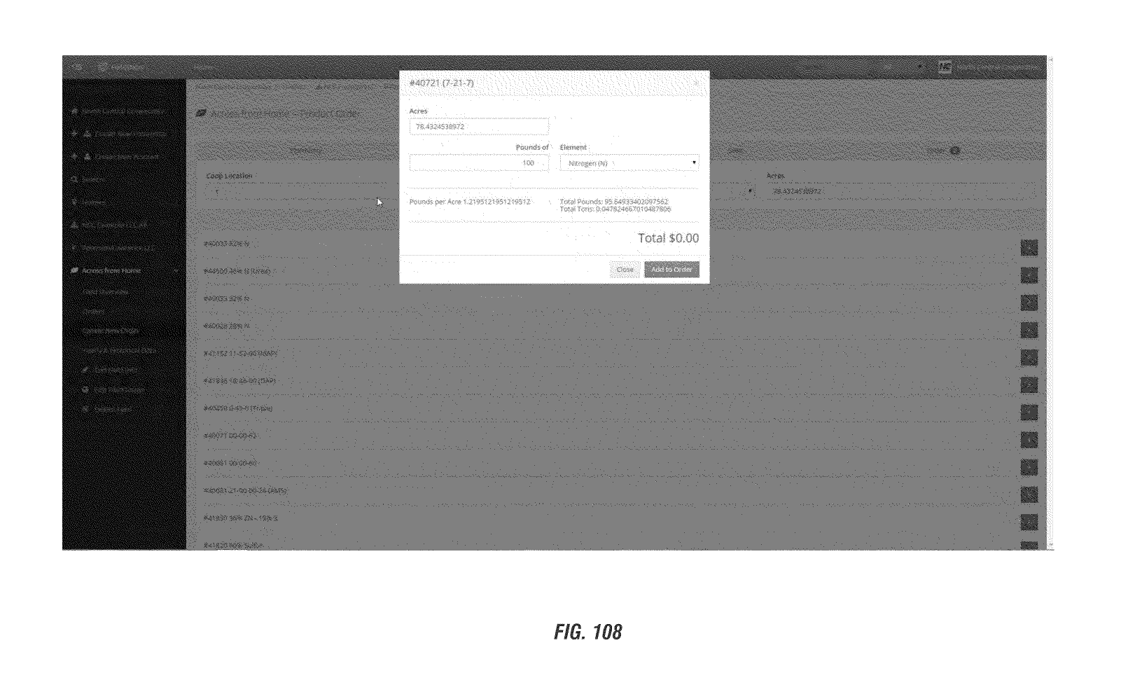

FIG. 108 is a screen display illustrating a fertilizer new order calculation page. The number of pounds of fertilizer per acre and the total pounds of fertilizer are calculated from the number of acres.

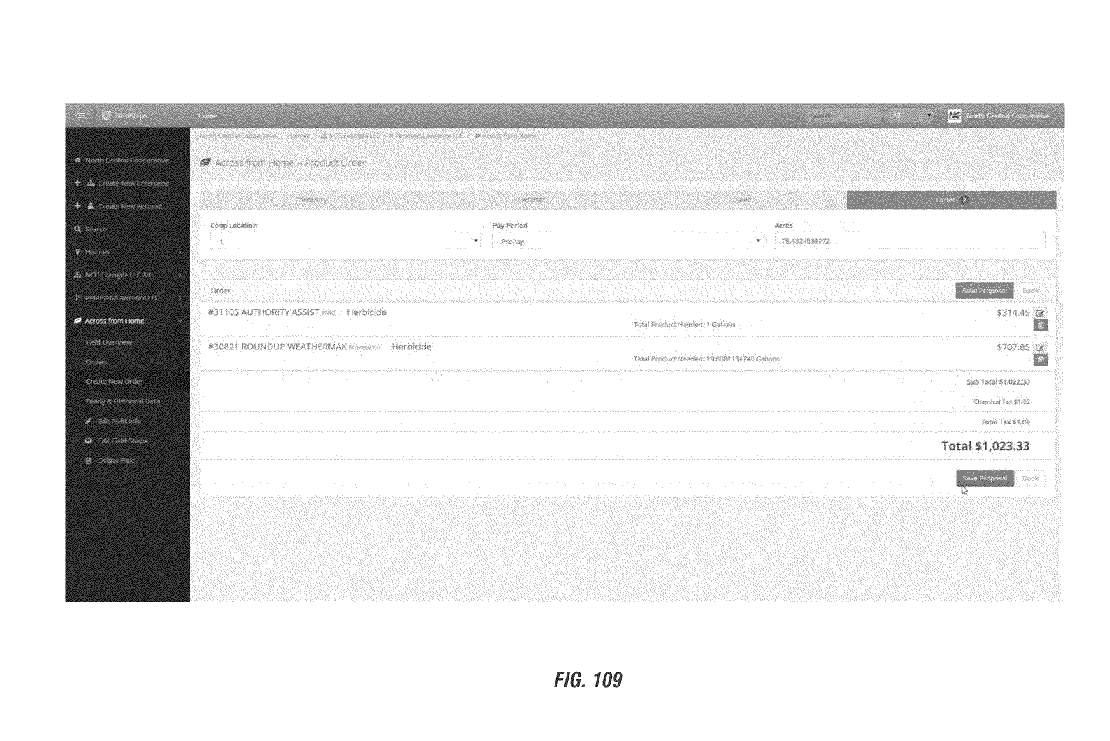

FIG. 109 is a screen display illustrating a new order proposal overall page. It shows the products to be ordered for a field, the total product needed, and the associated pricing.

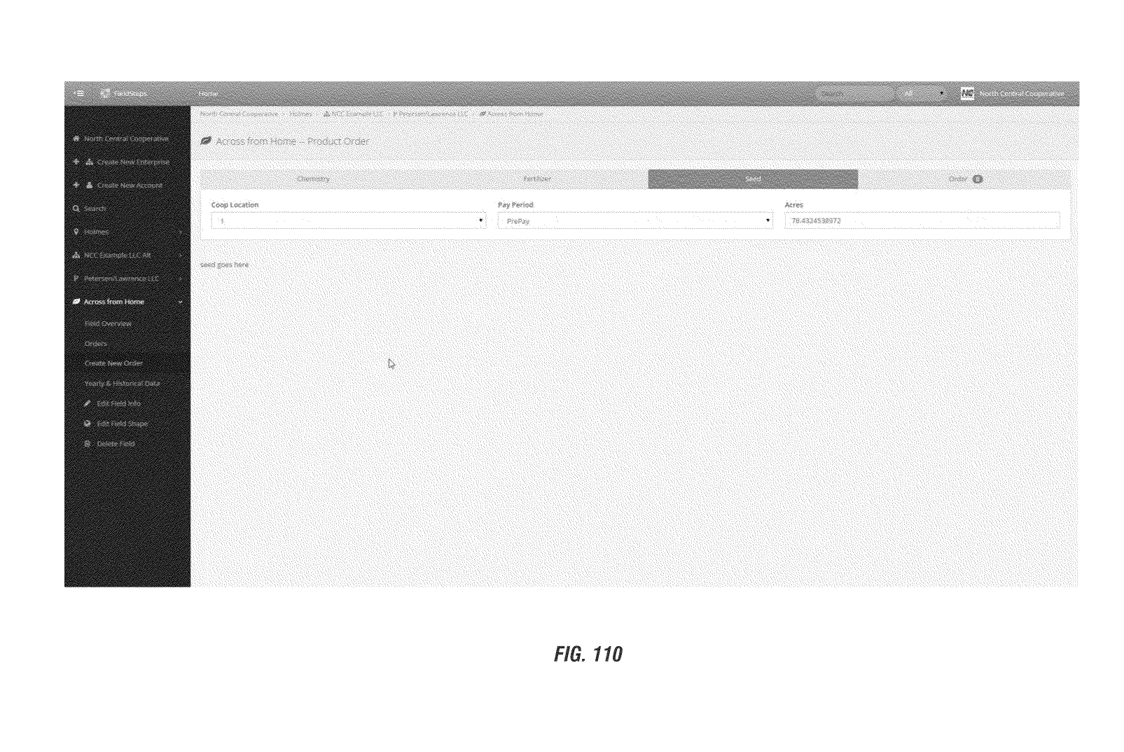

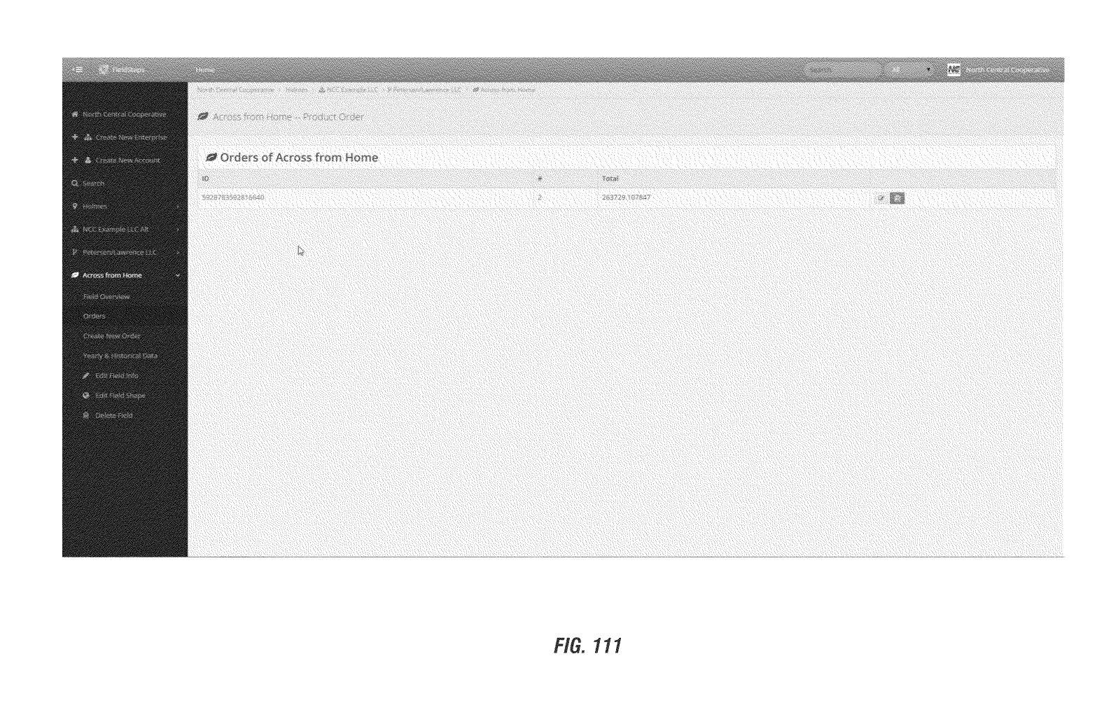

FIG. 110 is a screen display illustrating a new order proposal overall page for seed. Seed may be specified in a manner similar to that of chemicals.

FIG. 111 is a screen display illustrating an orders page. The page shows orders for a selected field.

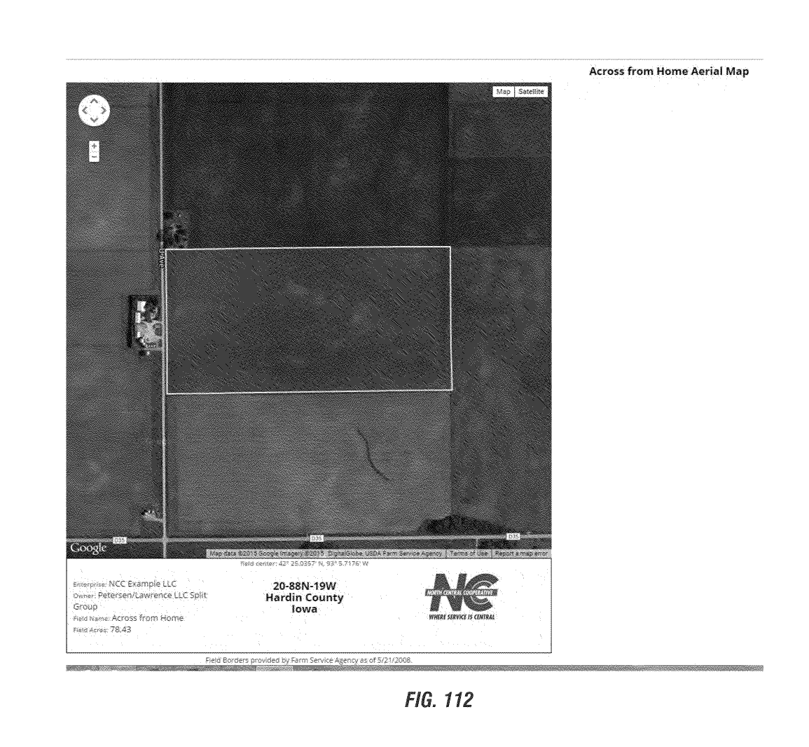

FIG. 112 is a screen display illustrating a print field map page. An outline of the field is presented on the page.

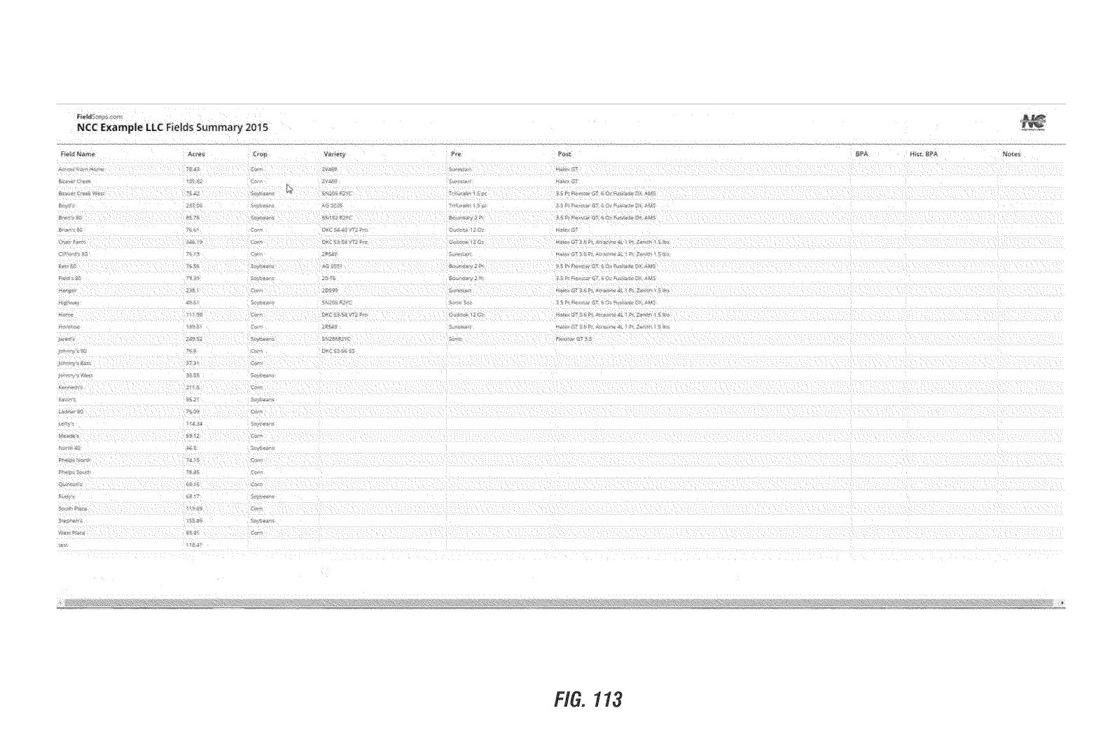

FIG. 113 is a screen display illustrating a print fields summary page. It displays information for fields such as the field name, acres, crop, variety, pre-emergence chemistry, post emergence chemistry, bushels per acre, historical bushels per acre, and notes.

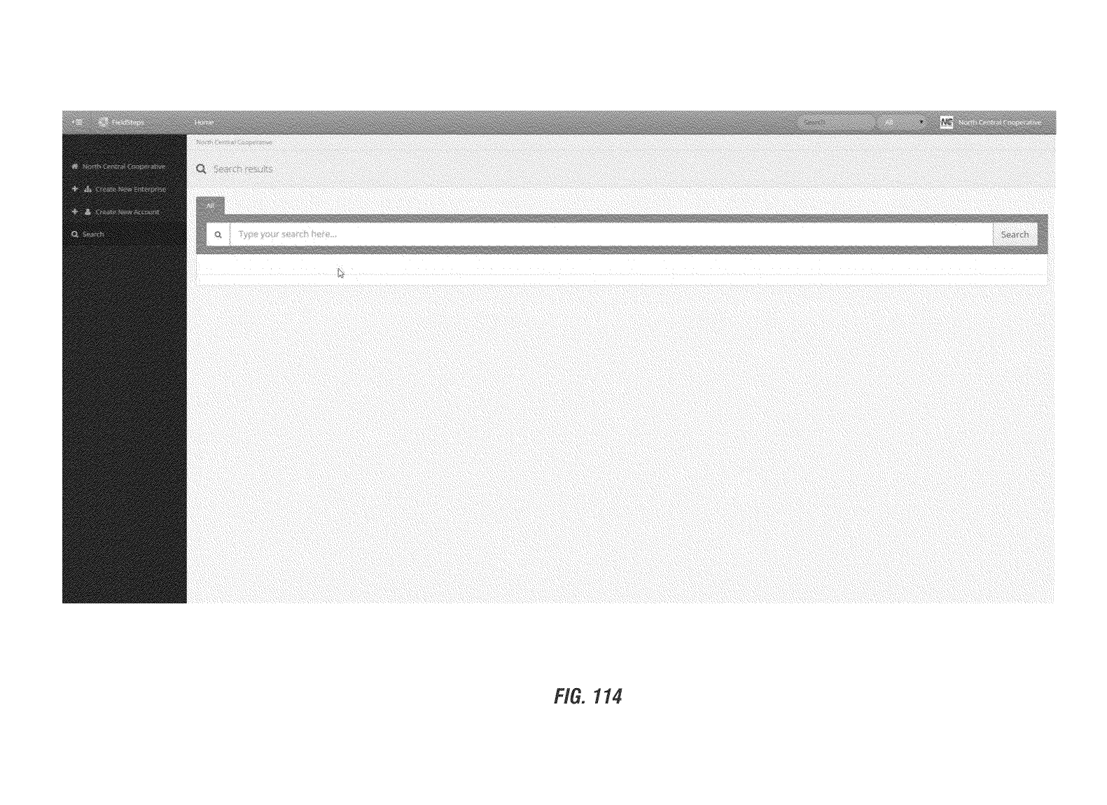

FIG. 114 is a screen display illustrating a search page. The search function may be used to search for an enterprise, an account, a field, a split group, or other information.

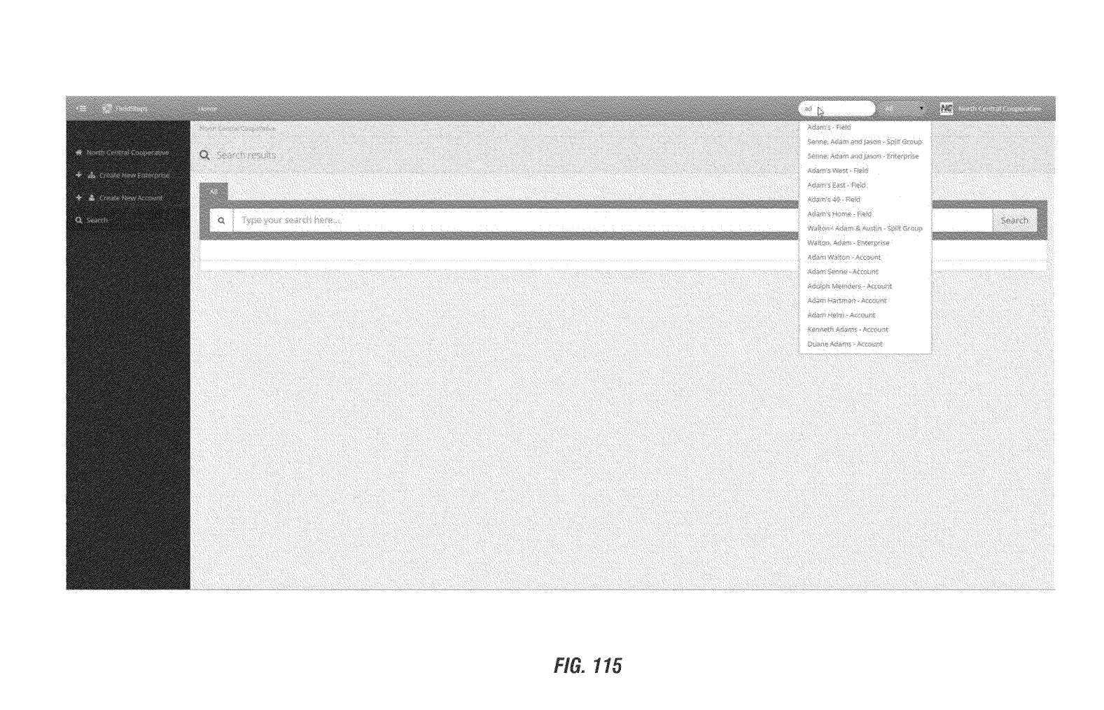

FIG. 115 is a screen display illustrating a search bar being used. Note that one may search for fields, split groups, enterprises, accounts, or other information.

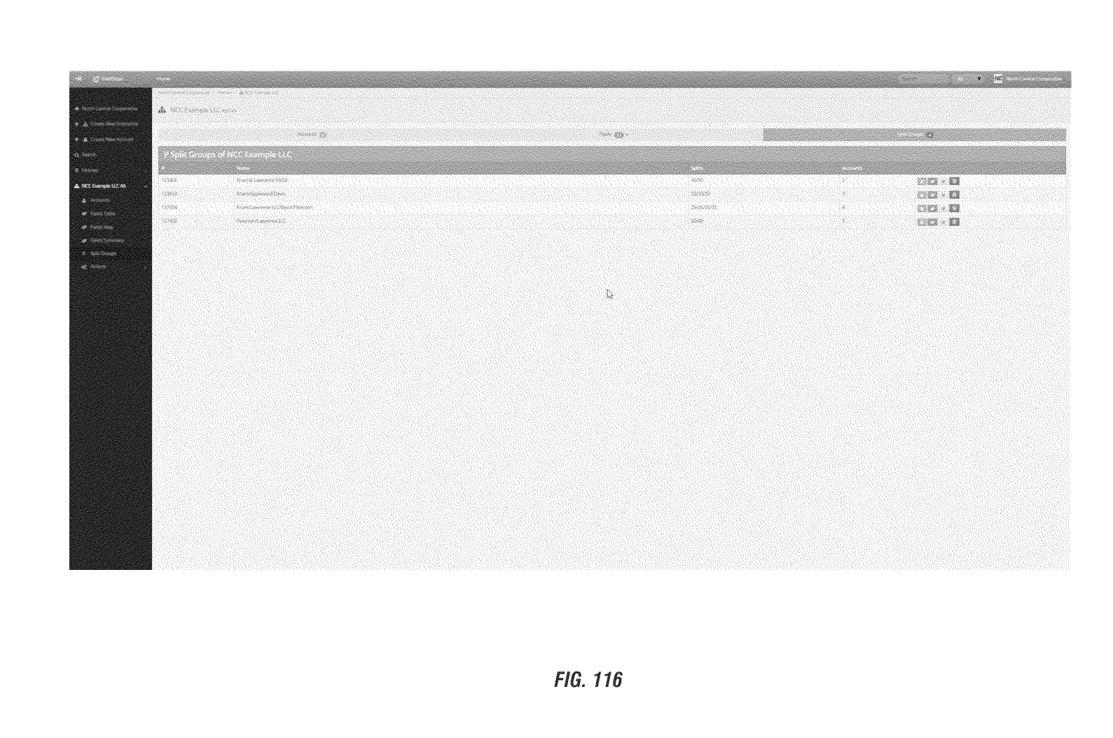

FIG. 116 is a screen display illustrating a split group home screen page. This shows all split groups. A number may be used to identify the split group as well as a name for the split group (which may be a listing of the accounts to split the group between), the splits (e.g. 50/50, 33/33/33, 25/25/25/25, 60/40, etc.), and the number of accounts within the split group (e.g. two, three, four, or more).

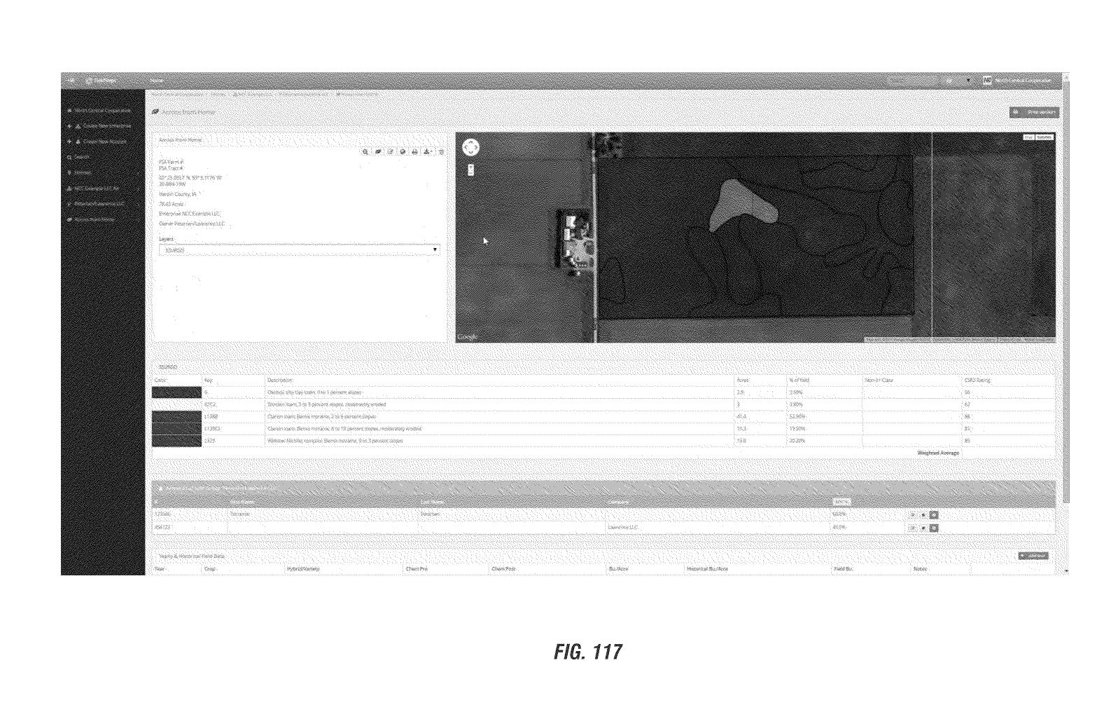

FIG. 117 is a screen display illustrating a SSURGO field map page. Note that a field map is shown and different colors may be used to identify the location of different soil types. A key may indicate what color is associated with what soil type, the number of acres for each type, the percentage of the field for each type, and a CSR2 rating.

It is to be understood that the collection, organization, and display information as provided by the systems shown and described are advantageous in a number of contexts and for a variety of reasons. For example, summaries may be produced for a field or an operation or enterprise. Such summaries may be used for any number of purposes including for a producer to determine compliance with regulations or government recommendations. This may include complying with regulations regarding fertilizer use and limitations on the amount of fertilizer use. This may include determining the fields or portions of fields which are to participate in particular government programs. Information maintained may be used by the producers for any number of purposes.

Information regarding production may be used to assist in grain marketing. Thus, for example, where a coop provides chemical or seed inputs to a producer, the coop may also provide information regarding availability of grain which a producer may have available to sell.

It is further to be understood that information associated with multiple producers may be aggregated for various purposes. For example, historical data may be used to predict performance of particular genetics in certain areas or under certain conditions. Of course, data may be aggregated in any number of ways for any number of other purposes.

Therefore, various methods and systems have been disclosed herein. Although specific examples have been shown, the present invention is not to be limited to the specific examples shown as numerous variations, options, and alternatives are contemplated.

What is claimed is:

1. A system for crop production management, wherein the system comprises:
instructions executing on a computing device for collecting and displaying field specific agricultural data and business data sufficient for a crop producer to make determinations regarding agricultural inputs comprising seed, fertilizer, and chemicals;
an ordering system associated with a back-end computing system for providing pricing for the agricultural inputs on a per unit basis and on a field-by-field basis; and
an inventory system associated with the back-end computing system and operatively connected to the ordering system for updating inventory for the agricultural inputs associated with an agricultural service business providing the agricultural inputs to the crop producer;
wherein the back-end computing system is in operative communication with the computing device.

2. The system of claim 1 wherein the computing device comprises a web-based server.

3. The system of claim 2 wherein the instructions further provide for generating a user interface.

4. The system of claim 1 wherein the field specific agricultural and business data comprises a field name, a field location, billing information for the field, an aerial map for the field, a soil type map for the field, historical yield data for the field, and weather data for the field.

5. The system of claim 1 further comprising an analysis component executing on the computing device for providing a field fertility analysis, a field chemistry analysis, and a field seed selection analysis.

6. The system of claim 5 wherein the analysis component further providing a field expense analysis, a field income analysis, and a field profit/loss analysis.

7. The system of claim 1 wherein the field specific agricultural data comprises soil data for the field and crop production history for the field.

8. The system of claim 1 wherein the business data comprises expenses associated with crop production in the field.

9. The system of claim 8 wherein the expenses comprise machinery expenses, fuel expenses, drying and electricity expenses, repairs, interest, property taxes, insurance, and crop input expenses.

10. The system of claim 1 wherein the business data comprises projected revenue data associated with crop production in the field.

11. The system of claim 10 wherein the projected revenue data comprises income from government programs.

12. The system of claim 10 wherein the projected revenue data comprises income from pre-selling grain contracts.

13. The system of claim 1 wherein the crop inputs comprise seed, nutrients, fertilizer, fungicide, insecticide, and herbicide.

14. The system of claim 1 wherein the field specific agricultural data comprises mapping data.

15. The system of claim 1 further comprising a field diagnostics component executing on the computer, the field diagnostics component comprising links to external data sources.

16. The system of claim 1 further comprising a field notes component.

17. The system of claim 1 further comprising a field learning blocks component configured to generate additional data for display by the computing device.

18. A method for crop management, the method comprising:
providing through a software system executing on a computer to a crop producer field specific agricultural data and business data sufficient for a crop producer to make determinations regarding agricultural inputs comprising seed, fertilizer, and chemicals;
recording ordering information for crop-producer ordered seed, fertilizer, and chemicals on a field-by-field basis; and
tracking pickup, delivery, and returns of the crop-producer ordered seed, fertilizer, and chemicals on a field-by-field basis.

19. The method of claim 18 further comprising displaying to the crop producer data on a field-by-field basis.

20. The method of claim 19 wherein the data is displayed on a map.

21. The method of claim 20 wherein the data comprises precipitation data.
